(19) United States
(12) Patent Application Publication
(10) Pub. No.: US 2022/0079280 A1
(43) Pub. Date: Mar. 17, 2022

(54) ARTICLES COMPRISING ADDITIVELY-MANUFACTURED COMPONENTS AND METHODS OF ADDITIVE MANUFACTURING

(71) Applicant: Bauer Hockey Ltd., Blainville (CA)

(72) Inventors: Jean-Francois Laperriere, Prevost (CA); Thierry Krick, Coteau-du-Lac (CA); Jacques Durocher, Saint-Jerome (CA); Jean-Francois Corbeil, Prevost (CA); Alexis Seguin, Laval (CA); Edouard Rouzier, Montreal (CA)

(21) Appl. No.: 17/526,489

(22) Filed: Nov. 15, 2021

Related U.S. Application Data
(63) Continuation of application No. PCT/CA2020/050689, filed on May 21, 2020.
(60) Provisional application No. 62/850,831, filed on May 21, 2019.
(60) Provisional application No. 62/851,080, filed on May 21, 2019.
(60) Provisional application No. 62/881,687, filed on Aug. 1, 2019.
(60) Provisional application No. 62/910,002, filed on Oct. 3, 2019.
(60) Provisional application No. 62/969,307, filed on Feb. 3, 2020.

(51) Int. Cl. A42B 3/12; B33Y 70/00; B29C 64/165; B33Y 80/00; B33Y 10/00; B29L 31/48; B29L 31/52; B29K 105/04

(52) U.S. Cl. CPC A42B 3/12; B33Y 70/00; B29C 64/165; B29K 2105/048; B33Y 10/00; B29L 2031/4821; B29L 2031/52; B33Y 80/00

(57) ABSTRACT

Articles comprising one or more additively-manufactured components are provided, as are method of additively manufacturing such components. The additively-manufactured components are designed to enhance performance and use of the article, such as, but not limited to: impact protection, including for managing different types of impacts; fit and comfort; adjustability; and/or other aspects of the article. The provided methods of additive manufacturing include methods involving expandable materials and the expansion of post-additively manufactured expandable components.

### CROSS-REFERENCE TO RELATED APPLICATIONS

This application is a continuation of international PCT patent application No. PCT/CA2020/050689 filed on May 21, 2020 and claims the benefit of U.S. Provisional Patent Application No. 62/851,080 filed May 21, 2019, U.S. Provisional Patent Application No. 62/850,831 filed May 21, 2019, U.S. Provisional Patent Application No. 62/881,687 filed Aug. 1, 2019, U.S. Provisional Patent Application No. 62/910,002 filed Oct. 3, 2019 and U.S. Provisional Patent Application No. 62/969,307 filed Feb. 3, 2020, the entire contents of which are incorporated by reference herein.

### FIELD

This disclosure generally relates to articles, such as of athletic gear (e.g., helmets, shoulder pads or other protective equipment, hockey sticks or other sporting implements, etc.) and other equipment, and, more particularly, to articles including components made by additive manufacturing.

### BACKGROUND

Articles, such as devices or other functional items, are manufactured for various purposes.

For example, articles of athletic gear are made for users engaging in sports or other athletic activities. Helmets, for example, are worn in sports and other activities (e.g., motorcycling, industrial work, military activities, etc.) to protect their wearers against head injuries. To that end, helmets typically comprise a rigid outer shell and inner padding to absorb energy when impacted.

Helmets are often desired to be lightweight and have various properties, such as strength, impact resistance, linear and rotational impact protection, breathability, compactness, comfort, etc., which can sometimes be conflicting, require tradeoffs, or not be readily feasible, for cost, material limitations, manufacturability, and/or other reasons.

Manufacturing of various devices often involves molding parts of these devices, such as by injection molding, compression molding, thermoforming, etc. For example, athletic gear such as helmets, shoulder pads, sporting implements (e.g., hockey sticks), etc., typically comprise molded parts.

More recently, additive manufacturing techniques have been used to manufacture various devices. Additive manufacturing usually entails building up layers of feedstock materials layer-by-layer to substantially final dimensions of the parts. In some cases, this may present certain drawbacks. For example, the final dimensions of the parts may is generally constrained by the maximum dimensions over which the additive material can be distributed in the layer-building process. As another example, additively manufacturing larger parts may take longer to manufacture because the additive material must be distributed over a larger area/volume. As yet another example, characteristics of additively-manufactured parts are often dictated or affected by their additive-manufacturing process.

For these and other reasons, there is a need to improve manufacturability, performance and use of devices and articles comprising additively-manufactured parts.

### SUMMARY

According to various aspects, this disclosure relates to a component for an article, the component comprising a 3D-printed portion, the component including expandable material expanded to define the component.

According to another aspect, this disclosure relates to an article comprising a component according to the above aspect.

According to another aspect, this disclosure relates to a component for an article, the component comprising a 3D-printed portion, the component including expandable material expanded from an initial shape to an expanded shape that is a scaled-up version of the initial shape.

According to another aspect, this disclosure relates to a method of making a component of an article, the method comprising: providing expandable material; 3D printing a 3D-printed portion of the component; and expanding the expandable material to define the component.

According to another aspect, this disclosure relates to an article comprising a component made by the method according to the above aspect.

According to another aspect, this disclosure relates to a component for an article, the component comprising 3D-printed expandable material expanded after being 3D printed.

According to another aspect, this disclosure relates to an article comprising a component according to the above aspect.

According to another aspect, this disclosure relates to a method of making a component of an article, the method comprising: providing expandable material; 3D printing the expandable material to create 3D-printed expandable material; and expanding the 3D-printed expandable material to define the component.

According to another aspect, this disclosure relates to an article comprising a component made by the method according to the above aspect.

According to another aspect, this disclosure relates to an impact absorbing article comprising an additively-manufactured component; a first portion of the additively-manufactured component is configured to protect more against higher-energy impacts than lower-energy impacts; and a second part of the additively-manufactured component is configured to protect more against lower-energy impacts than higher-energy impacts.

According to another aspect, this disclosure relates to an article comprising a plurality of additively-manufactured components with different functions additively-manufactured integrally with one another.

According to another aspect, this disclosure relates to an article comprising an additively-manufactured component and a non-additively-manufactured component received by the additively-manufactured component.

According to another aspect, this disclosure relates to an article comprising an additively-manufactured component and a sensor associated with the additively-manufactured component.

According to another aspect, this disclosure relates to a method of making an impact absorbing article, the method comprising: providing feedstock; and additively manufacturing a component of the impact absorbing article using the feedstock, wherein: a first part of the additively-manufactured component is configured to protect more against higher-energy impacts than lower-energy impacts; and a second part of the additively-manufactured component is configured to protect more against lower-energy impacts than higher-energy impacts.

According to another aspect, this disclosure relates to a method of making an impact absorbing article, the method comprising: providing feedstock; and additively manufacturing a plurality of components of the impact absorbing article that have different functions integrally with one another, using the feedstock.

### BRIEF DESCRIPTION OF DRAWINGS

A detailed description of embodiments is provided below, by way of example only, with reference to drawings accompanying this description, in which:

FIG. 1 shows an embodiment of an article comprising additively-manufactured components, in which the article is an article of athletic gear, and more particularly a helmet for protecting a user's head;

FIG. 2 shows a front view of the helmet;

FIGS. 3 and 4 show rear perspective views of the helmet;

FIGS. 5 and 6 show examples of a faceguard that may be provided on the helmet;

FIGS. 7 and 8 show the head of a user;

FIG. 9 shows internal dimensions of a head-receiving cavity of the helmet;

FIGS. 10 to 13 show operation of an example of an adjustment mechanism of the helmet;

FIGS. 14 and 15 show an example of shell members of an outer shell of the helmet;

FIGS. 16 to 20 show an example of a plurality of additively-manufactured components constituting a plurality of pads of an inner liner of the helmet;

FIGS. 21A to 21C show examples of linear acceleration at a center of gravity of a headform caused by a linear impact on a helmet at three energy levels according to hockey STAR methodology;

FIGS. 22A and 22B show examples of stress-strain curves for additively manufactured components comprising a pad of an inner liner of a helmet;

FIG. 23 shows an example of an additively-manufactured lattice structure that may be used in an additively-manufactured component;

FIG. 24A shows an example of a unit cell occupying a voxel that may be used to form an additively-manufactured component;

FIG. 24B shows another example of a mesh or shell style unit cell that may be used to form an additively-manufactured component;

FIGS. 24C, 24D, 24E and 24F shows further examples of unit cells that may be used to form an additively-manufactured component;

FIGS. 25A, 25B, 25C, 25D, 25E, 25F and 25G show examples how a volume occupied by an additively-manufactured component may be populated with different combinations of unit cells;

FIG. 26 shows examples of lattice and non-lattice “skins” that may be formed on a lattice structure in order to provide an outer surface for the lattice structure;

FIG. 27 shows a side view of an example of an additively-manufactured component constituting a front pad member of the inner lining of the helmet;

FIGS. 28A and 28B show an example of an additively-manufactured component comprising a two-dimensional (2D) lattice structure;

FIG. 29 shows an example of an additively-manufactured component comprising a three-dimensional (3D) lattice structure;

FIGS. 30A, 30B and 30C show another example of an additively-manufactured component comprising a 3D lattice structure;

FIGS. 31A and 31B show yet another example of an additively-manufactured component comprising a 3D lattice structure;

FIG. 32 shows still another example of an additively-manufactured component comprising a 3D lattice structure;

FIG. 33 shows an example of an additively-manufactured component constituting a shoulder cap member of shoulder padding for a hockey or lacrosse player;

FIGS. 34A, 34B and 34C show an example of an additively-manufactured component constituting an occipital pad member of the inner lining of a hockey helmet;

FIGS. 35A, 35B, 35C and 35D show examples of additively-manufactured components comprising a plurality of distinct zones structurally different from one another;

FIG. 36 shows examples of additively-manufactured components comprising lattice structures utilizing the same unit cell but different voxel sizes;

FIGS. 37A and 37B show another example of an additively-manufactured component constituting an occipital pad member of the inner lining of a hockey helmet;

FIG. 38 shows examples of additively-manufactured components comprising lattice structures utilizing the same unit cell but different elongated member sizes;

FIGS. 39A and 39B show an example of pads of a helmet in an open position and a closed position, respectively;

FIG. 40 shows an example of a precursor of a post-molded expandable component being expanded to form the post-molded expandable component;

FIG. 41 is a block diagram representing an example of an expandable material of the post-molded expandable component;

FIG. 42 shows an example of an expansion agent of the expandable material of the post-molded expandable component;

FIG. 43 shows a cross-sectional view of a sport helmet with inner padding that includes additively-manufactured components integrated into post-molded expandable components;

FIG. 44 shows an example of a precursor of a post-additively manufactured expandable component being expanded to form the post-additively manufactured expandable component;

FIG. 45 shows a schematic of an example of a binder jetting system for forming a precursor of a post-additively-manufactured expandable component;

FIG. 46 shows an exploded view of an example of inner padding for a sport helmet in which the comfort pads include additively manufactured components;

FIG. 47 shows a cross-sectional view of a portion of the inner padding of FIG. 46;

FIGS. 48A and 48B show examples of a liquid crystal elastomer material in compressed and uncompressed states;

FIG. 49 shows an example of inner padding for a sport helmet that includes liquid crystal elastomer components;

FIG. 50 shows an example of an additively manufactured component with a lattice structure in which liquid crystal elastomer components have been incorporated;

FIG. 51 shows a cross-sectional view of a sport helmet with inner padding that includes air channels integrally formed within additively manufactured components of the inner padding;

FIG. 52 shows an example of additively-manufactured components constituting a chin cup and a face mask of a helmet;

FIGS. 53A, 53B and 53C show an example of an additively-manufactured component constituting a face mask of a helmet for a hockey goalie;

FIG. 54 shows an embodiment of a lacrosse helmet comprising additively-manufactured components;

FIG. 55 shows an embodiment of a sporting implement that is a hockey stick;

FIG. 56 is a top view of a bottom portion of a shaft of the hockey stick and a blade of the hockey stick;

FIG. 57 is a rear view of the bottom portion of the shaft of the hockey stick and the blade of the hockey stick;

FIG. 58 is an embodiment of a lattice comprised in the hockey stick;

FIG. 59 is a variant of the hockey stick;

FIG. 60 is a portion of the shaft of the hockey stick;

FIGS. 61 to 65 show examples of framework of the lattice;

FIGS. 66 and 67 show elongate members of the lattice forming a node in accordance with an embodiment;

FIGS. 68 and 69 show the elongate members of the lattice forming the node in accordance with another embodiment;

FIGS. 70 to 75 show cross-sectional shapes of the elongate members of the lattice in accordance with various embodiments;

FIGS. 76 to 81 show cross-sectional structures of the elongate members of the lattice in accordance with various embodiments;

FIG. 82 shows a cross-section of a truss the lattice at the shaft of the hockey stick;

FIGS. 83 to 87 show variants of the cross-section of a truss the lattice at the shaft of the hockey stick;

FIGS. 88 to 91 show a cross-section of the shaft of the hockey stick in accordance with various embodiments;

FIGS. 92 and 93 show cross-sections of the blade of the hockey stick;

FIG. 94 shows an intersection between two zones of the lattice having different voxel sizes;

FIG. 95 shows an intersection between two zones of the lattice having elongate members and/or nodes of different thicknesses (or different “struts size”);

FIGS. 96A to 96H shows a manufacturing of the lattice in accordance with an embodiment;

FIG. 97 shows a variant of the lattice;

FIGS. 98 to 109 show variants of the hockey stick;

FIG. 110 shows another embodiment wherein the sporting implement is a goalie stick;

FIG. 111 shows another embodiment wherein the sporting implement is a lacrosse stick;

FIG. 112 shows another embodiment wherein the sporting implement is a ball bat;

FIG. 113 shows an example of a test for determining the strength of the sporting implement;

FIG. 114 shows an embodiment of footwear in which the footwear is a skate for a user comprising a skate boot and a blade holder and comprising additively-manufactured components;

FIG. 115 shows an exploded view of the skate;

FIGS. 116 and 117 are side and front views of a right foot of the skater with an integument of the foot shown in dotted lines and bones shown in solid lines;

FIGS. 118 to 126 show cross-sectional views of a shell of the skate boot in accordance with various embodiments;

FIG. 127 shows a tendon guard of the skate boot;

FIGS. 128 to 134 show perspective views, a lateral side view, a top view, a bottom view, a front view and a rear view of the blade holder;

FIGS. 135A and 135B show a lateral side view and a cross-sectional view of a blade in accordance with an embodiment;

FIGS. 136A and 136B show a variant of the blade;

FIGS. 137 to 139 show an assembly of the blade and the blade holder comprising a blade detachment mechanism;

FIGS. 140 to 141 show variants of the assembly of the blade and the blade holder and of the blade detachment mechanism;

FIGS. 144 to 148 show variants of the skate;

FIGS. 149 to 159 show a variant of the blade detachment mechanism;

FIGS. 160 to 163 show another variant of the blade detachment mechanism;

FIG. 164 shows a variant of the blade wherein the blade comprises a silkscreen;

FIGS. 165 to 167 show a variant of the skate wherein the additively-manufactured components comprise sensors and actuators;

FIGS. 168 to 170 show variants of the skate;

FIG. 171 shows a variant of the skate wherein the skate comprises a covering;

FIGS. 172 to 176 show examples of variants in which the footwear is a ski boot, a work boot, a snowboard boot, a sport cleat or a hunting boot;

FIG. 177 is another example of footwear wearable by the user and comprising an additively manufactured component in accordance with another embodiment, in which the footwear is a running shoe; and

FIG. 178 show an example of a footbed comprising an additively manufactured component in accordance with another embodiment

FIG. 179 show an embodiment in which an additively manufactured component is comprised by an arm guard;

FIG. 180 shows an embodiment in which an additively manufactured component is comprised by shoulder pads;

FIG. 181 shows an embodiment in which an additively manufactured component is comprised by a leg guard;

FIG. 182 shows an embodiment in which an additively manufactured component is comprised by a chest protector;

FIG. 183 shows an embodiment in which an additively manufactured component is comprised by a blocker glove;

FIG. 184 shows an embodiment in which an additively manufactured component is comprised by a hockey goalkeeper leg pad;

FIG. 185 shows an embodiment in which an additively manufactured component is comprised by a piece of personal protective equipment;

FIG. 186 shows an embodiment in which an additively manufactured component is comprised by an automobile seat;

FIG. 187 shows an embodiment in which an additively manufactured component is comprised by a child's car seat;

FIG. 188 shows an embodiment in which an additively manufactured component is comprised by a bumper assembly for an automobile; and

FIG. 189 shows a method of manufacturing additively-manufactured components.

It is to be expressly understood that the description and drawings are only for purposes of illustrating certain embodiments and are an aid for understanding. They are not intended to be and should not be limiting.

### DETAILED DESCRIPTION OF EMBODIMENTS

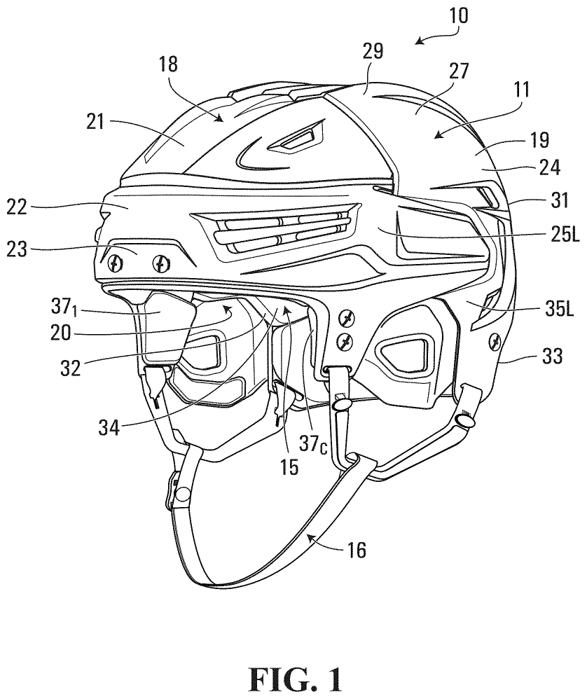

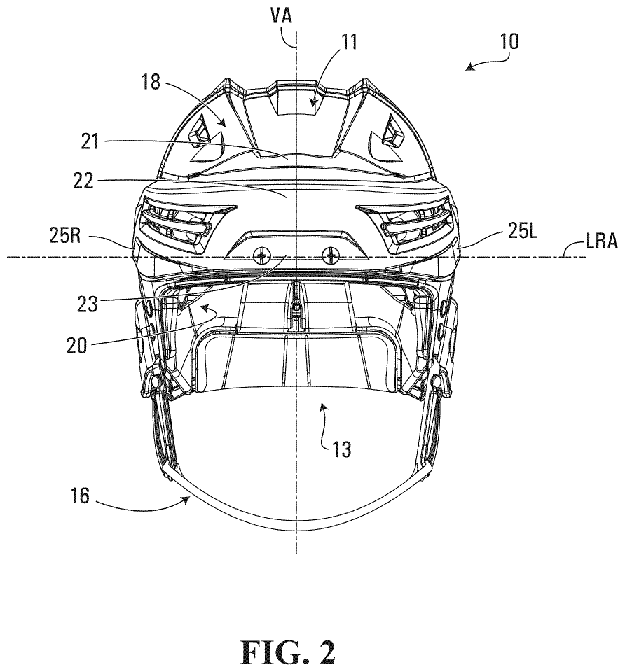

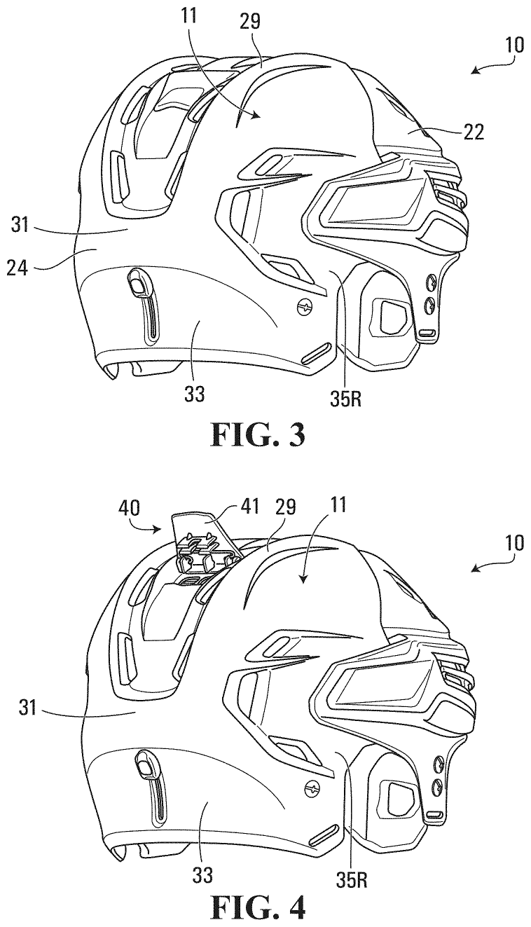

FIGS. 1 to 4 show an embodiment of an article 10 (e.g., a device or other functional article) comprising additively-manufactured components 12₁-12_{A}. in accordance with an embodiment of the present disclosure.

Each of the additively-manufactured components 12₁-12_{A} of the article 10 is a part of the article 10 that is additively manufactured, i.e., made by additive manufacturing, also known as 3D printing, in which material 50 thereof initially provided as feedstock (e.g., powder, liquid, filaments, fibers, and/or other suitable feedstock), which can be referred to as 3D-printed material 50, is added by a machine (i.e., a 3D printer) that is computer-controlled (e.g., using a digital 3D model such as a computer-aided design (CAD) model that may have been generated by a 3D scan of the intended wearer's head) to create it in its three-dimensional form (e.g., layer by layer, or by continuous liquid interface production from a pool of liquid, or by applying continuous fibers, or in any other way, normally moldlessly, i.e., without any mold). This is in contrast to subtractive manufacturing (e.g., machining) where material is removed and molding where material is introduced into a mold's cavity.

Any 3D-printing technology may be used to make the additively-manufactured components 12₁-12_{A} of the article 10. For instance, in some embodiments, one or more of the following additive manufacturing technologies may be used individually or in combination: material extrusion technologies, such as fused deposition modeling (FDM); vat photopolymerization technologies, such as stereolithography (SLA), digital light processing (DLP), continuous digital light processing (CDLP) or continuous liquid interface production (CLIP) with digital light synthesis (DLS); powder bed fusion technologies, such as multi-jet fusion (MJF), selective laser sintering (SLS), direct metal laser sintering/selective laser melting (DMLS/SLM), or electron beam melting (EBM); material jetting technologies, such as material jetting (MJ), nanoparticle jetting (NPJ) or drop on demand (DOD); binder jetting (BJ) technologies; sheet lamination technologies, such as laminated object manufacturing (LOM); material extrusion technologies, such as continuous-fiber 3D printing or fused deposition modeling (FDM), and/or any other suitable 3D-printing technology. Non-limiting examples of suitable 3D-printing technologies may include those available from Carbon (www.carbon3d.com), EOS (https://www.eos.info/en), HP (https://www8.hp.com/ca/en/printers/3d-printers.html), Arevo (https://arevo.com), and Continuous Composites (https://www.continuouscomposites.com/).

As further discussed later, in this embodiment, the additively-manufactured components 12₁-12_{A} of the article 10, which may be referred to as “AM” components, are designed to enhance performance and use of the article 10, such as: impact protection, including for managing different types of impacts; fit and comfort; adjustability; and/or other aspects of the article 10.

In this embodiment, the article 10 is an article of equipment usable by a user. More particularly, in this embodiment, the article 10 is an article of athletic gear for the user who is engaging in a sport or other athletic activity. Specifically, in this embodiment, the article of athletic gear 10 is an article of protective athletic gear wearable by the user to protect him/her. More specifically, in this example, the article of protective athletic gear 10 is a helmet for protecting a head of the user against impacts. In this case, the helmet 10 is a hockey helmet for protecting the head of the user, who is a hockey player, against impacts (e.g., from a puck or ball, a hockey stick, a board, ice or another playing surface, etc., with another player, etc.).

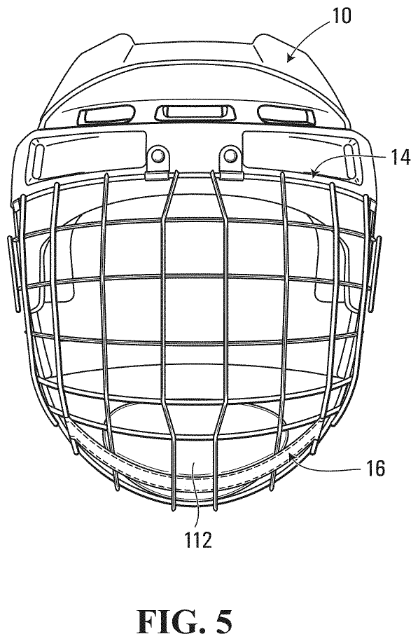

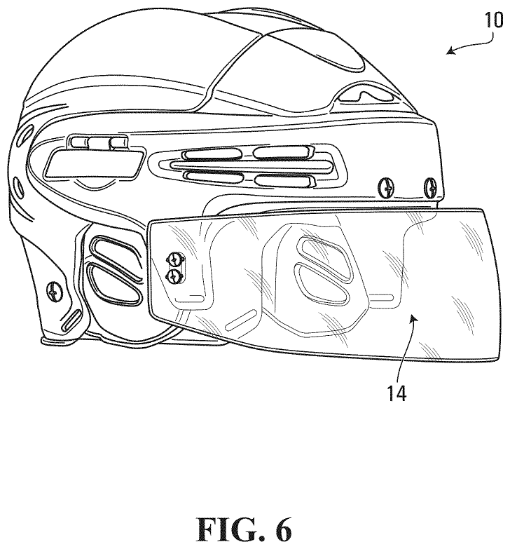

More particularly, in this embodiment, the helmet 10 comprises an outer shell 11 and a liner 15 to protect the player's head. In this example, the helmet 10 also comprises a chinstrap 16 for securing the helmet 10 to the player's head. The helmet 10 may also comprise a faceguard 14 (as shown in FIGS. 5 and 6) to protect at least part of the player's face (e.g., a grid (sometimes referred to as a “cage”) and a chin cup 112 as shown in FIG. 5 or a visor (sometimes referred to as a “shield”) as shown in FIG. 6).

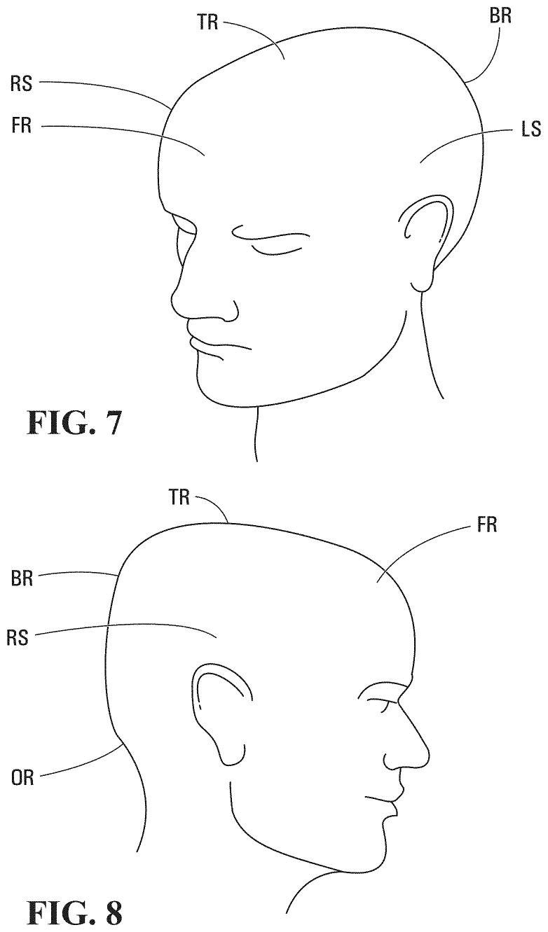

The helmet 10 defines a cavity 13 for receiving the player's head. In response to an impact, the helmet 10 absorbs energy from the impact to protect the player's head. The helmet 10 protects various regions of the player's head. As shown in FIGS. 7 and 8, the player's head comprises a front region FR, a top region TR, left and right side regions LS, RS, a back region BR, and an occipital region OR. The front region FR includes a forehead and a front top part of the player's head and generally corresponds to a frontal bone region of the player's head. The left and right side regions LS, RS are approximately located above the player's ears. The back region BR is opposite the front region FR and includes a rear upper part of the player's head. The occipital region OR substantially corresponds to a region around and under the head's occipital protuberance.

The helmet 10 comprises an external surface 18 and an internal surface 20 that contacts the player's head when the helmet 10 is worn. The helmet 10 has a front-back axis FBA, a left-right axis LRA, and a vertical axis VA which are respectively generally parallel to a dorsoventral axis, a dextrosinistral axis, and a cephalocaudal axis of the player when the helmet 10 is worn and which respectively define a front-back direction, a lateral direction, and a vertical direction of the helmet 10. Since they are generally oriented longitudinally and transversally of the helmet 10, the front-back axis FBA and the left-right axis LRA can also be referred to as a longitudinal axis and a transversal axis, respectively, while the front-back direction and the lateral direction can also be referred to a longitudinal direction and a transversal direction, respectfully.

The outer shell 11 provides strength and rigidity to the helmet 10. To that end, the outer shell 11 typically comprises a rigid material 27. For example, in various embodiments, the rigid material 27 of the outer shell 11 may be a thermoplastic material such as polyethylene (PE), polyamide (nylon), or polycarbonate, a thermosetting resin, or any other suitable material. The outer shell 11 includes an inner surface 17 facing the inner liner 15 and an outer surface 19 opposite the inner surface 17. The outer surface 19 of the outer shell 11 constitutes at least part of the external surface 18 of the helmet 10. In some embodiments, the outer shell 11 or at least portions thereof may be manufactured via additive manufacturing and portions thereof may have differing properties. For example, portions of the outer shell 11 may be additively manufactured such that they differ in terms of rigidity (e.g., to save on weight in areas of the helmet in which rigidity is less crucial and/or to intentionally provide flexibility in certain areas of the shell in order to provide impact cushioning via the shell).

In this embodiment, the outer shell 11 comprises shell members 22, 24 that are connected to one another. In this example, the shell member 22 comprises a top portion 21 for facing at least part of the top region TR of the player's head, a front portion 23 for facing at least part of the front region FR of the player's head, and left and right lateral side portions 25L, 25R extending rearwardly from the front portion 23 for facing at least part of the left and right side regions LS, RS of the player's head, respectively. The shell member 24 comprises a top portion 29 for facing at least part of the top region TR of the player's head, a back portion 31 for facing at least part of the back region BR of the player's head, an occipital portion 33 for facing at least part of the occipital region OR of the player's head, and left and right lateral side portions 35L, 35R extending forwardly from the back portion 31 for facing at least part of the left and right side regions LS, RS of the player's head, respectively.

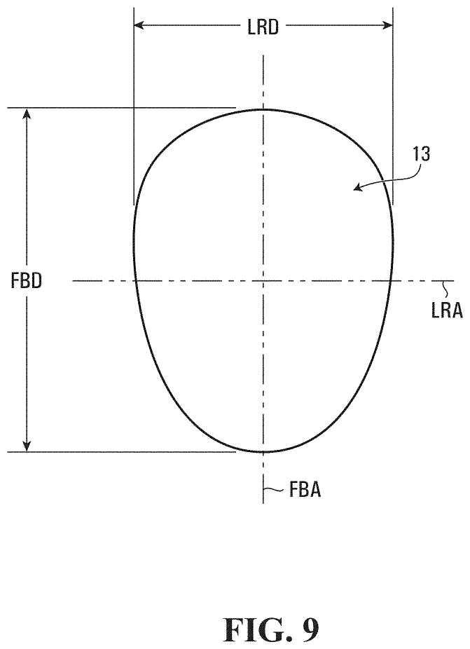

In this embodiment, the helmet 10 is adjustable to adjust how it fits on the player's head. To that end, the helmet 10 comprises an adjustment mechanism 40 for adjusting a fit of the helmet 10 on the player's head. The adjustment mechanism 40 may allow the fit of the helmet 10 to be adjusted by adjusting one or more internal dimensions of the cavity 13 of the helmet 10, such as a front-back internal dimension FBD of the cavity 13 in the front-back direction of the helmet 10 and/or a left-right internal dimension LRD of the cavity 13 in the left-right direction of the helmet 10, as shown in FIG. 9.

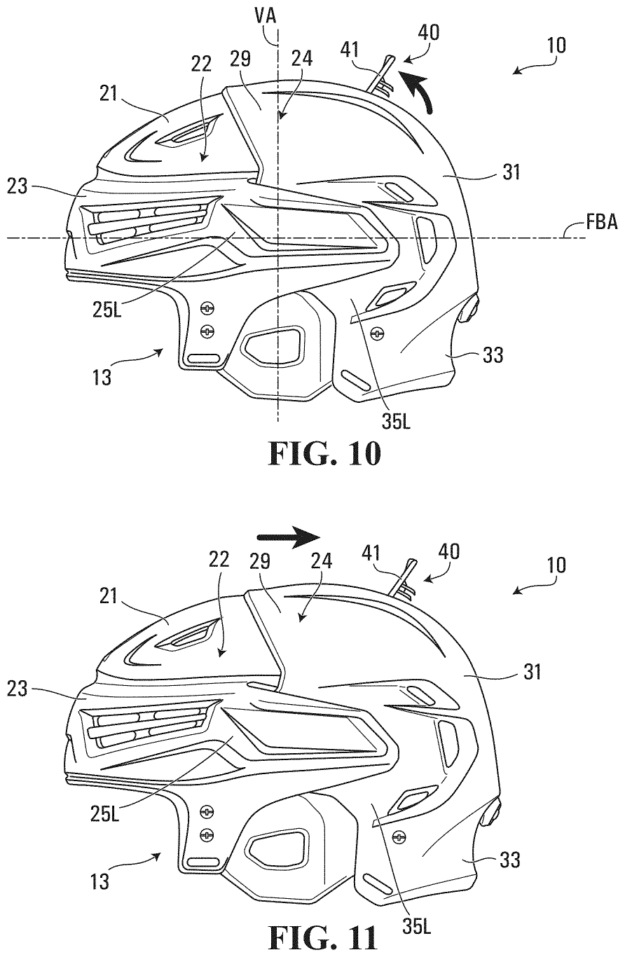

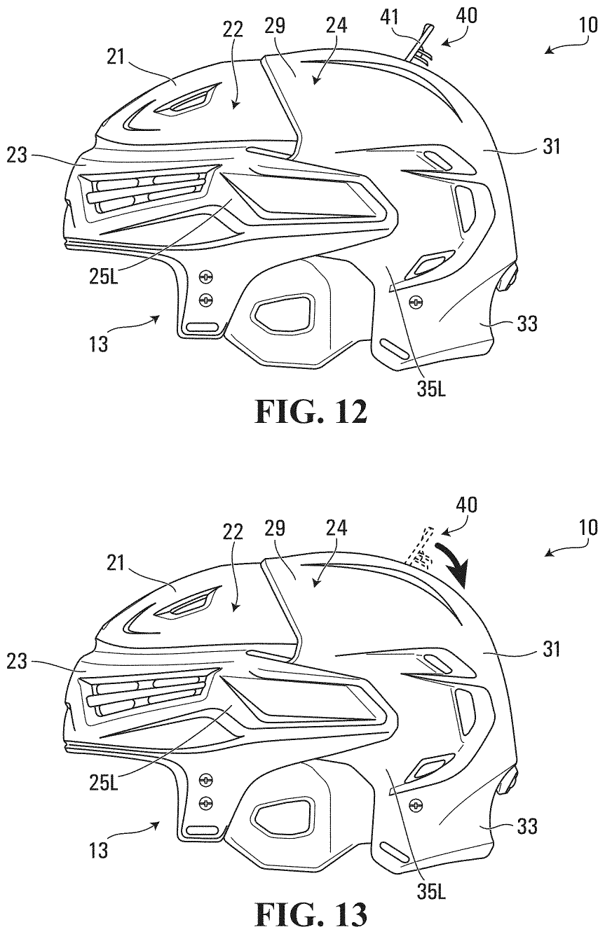

More particularly, in this embodiment, the adjustment mechanism 40 is configured such that the outer shell 11 and the inner liner 15 are adjustable to adjust the fit of the helmet 10 on the player's head. To that end, in this embodiment, the shell members 22, 24 are movable relative to one another to adjust the fit of the helmet 10 on the player's head. In this example, relative movement of the shell members 22, 24 for adjustment purposes is in the front-back direction of the helmet 10 such that the front-back internal dimension FBD of the cavity 13 of the helmet 10 is adjusted. This is shown in FIGS. 10 to 13 in which the shell member 24 is moved relative to the shell member 22 from a first position, which is shown in FIG. 10 and which corresponds to a minimum size of the helmet 10, to a second position, which is shown in FIG. 11 and which corresponds to an intermediate size of the helmet 10, and to a third position, which is shown in FIGS. 12 and 13 and which corresponds to a maximum size of the helmet 10.

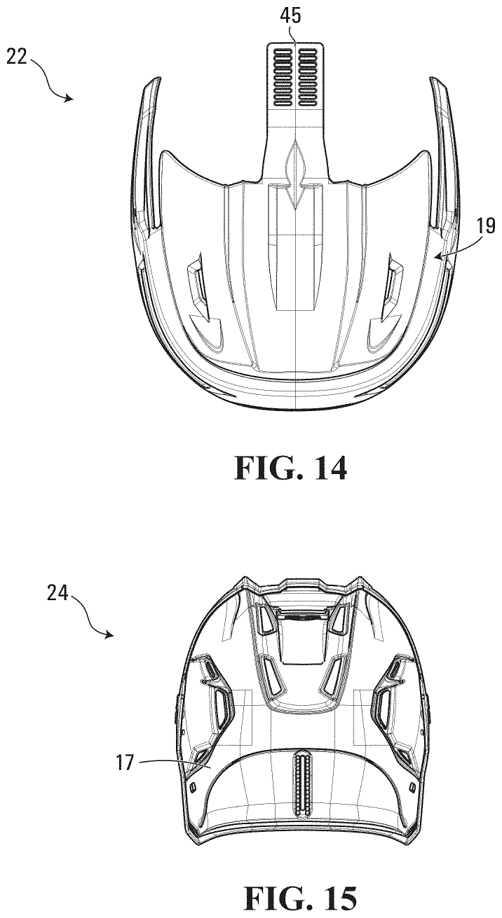

In this example of implementation, the adjustment mechanism 40 comprises an actuator 41 that can be moved (in this case pivoted) by the player between a locked position, in which the actuator 41 engages a locking part 45 (as best shown in FIGS. 14 and 15) of the shell member 22 and thereby locks the shell members 22, 24 relative to one another, and a release position, in which the actuator 41 is disengaged from the locking part 45 of the shell member 22 and thereby permits the shell members 22, 24 to move relative to one another so as to adjust the size of the helmet 10. The adjustment mechanism 40 may be implemented in any other suitably way in other embodiments.

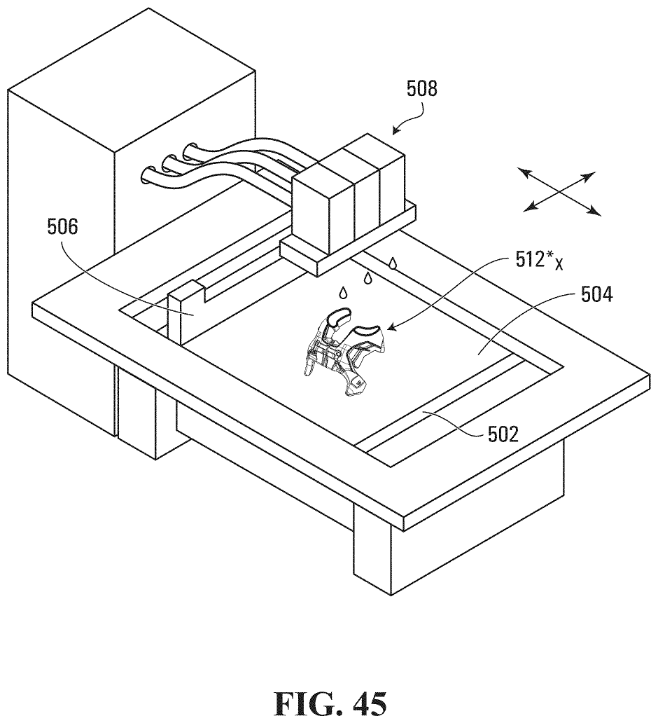

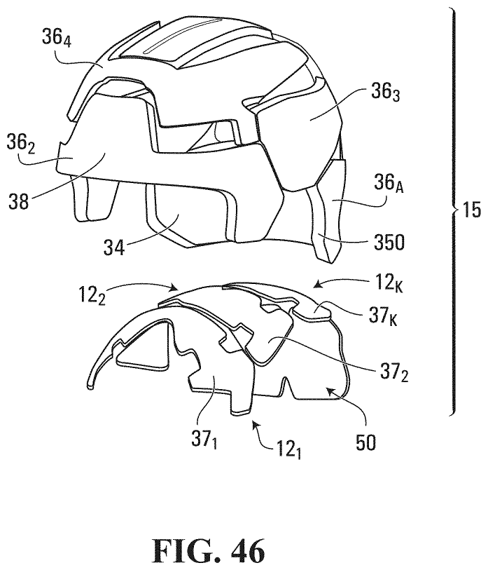

For instance, in some cases, the shock-absorbing material may include a polymeric foam (e.g., expanded polypropylene (EPP) foam, expanded polyethylene (EPE) foam, expanded polymeric microspheres (e.g., Expancel™ microspheres commercialized by Akzo Nobel), or any other suitable polymeric foam material) and/or a polymeric structure comprising one or more polymeric materials. Any other material with suitable impact energy absorption may be used in other embodiments. For example, in some embodiments, the shock-absorbing material may include liquid crystal elastomer (LCE) components, as discussed in further detail later on with reference to FIGS. 46 to 48. Additionally or alternatively, in some embodiments, the inner liner 15 may comprise an array of shock absorbers that are configured to deform when the helmet 10 is impacted. For instance, in some cases, the array of shock absorbers may include an array of compressible cells that can compress when the helmet 10 is impacted. Examples of this are described in U.S. Pat. No. 7,677,538 and U.S. Patent Application Publication 2010/0258988, which are incorporated by reference herein.

The liner 15 may be connected to the outer shell 11 in any suitable way. For example, in some embodiments, the inner liner 15 may be fastened to the outer shell 11 by one or more fasteners such as mechanical fasteners (e.g., tacks, staples, rivets, screws, stitches, etc.), an adhesive, or any other suitable fastener. In some embodiments, the liner 15 and/or the outer shell 11 may be manufactured via additive manufacturing such that they incorporate corresponding mating elements that are configured to securely engage one another, potentially without the need for other fastening means to fasten the liner 15 to the outer shell 11. In other embodiments, at least a portion of the liner 15 and at least a portion of the outer shell 11 may be additively manufactured as a unitary structure. For example, a rear portion of the liner 15 may be additively-manufactured together with the rear shell member 24 and/or a front portion of the liner 15 may be additively-manufactured together with the front portion 23 of the front shell member 22.

In this embodiment, the liner 15 comprises a plurality of pads 36₁-36_{A}, 37₁-37_{C} disposed between the outer shell 11 and the player's head when the helmet 10 is worn. In this example, respective ones of the pads 36₁-36_{A}, 37₁-37_{C} are movable relative to one another and with the shell members 22, 24 to allow adjustment of the fit of the helmet 10 using the adjustment mechanism 40.

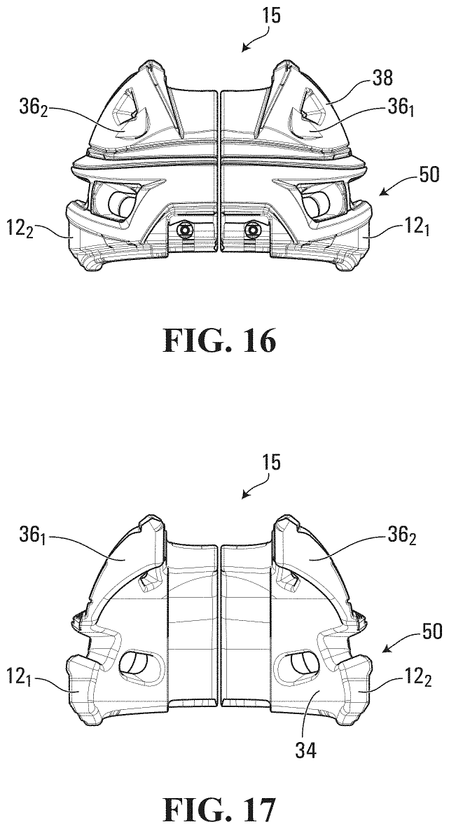

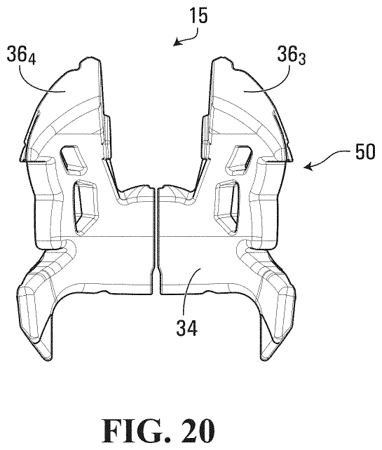

In this example, the pads 36₁-36_{A} are responsible for absorbing at least a bulk of the impact energy transmitted to the inner liner 15 when the helmet 10 is impacted and can therefore be referred to as “absorption” pads. In this embodiment, the pad 36₁ is for facing at least part of the front region FR and left side region LS of the player's head, the pad 36₂ is for facing at least part of the front region FR and right side region RS of the player's head, the pad 36₃ is for facing at least part of the back region BR and left side region LS of the player's head, the pad 36₄ is for facing at least part of the back region BR and right side region RS of the player's head. Another pad, (not shown in FIGS. 16 to 20) is for facing at least part of the top region TR and back region BR of the player's head. The shell member 22 overlays the pads 36₁, 36₂ while the shell member 24 overlays the pads 36₃, 36₄.

In this embodiment, the pads 37₁-37_{C} are responsible to provide comfort to the player's head and can therefore be referred to as “comfort” pads. The comfort pads 37₁-37_{C} may comprise any suitable soft material providing comfort to the player. For example, in some embodiments, the comfort pads 37₁-37_{C} may comprise polymeric foam such as polyvinyl chloride (PVC) foam, polyurethane foam (e.g., PORON XRD foam commercialized by Rogers Corporation), vinyl nitrile foam or any other suitable polymeric foam material and/or a polymeric structure comprising one or more polymeric materials. In some embodiments, given ones of the comfort pads 37₁-37_{C} may be secured (e.g., adhered, fastened, etc.) to respective ones of the absorption pads 36₁-36_{A}. In other embodiments, given ones of the comfort pads 37₁-37_{C} may be mounted such that they are movable relative to the absorption pads 36₁-36_{A}. For example, in some embodiments, one or more of the comfort pads 37₁-37_{C} may be part of a floating liner as described in U.S. Patent Application Publication 2013/0025032, which, for instance, may be implemented as the SUSPEND-TECH™ liner member found in the BAUER™ RE-AKT™ and RE-AKT 100™ helmets made available by Bauer Hockey, Inc. The comfort pads 37₁-37_{C} may assist in absorption of energy from impacts, in particular, low-energy impacts.

In this embodiment, the liner 15 comprises respective ones of the AM components 12₁-12_{A} of the helmet 10. More particularly, in this embodiment, respective ones of the pads 36₁-36_{A} comprise respective ones of the AM components 12₁-12_{A} of the helmet 10. In some embodiments, one or more other components of the helmet 10, such as the outer shell 11, comfort pads 37₁-37_{C}, face guard 14 and/or chin cup 112 may also or instead be AM components.

A pad 36_{X} comprising an AM component 12_{X} of the helmet 10 may be configured to enhance performance and use of the helmet 10, such as: impact protection, including for managing different types of impacts; fit and comfort; adjustability; and/or other aspects of the helmet 10.

For example, in some embodiments, the AM component 12_{X} comprised by the pad 36_{X} may be configured to provide multi-impact protection for repeated and different types of impacts, including linear and rotational impacts, which may be at different energy levels, such as high-energy, mid-energy, and low-energy impacts, as experienced during hockey.

The AM component 12_{X} comprised by the pad 36_{X} may provide such multi-impact protection while remaining relatively thin, i.e., a thickness T_{c} of the AM component 12_{X} comprised by the pad 36_{X} is relatively small, so that a thickness Tₕ of the helmet 10 at the AM component 12_{X}, which can be referred to as an “offset” of the helmet 10 at that location, is relatively small.

As an example, in some embodiments, at least part of the AM component 12_{X} comprised by the pad 36_{X} may be disposed in a given one of the lateral side portions 25L, 25R of the helmet 10 and the thickness T_{c} of the AM component 12_{X} comprised by the pad 36_{X} at that given one of the lateral side portions 25L, 25R of the helmet 10 may be no more than 22 mm, in some cases no more than 20 mm, in some cases no more than 18 mm, and in some cases no more than 16 mm (e.g., 15 mm or less). This may allow the offset of the helmet 10 at the lateral side portions 25L, 25R of the helmet 10 to be small, which may be highly desirable.

In other examples, in some embodiments, at least part of the AM component 12_{X} comprised by the pad 36_{X} may be disposed in a given one of the front portion 23 and the back portion 31 of the helmet 10 and the thickness T_{c} of the AM component 12_{X} comprised by the pad 36_{X} at that given one of the front portion 23 and the back portion 31 of the helmet 10 may be no more than 22 mm, in some cases no more than 20 mm, in some cases no more than 18 mm, and in some cases no more than 16 mm (e.g., 15 mm or less). In some cases, the thickness T_{c} of the AM component 12_{X} comprised by the pad 36_{X} at that given one of the front portion 23 and the back portion 31 of the helmet 10 may be thicker than the thickness T_{c} of the AM component 12_{X} or another one of the AM components 12₁-12_{A} at a given one of the lateral side portions 44L, 44R of the helmet 10.

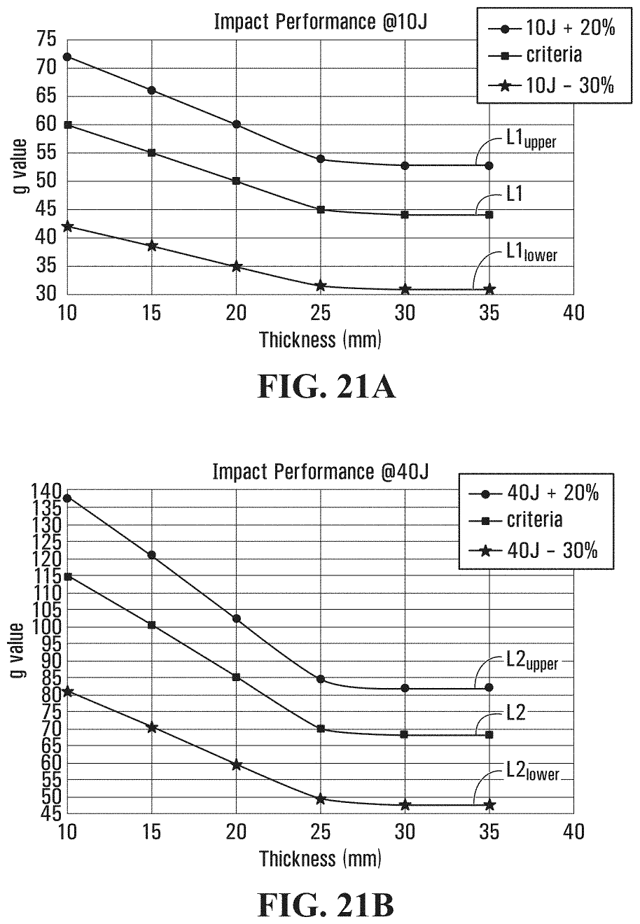

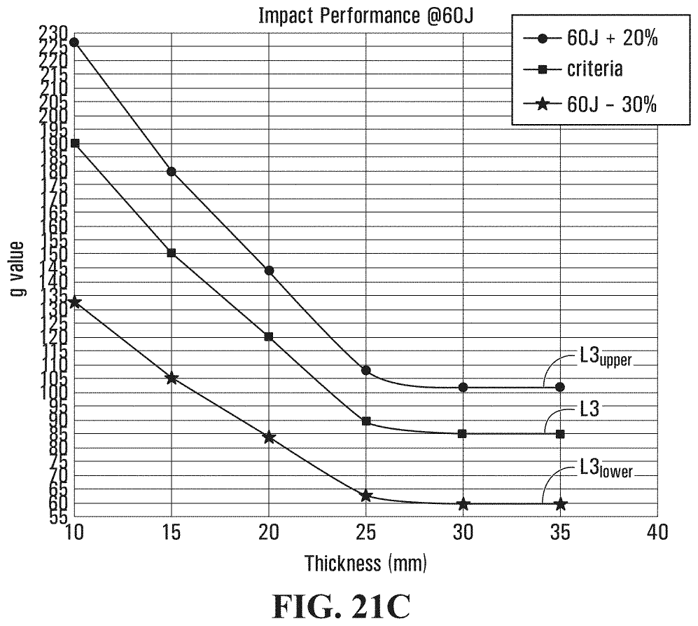

For instance, in some embodiments, the AM component 12_{X} comprised by the pad 36_{X} may be configured such that, when the helmet 10 is impacted where the AM component 12_{X} is located in accordance with hockey STAR methodology, linear acceleration at a center of gravity of a headform on which the helmet 10 is worn is no more than a value indicated by curves L1-L3 shown in FIGS. 21A-21C for impacts at three energy levels (10 Joules, 40 Joules and 60 Joules, respectively) according to hockey STAR methodology for the thickness T_{c} of the AM component 12_{X} where impacted.

In some embodiments, the AM component 12_{X} comprised by the pad 36_{X} may be configured such that, when the helmet 10 is impacted where the AM component 12_{X} is located in accordance with hockey STAR methodology, the linear acceleration at the center of gravity of the headform on which the helmet 10 is worn may be no more than 120%, in some cases no more than 110%, and in some cases no more than 105% of the value indicated by the curves L1-L3 for impacts at three energy levels according to hockey STAR methodology for the thickness T_{c} of the AM component 12_{X} where impacted. For example, the values indicated by the upper bound curves L1ᵤₚₚₑᵣ-L3ᵤₚₚₑᵣ shown in FIGS. 21A-21C are 20% higher than those of the curves L1-L3.

In some embodiments, the AM component 12_{X} comprised by the pad 36_{X} may be configured such that, when the helmet 10 is impacted where the AM component 12_{X} is located in accordance with hockey STAR methodology, the linear acceleration at the center of gravity of the headform on which the helmet 10 is worn may be no more than 90%, in some cases no more than 80%, and in some cases no more than 70% of the value indicated by the curves L1-L3 for impacts at three energy levels according to hockey STAR methodology for the thickness T_{c} of the AM component 12_{X} where impacted. For example, the values indicated by the lower bound curves L1_{lower}-L3_{lower} shown in FIGS. 21A-21C are 30% lower than those of the curves L1-L3.

The hockey STAR methodology is a testing protocol described in a paper entitled “Hockey STAR: A Methodology for Assessing the Biomechanical Performance of Hockey Helmets”, by B. Rowson et al., Department of Biomedical Engineering and Mechanics, Virginia Tech, 313 Kelly Hall, 325 Stanger Street, Blacksburg, Va. 24061, USA, published online on Mar. 30, 2015 and incorporated by reference herein.

The AM component 12_{X} comprised by the pad 36_{X} may be designed to have properties of interest in this regard.

For example, in some embodiments, the AM component 12_{X} comprised by the pad 36_{X} may be configured in order to provide a desired stiffness. The stiffness of the AM component 12_{X} may be measured by applying a compressive load to the AM component 12_{X}, measuring a deflection of the AM component 12_{X} where the compressive load is applied, and dividing the compressive load by the deflection.

As another example, in some embodiments, the AM component 12_{X} comprised by the pad 36_{X} may be configured in order to provide a desired resilience according to ASTM D2632-01 which measures resilience by vertical rebound.

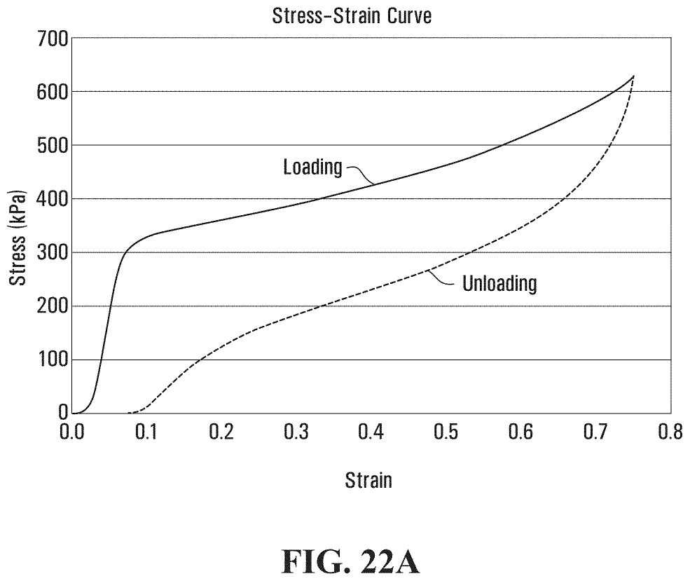

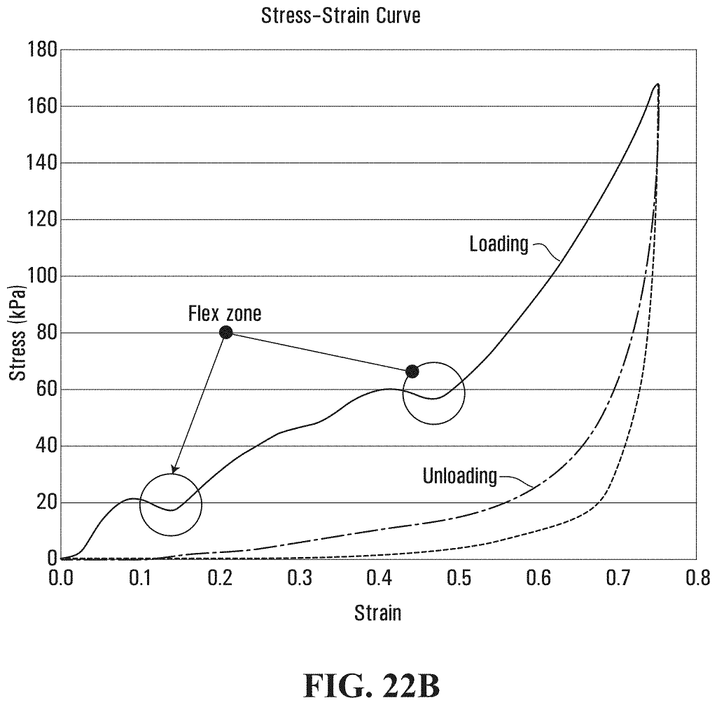

As another example, in some embodiments, the AM component 12_{X} comprised by the pad 36_{X} may be configured such that, when the AM component 12_{X} is loaded and unloaded, e.g., as a result of a stress temporarily applied to the pad 36_{X} from an impact on the helmet 10, the strain of the AM component 12_{X} is no more than a value indicated by the unloading curve shown in FIG. 22A for the unloading of the applied stress. In addition, or instead, in some embodiments, the AM component 12_{X} comprised by the pad 36_{X} may be configured such that when the AM component 12_{X} is loaded and unloaded the stress required to realize a given strain on the loading curve may be higher or lower than that of the loading curve shown in FIG. 22A, but the difference in stress between the loading and unloading curves at a given level of strain is at least as large as the difference between the loading and unloading curves shown in FIG. 22A at the given level of strain. In general, the greater the area between the loading and unloading curves for an impact absorbing component, the greater the impact energy that is absorbed by that component. For example, an impact absorbing component having the same loading curve as shown in FIG. 22B, but a lower unloading curve, as illustrated by a second dashed unloading curve in FIG. 22B, would dissipate a greater amount of impact energy.

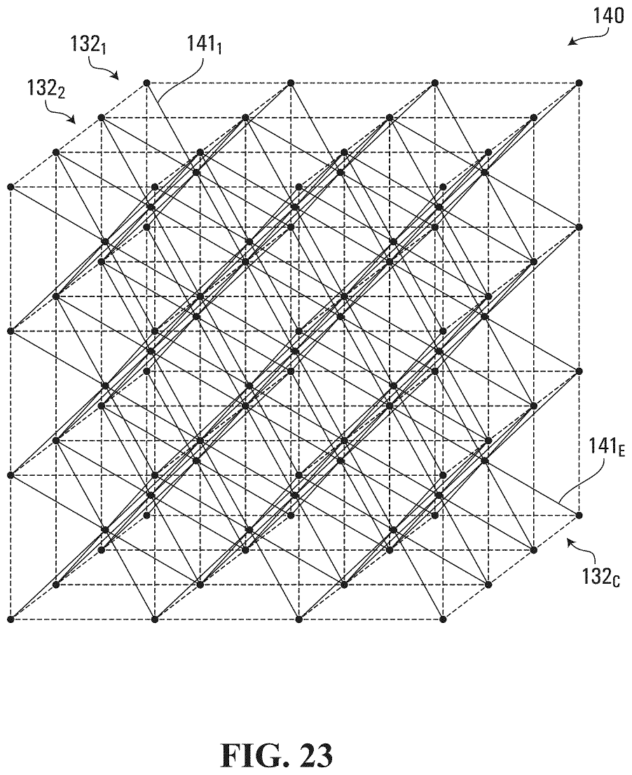

In this embodiment, the AM component 12_{X} comprised by the pad 36_{X} includes a lattice 140, an example of which is shown in FIG. 23, which is additively-manufactured such that AM component 12_{X} has an open structure. The lattice 140 can be designed and 3D-printed to impart properties and functions of the AM component 12_{X}, such as those discussed above, while helping to minimize its weight.

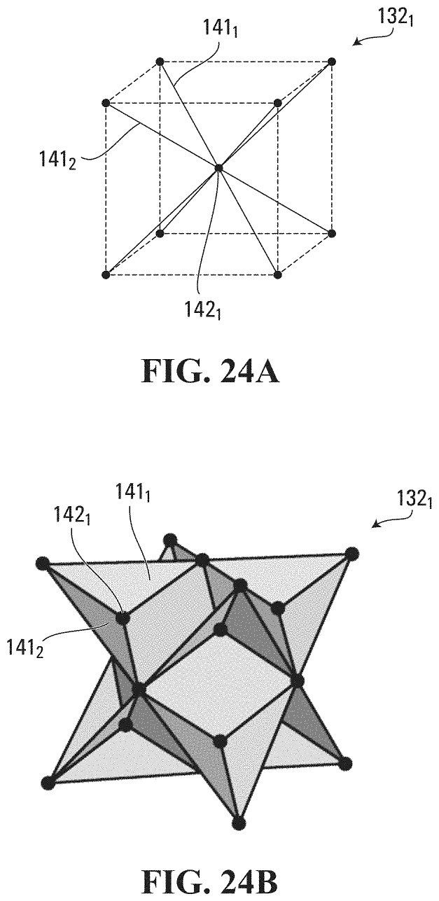

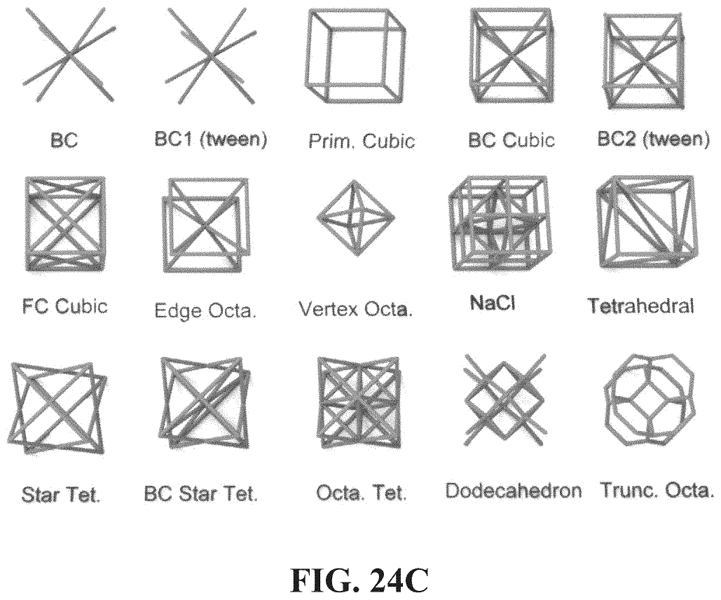

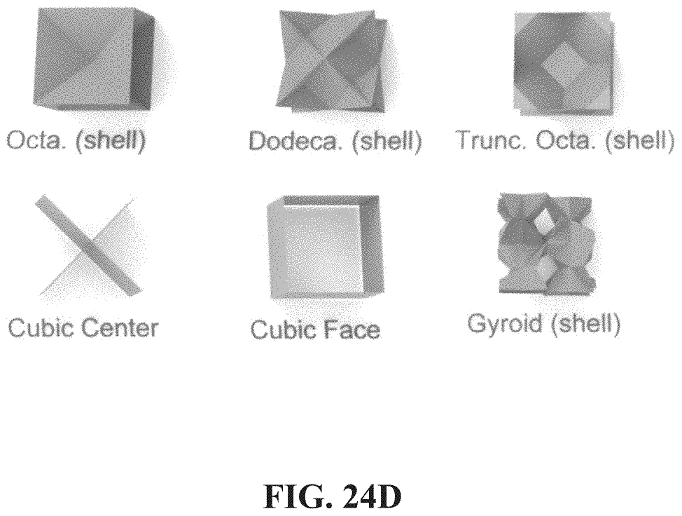

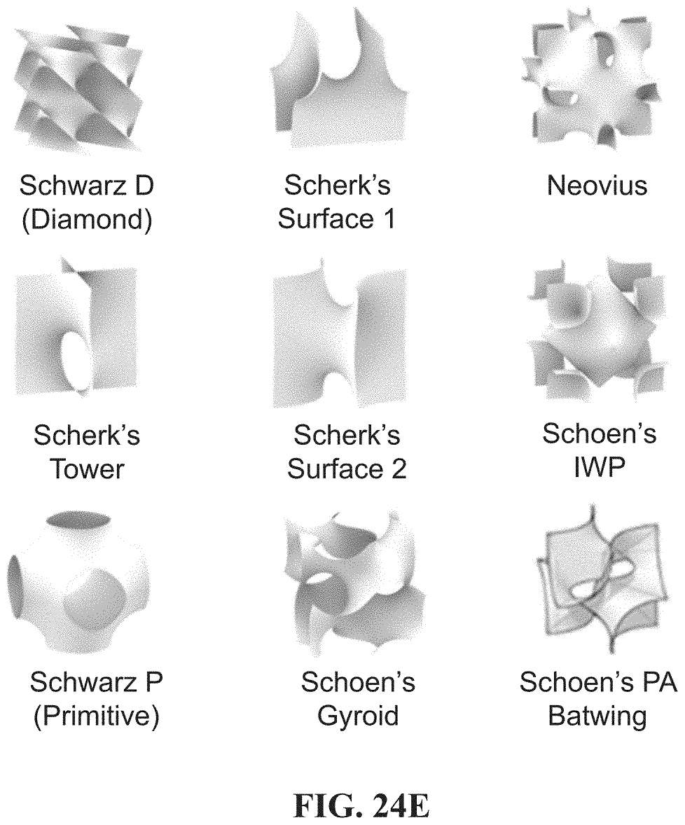

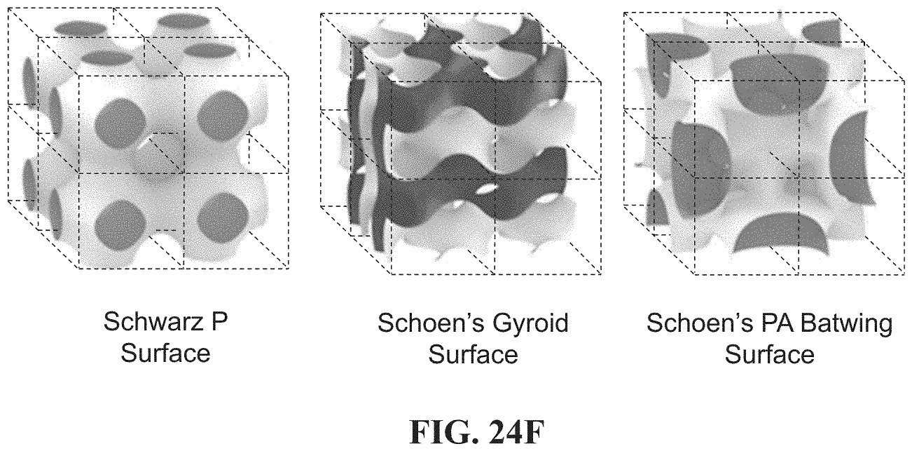

The lattice 140 comprises a framework of structural members 141₁-141_{E} (best shown in FIG. 24A) that intersect one another. In some embodiments, the structural members 141₁-141_{E} may be arranged in a regular arrangement repeating over the lattice 140. In some cases, the lattice 140 may be viewed as made up of unit cells 132₁-132_{C} each including a subset of the structural members 141₁-141_{E} that forms the regular arrangement repeating over the lattice 140. Each of these unit cells 132₁-132_{C} can be viewed as having a voxel (shown in dashed lines in FIGS. 23 and 24A), which refers to a notional three-dimensional space that it occupies. In other embodiments, the structural members 141₁-141_{E} may be arranged in different arrangements over the lattice 140 (e.g., which do not necessarily repeat over the lattice 140, do not necessarily define unit cells, etc.).

The lattice 140, including its structural members 141₁-141_{E}, may be configured in any suitable way.

In this embodiment, the structural members 141₁-141_{E} are elongate members that intersect one another at nodes 142₁-142_{N}. The elongate members 141₁-141_{E} may sometimes be referred to as “beams” or “struts”. Each of the elongate members 141₁-141_{E} may be straight, curved, or partly straight and partly curved.

The 3D-printed material 50 constitutes the lattice 140. Specifically, the elongate members 141₁-141_{E} and the nodes 142₁-142_{N} of the lattice 140 include respective parts of the 3D-printed material created by the 3D-printer.

In this example of implementation, the 3D-printed material 50 includes polymeric material. For instance, in this embodiment, the 3D-printed material 50 may include polyamide (PA) 11, thermoplastic polyurethane (TPU) 30A to 95A (fused), polyurethane (PU) 30A to 95A (light cured, chemical cured), polyether ether ketone (PEEK), polyetherketoneketone (PEKK), polypropylene (PP), silicone, rubber, gel and/or any other polymer.

In some embodiments, the AM components 12₁-12_{A} may comprise a plurality of materials different from one another. For example, a first one of the materials is a first polymeric material and a second one of the materials is a second polymeric material. In other embodiments, a first one of the materials may be a polymeric material and a second one of the materials may be a non-polymeric material.

In some embodiments, the structural members 141₁-141_{E} of the lattice 140 may be implemented in various other ways. For example, in some embodiments, the structural members 141₁-141_{E} may be planar members that intersect one another at vertices. For example, such an embodiment of the lattice 140 may be realized using a different “mesh” or “shell” style unit cell, such as the unit cell 132₁ shown in FIG. 24B, which includes planar members 141₁-141_{E} that intersect at vertices 142₁-142_{V}. The surfaces of the planar members 141₁-141_{E} may sometimes be referred to as “faces”. Each of the planar members 141₁-141_{E} may be straight, curved, or partly straight and partly curved. In some embodiments, the structural members 141₁-141_{E} of the lattice 140 may have a hybrid construction that includes both elongate members and planar members. For example, such embodiments may include a mix of elongate member style unit cells, such as the unit cell 132₁ shown in FIG. 24A, and mesh or shell style unit cells, such as the unit cell 132₁ shown in FIG. 24B. In some embodiments, the structural elements of a unit cell may include a combination of elongate member and surface/planar members. FIGS. 24C, 24D and 24E show further non-limiting examples of elongate member style unit cells and mesh or shell style unit cells that may be used individually and/or in combination to form additively-manufactured components as disclosed herein. The example unit cells shown in FIG. 24E are examples of cubic unit cells that are based on triply periodic minimal surfaces. A minimal surface is the surface of minimal area between any given boundaries. Minimal surfaces have a constant mean curvature of zero, which means that the sum of the principal curvatures at each point is zero. Triply periodic minimal surfaces have a crystalline structure, in that they repeat themselves in three dimensions, and thus are said to be triply periodic.

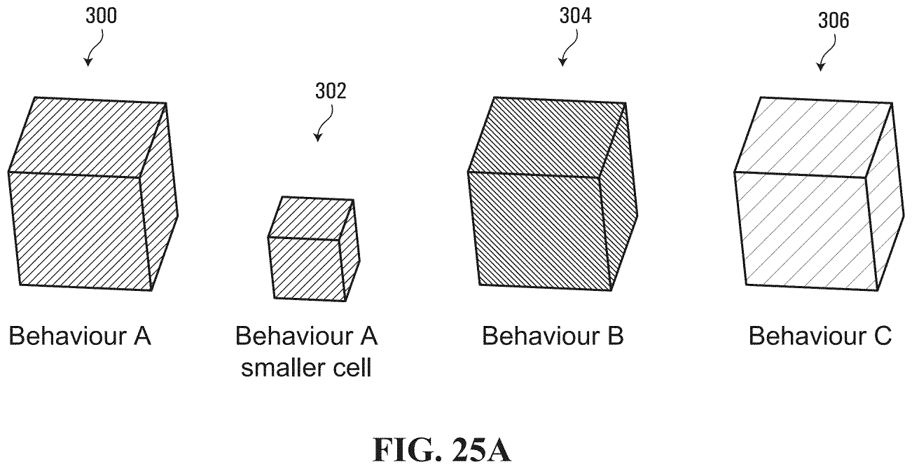

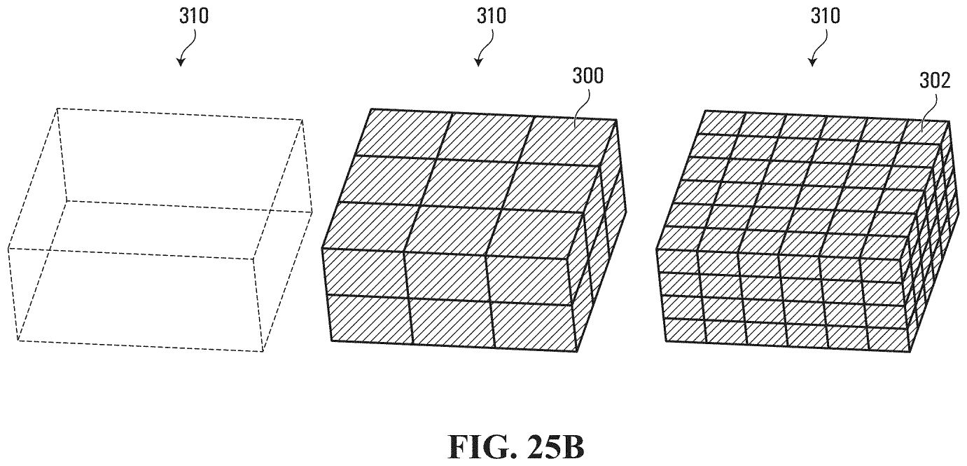

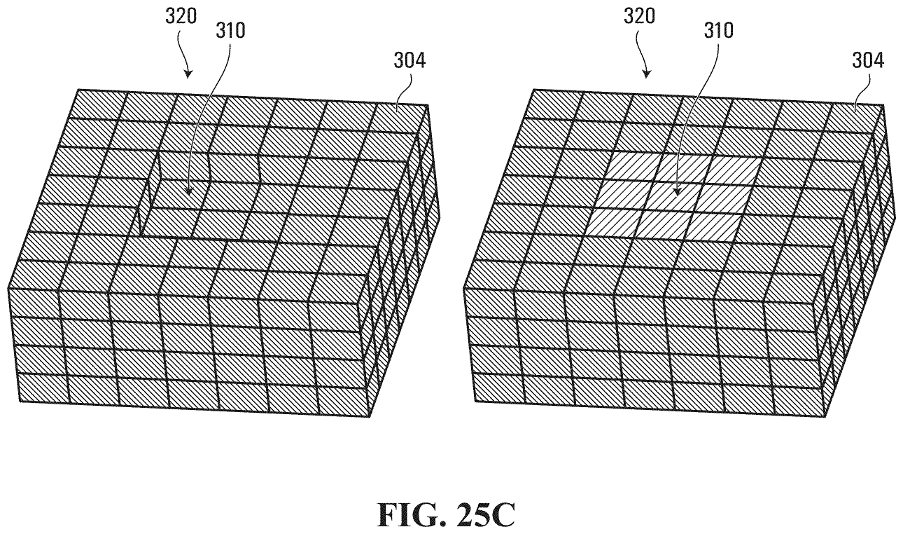

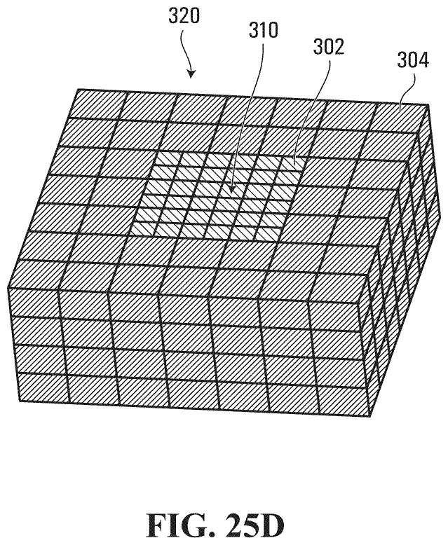

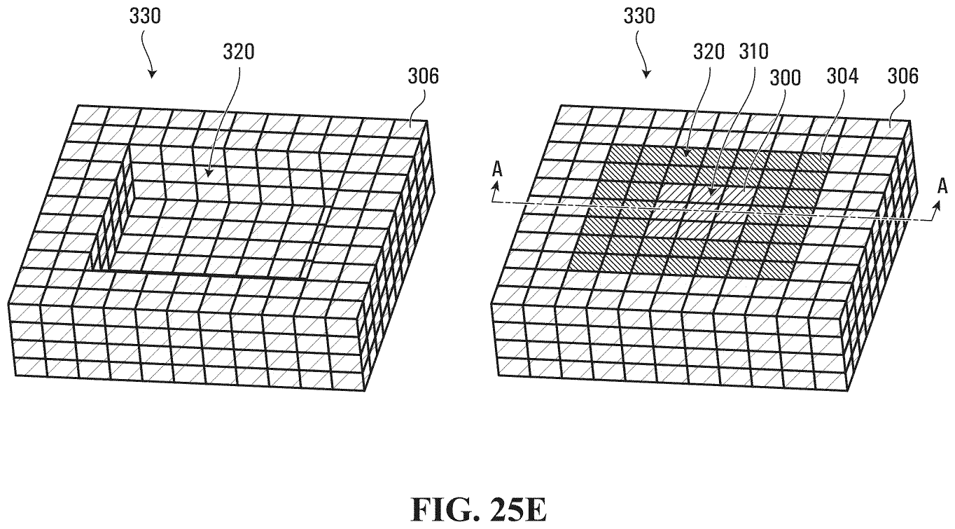

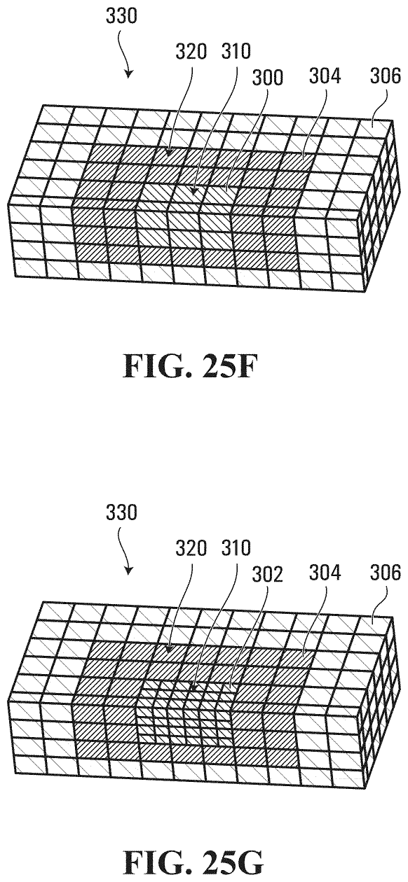

A volume of material can be constructed by “voxelizing” the volume (dividing the volume into voxels of the same or different sizes), and populating the voxels with unit cell structures, such as those shown in FIGS. 24A-24E. For example, FIG. 24F shows three examples of volumes containing triply periodic surfaces implemented by 2×2×2 lattices of equal sized voxels populated with different unit cells from the examples shown in FIG. 24D. The behavior or performance of an AM component that includes a voxelized volume of unit cells can be adapted by changing the structure, size or combination of unit cells that make up the AM component. Unit cells having different structures (e.g., the body centered (BC) unit cell shown in FIG. 24A vs. the Schwarz P unit cell shown in FIG. 24E) may have different behaviors. Similarly, unit cells having the same structure but different sizes may behave differently. Furthermore, implementing unit cells using the same structure but using different materials may result in different behaviors. Likewise, implementing an AM component using multiple different types of unit cells that differ in terms of structure, size and/or materials may result in different behavior/performance. As such, it may be possible to achieve a desired performance of an AM component by adapting the structure, size, material and/or mix of the unit cells that are used within a given volume of the AM component. This concept is discussed in further detail below with reference to FIGS. 25A-25G.

FIG. 25A shows four different cubic unit cells 300, 302, 304 and 306. Unit cells 300, 304 and 306 are of the same size, but exhibit different behaviors which are identified generically as Behavior A, Behavior B and Behavior C, respectively. For example, unit cells 300, 302 and 306 may differ in terms of structure and/or materials, and thereby provide different impact absorbency properties, such as resiliency, stiffness, modulus of elasticity, etc.

Unit cells 300 and 302 are characterized by the same behavior, Behavior A, but unit cell 302 is smaller than the other three unit cells 300, 304 and 306. In particular, in this example unit cell 302 is one eighth the volume of the other three unit cells 300, 304 and 306, such that a 2×2×2 lattice of unit cells 302 would have the same volume of each of the other three unit cells 300, 304 and 306. This is shown by way of example in FIG. 25B, which shows that an AM component occupying a volume 310 may be implemented by either a 3×3×2 lattice of unit cells 300 or a 6×6×4 lattice of unit cells 302.

As noted above, the behavior of an AM component constituting a voxelized volume of unit cells may be changed by incorporating different unit cells within the volume. This is shown by way of example in FIGS. 25C-25G. FIG. 25C shows that a smaller volume 310 within a larger volume 320 of an AM component may be implemented with a 3×3×2 lattice of unit cells 300 characterized by Behavior A, while the remainder of volume 320 is implemented with unit cells 304 characterized by Behavior B. Such a combination of unit cells 300 and 304 may result in an overall behavior for the AM component that is different than either Behavior A or Behavior B alone. FIG. 25D shows an alternative example in which the smaller volume 310 is implemented with a 6×6×4 lattice of unit cells 302. FIG. 25E shows another example of this concept, in which the voxelized volume 320 of unit cells shown in FIG. 25C, which includes a mix of unit cells 300 and 304, is located within an even larger voxelized volume 330 of an AM component. In this example, the remainder of the volume 330 of the AM component is implemented with unit cells 306 characterized by Behavior C. FIG. 25F shows a profile of the cross-section of the AM component of FIG. 25E along the line A-A. FIG. 25G shows a profile of the cross-section of an alternative example in which the smaller volume 310 within the volume 320 is implemented with a 6×6×4 lattice of unit cells 302 rather than a 3×3×2 lattice of unit cells 300.

Referring again to FIGS. 16 to 20, in some embodiments, an AM component 12_{X} may include a non-lattice member connected to the lattice 140. For example, the non-lattice member may be configured to be positioned between the lattice 140 and a user's head when the helmet is worn. In other embodiments, the non-lattice member may be positioned between the lattice 140 and the shell 11. In some embodiments, such a non-lattice member may be thinner than the lattice 140. In other embodiments, the non-lattice member may be bulkier than the lattice 140.

In the example of implementation shown in FIG. 23, the lattice 140 of the AM component 12_{X} comprised by the pad 36_{X} may include outer surfaces or “skins” that provide interfaces to other components of the helmet and/or the user's head. The outer surfaces of the lattice 140 may be implemented with an open lattice skin 150 and/or solid non-lattice skin 152.

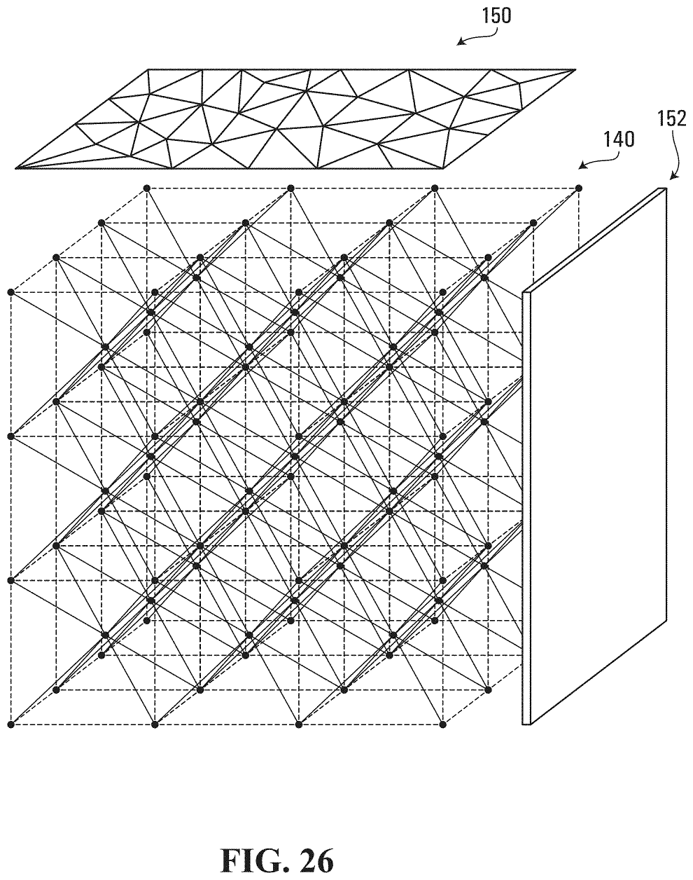

FIG. 26 shows examples of a lattice skin 150 and a solid non-lattice skin 152 that may be formed on the lattice 140 of FIG. 23 in order to provide outer surfaces for the lattice 140. For example, the solid skin 152 may be used to provide an outer surface of the AM component 12_{X} comprised by the pad 36_{X} to interface the pad 36_{X} to the inner surface 17 of the outer shell 11 of the helmet 10.

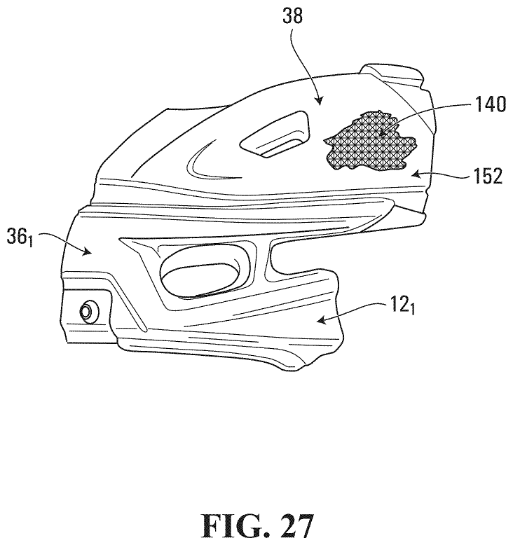

FIG. 27 shows a side view of an example of the AM component 12₁ constituting the front pad 36₁ of the inner lining 15 of the helmet 10. The AM component 12₁ includes the lattice 140 and the solid skin 152 which forms the outer surface 38 of the front pad 36₁.

It is noted that the lattice 140 shown in FIGS. 23 and 26, which has a 3D structure, is merely one example of an additively-manufactured lattice that may be used in some embodiments. Other 2D and 3D lattice structures, which may be based on unit cells such as those shown by way of non-limiting example in FIGS. 24A-24E, may be used in other embodiments.

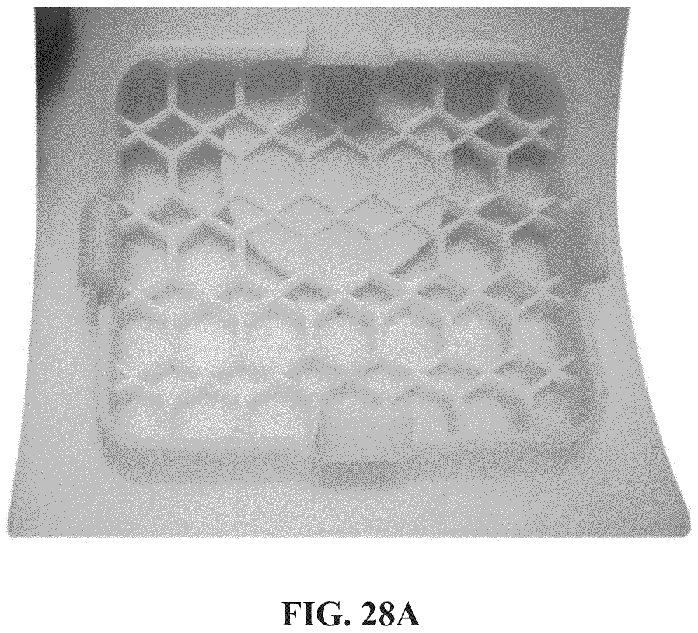

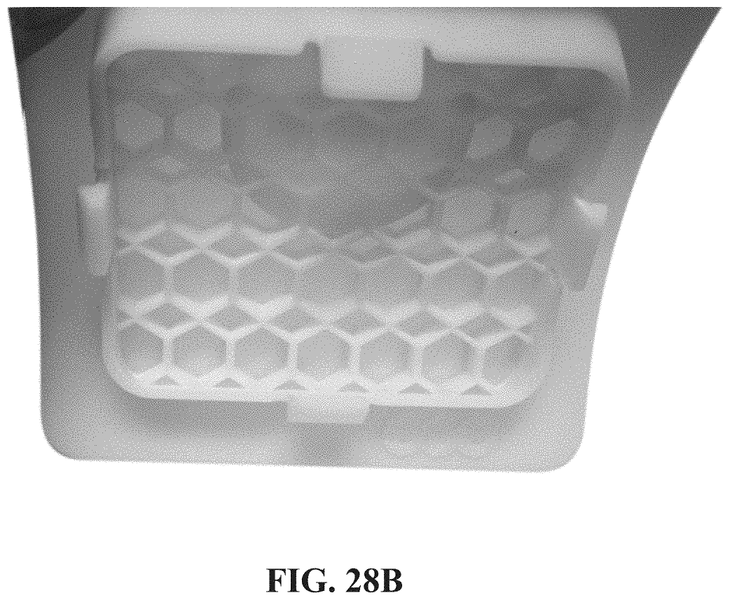

FIGS. 28 to 34 show non-limiting examples of AM components incorporating lattices that may be used in embodiments. FIGS. 28A and 28B show an example of an AM component comprising a 2D lattice structure. In this example of implementation, the lattice has a generally honeycomb pattern and the component includes fastening means for fastening the AM component to another component.

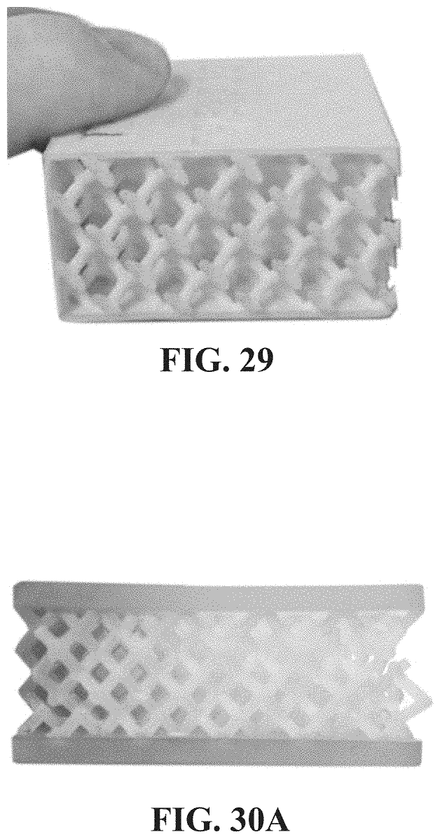

FIG. 29 shows an example of an AM component comprising a 3D lattice structure similar to that of the lattice 140 shown in FIGS. 21 and 25.

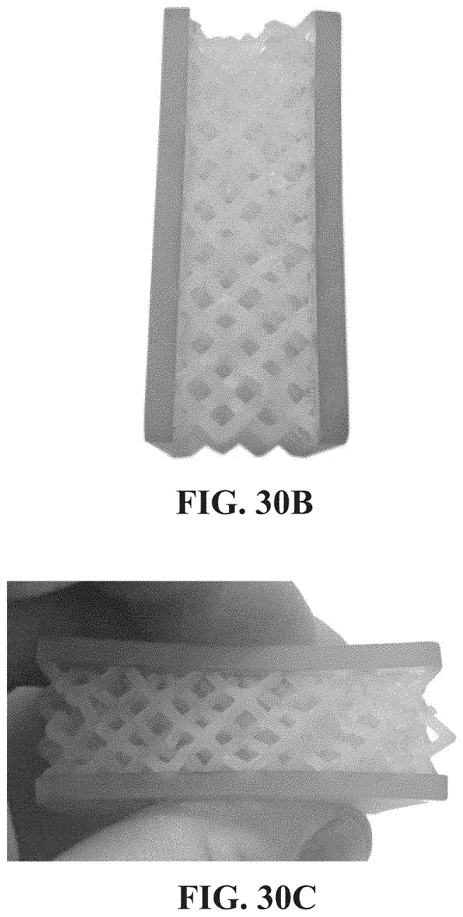

FIGS. 30A, 30B and 30C show another example of an AM component comprising a 3D lattice structure. In this example of implementation, the lattice has a solid non-lattice outer surface on two of its opposite sides and the AM component is configured so that it is easily compressible by forces applied through its opposing solid sides.

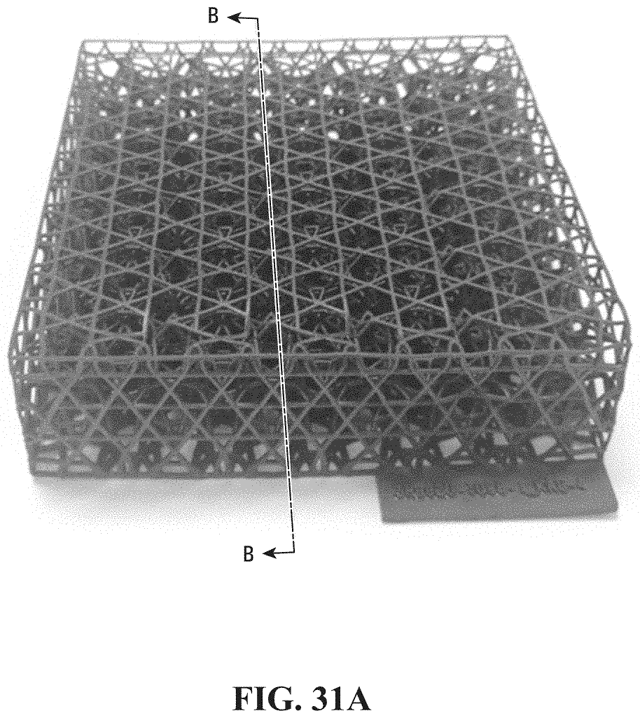

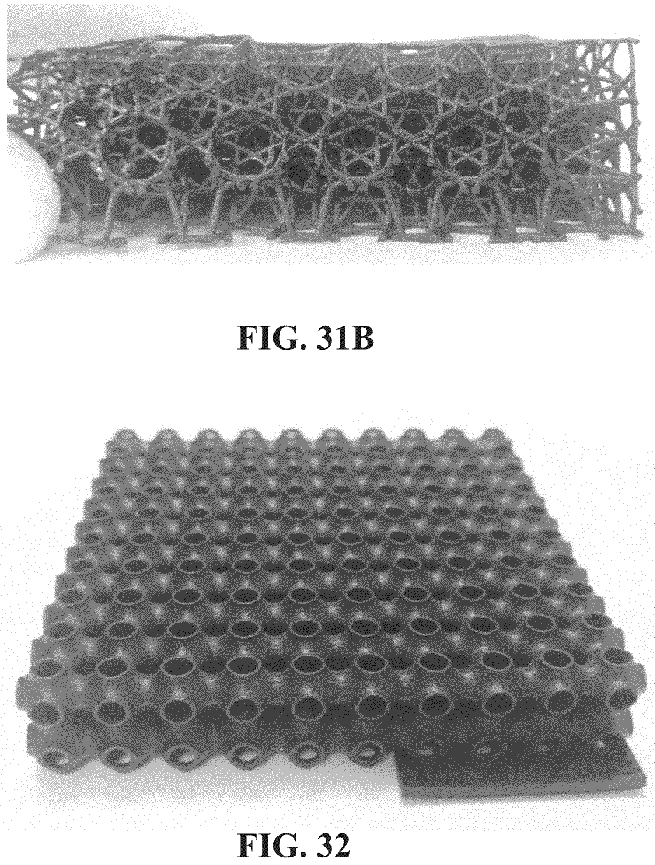

FIGS. 31A and 31B show another example of an AM component comprising a 3D lattice structure. FIG. 31B shows a profile of the cross-section of the AM component along the line B-B shown in FIG. 31A. In this example of implementation, the 3D lattice is formed by the vertices and edges of a quarter cubic honeycomb. In this example implementation, the 3D lattice contains four sets of parallel planes of points and lines, each plane being a two dimensional kagome or trihexagonal lattice, and therefore this lattice structure may be referred to as a hyper-kagome lattice.

FIG. 32 shows yet another example of an AM component comprising a 3D lattice structure. In this example of implementation, the 3D lattice forms a periodic minimal surface based on the Schwarz P (Primitive) unit cell example shown in FIG. 24E, which results in a structure with a high surface-to-volume ratio and high porosity.

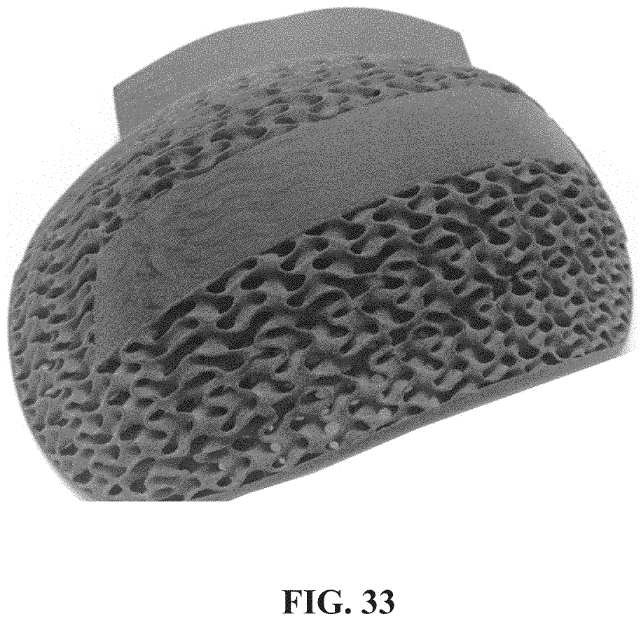

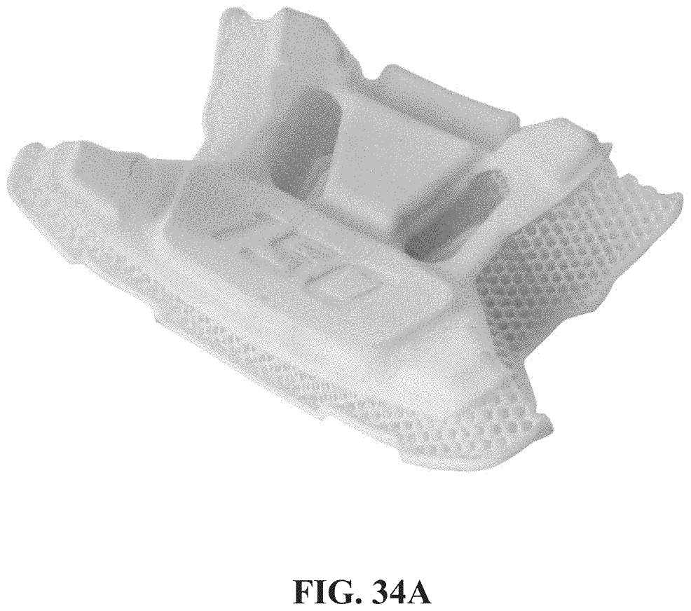

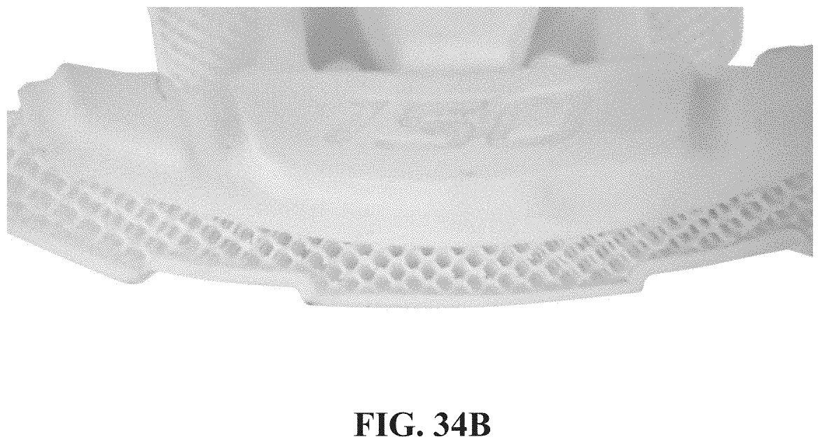

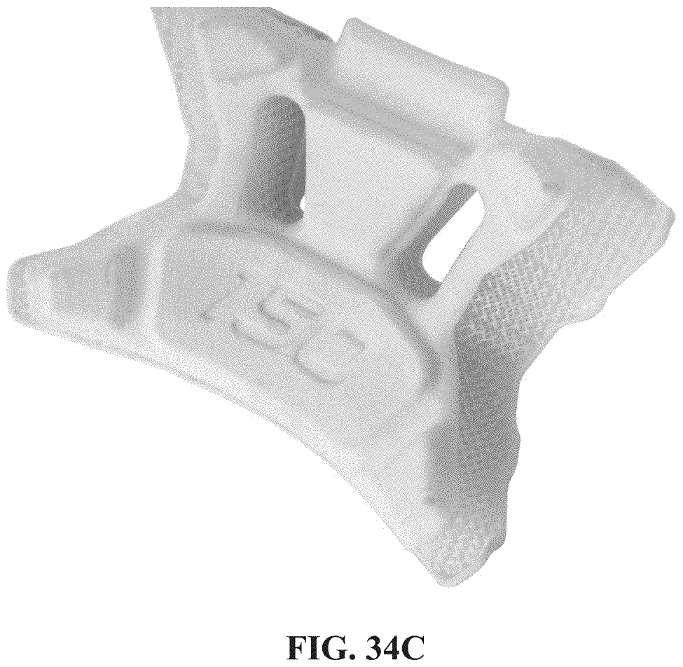

FIG. 33 shows an example of an AM component constituting a shoulder cap member of shoulder pads for a hockey or lacrosse player. In this example of implementation, the AM component constituting the shoulder cap member comprises a 3D lattice structure that forms a triply periodic minimal surface based on a gyroid structure. Gyroid structures generally have exceptional strength properties at low densities, which means that structures such as shoulder caps, that have conventionally been made by molding, can potentially be made lighter while retaining a suitable level of structural integrity and resilience by utilizing additively-manufactured gyroid surface structures. In the example shoulder pad shown in FIG. 33, an exterior facing portion of the shoulder pad has been formed as a closed surface to act as a bonding surface between the shoulder pad and a shell member (not shown). In some cases, a portion of an AM component that faces a wearer (e.g., an interior facing portion of the shoulder pad shown in FIG. 33) may also or instead include such a closed surface for the purpose of providing better comfort to the wearer, such as in the case of the interior facing surface of the occipital pad discussed below with reference to FIGS. 34A-34C.

FIGS. 34A, 34B and 34C show an example of an AM component constituting an occipital pad member of the inner lining of a hockey helmet. In this example of implementation, the AM component constituting the occipital pad member is configured with generally opposing solid outer surfaces. For example, if such an occipital pad member were used in the helmet 10, one of the solid opposing outer surfaces of the pad member would faces a user's head and the opposite solid outer surface would faces the inner surface 17 of the outer shell 11 of the helmet 10. As shown in this example of implementation, the outer surface of the pad that would face the user's head when the helmet is worn may be formed with one or more decorative structures or indicia. In this case, the numeral “150” has been formed in the outer surface of the occipital pad and would be visible to the wearer each time a helmet incorporating the occipital pad is donned. Such decorative indicia may also or instead be incorporated in any of the other AM components 12_{X} of the helmet 10 and may be customized for a particular model and/or user.

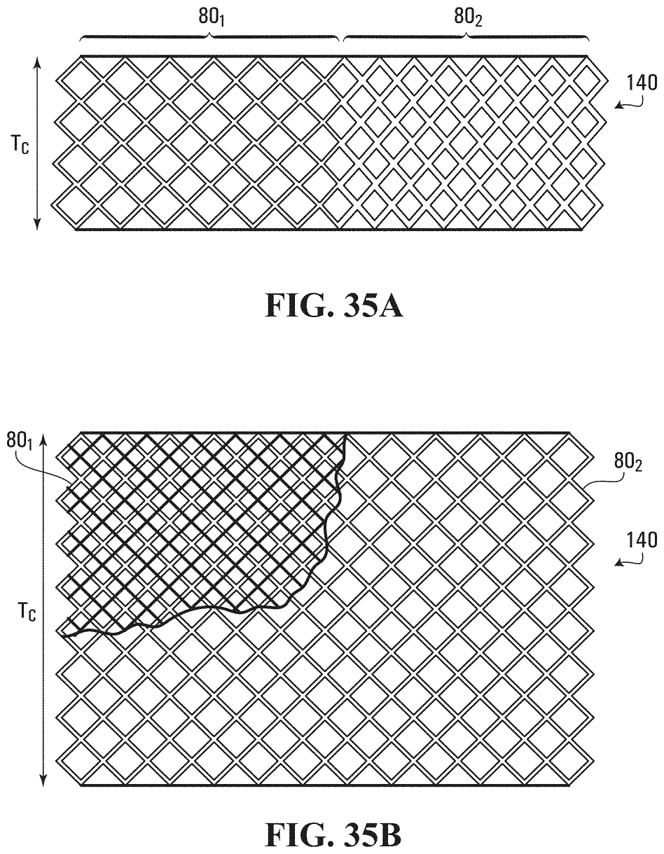

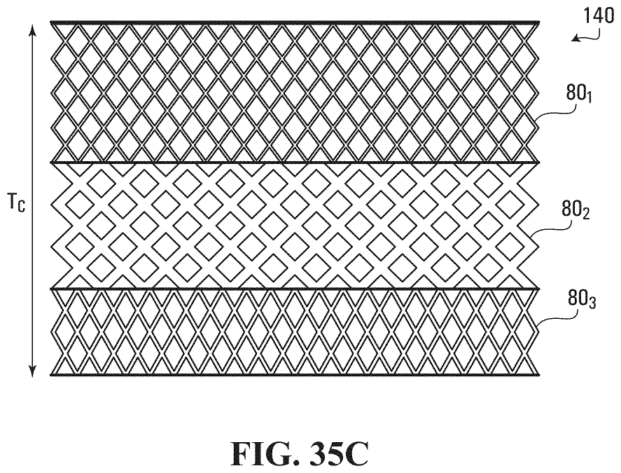

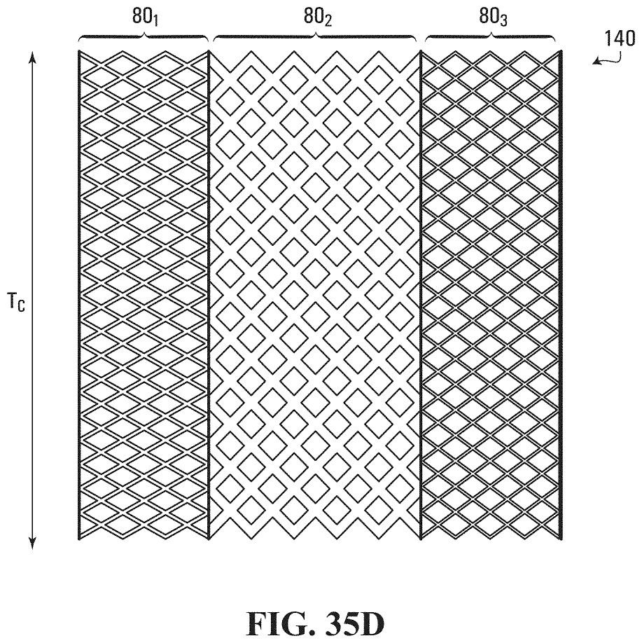

In some embodiments, the lattice 140 may include distinct zones 80₁-80_{Z} that are structurally different from one another and may be useful to manage different types of impacts, enhance comfort and/or fit, etc. FIGS. 35A, 35B, 35C and 35D show non-limiting examples of AM components that each includes a lattice 140 comprising a plurality of distinct zones 80₁-80_{Z} that are structurally different from one another.

As an example, the lattice 140 of the AM component 12_{X} comprised by the pad 36_{X} may include distinct zones that differ in stiffness.

As another example, in some embodiments, the distinct zones 80₁-80_{Z} of the lattice 140 may also or instead differ in resilience.

In a further example, in some embodiments, the distinct zones 80₁-80_{Z} of the lattice 140 may also or instead be configured to protect against different types of impacts. For example, a first one of the distinct zones 80₁ of the lattice 140 is configured to protect more against rotational impact components than linear impact components; and a second one of the distinct zones 80₂ of the lattice 140 is configured to protect more against linear impact components than rotational impact components.

In some embodiments, a first one of the distinct zones 80₁ of the lattice 140 is configured to protect more against lower-energy impacts than higher-energy impacts; and a second one of the distinct zones 80₂ of the lattice 140 is configured to protect more against higher-energy impacts than lower-energy impacts.

In a further example, in some embodiments, a first one of the distinct zones 80₁ of the lattice 140 is less stiff in shear than a second one of the distinct zones 80₂ of the lattice 140. In such embodiments, the second one of the distinct zones 80₂ of the lattice 140 may be less stiff in compression than the first one of the distinct zones 80₁ of the lattice 140. In some embodiments, a stress-strain curve for an AM component having two or more distinct zones that differ in stiffness and/or compression has multiple “flex” zones in the loading portion of the stess-strain curve. An example of such a stress-strain curve is shown in FIG. 22B. As shown in FIG. 22B, the flex zones are regions of the loading curve where a value of slope of the loading curve reaches zero and may temporarily turn negative before once again resuming a positive value.

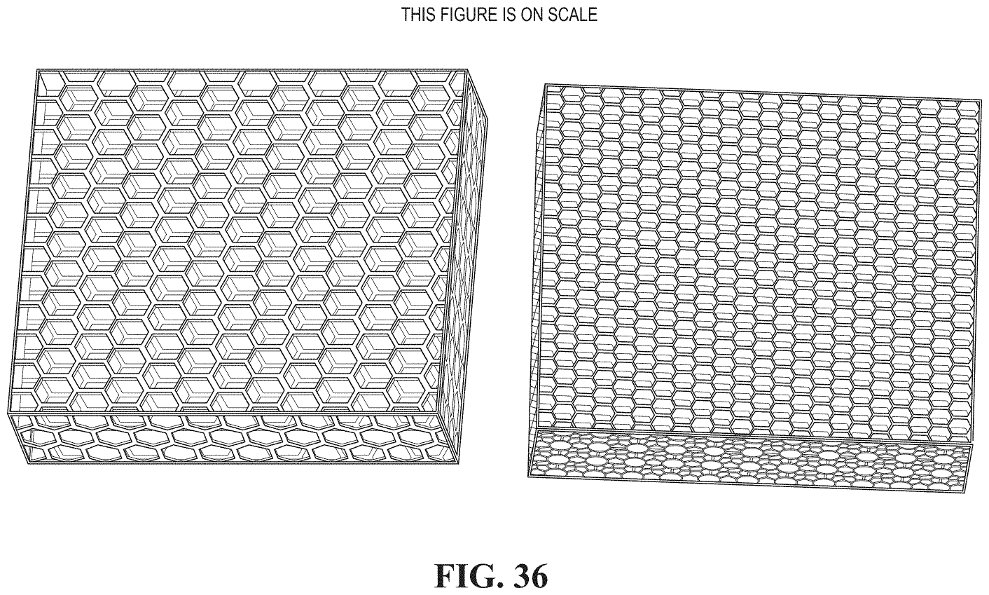

In some embodiments, such as the one shown in FIG. 35B, a density of the lattice 140 in a first one of the distinct zones 80₁ of the lattice 140 is greater than the density of the lattice in a second one of the distinct zones 80₂ of the lattice 140. Different densities of a lattice can be achieved in a number of ways. For example, FIG. 36 shows examples of lattices with different densities by virtue of using the same unit cell but different voxel sizes.

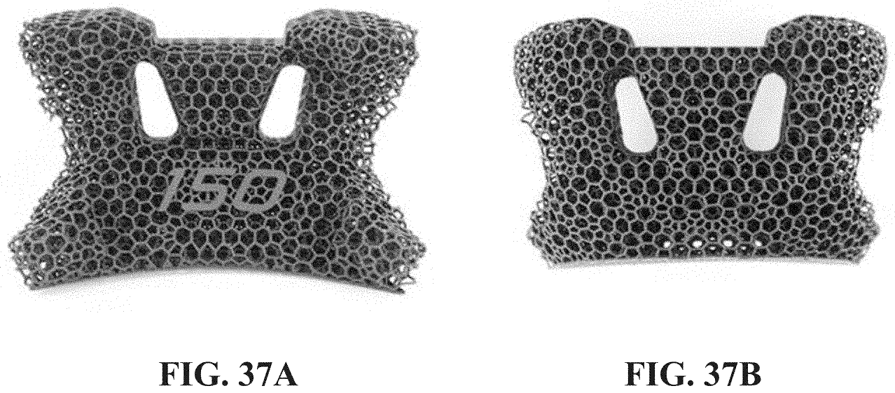

FIGS. 37A and 37B show front and back views, respectively, of another example of an AM component constituting an occipital pad member of the inner lining of a hockey helmet. In this example of implementation, the AM component constituting the occipital pad member is configured with a lattice structure that has a varying density by virtue of using varying voxel sizes in different regions of the lattice structure. As in the previous example implementation of an occipital pad shown in FIGS. 34A-C, in the example implementation shown in FIG. 37A the inner facing portion of the pad that would face the user's head when the helmet is worn is formed with a decorative indicia (i.e., the number “150”).

In some embodiments, a spacing of elongate members 141₁-141_{E} of the lattice 140 in a first one of the distinct zones 80₁ of the lattice 140 is less than the spacing of elongate members 141₁-141_{E} of the lattice 140 in a second one of the distinct zones 80₂ of the lattice 140.

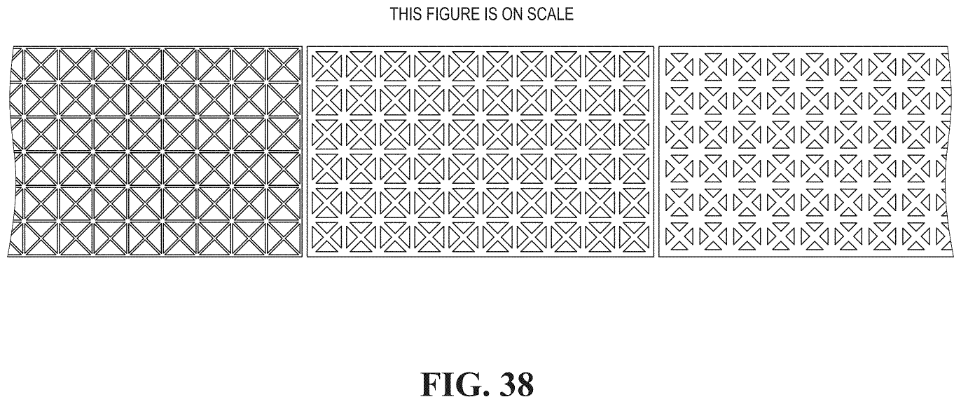

In some embodiments, elongate members 141₁-141_{E} of the lattice 140 in a first one of the distinct zones 80₁ of the lattice 140 are cross-sectionally larger than elongate members 141₁-141_{E} of the lattice 140 in a second one of the distinct zones of the lattice. For example, FIG. 38 shows examples of additively-manufactured components comprising lattice structures utilizing the same unit cell but different elongated member sizes.

In some embodiments, an orientation of elongate members 141₁-141_{E} of the lattice 140 in a first one of the distinct zones 80₁ of the lattice 140 is different from the orientation of elongate members 141₁-141_{E} of the lattice 140 in a second one of the distinct zones 80₂ of the lattice 140.

In some embodiments, a material composition of the lattice 140 in a first one of the distinct zones 80₁ of the lattice 140 is different from the material composition of the lattice 140 in a second one of the distinct zones 80₂ of the lattice 140.

In some embodiment, such as those shown in FIGS. 35C and 35D, the distinct zones 80₁-80_{Z} of the lattice 140 include at least three distinct zones 80₁, 80₂, 80₃.

In some embodiment, such as the one shown in FIG. 35C, the distinct zones 80₁-80_{Z} of the lattice 140 are layers of the lattice 140 that are layered on one another.

In some embodiments, the distinct zones 80₁-80_{Z} of the lattice 140 may facilitate adjustment of the fit of the helmet. For example, in some embodiments, the AM component 12_{X} comprised by the pad 36_{X} may facilitate adjustment of the helmet 10 when operating the adjustment mechanism 40. For example, in some embodiments, the AM component 12_{X} comprised by the pad 36_{X} may span adjacent ones of the shell members 22, 24 of the outer shell 11 and comprise an adjustment area 60_{X} between a portion 61_{X} of the AM component 12_{X} fastened to the shell member 22 and a portion 62_{X} of the AM component 12_{X} fastened to the shell member 24, such that these portions 61_{X}, 62_{X} of the AM component 12_{X} are movable relative to one another when the shell members 22, 24 are moved relative to one another. The adjustment area 60_{X} of the AM component 12_{X} may be less stiff than the portions 61_{X}, 62_{X} of the AM component 12_{X} so that the adjustment area 60 flexes more than the portions 61, 62 to facilitate their relative movement during adjustment.

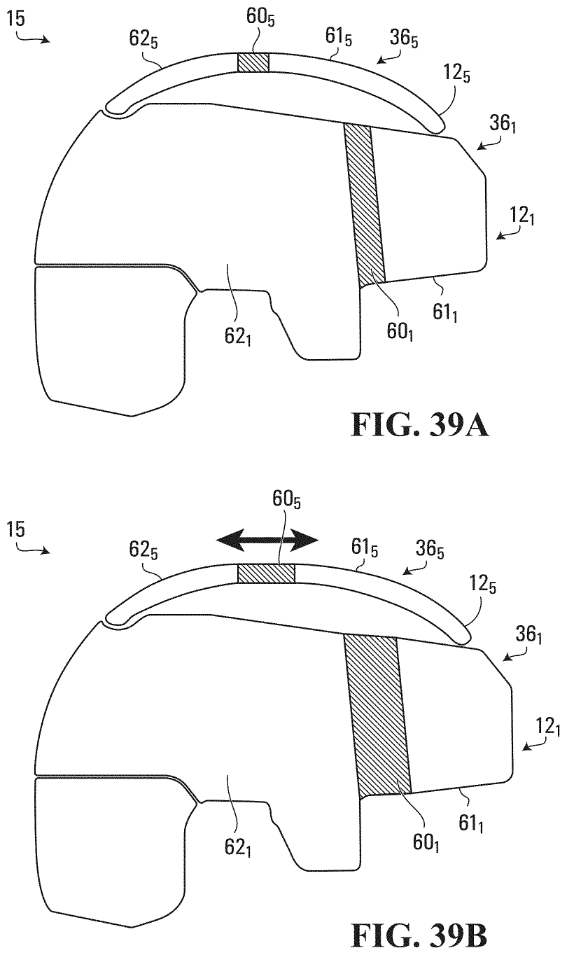

An example of such an embodiment is shown in FIGS. 39A and 39B, which show an example of the AM components 12₁ and 12₅ comprised by the pad 36₁ and 36₅ of the inner lining 15 of a helmet 10 in an open position and a closed position, respectively. For example, the AM component 12₁ comprised by the pad 36₁ spans the shell members 22, 24 of the outer shell 11 and comprises an adjustment area 60₁ between a portion 61₁ of the AM component 12₁ fastened to the front shell member 22 and a portion 62₁ of the AM component 12₁ fastened to the rear shell member 24, such that the portions 61₁, 62₁ of the AM component 12₁ are movable relative to one another when the shell members 22, 24 are moved relative to one another. The adjustment area 60₁ of the AM component 12₁ is configured so that it is less stiff than the portions 61₁, 62₁ of the AM component 12₁ so that the adjustment area 60₁ flexes more than the portions 61₁, 62₁ to facilitate their relative movement during adjustment of the shell members 22, 24. The adjustment areas of the AM components may have different structural components than the other areas of the AM components in order to provide the desired stiffness/flexibility, such as different material(s), a lesser density, lesser cross sectional size of elongate members, different unit cell(s) and/or different voxel size(s), as described above.

In some embodiments, a sensor may be associated with one or more of the AM components 12₁-12_{A} of the helmet 10. For example, the sensor may be sensitive to compression of the inner lining 15 and/or outer shell 11 of the helmet 10. In some embodiments, the AM component comprises the sensor, e.g., the sensor may be additively manufactured together with the AM component.

In some embodiments, the helmet comprises an actuator, and the sensor is responsive to an event to cause the actuator to alter the AM component. For example, the AM component may comprise material that is deformable by applying an electric current/voltage, and the actuator may be an electronic actuator configured to apply such an electric current/voltage to the AM component responsive to control signaling from the sensor. In some embodiments, the additively-manufactured component comprises piezoelectric material implementing the sensor.

In some embodiments, one or more of the AM components 12₁-12_{A} of the helmet 10 may be configured to receive a non-additively-manufactured component. For example, one or more of the AM components 12₁-12_{A} may be formed with a void that is accessible from an outer surface of the AM component and is configured to receive a non-AM component. For example, the AM component may comprise a lattice, such as the lattice 140 described above, and the non-AM component may be received within the lattice. In some embodiments, the non-AM component may be configured as an insert that is removably mountable to the lattice. In some embodiments, the non-AM component may comprise foam, for example. In other embodiments, the non-AM component may comprise fiber-reinforced polymeric material. In some embodiments, the non-AM component, when received in the AM component, serves to alter the shape and/or a functional property of the AM component, such as stiffness, rigidity, compressibility, etc.

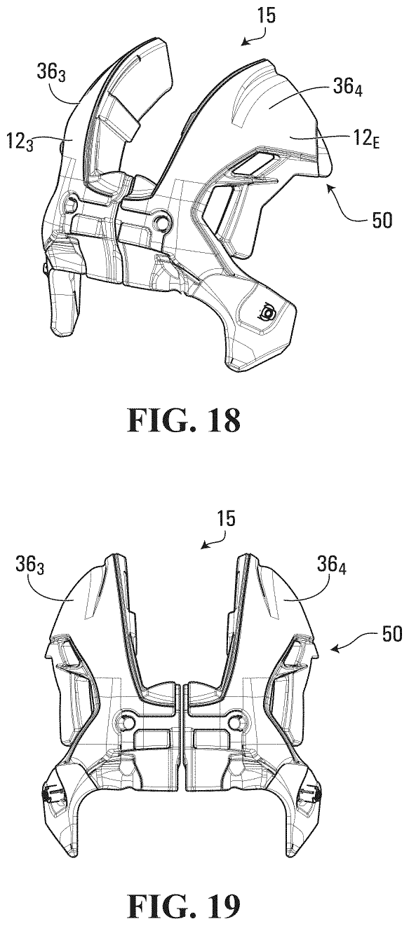

In some embodiments, the non-AM component may comprise expandable material. For example, the AM component may be sacrificed when the non-AM component is expanded. In such embodiments, the AM component may function as a frame to contain and/or shape the expandable component, and is sacrificed when the non-AM component is expanded. In other embodiments, the AM component may be integrated with the expandable material of the expandable non-AM component so as to provide structural support to the non-AM component once it is expanded. For example, referring again to FIGS. 18 to 20, the inner padding 15 of the helmet may include post-molded expandable components 212 constituting the pads 36₁ to 36_{X}. Integrating an AM component into a post-molded expandable component has many potential benefits, such as potentially improving resistance to breakage, and may also allow a wider range of grades of expandable material to be used. For example, the integration of an AM component may allow lighter and/or more expandable materials to be used.

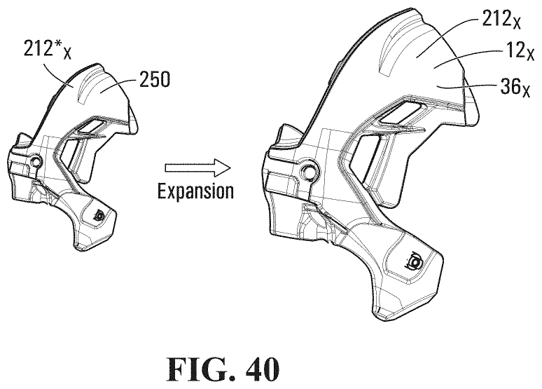

FIG. 40 shows an example of a precursor 212_{X}* of a post-molded expandable component 212_{X} being expanded to form the post-molded expandable component 212_{X} constituting a pad 36_{X}. In this example, the pad 36_{X} corresponds to the right pad 364 that was shown previously in FIGS. 18 to 20. In this example of implementation, the post-molded expandable component 212_{X} of the helmet 10 constituting the pad 36_{X} comprises an expandable material 250 that is molded into a precursor 212_{X} * which can then be expanded by a stimulus (e.g., heat or another stimulus) to an expanded shape that is a scaled-up version of an initial shape of the precursor 212_{X}*. Thus, in this example, a three-dimensional configuration of the initial shape of the precursor 212_{X}* is such that, once the expandable material 250 is expanded, a three-dimensional configuration of the expanded shape of the post-molded expandable component 212_{X} imparts a three-dimensional configuration of the pad 36_{X} (e.g., including curved and/or angular parts of the pad 36_{X}).

The post-molded expandable component 212_{X} of the helmet 10 constituting the pad 36_{X} is “expandable” in that it is capable of expanding and/or has been expanded by a substantial degree in response to a stimulus after being molded. That is, an expansion ratio of the post-molded expandable component 212_{X} of the helmet 10 constituting the pad 36_{X}, which refers to a ratio of a volume of the post-molded expandable component 212_{X} of the helmet 10 after the expandable material 250 has been expanded subsequently to having been molded into the precursor 212_{X}* over a volume of the precursor 212_{X}* into which the expandable material 250 is initially molded, may be significantly high. For example, in some embodiments, the expansion ratio of the post-molded expandable component 212_{X} of the helmet 10 constituting the pad 36_{X} may be at least 2, in some cases at least 3, in some cases at least 5, in some cases at least 10, in some cases at least 20, in some cases at least 30, in some cases at least 40 and in some cases even more (e.g., 45).

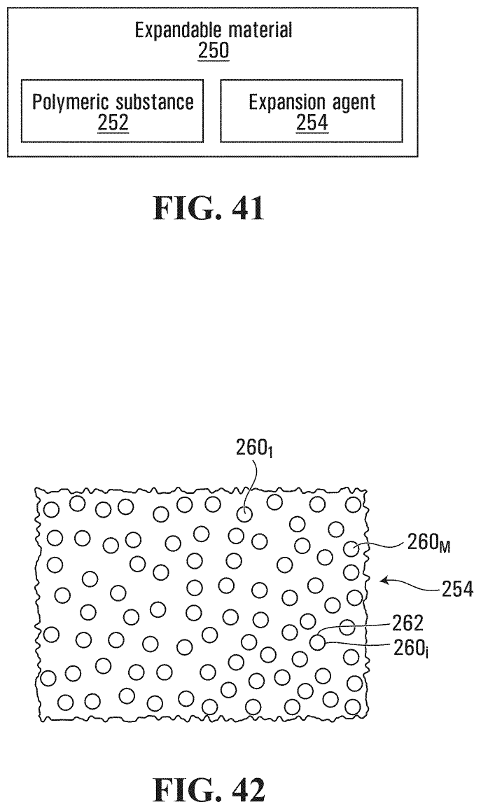

In such embodiments, the expandable material 250 can be any material capable of expanding after being molded. For example, the expandable material 250 may include a mixture of a polymeric substance 252 and an expansion agent 254 that allows the expandable material 250 to expand. FIG. 41 is a block diagram representing an example of an expandable material of the post-molded expandable component. Once expanded into its final shape, the pad 36_{X} may have desirable properties, such as being more shock-absorbent than it if had been made entirely of the expansion agent 254 and/or being lighter than if it had been made entirely of the polymeric substance 252.

The polymeric substance 252 constitutes a substantial part of the expandable material 250 and substantially contributes to structural integrity of the pad 36_{X}. For instance, in some embodiments, the polymeric substance 252 may constitute at least 40%, in some cases at least 50%, in some cases at least 60%, in some cases at least 70%, in some cases at least 80%, and in some cases at least 90% of the expandable material 250 by weight. In this example of implementation, the polymeric substance 252 may constitute between 50% and 90% of the expandable material 250 by weight.

In this embodiment, the polymeric substance 252 may be an elastomeric substance. For instance, the polymeric substance 252 may be a thermoplastic elastomer (TPE) or a thermoset elastomer (TSE).

More particularly, in this embodiment, the polymeric substance 252 comprises polyurethane. The polyurethane 252 may be composed of any suitable constituents such as isocyanates and polyols and possibly additives. For instance, in some embodiments, the polyurethane 252 may have a hardness in a scale of Shore 00, Shore A, Shore C or Shore D, or equivalent. For example, in some embodiments, the hardness of the polyurethane 252 may be between Shore 5A and 95A or between Shore D 40D to 93D. Any other suitable polyurethane may be used in other embodiments.

The polymeric substance 252 may comprise any other suitable polymer in other embodiments. For example, in some embodiments, the polymeric substance 252 may comprise silicon, rubber, ethylene-vinyl acetate (EVA), etc.

The expansion agent 254 is combined with the polyurethane 252 to enable expansion of the expandable material 250 to its final shape after it has been molded. A quantity of the expansion agent 254 allows the expandable material 250 to expand by a substantial degree after being molded. For instance, in some embodiments, the expansion agent 254 may constitute at least 10%, in some cases at least 20%, in some cases at least 30%, in some cases at least 40%, in some cases at least 50%, and in some cases at least 60%, of the expandable material 250 by weight and in some cases even more. In this example of implementation, the expansion agent 254 may constitute between 15% and 50% of the expandable material 250 by weight. Controlling the quantity of the expansion agent 254 may allow control of the expansion ratio of the post-molded expandable component 212_{X}.

In this embodiment, as shown in FIG. 42, the expansion agent 254 comprises an amount of expandable microspheres 260₁-260_{M}. Each expandable microsphere 260ᵢ comprises a polymeric shell 262 expandable by a fluid encapsulated in an interior of the polymeric shell 262. In this example of implementation, the polymeric shell 262 of the expandable microsphere 260ᵢ is a thermoplastic shell. The fluid encapsulated in the polymeric shell 262 is a liquid or gas (in this case a gas) able to expand the expandable microsphere 260ᵢ when heated during manufacturing of the pad 36_{X}. In some embodiments, the expandable microspheres 260₁-260_{M} may be Expancel™ microspheres commercialized by Akzo Nobel. In other embodiments, the expandable microspheres 260₁-260_{M} may be Dualite microspheres commercialized by Henkel; Advancell microspheres commercialized by Sekisui; Matsumoto Microsphere microspheres commercialized by Matsumoto Yushi Seiyaku Co; or KUREHA

Microsphere microspheres commercialized by Kureha. Various other types of expandable microspheres may be used in other embodiments.

In this example of implementation, the expandable microspheres 260₁-260_{M} include dry unexpanded (DU) microspheres when combined with the polymeric substance 252 to create the expandable material 250 before the expandable material 250 is molded and subsequently expanded. For instance, the dry unexpanded (DU) microspheres may be provided as a powder mixed with one or more liquid constituents of the polymeric substance 252.

The expandable microspheres 260₁-260_{M} may be provided in various other forms in other embodiments. For example, in some embodiments, the expandable microspheres 260₁-260_{M} may include dry expanded, wet and/or partially-expanded microspheres. For instance, wet unexpanded microspheres may be used to get better bonding with the polymeric substance 252. Partially-expanded microspheres may be used to employ less of the polymeric substance 252, mix with the polymeric substance 252 in semi-solid form, or reduce energy to be subsequently provided for expansion.

In some embodiments, the expandable microspheres 260₁-260_{M} may constitute at least 10%, in some cases at least 20%, in some cases at least 30%, in some cases at least 40%, in some cases at least 50%, and in some cases at least 60% of the expandable material 250 by weight and in some cases even more. In this example of implementation, the expandable microspheres 260₁-260_{M} may constitute between 15% and 50% of the expandable material 250 by weight.

The post-molded expandable component 212_{X} of the helmet 10 constituting the pad 36_{X} may have various desirable qualities.

For instance, in some embodiments, the pad 36_{X} may be less dense and thus lighter than if it was entirely made of the polyurethane 252, yet be more shock-absorbent and/or have other better mechanical properties than if it was entirely made of the expandable microspheres 260₁-260_{M}.

For example, in some embodiments, a density of the expandable material 250 of the pad 36_{X} may be less than a density of the polyurethane 252 (alone). For instance, the density of the expandable material 250 of the pad 36_{X} may be no more than 70%, in some cases no more than 60%, in some cases no more than 50%, in some cases no more than 40%, in some cases no more than 30%, in some cases no more than 20%, in some cases no more than 10%, and in some cases no more than 5% of the density of the polyurethane 252 and in some cases even less. For example, in some embodiments, the density of the expandable material 250 of the pad 36_{X} may be between 2 to 75 times less than the density of the polyurethane 252, i.e., the density of the expandable material 250 of the pad 36_{X} may be about 1% to 50% of the density of the polyurethane 252).

The density of the expandable material 250 of the pad 36_{X} may have any suitable value. For instance, in some embodiments, the density of the expandable material 250 of the pad 36_{X} may be no more than 0.7 g/cm³, in some cases no more than 0.4 g/cm³ , in some cases no more than 0.1 g/cm³, in some cases no more than 0.080 g/cm³, in some cases no more than 0.050 g/cm3, in some cases no more than 0.030 g/cm³, and/or may be at least 0.010 g/cm³. In some examples of implementation, the density of the expandable material 250 may be between 0.015 g/cm³ and 0.080 g/cm³, in some cases between 0.030 g/cm³ and 0.070 g/cm³, and in some cases between 0.040 g/cm³ and 0.060 g/cm³.

As another example, in some embodiments, a stiffness of the expandable material 250 of the pad 36_{X} may be different from (i.e., greater or less than) a stiffness of the expandable microspheres 260₁-260_{M} (alone). For instance, a modulus of elasticity (i.e., Young's modulus) of the expandable material 250 of the pad 36_{X} may be greater or less than a modulus of elasticity of the expandable microspheres 260₁-260_{M} (alone). For instance, a difference between the modulus of elasticity of the expandable material 250 of the pad 36_{X} and the modulus of elasticity of the expandable microspheres 260₁-260_{M} may be at least 20%, in some cases at least 30%, in some cases at least 50%, and in some cases even more, measured based on a smaller one of the modulus of elasticity of the expandable material 250 of the pad 36_{X} and the modulus of elasticity of the expandable microspheres 260₁-260_{M}. In some cases, the modulus of elasticity may be evaluated according to ASTM D-638 or ASTM D-412.

As another example, in some embodiments, a resilience of the expandable material 250 of the pad 36_{X} may be less than a resilience of the expandable microspheres 260₁-260_{M} (alone). For instance, in some embodiments, the resilience of the expandable material 250 of the pad 36_{X} may be no more than 70%, in some cases no more than 60%, in some cases no more than 50%, in some cases no more than 40%, in some cases no more than 30%, in some cases no more than 20%, and in some cases no more than 10% of the resilience of the expandable microspheres 260₁-260_{M} according to ASTM D2632-01 which measures resilience by vertical rebound. In some examples of implementation, the resilience of the expandable material 250 of the pad 36_{X} may be between 20% and 60% of the resilience of the expandable microspheres 260₁-260_{M}. Alternatively, in other embodiments, the resilience of the expandable material 250 of the pad 36_{X} may be greater than the resilience of the expandable microspheres 260₁-260_{M}.

The resilience of the expandable material 250 of the pad 36_{X} may have any suitable value. For instance, in some embodiments, the resilience of the expandable material 250 of the pad 36_{X} may be no more than 40%, in some cases no more than 30%, in some cases no more than 20%, in some cases no more than 10% and in some cases even less (e.g., 5%), according to ASTM D2632-01, thereby making the pad 36_{X} more shock-absorbent. In other embodiments, the resilience of the expandable material 50 of the pad 36_{X} may be at least 60%, in some cases at least 70%, in some cases at least 80% and in some cases even more, according to ASTM D2632-01, thereby making the expandable material 250 provide more rebound.

As another example, in some embodiments, a tensile strength of the expandable material 250 of the pad 36_{X} may be greater than a tensile strength of the expandable microspheres 260₁-260_{M} (alone). For instance, in some embodiments, the tensile strength of the expandable material 250 of the pad 36_{X} may be at least 120%, in some cases at least 150%, in some cases at least 200%, in some cases at least 300%, in some cases at least 400%, and in some cases at least 500% of the tensile strength of the expandable microspheres 260₁-260_{M} according to ASTM D-638 or ASTM D-412, and in some cases even more.

The tensile strength of the expandable material 250 of the pad 36_{X} may have any suitable value. For instance, in some embodiments, the tensile strength of the expandable material 250 of the pad 36_{X} may be at least 0.9 MPa, in some cases at least 1 MPa, in some cases at least 1.2 MPa, in some cases at least 1.5 MPa and in some cases even more (e.g. 2 MPa or more).

As another example, in some embodiments, an elongation at break of the expandable material 250 of the pad 36_{X} may be greater than an elongation at break of the expandable microspheres 260₁-260_{M} (alone). For instance, in some embodiments, the elongation at break of the expandable material 250 of the pad 36_{X} may be at least 120%, in some cases at least 150%, in some cases at least 200%, in some cases at least 300%, in some cases at least 400%, and in some cases at least 500% of the elongation at break of the expandable microspheres 260₁-260_{M} according to ASTM D-638 or ASTM D-412, and in some cases even more.

The elongation at break of the expandable material 250 of the pad 36_{X} may have any suitable value. For instance, in some embodiments, the elongation at break of the expandable material 250 of the pad 36_{X} may be at least 20%, in some cases at least 30%, in some cases at least 50%, in some cases at least 75%, in some cases at least 100%, and in some cases even more (e.g. 150% or more).

With additional reference to FIG. 40, in this example of implementation the post-molded expandable component 212_{X} constituting the pad 36_{X} includes an additively manufactured component 12_{X}. For example, the precursor 212_{X}* of the post-molded expandable component 212_{X} may be molded around the additively manufactured component 12_{X}. In some embodiments, the additively manufactured component 12_{X} may include a lattice with an open structure. In such embodiments, the expandable material 250 may extend at least partially into/through the additively manufactured component 12_{X}.

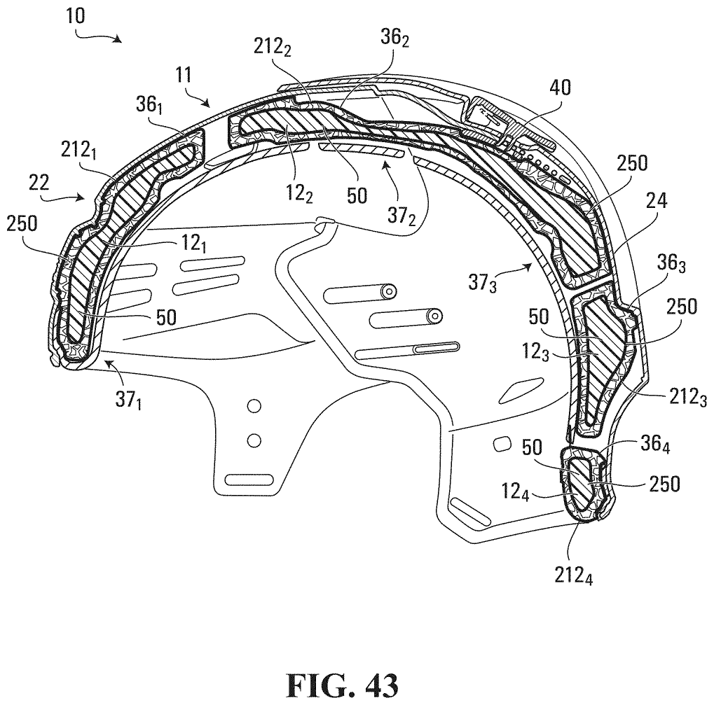

FIG. 43 shows a cross-sectional view of a sport helmet 10 with inner padding 15 that includes additively manufactured components 12₁-12₄ integrated into post-molded expandable components 212₁-212₄ constituting pads 36₁-36₄. In this example of implementation, the additively manufactured component 12₁-12₄ are made from additively manufactured material 50 and act as a reinforcing structure or armature for the post-molded expandable components 212₁-212₄.

In some embodiments, an AM component may comprise expandable material. For example, rather than being molded and then expanded through a post-molded expansion process like the one discussed above with reference to FIGS. 40 to 43, an expandable component may instead be additively manufactured by additively-manufacturing a precursor and then expanding the precursor into a post-additively-manufactured (post-AM) expandable component through a post-AM expansion process.

For example, referring again to FIGS. 18 to 20, the inner padding 15 of the helmet 10 may include post-AM expandable components 512 constituting the pads 36₁ to 36_{X}. Utilizing post-AM expandable components has many potential benefits, such as potentially reducing the time required for the additive-manufacturing, because the physical size of the precursor is potentially many times smaller than that of the fully expanded component. For example, the additional time required to expand a post-AM precursor into a post-AM expandable component may be more than offset by a reduction in time required to additively-manufacture the physically smaller precursor. Furthermore, and the use of post-AM expandable components may also allow components to be made lighter/less dense for a given volume while still satisfying other desirable performance characteristics, such as impact absorption, resiliency, structural integrity, etc.

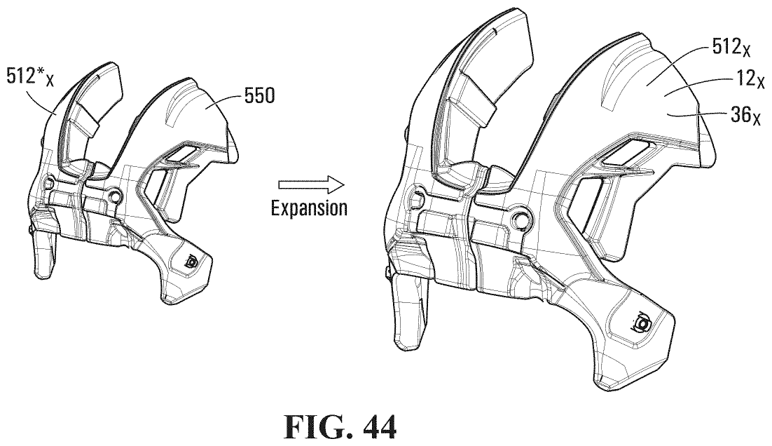

FIG. 44 shows an example of a precursor 512_{X}* of a post-AM expandable component 512_{X} being expanded to form the post-AM expandable component 512_{X} constituting a pad 36_{X}. In this example, the pad 36_{X} corresponds to the left and right pads 36₃ and 36₄ that were shown previously in FIGS. 18 to 20. In this example of implementation, the post-AM expandable component 512_{X} of the helmet 10 constituting the pad 36x comprises an expandable material 550 that is additively-manufactured into a precursor 512_{X}* which can then be expanded by a stimulus (e.g., heat or another stimulus) to an expanded shape that is a scaled-up version of an initial shape of the precursor 512_{X}*. Thus, in this example, a three-dimensional configuration of the initial shape of the precursor 512_{X}* is such that, once the expandable material 550 is expanded, a three-dimensional configuration of the expanded shape of the post-AM expandable component 512_{X} imparts a three-dimensional configuration of the pad 36_{X} (e.g., including curved and/or angular parts of the pad 36_{X}).

The post-AM expandable component 512_{X} of the helmet 10 constituting the pad 36_{X} is “expandable” in that it is capable of expanding and/or has been expanded by a substantial degree in response to a stimulus after being additively-manufactured. That is, an expansion ratio of the post-AM expandable component 512_{X} of the helmet 10 constituting the pad 36_{X}, which refers to a ratio of a volume of the post-AM expandable component 512_{X} of the helmet 10 after the expandable material 550 has been expanded subsequently to having been additively-manufactured into the precursor 512_{X}* over a volume of the precursor 512_{X} * into which the expandable material 550 is initially additively-manufactured, may be significantly high. For example, in some embodiments, the expansion ratio of the post-AM expandable component 512_{X} of the helmet 10 constituting the pad 36_{X} may be at least 2, in some cases at least 3, in some cases at least 5, in some cases at least 10, in some cases at least 20, in some cases at least 30, in some cases at least 40 and in some cases even more (e.g., 45).

In such embodiments, the expandable material 550 can be any material capable of expanding after being additively-manufactured. For example, the expandable material 550 may include a mixture of a polymeric substance and an expansion agent that allows the expandable material 550 to expand after an additive manufacturing step has been done to form the expandable material 550 into a precursor component. Once expanded into its final shape, the pad 36_{X} may have desirable properties, such as being more shock-absorbent than it if had been made entirely of the expansion agent and/or being lighter than if it had been made entirely of the polymeric substance.

In some embodiments, a polymeric substance may constitute a substantial part of the expandable material 550 and may substantially contribute to structural integrity of the pad 36_{X}. For instance, in some embodiments, a polymeric substance may constitute at least 40%, in some cases at least 50%, in some cases at least 60%, in some cases at least 70%, in some cases at least 80%, and in some cases at least 90% of the expandable material 550 by weight.

In some embodiments, the expandable material 550 may comprise a polymeric substance that is elastomeric. For instance, the expandable material 550 may comprise a polymeric substance such as a thermoplastic elastomer (TPE) or a thermoset elastomer (TSE). In some embodiments, the polymeric substance may comprise polyurethane. The polyurethane may be composed of any suitable constituents such as isocyanates and polyols and possibly additives. For instance, in some embodiments, the polyurethane may have a hardness in a scale of Shore 00, Shore A, Shore C or Shore D, or equivalent. For example, in some embodiments, the hardness of the polyurethane may be between Shore 5A and 95A or between Shore D 40D to 93D. Any other suitable polyurethane may be used in other embodiments.

In other embodiments, the expandable material 550 may comprises any other suitable polymer in other embodiments. For example, in some embodiments, the expandable material 550 may include a polymeric substance such as silicon, rubber, etc.

In some embodiments an expansion agent may be combined with a polymeric substance, such as polyurethane, to enable expansion of the expandable material 550 to its final shape after the precursor 512_{X}* has been additively-manufactured.

A quantity of the expansion agent allows the expandable material 550 to expand by a substantial degree after being additively-manufactured to form the precursor 512_{X}*. For instance, in some embodiments, the expansion agent may constitute at least 10%, in some cases at least 20%, in some cases at least 30%, in some cases at least 40%, in some cases at least 50%, and in some cases at least 60%, of the expandable material 550 by weight and in some cases even more. Controlling the quantity of the expansion agent may allow control of the expansion ratio of the post-AM expandable component 5 12_{X}.

The post-AM expandable component 512_{X} of the helmet 10 constituting the pad 36_{X} may have various desirable qualities similar to the post-molded expandable component 212_{X} described earlier.

In some embodiments, the combining of the polymeric substance and the expansion agent occurs during the additive-manufacturing process, and there is an intermediary polymerizing step to polymerize the polymeric substance and the expansion agent before the further step of expansion of the precursor 512_{X}* into the post-AM expandable component 512_{X}. For example, the intermediate polymerizing step might involve applying heat, light or some other form of energy to the preliminary formed combination of the polymeric substance and the expansion agent in order to promote polymerization without causing expansion.

The additive manufacturing technology utilized in such embodiments could include any one or more of the additive manufacturing technologies discussed earlier. For instance, in one example of implementation, a vat photopolymerization AM technology, such as SLA, DLP or CDLP may be used to light-cure a mixture of a polymeric substance and an expansion agent. For example, in such embodiments, a planetary mixer or any other suitable mixer may be used to first mix the polymeric substance (e.g., polyurethane or acrylic) with the expansion agent (e.g., expandable microspheres, such as unexpanded Expancel, Dualite microspheres, Advancell microspheres, etc.), and then a SLA, DLP or CDLP type 3D printer may be used to light-cure the polymeric substance/expansion agent mixture to consolidate the material into a preliminary form. In such embodiments, final polymerization of the polymeric substance/expansion agent mixture may be done using a heat and/or light source that does not reach the expansion temperature of the expansion agent so that the temperature of the expandable material during the additive-manufacturing is lower than the expansion temperature of the expansion agent. For instance, in some embodiments where the expansion temperature of the expansion agent may be 70° C. or more, the additive-manufacturing process may be carried out such that the temperature of the expandable material 550 being additively-manufactured into the precursor 512_{X}* is less than 70° C. (e.g., 40° C.). Once the polymerization step has been completed, the expansion phase may be activated by using a heat source to raise the temperature of the expandable material 550 above the expansion temperature of the expansion agent.

Other AM technologies may be used to additively-manufacture expandable components in other embodiments. For example, FIG. 45 shows an example of a binder jetting 3D printer system 500 being used to additively manufacture a precursor 512_{X}* of a post-AM expandable component 512_{X} in accordance with another embodiment of the present disclosure. In binder jetting, a binder is selectively deposited onto a bed of powder to selectively bond areas together to form solid parts layer-by-layer. The binder jetting 3D printer system 500 includes a build platform 502, a recoating blade 506 and a binder nozzle carriage 508. In operation, the recoating blade 506 first spreads a bed or layer of powder expansion agent 504 (e.g., unexpanded Expancel, Dualite microspheres, Advancell microspheres, etc.) over the build platform 502. Then, the binder jetting nozzle carriage 508, which includes jetting nozzles similar to the nozzles used in desktop inkjet 2D printers, is moved over the powder bed 504 and the nozzles are controlled to selectively deposit droplets of a binding agent (e.g., a polymeric substance such as polyurethane) that bonds the powder particles of the expansion agent together. When a layer is complete, the build platform 502 moves downwards and the recoating blade 506 spreads a new layer of powder expansion agent 504 to re-coat the powder bed. This process then repeats until the preliminary form of the precursor 512_{X}* is complete. After printing, the preliminary form of the precursor 512_{X}* may be removed from the powder bed and unbound, excess powder expansion agent may be removed via pressurized air. Similar to the previous vat photopolymerization example, the final polymerization or curing of the preliminary form of the precursor 512_{X}* may be done using a heat source that does not reach the expansion temperature of the expansion agent. For instance, in some embodiments where the expansion temperature of the expansion agent may be 70° C. or more, the preliminary form of the precursor 512_{X}* may be cured in an oven at 50-60° C. after being removed from the powder bed. Once the polymerization step has been completed and the precursor 512_{X}* has been cured, the expansion phase may be activated by raising the temperature of the expandable material 550 above the expansion temperature of the expansion agent.

Referring again to the example embodiment of a sport helmet 10 shown in FIG. 43, it is noted that, in addition to the inner padding 15, in this embodiment the helmet 10 also includes comfort pads 37₁-37₄. In some embodiments, the comfort pads 37₁-37₄ may also or instead include additively manufactured components. For example, in some embodiments, the additively manufactured components 12_{X} of the helmet 10 may instead constitute the comfort pads 37_{X}.

FIG. 46 shows an exploded view of an example of inner padding 15 for a sport helmet in which the comfort pads 37_{X} include additively manufactured components 12_{X}. In particular, in this example of implementation, the inner padding 15 includes absorption pads 36₁-36_{A}, and additively manufactured components 12₁-12_{K} constituting comfort pads 37₁-37_{K}. In this example of implementation, the comfort pads 37₁-37_{K} are made from an additively manufactured material 50, which, in some embodiments, could be an expandable material 550 as described above. In contrast, the absorption pads 36₁-36_{A} may be made from a more conventional non-additively manufactured material 350, such as EPP or Expancel.

In some embodiments, the comfort pads 37₁-37_{K} are configured for low energy levels that reach a targeted 35 shore 00 durometer or less. Since additively manufactured material 50 can be a solid material rather than a material with an open cell structure, such as many conventional memory foams, implementing the comfort pads 37₁-37_{K} with additively manufactured components 12₁-12_{K} may address the water absorption problem that often occurs when materials with open cell structures are used for comfort padding parts in order to provide a desired level of comfort. For example, in some embodiments a relatively low hardness and feel to provide a desired level of comfort could be achieved by using a relatively small mesh lattice structure with relatively thin elongate members.

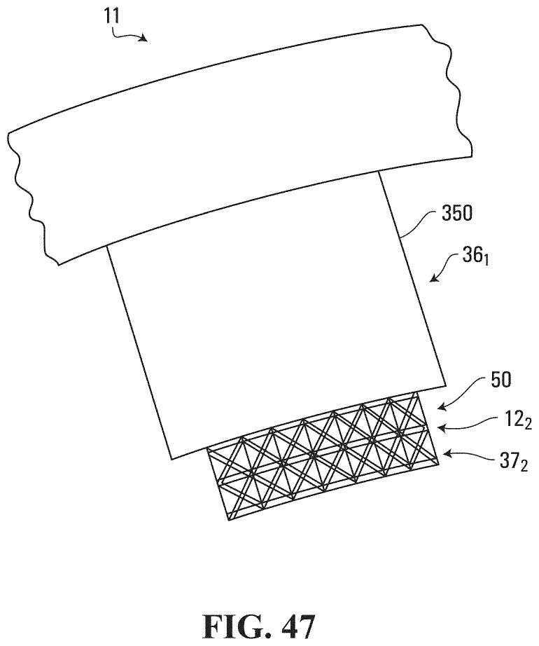

FIG. 47 shows a cross-sectional view of a portion of the inner padding of FIG. 46 showing that the additively manufactured component 122 constituting the comfort pad 37₂ lies between the wearer's head and the absorption pad 36₁ when the helmet 10 is worn. In some embodiments the comfort pads 37₁-37_{K} may be affixed to the absorption pads 36₁-36_{A}. In other embodiments the comfort pads may be otherwise affixed to the helmet, but may be moveable relative to the absorption pads. In some embodiments, the comfort pads may also or instead be moveable relative to one another, e.g., during adjustment of the fit of the helmet and/or as a result of deflection of the helmet due to an impact.

As noted above with reference to the example hockey helmet 10 shown in FIGS. 10-20, in some embodiments the shock-absorbing materials used in the liner 15 may include liquid crystal elastomer (LCE) components in order to enhance their impact absorbing performance, e.g., to provide better impact energy dissipation. A mesogen is a compound that displays liquid crystal properties. Mesogens can be described as disordered solids or ordered liquids because they arise from a unique state of matter that exhibits both solid-like and liquid-like properties called the liquid crystalline state. This liquid crystalline state is called the mesophase and occurs between the crystalline solid state and the isotropic liquid state at distinct temperature ranges. LCEs are materials that are made up of slightly crosslinked liquid crystalline polymer networks. LCE materials combine the entropy elasticity of an elastomer with the self-organization of a liquid crystalline phase. In LCEs, the mesogens can either be part of the polymer chain (main-chain liquid crystalline elastomers) or they are attached via an alkyl spacer (side-chain liquid crystalline elastomers).

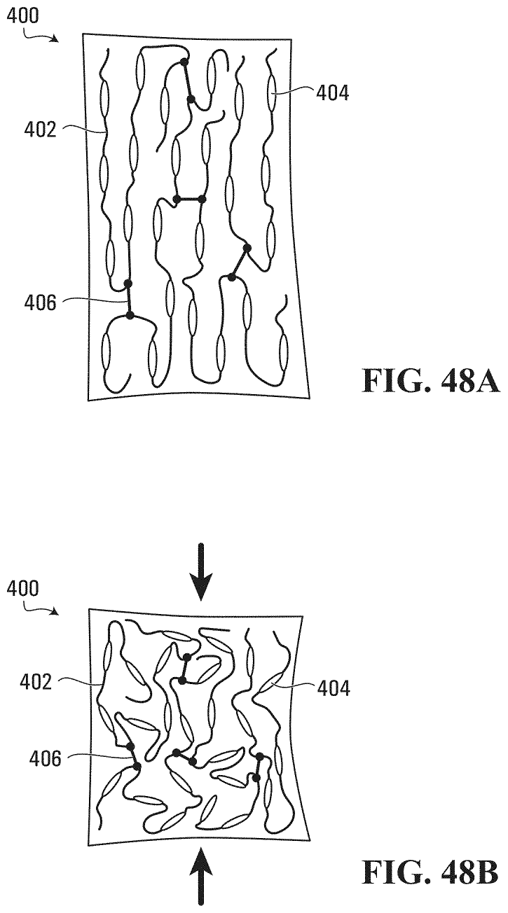

FIG. 48A shows an example of a main-chain LCE material 400 in which the mesogens 404 are part of polymer chains 402 that are slightly crosslinked at crosslinks 406. As shown in FIG. 48A, when the LCE material 400 is uncompressed the mesogenic groups 404 are generally aligned. When a compressive force is applied to the LCE material 400, as shown in FIG. 48B, the mesogenic groups 404 are displaced out of alignment. The displacement of the mesogenic groups 404 serves to elastically dissipate the energy of the applied force and afterward return to substantially the same state as shown in FIG. 48A. In this way, many LCE materials provide better impact absorbing performance relative to conventional shock-absorbing materials such as polymeric foam

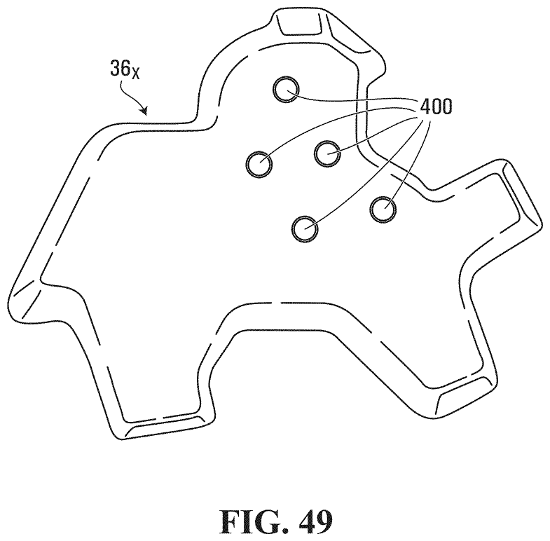

In some embodiments, one or more of the pads 36_{X} of the liner 15 for a helmet 10 may have a hybrid structure that includes a combination of shock-absorbing materials, such as non-AM LCE materials/components, AM LCE materials/components (e.g., 3D printed LCE components) and/or more conventional shock-absorbing materials/components (e.g., EPP foram, EPS foam, PORON XRD foam, etc.) that may be fabricated using non-AM and/or AM technologies. For example, FIG. 49 shows an example of a pad 36_{X} in which multiple column- or cylinder-shaped LCE components 400 are embedded in a polymeric foam structure constituting the remainder of the pad 36_{X}. The column-shaped LCE components 400 are arranged such that the elongated dimension of each column extends in a direction that is generally radial to a wearer's head. Although the LCE components are cylindrical or column-shaped in this example, more generally LCE components or other shock-absorbing materials that are utilized in a hybrid structure may be any suitable shape, e.g., in some embodiments one or more of the shock-absorbing materials in a hybrid structure may be designed to provide optimized attenuation under impact (specific buckling, twisting, collapsing).

In this example shown in FIG. 49, the pad 36_{X} forms part of the side padding for a helmet and the LCE components 400 are located in a portion of the pad 36_{X} that would face the wearer's temple region when the helmet is worn in order to enhance lateral impact absorption. In other embodiments, LCE components may also or instead be incorporated into padding that faces other portions of the wearer's head, such as the front region, top region, back region and/or occipital region. In some embodiments, the LCE components used in different regions of the helmet may be configured with different shapes, sizes and/or materials in order to provide different impact-absorbing properties in different regions.

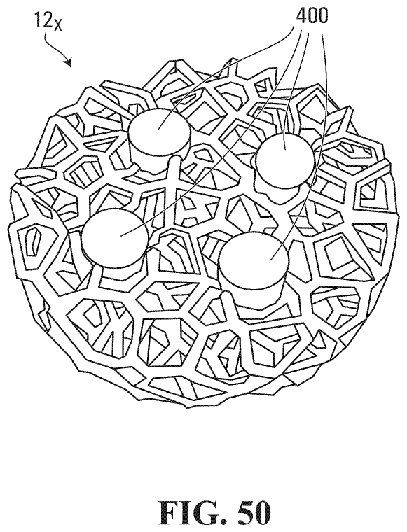

In some embodiments, the additively manufactured components 12_{X} constituting the pads 36_{X} and/or the comfort pads 37_{X} of the helmet 10 may have LCE components integrated into the pads. For example, FIG. 50 shows an example of an AM component 12_{X} that has a lattice structure into which a cluster of four column-shaped LCE components 400 have been embedded. The four LCE components 400 have been thinly outlined in FIG. 50 in order to allow them to be more easily identified in the image. In some embodiments, the lattice structure of the AM component 12_{X} may be formed from a shock-absorbing material that includes a polymeric foam and/or a polymeric structure comprising one or more polymeric materials, while the LCE components 400 may include any suitable LCE material. The column shape of the LCE components in this example is merely illustrative of one example shape that may be used in some embodiments. Differently shaped and/or sized LCE components may be used in other embodiments. In some embodiments, the spaces in the AM component 12_{X} for receiving and retaining the LCE components 400 may be formed in the AM component 12_{X} during the additive manufacturing process. In other embodiments, the spaces may be created after the additive manufacturing process, e.g., by drilling or cutting into the AM component 12_{X} to create the spaces.

One of the common problems that is encountered when designing helmet liner/padding parts is air channel integration. It is often desirable to provide a high level of ventilation, but conventional molding techniques that have traditionally been used to manufactured helmet liner/padding parts limit the types of structures that can practically be realized. The use of additively manufactured components with lattice structures to implement liner/padding parts may solve some of these problems, because a lattice can be implemented as an open structure that permits air flow. However, in some embodiments, a desired level of ventilation may be achieved by also or instead using non-lattice additively manufactured components that have air channels formed in and/or on them that could not be practically mouldable by traditional molding. For example, in some embodiments the additively manufactured components 12_{X} constituting the pads 36_{X} and/or the comfort pads 37_{X} of the helmet 10 may have air channels integrated in the core of the pads.

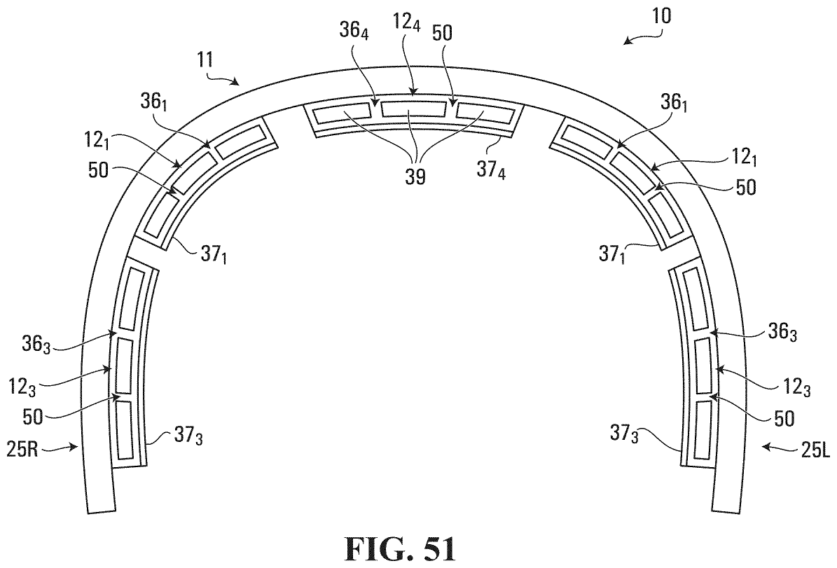

FIG. 51 shows a cross-sectional view of a sport helmet 10 with inner padding that includes air channels 39 integrally formed within additively manufactured components 12₁, 12₃, 12₄ constituting the absorption pads 36₁, 36₃, 36₄ of the inner padding. The outer shell 11 of the helmet 10 may include apertures (not shown in FIG. 51) that allow air in the air channels 39 to exit the helmet 10. Similarly, the absorption pads 36₁, 36₃, 36₄ may include apertures (not shown in FIG. 51) that permit heated air from the interior of the helmet to pass into the air channels 39 in order eventually exit the helmet 10. For example, portions of the absorption pads 36₁, 36₃, 36₄ nearest the wearer's head when the helmet is worn may have an open lattice structure to permit this air flow from the interior of the helmet into the air channels 39. In such embodiments, portions of the absorption pads 36₁, 36₃, 36₄ furthest from the wearer's head when the helmet 10 is worn, i.e., the portions of the absorption pads 36₁, 36₃, 36₄ proximal the outer shell 11 may be manufactured with a solid non-lattice structure. In other embodiments, the absorption pads 36₁, 36₃, 36₄ may be wholly formed with a solid non-lattice structure. In other embodiments, the absorption pads 36₁, 36₃, 36₄ may be wholly formed with a lattice structure. In such embodiments, the cross-sectional area of the air channels 39 may be greater than the cross-sectional area of spaces between elongate members of the lattice structure itself.

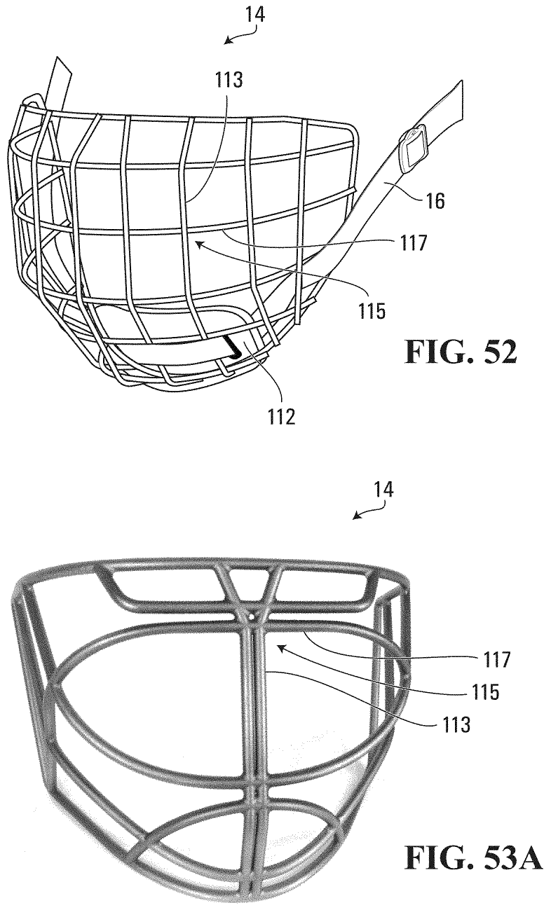

While in many of the embodiments described above the inner liner 15 of the helmet 10 comprises the AM components 12₁-12_{A}, in other embodiments, another part of the helmet 10 may comprise one or more AM components such as the AM components 12₁-12_{A}. For instance, in some embodiments, as shown in FIG. 52, when the helmet 10 comprises a faceguard 14, the faceguard 14 and/or a chin cup 112 mounted to the chin strap 16 of the helmet 10 to engage a chin of the user may comprise an AM component constructed using principles described here in respect of the AM components 12₁-12_{A}. A cage or visor faceguard 14 comprising an AM component may have several advantages relative to a conventional faceguard. For example, a conventional cage faceguard is typically manufactured by welding together a plurality of elongate metal members to form a cage. In the conventional cage faceguard, the elongate metal members are welded together where they overlap. These welds are a potential point of failure. In contrast, as shown in FIG. 52, in an additively-manufactured cage faceguard 14, the vertically oriented elongate members 113 may directly intersect the horizontally oriented elongate members 117 at points of intersection 115. In addition, the use of additive-manufacturing makes it feasible to customize the positioning and/or profile of the elongate members 113, 115 of the faceguard 14. For example, the positioning of the elongate members 113,115 may be customized based on the eye positions of an intended user (e.g., pupillary distance, location of eyes relative to the top and/or sides of the head, etc.). Furthermore, the profiles of the elongate members 113,115 of the faceguard may be tapered and/or shaped to minimize their impact on the user's field of vision. For example, portions of the elongate members 113,115 that may fall within the user's field of vision may have an ovoid cross-section, with a major axis of the ovoid oriented substantially parallel with the user's line of sight.

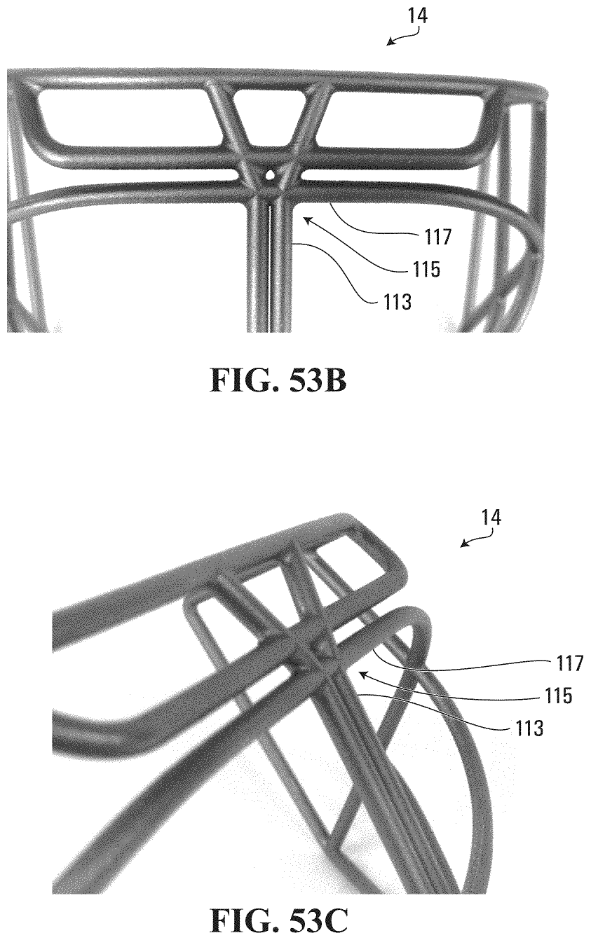

FIGS. 53A, 53B and 53C show another example of an additively-manufactured cage faceguard 14. In this example, the additively-manufactured cage faceguard 14 has been formed by 3D printing metal and is configured as a faceguard for a goalie mask. Similar to the faceguard 14 shown in FIG. 52, the example implementation of a faceguard 14 shown in FIGS. 53A-C includes elongate members 113 and 117 that merge into one another at points of intersection 115.

In some embodiments, at least part of the outer shell 11 may comprise an AM component that is similar to the AM components 12₁-12_{A}. For instance, a given one of the front shell member 22 and the rear shell member 24 of the outer shell 11 may comprise an AM component.

Although in embodiments considered above the helmet 10 is a hockey helmet, in other embodiments, the helmet 10 may be any other helmet usable by a player playing another type of contact sport (e.g., a “full-contact” sport) in which there are significant impact forces on the player due to player-to-player and/or player-to-object contact or any other type of sports, including athletic activities other than contact sports.

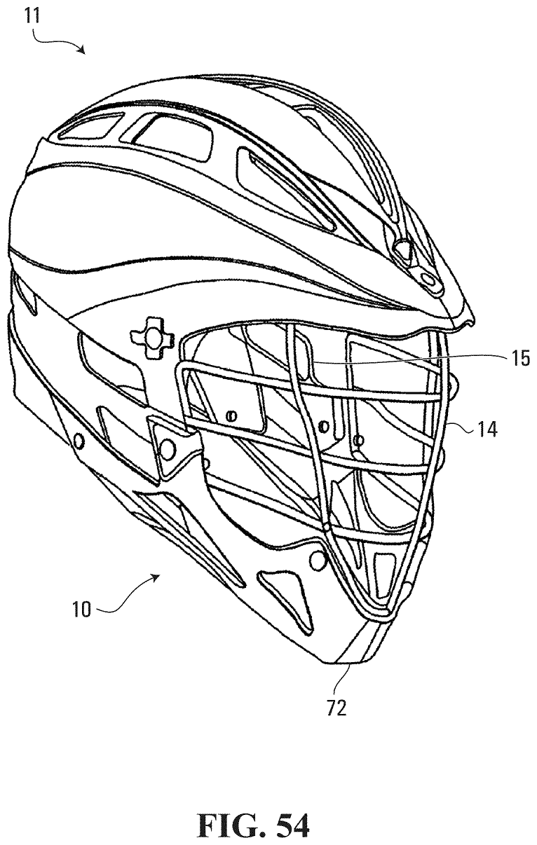

For example, in other embodiments, as shown in FIG. 54, the helmet 10 may be a lacrosse helmet. The lacrosse helmet 10 comprises a chin piece 72 extending from the left lateral side portion 25L to the right lateral side portion 25R of the helmet 10 and configured to extend in front of a chin area of the user. The lacrosse helmet 10 also comprises the faceguard 14 which is connected to the shell 11 and the chin piece 72.

The lacrosse helmet 10 may be constructed according to principles discussed herein. For example, in some embodiments, the lacrosse helmet 10 may the additively-manufactured components 12₁-12_{A}, as discussed above. For instance, in some embodiments, the additively-manufactured components 12₁-12_{A} may constitute at least part of the shell 11, at least part of the liner 15, at least part of the chin piece 72, and/or at least part of the faceguard 14, according to principles discussed herein.

In other embodiments, the helmet 10 may be a baseball/softball helmet or any other type of helmet.

While in many of the embodiments described above it is the inner liner 15 of a helmet 10 that comprises an AM component, in other embodiments, another part of the helmet 10 may comprise one or more AM components. For instance, referring again to FIG. 5, in some embodiments when the helmet 10 comprises a faceguard 14, a chin cup 112 mounted to the chin strap 16 of the helmet 10 to engage a chin of the user may comprise a post-AM expandable component constructed using principles described here in respect of the post-AM expandable component 512_{X} described herein. In some embodiments, at least part of the outer shell 11 may comprise a post-AM expandable component that is similar to the post-AM expandable component 512_{X}. For instance, a given one of the front shell member 22 and the rear shell member 24 of the outer shell 11 may comprise a post-AM expandable component.

Moreover, although in many of the embodiments described above the article of protective athletic gear comprising an AM component is a helmet, in other embodiments, the article of protective athletic gear may be any other article of protective athletic gear comprising one or more AM components. For example, with reference again to FIG. 33, in some embodiments the example implementation of an additively manufactured shoulder pad shown in FIG. 33 may be constructed as a post-AM expandable component using principles described herein in respect of the post-AM expandable component 512_{X}.

In other embodiments, the article of manufacture that includes AM components may be some other form of athletic gear. For example, in some embodiments the article comprising additively-manufactured components may be a sporting implement for use by a user engaging in a sport.

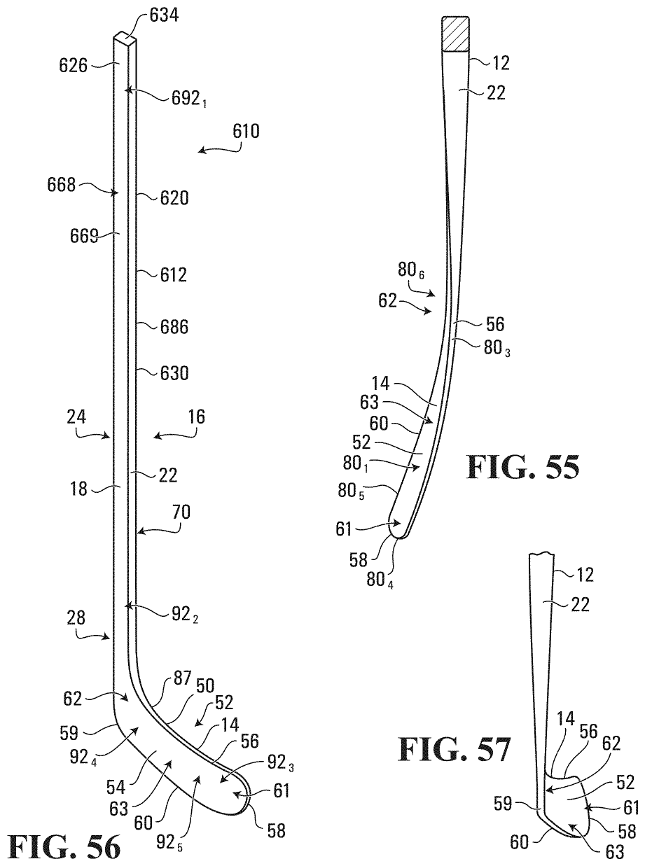

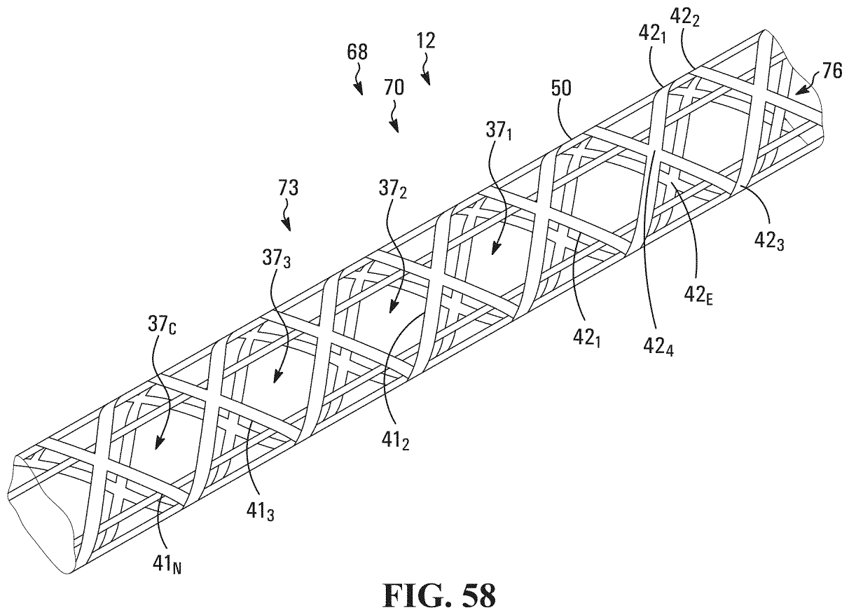

FIG. 55 shows an embodiment of a sporting implement 10 for use by a user engaging in a sport. The sporting implement 10 comprises an elongate holdable member 12 configured to be held by the user and an object-contacting member 14 configured to contact an object (e.g., a puck or ball) intended to be moved in the sport. In this embodiment, the sport is hockey and the sporting implement 10 is a hockey stick for use by the user, who is a hockey player, to pass, shoot or otherwise move a puck or ball. The elongate holdable member 12 of the hockey stick 10 is a shaft, which comprises a handle 20 of the hockey stick 10, and the object-contacting member 14 of the hockey stick 10 is a blade.

In this embodiment, as further discussed later, the hockey stick 10 is designed to enhance its use, performance and/or manufacturing, including, for example, by being lightweight, having improved strength, flex, stiffness, impact resistance and/or other properties, reducing scrap or waste during its construction, and/or enhancing other aspects of the hockey stick 10. For instance, in some embodiments, the hockey stick 10 may include a structure that is open, such as by being latticed (e.g., trussed), and/or made by additive manufacturing, selective material positioning, etc.

The shaft 12 is configured to be held by the player to use the hockey stick 10. A periphery 30 of the shaft 12 includes a front surface 16 and a rear surface 18 opposite one another, as well as a top surface 22 and a bottom surface 24 opposite one another. Proximal and distal end portions 26, 28 of the shaft 12 are spaced apart in a longitudinal direction of the shaft 12, respectively adjacent to the handle 20 and the blade 14, and define a length of the shaft 12. A length of the hockey stick 10 is measured from a proximal end 34 of the shaft 12 along the top surface 22 of the shaft 12 through the blade 14.

A cross-section of the shaft 12 may have any suitable configuration. For instance, in this embodiment, the cross-section of the shaft 12 has a major axis 36 which defines a major dimension D of the shaft's cross-section and a minor axis 38 which defines a minor dimension W of the shaft's cross-section. In this example, the cross-section of the shaft 12 is generally polygonal. More particularly, in this example, the cross-section of the shaft 12 is generally rectangular, with the front surface 16, the rear surface 18, the top surface 22, and the bottom surface 24 being generally flat. Corners between these surfaces of the shaft 12 may be rounded or beveled.

The shaft 12 may have any other suitable shape and/or be constructed in any other suitable way in other embodiments. For example, in some embodiments, the cross-section of the shaft 12 may have any other suitable shape (e.g., the front surface 16, the rear surface 18, the top surface 22, and/or the bottom surface 24 may be curved and/or angular and/or have any other suitable shape, possibly including two or more sides or segments oriented differently, such that the cross-section of the shaft 12 may be pentagonal, hexagonal, heptagonal, octagonal, partly or fully curved, etc.). As another example, the cross-section of the shaft 12 may vary along the length of the shaft 12.

The blade 14 is configured to allow the player to pass, shoot or otherwise move the puck or ball. A periphery 50 of the blade 14 comprises a front surface 52 and a rear surface 54 opposite one another, as well as a top edge 56, a toe edge 58, a heel edge 59, and a bottom edge 60. The blade 14 comprises a toe region 61, a heel region 62, and an intermediate region 63 between the toe region 61 and the heel region 62. The blade 14 has a longitudinal direction that defines a length of the blade 14, a thicknesswise direction that is normal to the longitudinal direction and defines a thickness of the blade 14, and a heightwise direction that is normal to the longitudinal direction and defines a height of the blade 14.

A cross-section of the blade 14 may have any suitable configuration. For instance, in this embodiment, the cross-section of the blade 14 varies along the longitudinal direction of the blade 14 (e.g., tapers towards the toe region 61 of the blade 14), with the front surface 52 and the rear surface 54 curving so that the front surface 52 is concave and the rear surface 54 is convex. Corners between the front surface 52, the rear surface 54, the top edge 56, the toe edge 58, the heel edge 59, and the bottom edge 60 may be rounded or beveled.

The blade 14 may have any other suitable shape and/or be constructed in any other suitable way in other embodiments. For example, in some embodiments, the cross-section of the blade 14 may have any other suitable shape (e.g., the front surface 52, the rear surface 54, the top edge 56, the toe edge 58, the heel edge 59, and the bottom edge 60 may be curved differently and/or angular and/or have any other suitable shape, etc.).

The shaft 12 and the blade 14 may be interconnected in any suitable way. For instance, in this embodiment, the shaft 12 and the blade 14 are integrally formed with one another (i.e., at least part of the shaft 12 and at least of the blade 14 are integrally formed together) such that they constitute a one-piece stick. In other embodiments, the blade 14 may be secured to and removable from the shaft 12 (e.g., by inserting a shank of the blade 14, which may include a tenon, into a cavity of the shaft 12).

In this embodiment, the hockey stick 10 includes an open structure 68 and a covering 69 that covers at least part of the open structure 68. This may reduce a weight of the hockey stick 10, enhance properties such as the strength, the stiffness, the flex, the impact resistance, and/or other characteristics of the hockey stick 10, etc.

More particularly, in this embodiment, at least part of the hockey stick 10 is latticed, i.e., comprises a lattice 70. Thus, in this example, the lattice 70 constitutes at least part of the shaft 12 and/or at least part of the blade 14. Specifically, in this example, the shaft 12 includes a portion 71 of the lattice 70, while the blade 14 includes another portion 73 of the lattice 70. In this embodiment, the lattice 70 occupies at least a majority (i.e., a majority or an entirety) of the length of the shaft 12 and at least a majority (i.e., a majority or an entirety) of the length of the blade 14.

In some embodiments, the lattice 70 comprises a framework of structural members 41₁-41_{E} that intersect one another. In some embodiments, the structural members 41₁-41_{E} may be arranged in a regular arrangement repeating over the lattice 70. In some cases, the lattice 70 may be viewed as made up of unit cells 37₁-37_{C} each including a subset of the structural members 41₁-41_{E} that forms the regular arrangement repeating over the lattice 70. Each of these unit cells 37₁-37_{C} can be viewed as having a voxel, which refers to a notional three-dimensional space that it occupies. In other embodiments, the structural members 41₁-41_{E} may be arranged in different arrangements over the lattice 70 (e.g., which do not necessarily repeat over the lattice 70, do not necessarily define unit cells, etc.).

The lattice 70, including its structural members 41₁-41_{E}, may be configured in any suitable way.

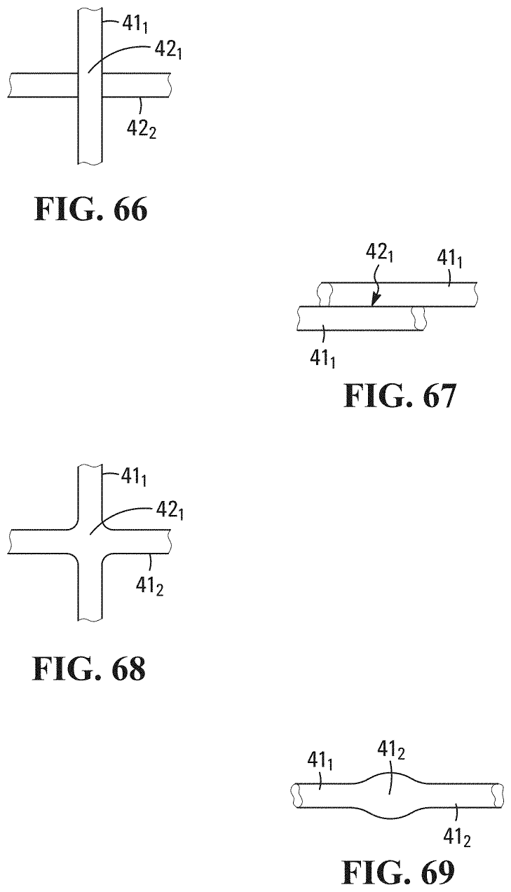

In this embodiment, the structural members 41₁-41_{E} are elongate members that intersect one another at nodes 42₁-42_{N}. The elongate members 41₁-41_{E} may sometimes be referred to as “beams” or “struts”. Each of the elongate members 41₁-41_{E} may be straight, curved, or partly straight and partly curved. While in some embodiments at least some of the nodes 42₁-42_{N} (i.e. some of the nodes 42₁-42_{N} or every one of the nodes 42₁-42_{N}) may be formed by having the structural members 41₁-41_{E} forming the nodes affixed to one another (e.g., chemically fastened, via an adhesive, etc.), as shown in FIGS. 66 and 67, in some embodiments at least some of the nodes 42₁-4_{N} (i.e. some of the nodes 42₁-42_{N} or every one of the nodes 42₁-42_{N}) may be formed by having the structural members 41₁-41_{E} being unitary (e.g., integrally made with one another, fused to one another, etc.), as shown in FIGS. 68 and 69. Also, in this embodiment, the nodes 42₁-42_{N} may be thicker than respective ones of the elongate members 41₁-41_{E} that intersect one another thereat, as shown in FIGS. 67 and 69, while in other embodiments the nodes 42₁-42_{N} may have a same thickness as respective ones of the elongate members 41₁-41_{E} that intersect one another thereat.

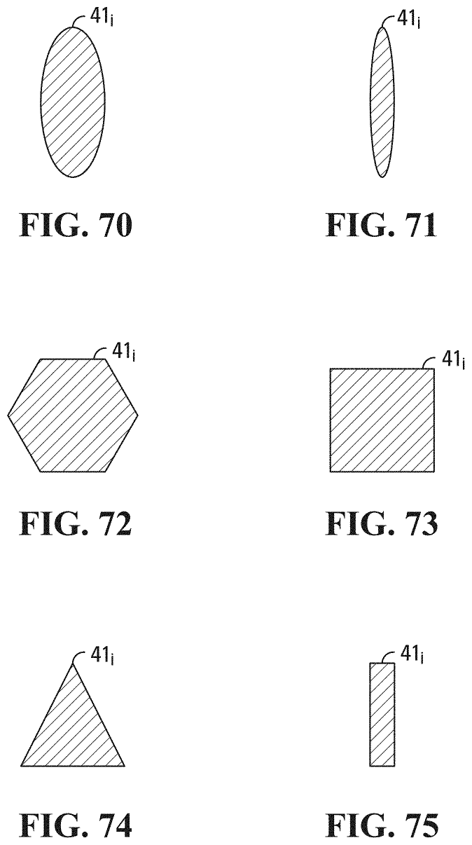

In this embodiment, the structural members 41₁-41_{E} may have any suitable shape, as shown in FIGS. 70 to 75. That is, a cross-section of a structural member 41ᵢ across a longitudinal axis of the structural member 41ᵢ may have any suitable shape, for instance: a circular shape, an oblong shape, an elliptical shape, a square shape, a rectangular shape, a polygonal shape (e.g. triangle, hexagon, and so on), etc.

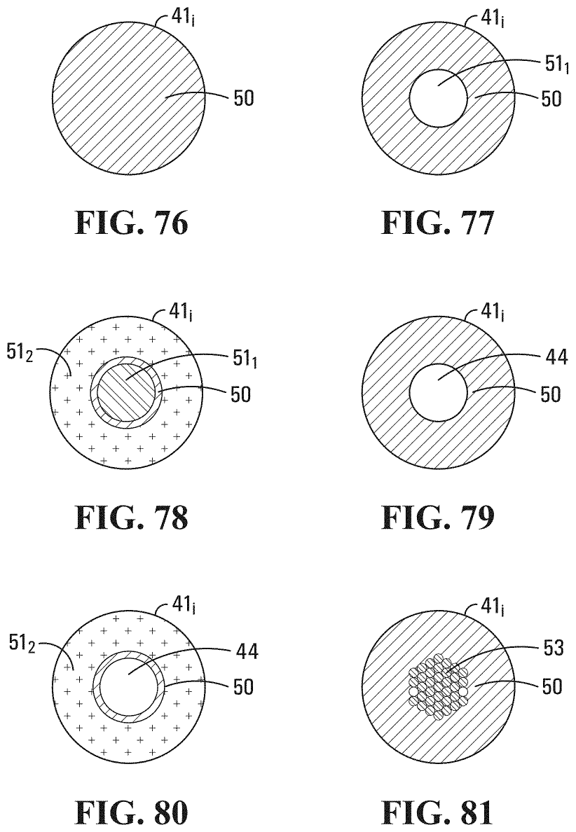

Moreover, in this embodiment, the structural member 41ᵢ may comprise any suitable structure and any suitable composition, as shown in FIGS. 76 to 81. As an example, the structural member 41ᵢ may be solid (i.e. without any void) and composed of a material 50, as shown in FIG. 76. In another embodiment, the structural member 41ᵢ may comprise the material 50 and another material 51₁ inner to the material 50, as shown in FIG. 77. In another embodiment, the structural member 41ᵢ may comprise the material 50, the other material 51₁ inner to the material 50 and another material 512 outer to the material 50, as shown in FIG. 78. In another embodiment, the structural member 41ᵢ may be composed of the material 50 and may comprise a void 44 that is not filled by any specific solid material, as shown in FIG. 79. In another embodiment, the structural member 41ᵢ may comprise the material 50, another material outer to the material 50 and the void 44 that is not filled by any specific solid material, as shown in FIG. 80. In another embodiment, the structural member 41ᵢ may comprise the material 50 and a plurality of reinforcements 53 (e.g. continuous or chopped fibers), as shown in FIG. 81.

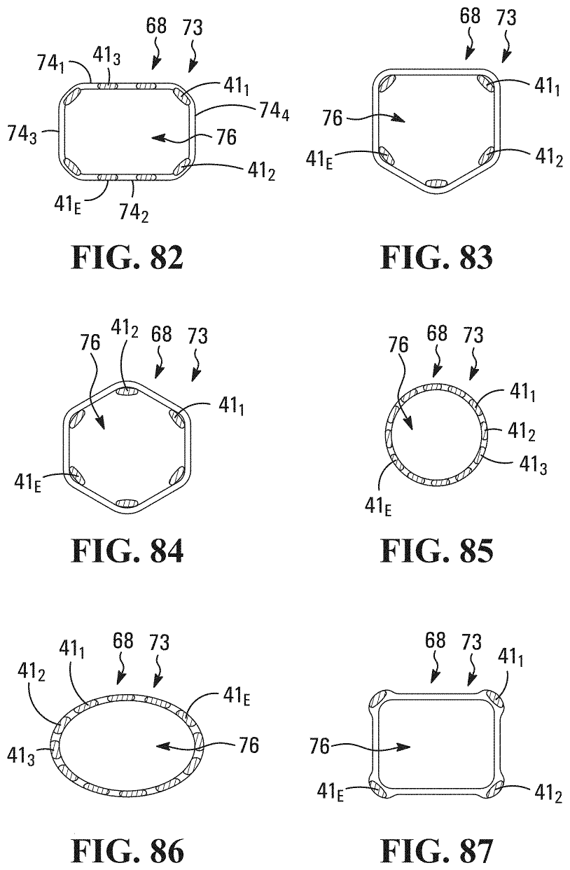

More particularly, in this embodiment, the lattice 70 includes a truss 73, as shown in FIG. 82. In this example, the truss 73 constitutes the portion 71 of the lattice 70 of the shaft 12. The truss 73 comprises peripheral portions 74₁-74₄ that are part of walls 75₁-75₄ of the shaft 12 that define the periphery 30 of the shaft 12, including its front surface 16, rear surface 18, top surface 22 and bottom surface 24. Each of the peripheral portions 74₁-74₄ of the truss 73 includes respective ones of the elongate members 41₁-41_{E} and the nodes 42₁-42_{N} of the lattice 70. A front one of the peripheral portions 74₁-74₄ of the truss 73 is part of a front one of the walls 75₁-75₄ of the shaft 12 that includes its front surface 16, a rear one of the peripheral portions 74₁-74₄ of the truss 73 is part of a rear one of the walls 75₁-75₄ of the shaft 12 that includes its rear surface 18, a top one of the peripheral portions 74₁-74₄ of the truss 73 is part of a top one of the walls 75₁-75₄ of the shaft 12 that includes its top surface 22, and a bottom one of the peripheral portions 74₁-74₄ of the truss 73 is part of a bottom one of the walls 75₁-75₄ of the shaft 12 that includes its bottom surface 24.

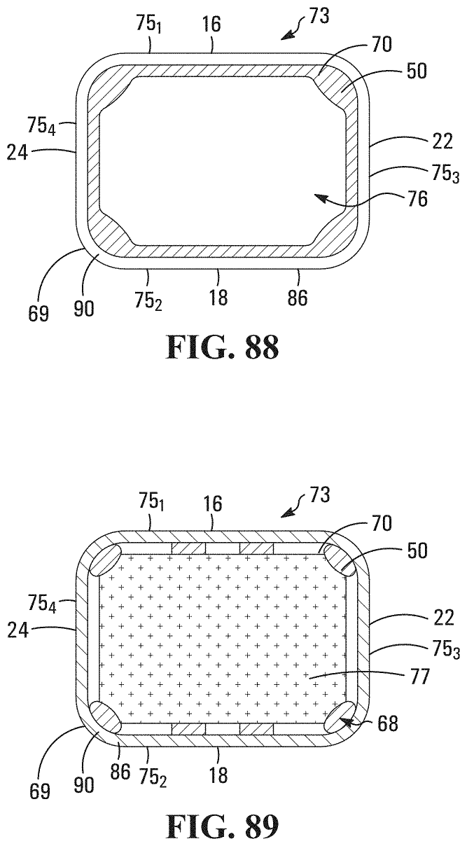

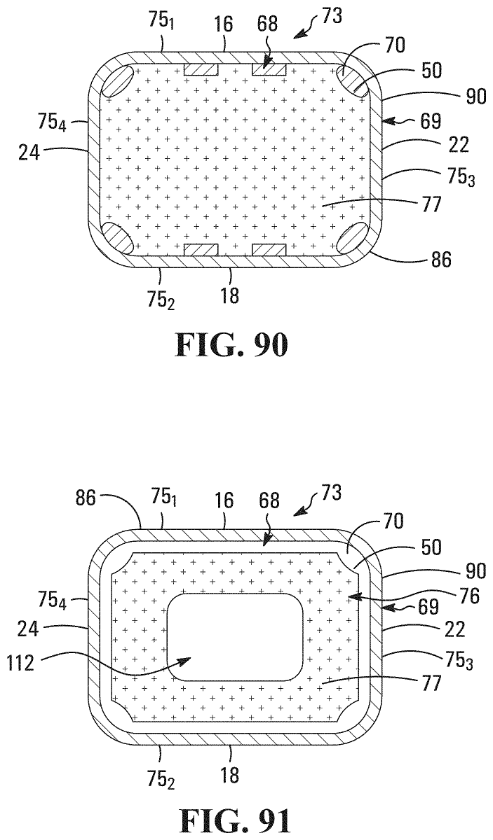

In this example, between its peripheral portions 74₁-74₄, the truss 73 includes a void 76, as shown in FIG. 88. In this embodiment, the shaft 12 comprises a core 77 disposed in the void 76 of the truss 73, as shown in FIGS. 89 and 90. The core 77 may be entirely disposed inside the lattice 70 such that it does not engage a surface of the covering 69, as shown in FIG. 89, although alternatively the core 77 may engage the lattice 70 and the inner surface of the covering 69, in the embodiment shown in FIG. 90. For instance, the core 77 may include one or more internal members of foam, elastomeric material, etc. Alternatively, in other embodiments, the void 76 of the truss 73 may be hollow (i.e., not contain any core), or may be filled by the core 77 having a shape defining an inner void 112.

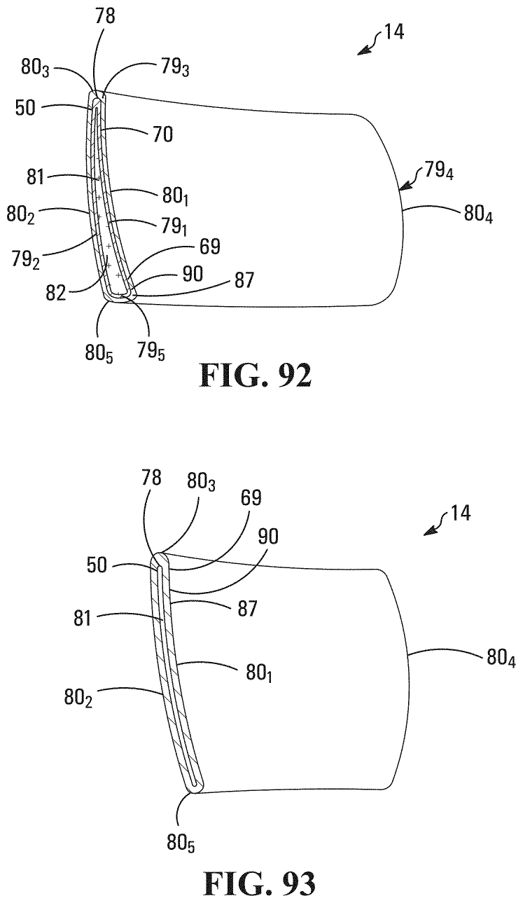

Also, in this embodiment, the lattice 70 includes another truss 78, as shown in FIGS. 92 and 93. In this example, the truss 78 constitutes the portion 73 of the lattice 70 of the blade 14. The truss 78 comprises peripheral portions 79₁-79₆ that are part of walls 80₁-80₆ of the blade 14 that define the periphery 50 of the blade 14, including its front surface 52, rear surface 54, top edge 56, toe edge 58, heel edge 59, and bottom edge 60. Each of the peripheral portions 79₁-79₆ of the truss 78 includes respective ones of the elongate members 41₁-41_{E} and the nodes 42₁-42_{N} of the lattice 70. A front one of the peripheral portions 79₁-79₆ of the truss 78 is part of a front one of the walls 80₁-80₆ of the blade 14 that includes its front surface 52, a rear one of the peripheral portions 79₁-79₆ of the truss 78 is part of a rear one of the walls 80₁-80₆ of the blade 14 that includes its rear surface 54, a top one of the peripheral portions 79₁-79₆ of the truss 78 is part of a top one of the walls 80₁-80₆ of the blade 14 that includes its top edge 56, a toe one of the peripheral portions 79₁-79₆ of the truss 78 is part of a toe one of the walls 80₁-80₆ of the blade 14 that includes its toe edge 48, a heel one of the peripheral portions 79₁-79₆ of the truss 78 is part of a heel one of the walls 80₁-80₆ of the blade 14 that includes its heel edge 59, and a bottom one of the peripheral portions 79₁-79₆ of the truss 78 is part of a bottom one of the walls 80₁-80₆ of the blade 14 that includes its bottom edge 60.

In this example, between its peripheral portions 79₁-79₆, the truss 78 includes a void 81. In this embodiment, the blade 14 comprises a core 82 disposed in the void 81 of the truss 78. For instance, the core 82 may include one or more internal members of foam, elastomeric material, etc. Alternatively, in other embodiments, the void 81 of the truss 78 may be hollow (i.e., not contain any core).

Material 50 of the lattice 70 can be of any suitable kind. In this embodiment, the material 50 is composite material. More particularly, in this embodiment, the composite material 50 is fiber-reinforced composite material comprising fibers disposed in a matrix. For instance, in some embodiments, the material 50 may be fiber-reinforced plastic (FRP—a.k.a., fiber-reinforced polymer), comprising a polymeric matrix may include any suitable polymeric resin, such as a thermoplastic or thermosetting resin, like epoxy, polyethylene, polypropylene, acrylic, thermoplastic polyurethane (TPU), polyether ether ketone (PEEK) or other polyaryletherketone (PAEK), polyethylene terephthalate (PET), polyvinyl chloride (PVC), poly(methyl methacrylate) (PMMA), polycarbonate, acrylonitrile butadiene styrene (ABS), nylon, polyimide, polysulfone, polyamide-imide, self-reinforcing polyphenylene, polyester, vinyl ester, vinyl ether, polyurethane, cyanate ester, phenolic resin, etc., a hybrid thermosetting-thermoplastic resin, or any other suitable resin, and fibers such as carbon fibers, glass fibers, polymeric fibers such as aramid fibers (e.g., Kevlar fibers), boron fibers, silicon carbide fibers, metallic fibers, ceramic fibers, etc. In some embodiments, the fibers of the fiber-reinforced composite material 50 may be provided as layers of continuous fibers, such as pre-preg (i.e., pre-impregnated) tapes of fibers (e.g., including an amount of resin) or as continuous fibers deposited (e.g., printed) along with rapidly-curing resin forming the polymeric matrix. In other embodiments, the fibers of the fiber-reinforced composite material 50 may be provided as fragmented (e.g., chopped) fibers dispersed in the polymeric matrix.

In some embodiments, the material 50 of the lattice 70 may be identical throughout the lattice 70. In other embodiments, the material 50 of the lattice 70 may be different in different parts of the lattice 70. For example, in some embodiments, the material 50 of the portion 71 of the lattice 70 that is part of the shaft 12 may be different from the material 50 of the portion 73 of the lattice 70 that is part of the blade 14. Alternatively or additionally, in some embodiments, the material 50 of one region of the portion 71 of the lattice 70 that is part of the shaft 12 may be different from the material 50 of another region of the portion 71 of the lattice 70 that is part of the shaft 12, and/or the material 50 of one region of the portion 73 of the lattice 70 that is part of the blade 14 may be different from the material 50 of another region of the portion 73 of the lattice 70 that is part of the blade 14.

The material 50 of the lattice 70 may be polymeric material (e.g., not fiber-reinforced), metallic material, or ceramic material in other embodiments.

The lattice 70 of the hockey stick 10 may be designed to have properties of interest in various embodiments.

For example, in some embodiments, strength of the lattice 70 may be at least 800N, in some cases at least 1000N, some cases at least 1100N, some cases at least 1200N, and in some cases at least 1300N, and/or in some cases no more than 2000N, in some cases no more than 1500N, in some cases no more than 1400N, in some cases no more than 1300N, in some cases no more than 1200N, in some cases no more than 1100N, in some cases no more than 1000N, in some cases even less.

The strength of the lattice 70 may be measured by a 3-points-bending test to failure, as shown in FIG. 113. In this example, the supports used for the 3-points-bending test to failure may be spaced from one another by a distance of approximately 1050 mm, while the strength corresponds to the force applied at the midpoint between the supports.

In some embodiments, the lattice 70 may include distinct zones 92₁-92_{Z} that are structurally different from one another. For instance, this may be useful to modulate properties, such as the strength, flex, stiffness, etc., of the zones 92₁-92_{Z} of the lattice 70.

For example, the zones 92₁-92_{Z} of the lattice 70 may include a zone 921 at the proximal end portion 26 of the shaft 12, a zone 92₂ at the distal end portion 28 of the shaft 12, a zone 92₃ at the toe region 61 of the blade 14, a zone 924 at the heel region 62 of the blade 14, and a zone 92₅ at the intermediate region 63 of the blade 14.

In this embodiment, delimitations of the zones 92₁-92_{Z} of the lattice 70 are configured to match different parts of the hockey stick 10 which may be subject to different stresses and may require different mechanical properties. Accordingly, the zones 92₁-92_{Z} of the lattice 70 may have different mechanical properties to facilitate puck handling, to increase power transmission and/or energy transmission from the hockey stick 10 to the puck during wrist shots and/or slap shots, to lighten the hockey stick, to increase impact resistance of the hockey stick 10, to increase elongation at break of the hockey stick 10, to position a kickpoint, to reduce manufacturing costs, and so on.

Mechanical properties of the zones 92₁-92_{Z} of the lattice 70 may be achieved by any suitable means.

For example, in some embodiments, a shape of the unit cells 37₁-37_{C} of each zone 92ᵢ may be pre-determined to increase or diminished the aforementioned mechanical properties.

As another example, in some embodiments, the voxel (or size) of the unit cells 37₁-37_{c} of each zone 92ᵢ may be pre-determined to increase or diminished the aforementioned mechanical properties.

As another example, in some embodiments, a thickness of elongate members 41₁-41_{E} of each zone 92ᵢ may be pre-determined to increase or diminished the aforementioned mechanical properties.

As another example, in some embodiments, the material 50 of each zone 92ᵢ may be pre-determined to increase or diminished the aforementioned mechanical properties.

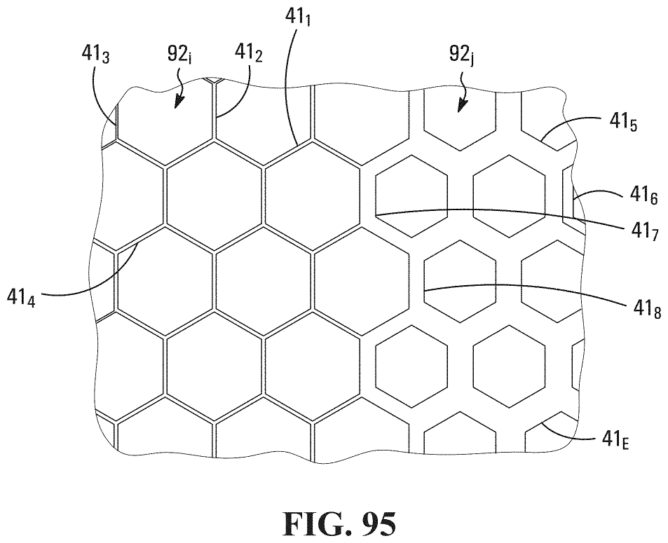

As such, in some embodiments, the shape of the unit cells 37₁-37_{c} (and thus the shape of the elongate members 41₁-41_{E} and/or nodes 42₁-42N), the voxel (or size) of the unit cells 37₁-37_{c}, a thickness of elongate members 41₁-41_{E} of each zone 92ᵢ and/or the material 50 of each zone 92ᵢ may vary between the zones 92₁-92_{Z}. For instance, in some embodiments, adjacent ones of the nodes 42₁-42_{N} in one region 92ᵢ of the lattice 70 may be located closer to one another than adjacent ones of the nodes 42₁-42_{N} in another region of the lattice 70, as shown in FIG. 3694, and/or the thickness of the elongate members 41₁-41_{E} and nodes 42₁-42_{N} in one region 92ᵢ of the lattice 70 may be greater than the thickness of the elongate members 41₁-41_{E} and nodes 42₁-42_{N} in another region 92ⱼ of the lattice 70, as shown in FIGS. 38 and 95 .

In this embodiment, the distinct zones 92₁-92_{Z} of the lattice 70 differ in stiffness and/or stiffness. For example, in some embodiments, a ratio of the stiffness of a given one of the zones 92₁-92_{Z} of the lattice 70 over the stiffness of another one of the zones 92₁-92_{Z} of the lattice 70 may be at least 10%, in some embodiments at least 20%, in some embodiments at least 30%, in some embodiments at least 40%, in some embodiments even more. Similarly, in some embodiments, a ratio of the strength of a given one of the zones 92₁-92_{Z} of the lattice 70 over the strength of another one of the zones 92₁-92_{Z} of the lattice 70 may be at least 10%, in some embodiments at least 20%, in some embodiments at least 30%, in some embodiments at least 40%, in some embodiments even more.

In this embodiment, the distinct zones 92₁-92_{Z} of the lattice 70 differ in resilience. For example, in some embodiments, a ratio of the resilience of a given one of the zones 92₁-92_{Z} of the lattice 70 over the resilience of another one of the zones 92₁-92_{Z} of the lattice 70 may be at least 5%, in some embodiments at least 10%, in some embodiments at least 20%, in some embodiments at least 30%, in some embodiments even more.

In this embodiment, the covering 69 may covers at least part of the open structure 68 of the hockey stick 10. In that sense, the covering 69 may be viewed as a “skin”. In this embodiment, the covering 69 covers at least a majority (i.e., a majority or an entirety) of the lattice 70. More particularly, in this embodiment, the covering 69 covers the entirety of the lattice 70, as notably shown in FIG. 60. The hockey stick 10 may thus externally appear like a conventional hockey stick, as its open structure 68 is concealed.

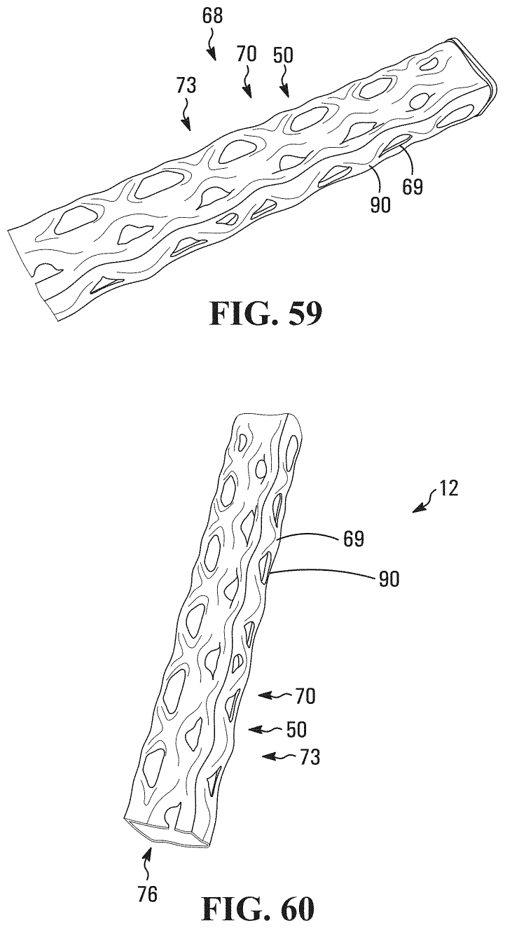

In other embodiments, the covering 69 may not cover the entirety of the lattice open structure 68 and may therefore comprise apertures, as shown in FIG. 59.

In this embodiment, the shaft 12 includes a portion 86 of the covering 69, while the blade 14 includes another portion 87 of the covering 69. The portion 86 of the covering 69 thus covers the truss 73 of the shaft 12, whereas the portion 87 of the covering 69 covers the truss 78 of the blade 14.

Material 90 of the covering 69 can be of any suitable kind. In this embodiment, the material 90 is composite material. More particularly, in this embodiment, the composite material 90 is fiber-reinforced composite material comprising fibers disposed in a matrix. For instance, in some embodiments, the material 90 may be fiber-reinforced plastic (FRP—a.k.a., fiber-reinforced polymer), comprising a polymeric matrix may include any suitable polymeric resin, such as a thermoplastic or thermosetting resin, like epoxy, polyethylene, polypropylene, acrylic, thermoplastic polyurethane (TPU), polyether ether ketone (PEEK) or other polyaryletherketone (PAEK), polyethylene terephthalate (PET), polyvinyl chloride (PVC), poly(methyl methacrylate) (PMMA), polycarbonate, acrylonitrile butadiene styrene (ABS), nylon, polyimide, polysulfone, polyamide-imide, self-reinforcing polyphenylene, polyester, vinyl ester, vinyl ether, polyurethane, cyanate ester, phenolic resin, etc., a hybrid thermosetting-thermoplastic resin, or any other suitable resin, and fibers such as carbon fibers, glass fibers, polymeric fibers such as aramid fibers (e.g., Kevlar fibers), boron fibers, silicon carbide fibers, metallic fibers, ceramic fibers, etc. In some embodiments, the fibers of the fiber-reinforced composite material 50 may be provided as layers of continuous fibers, such as pre-preg (i.e., pre-impregnated) tapes of fibers (e.g., including an amount of resin) or as continuous fibers deposited (e.g., printed) along with rapidly-curing resin forming the polymeric matrix. In other embodiments, the fibers of the fiber-reinforced composite material 90 may be provided as fragmented (e.g., chopped) fibers dispersed in the polymeric matrix.

In some embodiments, the material 90 of the covering 69 may be identical throughout the covering 69. In other embodiments, the material 90 of the covering 69 may be different in different parts of the covering 69. For example, in some embodiments, the material 90 of the portion 86 of the covering 69 that is part of the shaft 12 may be different from the material 90 of the portion 87 of the covering 69 that is part of the blade 14. Alternatively or additionally, in some embodiments, the material 90 of one region of the portion 86 of the covering 69 that is part of the shaft 12 may be different from the material 90 of another region of the portion 86 of the covering 69 that is part of the shaft 12, and/or the material 90 of one region of the portion 87 of the covering 69 that is part of the blade 14 may be different from the material 90 of another region of the portion 87 of the covering 69 that is part of the blade 14.

In other embodiments, the material 90 of the covering 69 may be (non-fiber-reinforced) polymeric material, metallic material, or ceramic material.

The hockey stick 10, including the lattice 70 and the covering 69, may be manufactured in any suitable way.

For example, in some embodiments, the lattice 70 may be an additively-manufactured lattice that is additively manufactured, i.e., made by additive manufacturing, also known as 3D printing, in which the material 50 thereof initially provided as feedstock (e.g., as powder, liquid, filaments, fibers, and/or other suitable feedstock), which can be referred to as 3D-printed material, is added by a machine (i.e., a 3D printer) that is computer-controlled (e.g., using a digital 3D model such as a computer-aided design (CAD) file) to create it in its three-dimensional form (e.g., layer by layer, from a pool of liquid, applying continuous fibers, or in any other way, normally moldlessly, i.e., without any mold). This is in contrast to subtractive manufacturing (e.g., machining) where material is removed and molding where material is introduced into a mold's cavity.

Any 3D-printing technology may be used to make the lattice 70, such as the example AM techniques that were discussed earlier.

In this embodiment, as it includes the fiber-reinforced composite material 50, the lattice 70 may be 3D-printed using continuous-fiber 3D printing technology. For instance, in some embodiments, this may allow each of one or more of the fibers of the fiber-reinforced composite material 50 to extend along at least a significant part, such as at least a majority (i.e., a majority or an entirety), of a length of the lattice 70 (e.g., monofilament winding). This may enhance the strength, the impact resistance, and/or other properties of the hockey stick 10.

The lattice 70 can be designed and 3D-printed to impart its properties and functions, such as those discussed above, while helping to minimize its weight. The 3D-printed material 50 constitutes the lattice 70. Specifically, the elongate members 41₁-41_{E} and the nodes 42₁-42_{N} of the lattice 70 include respective parts of the 3D-printed material 50 that are created by the 3D-printer. Fibers may be printed by the 3D printer along with rapidly-curing resin to form the fiber-reinforced composite material 50.

The lattice 70 may be manufactured in any other suitable way in other embodiments, including by technology other than 3D printing.

For instance, in some embodiments, the lattice 70 may be provided by positioning pre-preg tapes of fibers (e.g., including an amount of resin) to form the elongate members 41₁-41_{E} and the nodes 42₁-42_{N} of the lattice 70 and heating it (e.g., in a mold) to form its fiber-reinforced composite material 50 once cured.

For instance, pre-preg tapes of fibers may be enrolled around a support 108 (e.g. a mandrel, foam, procured part, and so on) with a pre-determined pitch and a pre-determined angle to form a “green” lattice. The pre-determined pitch and pre-determined angle used to form the green lattice may contribute to determine the geometry of the unit cells 37₁-37_{C} and thus mechanical properties (e.g. stiffness) of the lattice 70.

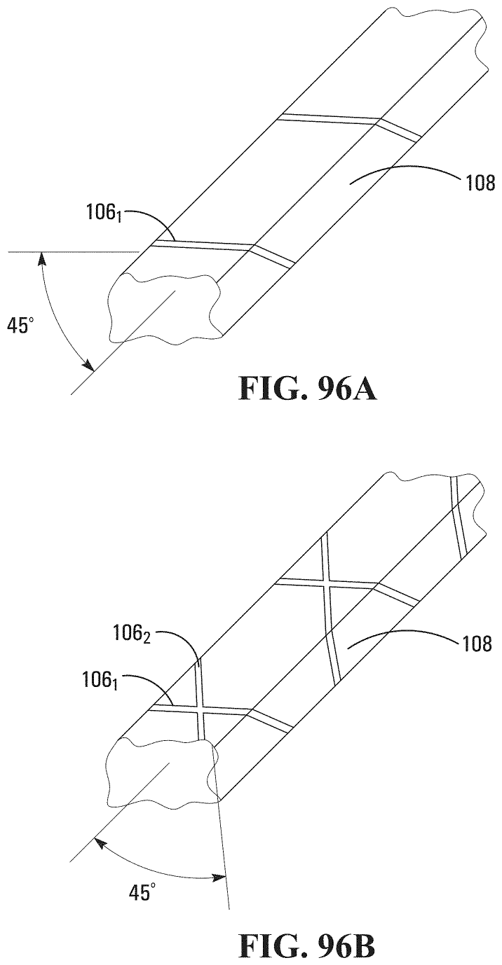

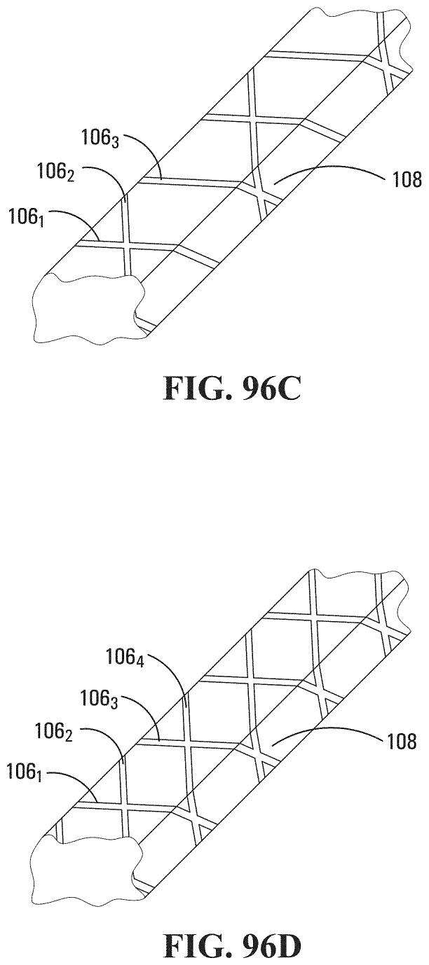

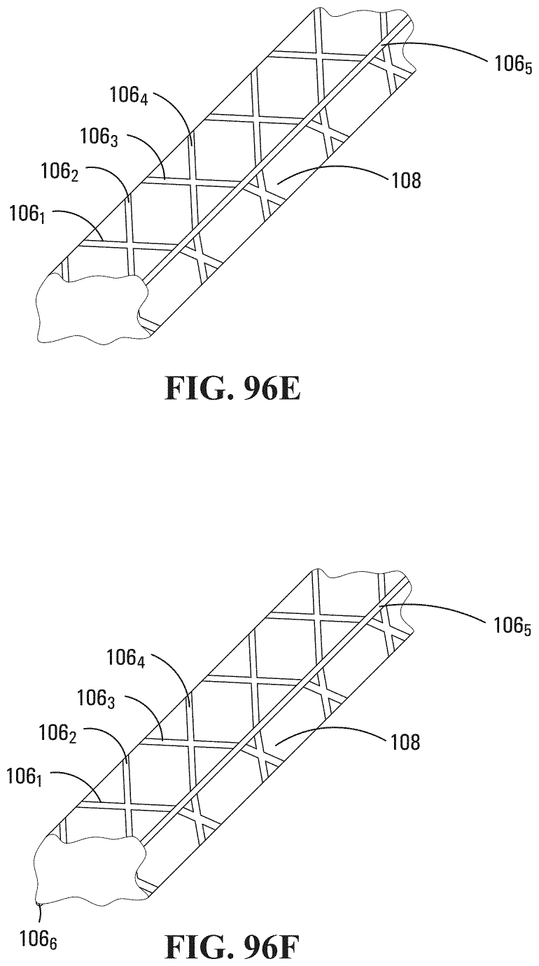

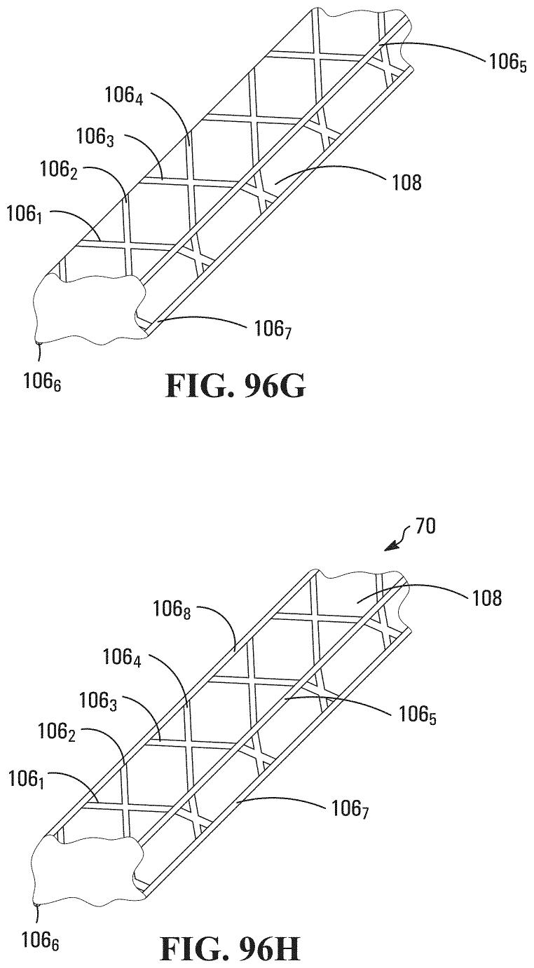

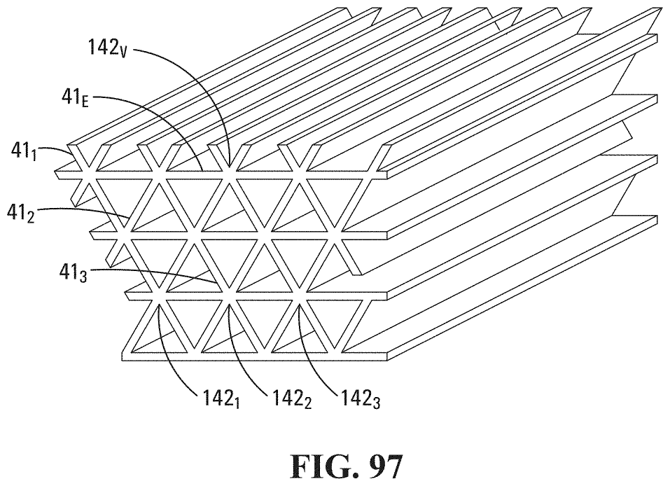

For example, in some embodiments, as shown in FIGS. 96A to 96H, the lattice 70 may comprise segments 106₁-106₈ each formed using one continuous string of pre-preg tape and the structural members 41₁-41_{E} may have a thickness of 1 mm. In order to form the lattice 70, the pre-preg tape may have a thickness of 1 mm and be enrolled successively around the support 108, at a pre-determined angle. For example, segments 106₅-106₈ forming edges (i.e. corners) of the lattice 70 may be enrolled at an angle of 0° relative to a longitudinal axis of the support, while segments 106₁, 106₃ may be enrolled at an angle of about 45° relative to a longitudinal axis of the support and segments 106₂, 106₄ may be enrolled at an angle of about −45° relative to a longitudinal axis of the support. Each time segments 106₁-106₈ cross one another, a node 42ᵢ may be created—each node 42ᵢ having a thickness that is superior to the thickness of the segments 106₁-106₈ in this embodiment.

As another example, in some embodiments, to obtain a similar lattice 70 using pre-preg tape having a thickness of 0.25 mm, four successive passes of the aforementioned steps may be repeated, which in comparison with the preceding embodiment may provide a lattice 70 having superior strength and interlaminar shear.

It is noted that, in other embodiments, width, thickness and material of the pre-preg tape used for manufacturing the lattice 70 may vary for each segment 106ᵢ and/or for each pass, and that any stage layers of material (e.g. the covering 69) may be added under or over the .

The obtained “green” 70 may be subsequently cured or molded, for example using an autoclave, vacuum molding, RTM, compression molding (e.g. with a bladder or a mandrel to control an external dimension of the lattice during and after molding), or so on.

The covering 69 may be provided about the lattice 70 in any suitable way in various embodiments.

For example, in some embodiments, the covering 69 may be an additively-manufactured covering that is additively manufactured, i.e., 3D-printed. Any 3D-printing technology may be used to make the covering 69, such as those discussed above. For instance, in some embodiments, the covering 69 may be 3D-printed using continuous-fiber 3D printing technology. This may allow each of one or more of the fibers of the fiber-reinforced composite material 90 to extend along at least a significant part, such as at least a majority (i.e., a majority or an entirety), of a length of the covering 69 (e.g., monofilament winding).

As another example, in some embodiments, the covering 69 may be provided by wrapping pre-preg tapes of fibers (e.g., including an amount of resin) about the lattice 70 and heating it (e.g., in a mold) to form its fiber-reinforced composite material 90 once cured.

The hockey stick 10, including the shaft 12 and the blade 14, may be implemented in various other ways in other embodiments.

For example, in some embodiments, the lattice 70 may have any suitable cross-section shape such as a pentagonal shape, a hexagonal shape, a round shape, an elliptical shape, and so on, as shown in FIGS. 83 to 88. Additionally, the shape of the cross-section of the lattice 70 may vary from a zone 92ᵢ to another 92ⱼ.

In this embodiment, the portion 73 of the lattice 70 that is part of the blade 14 may be structurally different from the portion 71 of the lattice 70 that is part of the shaft 12. For example, an average voxel of the unit cells 37₁-37_{C} of the portion 73 of the lattice 70 may be significantly smaller than an average voxel of the unit cells 37₁-37_{C} of the portion 71 of the lattice 70 and in some embodiments a ratio of the average voxel of the portion 73 over the average voxel of the portion 71 may be less than 0.95, in some embodiments less than 0.75, in some embodiments less than 0.50, in some embodiments less than 0.25, in some embodiments even less. As another example, the shape of the unit cells 37₁-37_{C} of the portion 73 of the lattice 70 may be different from the shape of the unit cells 37₁-37_{C} of the portion 71 of the lattice 70 such that the portion 73 is significantly stiffer than the portion 71. As another example, in some embodiments, the portion 73 of the lattice 70 that is part of the blade 14 comprises a framework defining a non-hollow lattice, while the portion 71 of the lattice 70 that is part of the shaft 12 comprises a framework defining a hollow lattice.

As another example, in some embodiments, the structural members 41₁-41_{E} of the lattice 70 may be implemented in various other ways. For example, in some embodiments, as shown in FIG. 97, the structural members 41₁-41_{E} may be planar members that intersect one another at vertices 142₁-142_{V}. The planar members 41₁-41_{E} may sometimes be referred to as “faces”. Each of the planar members 41₁-41_{E} may be straight, curved, or partly straight and partly curved.

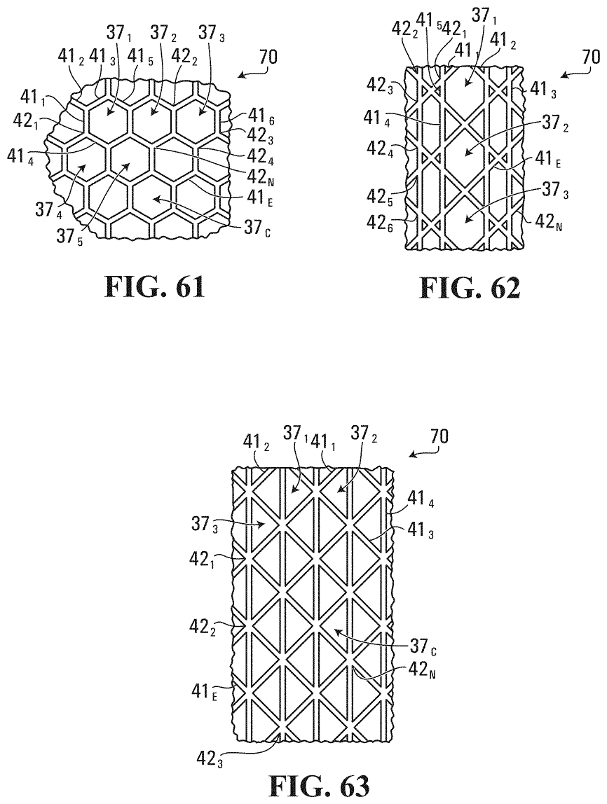

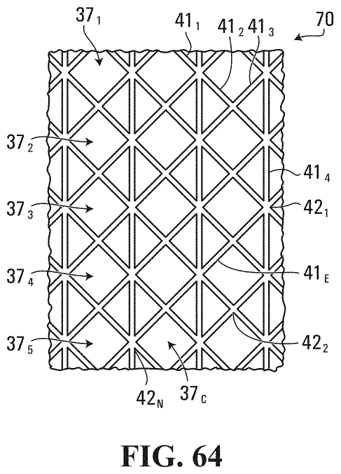

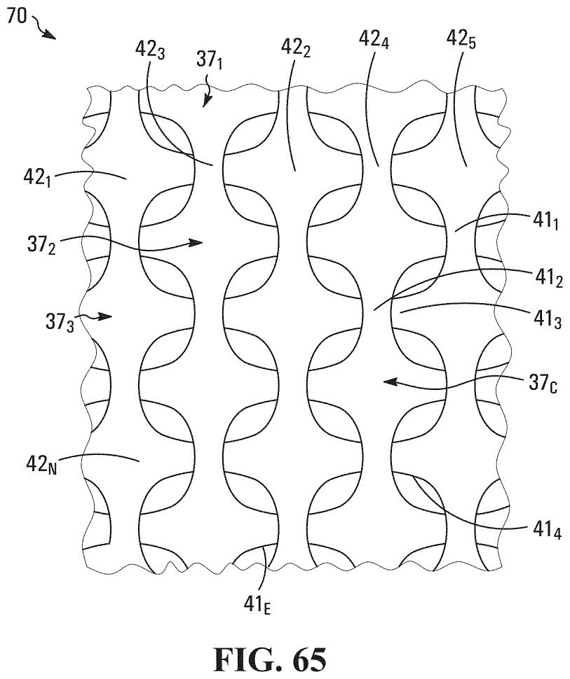

The lattice 70 may be implemented in any other suitable way and have any other suitable configuration. Examples of other possible configurations for the lattice 70 in other embodiments are shown in FIGS. 61 to 65.

In some embodiments, the hockey stick may be an “intelligent” hockey stick. That is, the hockey stick 10 may comprise sensors 280₁-280ₛ to sense a force acting on the hockey stick, a position, a speed, an acceleration and/or a deformation of the hockey stick 10 during play or during a testing (e.g. of hockey sticks, of players, etc.). More particularly, in this embodiment, the lattice 70 comprises the sensors 280₁-280ₛ. More specifically, in this embodiment, the sensors 280₁-280ₛ are associated with an additively-manufactured component of the lattice 70.

Further, in this embodiment, the hockey stick 10 may comprise actuators 286₁-286_{A}. Specifically, the actuators 286₁-286_{A} may be associated with at least some of sensors 280₁-280ₛ and may be configured to respond to a signal of the sensors 280₁-280ₛ. In particular, the sensors 280₁-280ₛ may be responsive to an event (e.g. an increase in acceleration of the hockey stick 10, an increase of a force acting on the hockey stick 10, an increase of the deformation of the hockey stick 10, etc.) to cause the actuators 286₁-286_{A} to alter the additively-manufactured component to alter the lattice 70 (e.g. to increase resilience, to increase stiffness, etc.).

Practically, in this embodiment, this may be achieved using piezoelectric material 290 implementing the sensors 280₁-280ₛ, the piezoelectric material 290 being comprised in the additively-manufactured component of the lattice 70.

In other embodiments, more or less of the hockey stick 10 may be latticed as discussed above.

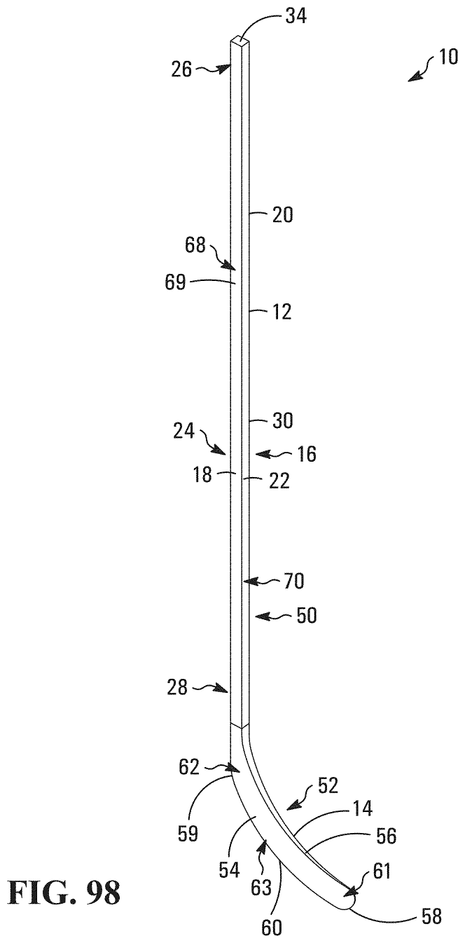

For example, in some embodiments, as shown in FIG. 98, the lattice 70 may constitute at least part (e.g., occupy at least a majority, i.e., a majority or an entirety, of the length) of the shaft 12, but not constitute any part of the blade 14. That is, the shaft 12 may include all of the lattice 70, while the blade 14 may not include any lattice.

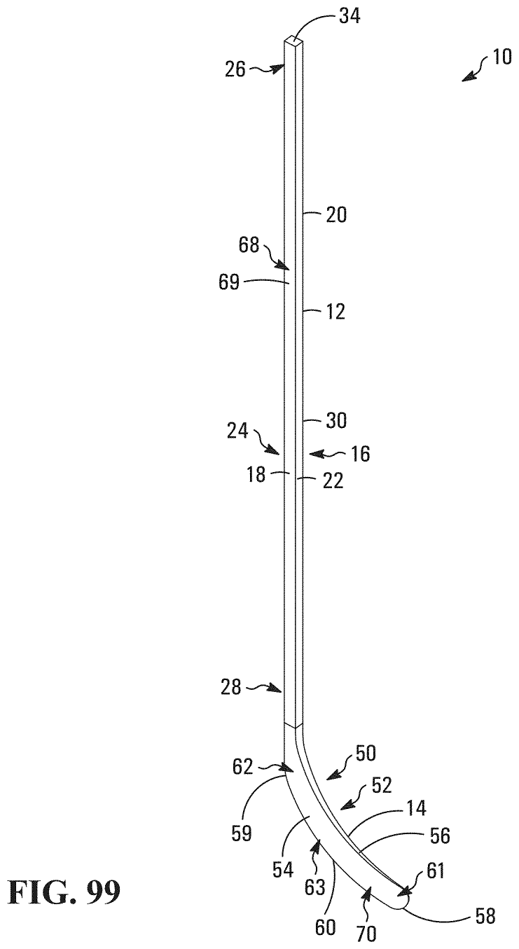

As another example, in some embodiments, as shown in FIG. 99, the lattice 70 may constitute at least part (e.g., occupy at least a majority, i.e., a majority or an entirety, of the length) of the blade 14, but not constitute any part of the shaft 12. That is, the blade 14 may include all of the lattice 70, while the shaft 12 may not include any lattice.

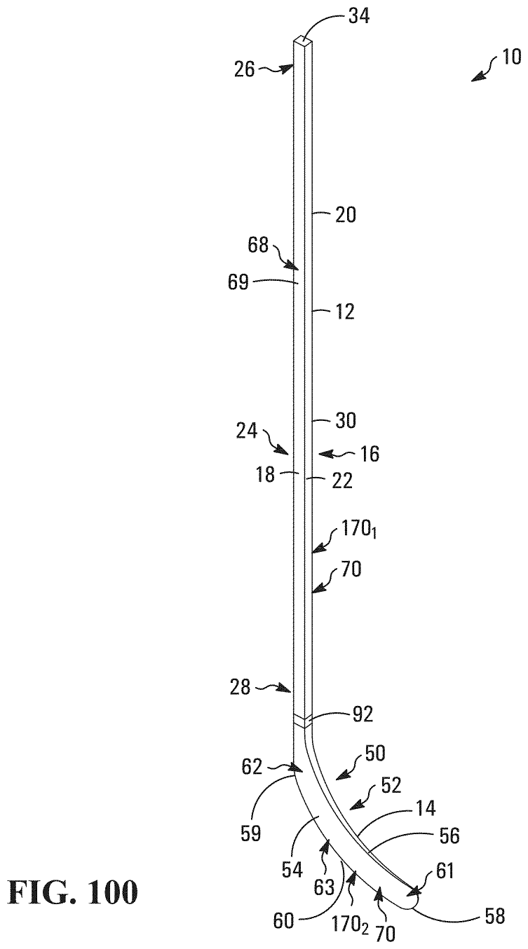

As yet another example, as shown in FIGS. 100, the shaft 12 and/or the blade 14 may include two or more lattices like the lattice 70 that are separate (e.g., spaced apart) from one another.

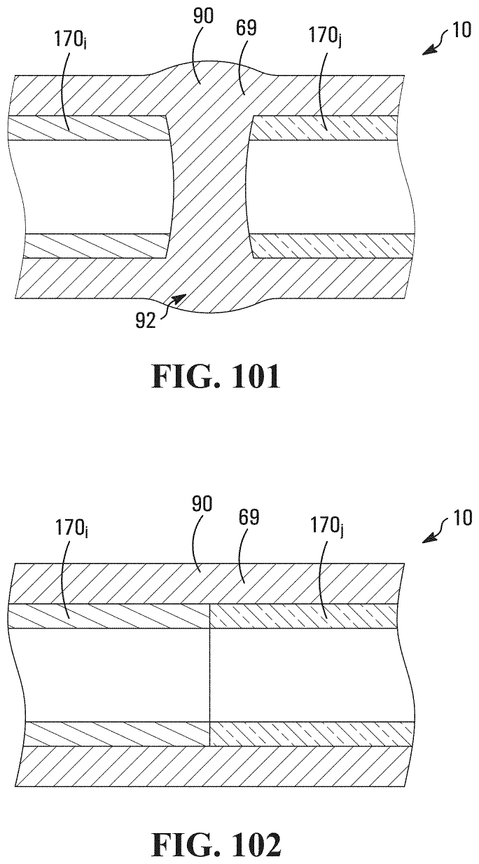

For instance, in some embodiments, as shown in FIGS. 100 and 101, the blade 14 may comprises lattices 170₁-170_{L} similar to the lattice 70 that are separate from one another. In this example, adjacent ones of the lattices 170₁-170_{L} are spaced from one another by a rib 92 extending from a front one of the walls 80₁-80₆ of the blade 14 to a back one of the walls 80₁-80₆ of the blade 14. The lattices 170₁-170_{L} may be or include distinct zones structurally different from one another, as discussed above. For example, in some embodiments, a lower one of the lattices 170₁-170_{L} may be less stiff or more resilient than a higher one of the lattices 170₁-170_{L} (e.g., to better absorb impacts).

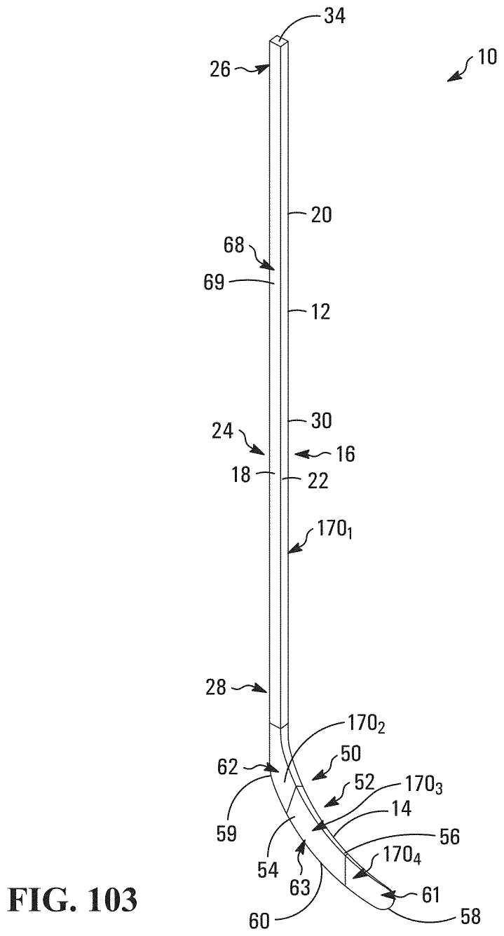

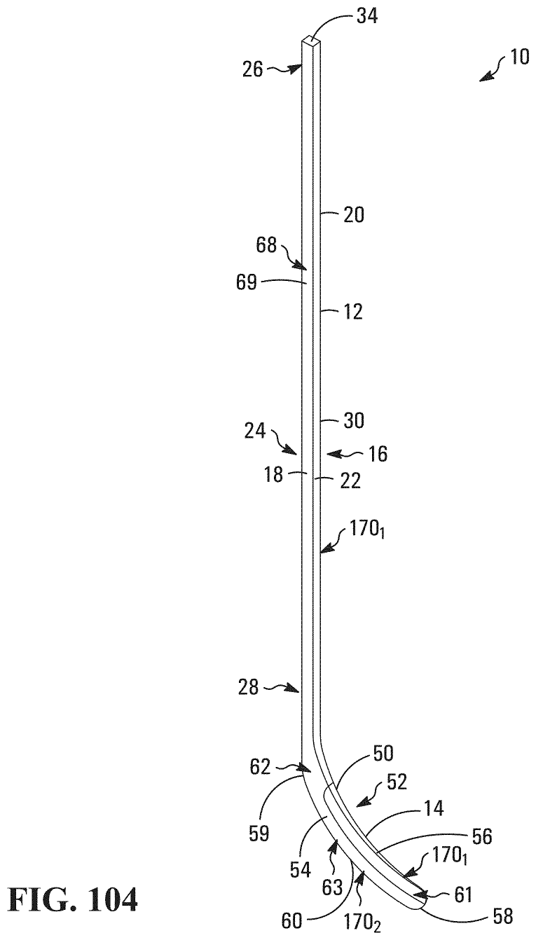

In some embodiments, as shown in FIG. 102, the lattices 170₁-170_{L} may not be spaced from one another by a rib 92 and may engage one another. For example, in some embodiments, the blade 14 may comprise different lattices 170₁-170_{L} each covering a given one of the toe portion 61, the heel portion 62 and the intermediate portion 63, as shown in FIG. 103. As another example, in some embodiments, the blade 14 may comprise different lattices 170₁, 170₂ the lattice 170₁ defining an upper portion of the blade 14 and the lattice 170₂ defining a lower portion of the blade 14, the lattice 170₂ being lighter but less stiff than the lattice 170₁ in order to facilitate handling (e.g. by increasing vibration damping and diminishing weight of the blade 14) and still increase energy transfer to a hockey puck (e.g. by having a relatively stiff blade 14), as shown in FIG. 104.

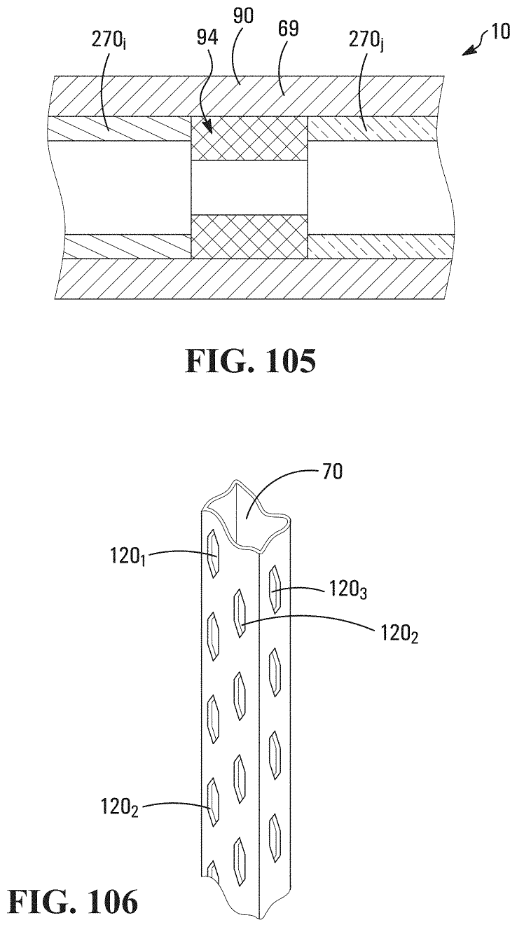

In some embodiments, as shown in FIG. 105, the shaft 12 may comprises lattices 270₁-270_{L} similar to the lattice 70 that are separate from one another. In this example, adjacent ones of the lattices 270₁-270_{L} are spaced from one another by a non-latticed portion 94. The lattices 270₁-270_{L} may be or include distinct zones structurally different from one another, as discussed above. For example, in some embodiments, a lower one of the lattice 270₁-270_{L} may be less stiff or more resilient than a higher one of the lattices 270₁-270_{L} (e.g., to adjust the flex of the hockey stick 10).

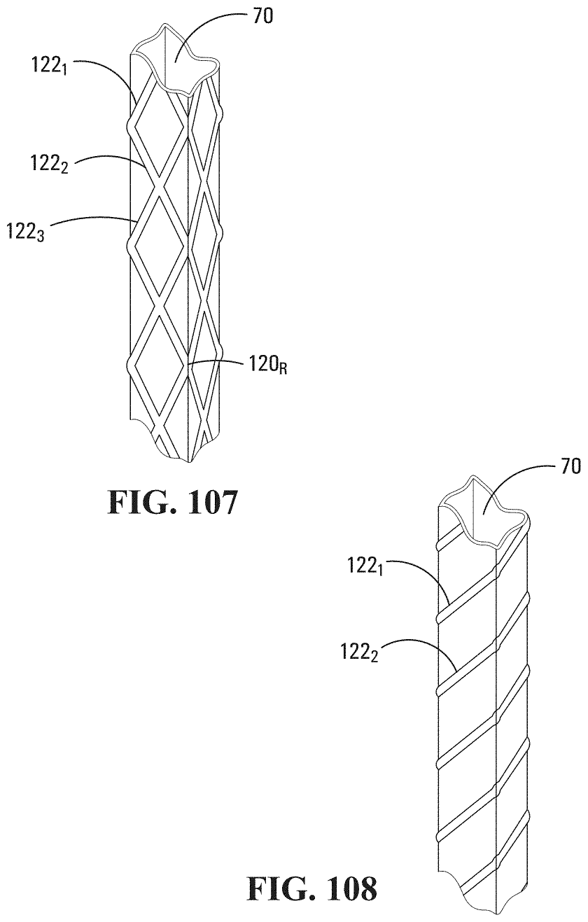

In some embodiments, as shown in FIGS. 106 to 108, the lattice 70 may comprise recesses 120₁-120_{R} and/or ribs 122₁-122_{R} in order to provide a stick 10 which facilitates puck handling, facilitates grip, increases power transmission and/or energy transmission from the hockey stick 10 to the puck during wrist shots and/or slap shots, is light, increases impact resistance of the hockey stick 10, increases elongation at break of the hockey stick 10, is relatively cheap to manufacture, and so on. In some embodiments, a depth of the recesses 120₁-120_{R} and/or ribs 122₁-122_{R} may be insignificant and may improve an appearance and a touch (i.e. a feel) of the stick 10. For example, in some embodiments, the depth of the recesses 120₁-120_{R} and/or ribs 122₁-122_{R} may be no more than 1.5 mm, in some embodiments no more than 1 mm, in some embodiments no more than 0.5 mm and in some embodiments even less. However, in some embodiments, the depth of the recesses 120₁-120_{R} and/or ribs 122₁-122_{R} may be significant and may increase stiffness of the stick 10 and/or reduce weight of the stick 10. For example, in some embodiments, the depth of the recesses 120₁-120_{R} and/or ribs 122₁-122_{R} may be at least 1.5 mm, in some embodiments at least 2 mm, in some embodiments at least 3 mm, in some embodiments at least 4 mm, in some embodiments at least 5 mm, and in some embodiments even more.

Further, in some embodiments, as shown in FIG. 108, the lattice 70 may be anisotropic. For instance, a torsional stiffness of the lattice 70 may be greater in one direction than in another opposite direction. This may allow the stick to be light, yet to resist repetitive impacts when the impacts are expected to be mostly in the same direction. In this embodiment, this is achieved by having the lattice 70 defining rib 122₁, 122₂ which are configured for supporting the lattice 70 when the lattice 70 is subject to torsional stress in one direction but not for supporting the lattice 70 when the lattice 70 is subject to torsional stress in the other opposite direction.

Alternatively, in some embodiments, instead of being formed by the lattice 70, the 120₁-120_{R} and/or ribs 122₁-122_{R} may be formed by the covering 69 around the lattice 70.

In some embodiments, the hockey stick 10 may comprise one or more additively-manufactured components, instead of or in addition to the lattice 70. That is, the lattice 70 is one example of an additively-manufactured component in embodiments where it is 3D-printed. Such one or more additively-manufactured components of the hockey stick 10 may be 3D-printed as discussed above, using any suitable 3D-printing technology, similar to what was discussed above in relation to the lattice 70 in embodiments where the lattice 70 is 3D-printed. The hockey stick 10 may comprise the lattice 70, which may or may not be additively-manufactured, or may not have any lattice in embodiments where the hockey stick 10 comprises such one or more additively-manufactured components.

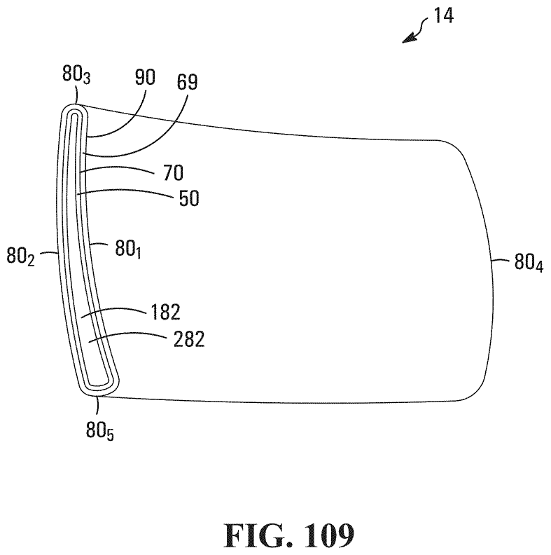

For example, in some embodiments, as shown in FIG. 109, the blade 14 may comprises an additively-manufactured core 182. In this embodiment, the additively-manufactured core 182 comprises a 3D-printed lattice 282 that can be constructed and configured similarly to what is discussed above in relation of the lattice 70, in embodiments where the lattice 70 is 3D-printed.

The 3D-printed lattice 282 of the core 182 of the blade 14 may be manufactured in any suitable way, using any suitable materials and may have any suitable mechanical properties, such as those described with regards to the lattice 70. In this embodiment, the 3D-printed lattice 282 is manufactured prior to the lattice 70, while in other embodiments, the 3D-printed lattice 282 and the lattice 70 are manufactured simultaneously.

In some embodiments, the method of manufacture, the materials and the structure of the lattices 70, 282 forming the blade 14 may differ. For instance, the lattice 282 may be lighter (i.e. less dense) but less stiff than the lattice 70 which is over the lattice 282 and thus may provide stiffness to the blade 14 more efficiently.

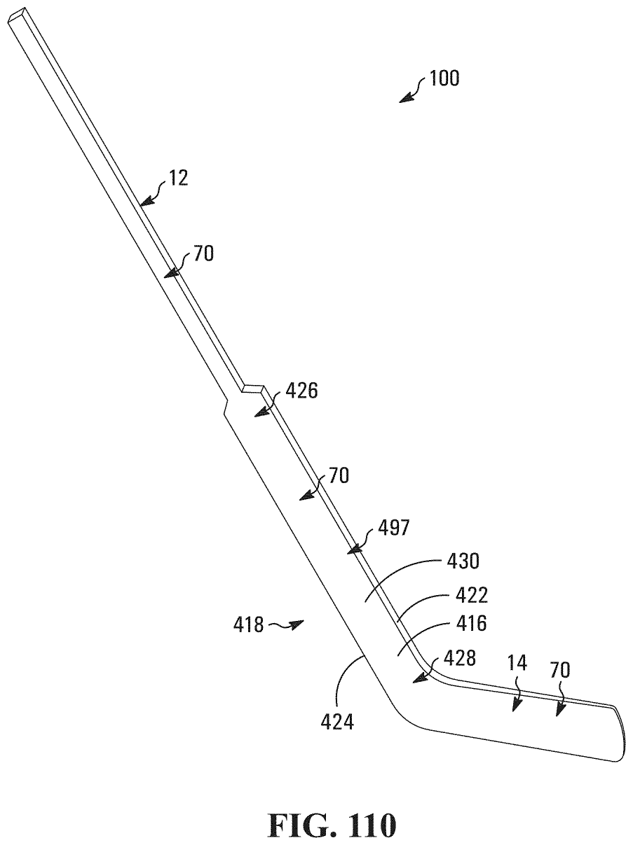

While in this embodiment the hockey stick 10 is a player stick for the user that is a forward, i.e., right wing, left wing, or center, or a defenseman, in other embodiments, as shown in FIG. 110, the hockey stick 10 may be a goalie stick where the user is a goalie. The goalie stick 10 may be constructed according to principles discussed herein. For example, in some embodiments, the goalie stick 10 may comprise the lattice 70 (e.g., which may be additively-manufactured or otherwise made) and/or one or more other additively-manufactured components, as discussed above.

The goalie stick 10 comprises a paddle 497 that may be constructed according to principles discussed herein. For instance, in some embodiments, the paddle 497 may be disposed between the shaft 12 and the blade 14. The paddle 497 is configured to block hockey pucks from flying into the net. A periphery 430 of the paddle 497 includes a front surface 416 and a rear surface 418 opposite one another, as well as a top edge 422 and a bottom edge 424 opposite one another. Proximal and distal end portions 426, 428 of the paddle 497 are spaced apart in a longitudinal direction of the paddle 497, respectively adjacent to the shaft 12 and the blade 14, and define a length of the paddle 497. More particularly, in this embodiment, at least part of the goalie stick 10 is latticed, i.e., comprises the lattice 70. Thus, in this example, the lattice 70 (e.g., which may be additively-manufactured or otherwise made) and/or one or more other additively-manufactured components constitutes at least part of the shaft 12 and/or at least part of the blade 14 and/or at least part of the paddle 497 in a similar fashion as described above with regards to the hockey player stick 10.

Although in this embodiment the sporting implement 10 is a hockey stick, in other embodiments, the sporting implement 10 may be any other implement used for striking, propelling or otherwise moving an object in a sport.

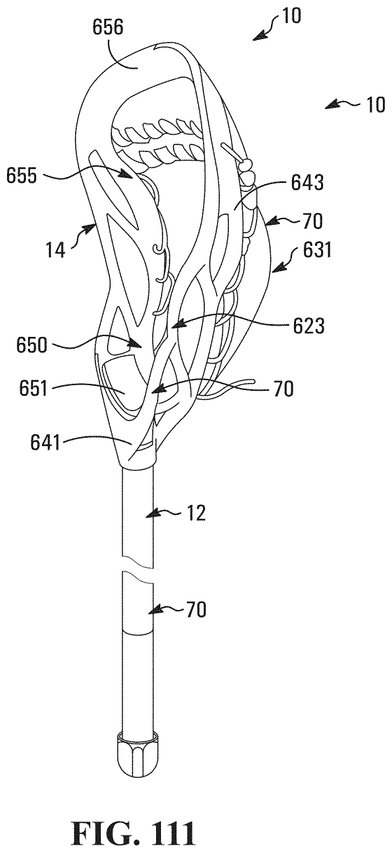

For example, in other embodiments, as shown in FIG. 111, the sporting implement 10 may be a lacrosse stick for a lacrosse player, in which the object-contacting member 14 of the lacrosse stick 10 comprises a lacrosse head for carrying, shooting and passing a lacrosse ball.

The lacrosse head 14 comprises a frame 623 and a pocket 631 connected to the frame 623 and configured to hold the lacrosse ball. The frame 623 includes a base 641 connected to the shaft 12 and a sidewall 643 extending from the base 641. In this embodiment, the sidewall 643 is shaped to form a narrower area 650 including a ball stop 651 adjacent to the base 641 and an enlarged area 655 including a scoop 656 opposite to the base 641. Also, in this embodiment, the pocket 31 includes a mesh 660.

The lacrosse stick 10 may be constructed according to principles discussed herein. For example, in some embodiments, the lacrosse stick 10 may comprise the lattice 70 (e.g., which may be additively-manufactured or otherwise made) and/or one or more other additively-manufactured components, as discussed above. For instance, in some embodiments, the lattice 70 (e.g., which may be additively-manufactured or otherwise made) and/or one or more other additively-manufactured components may constitute at least part of the shaft 12 and/or at least part of the lacrosse head 14, such as at least part of the frame 623 and/or at least part of the pocket 631, according to principles discussed herein.

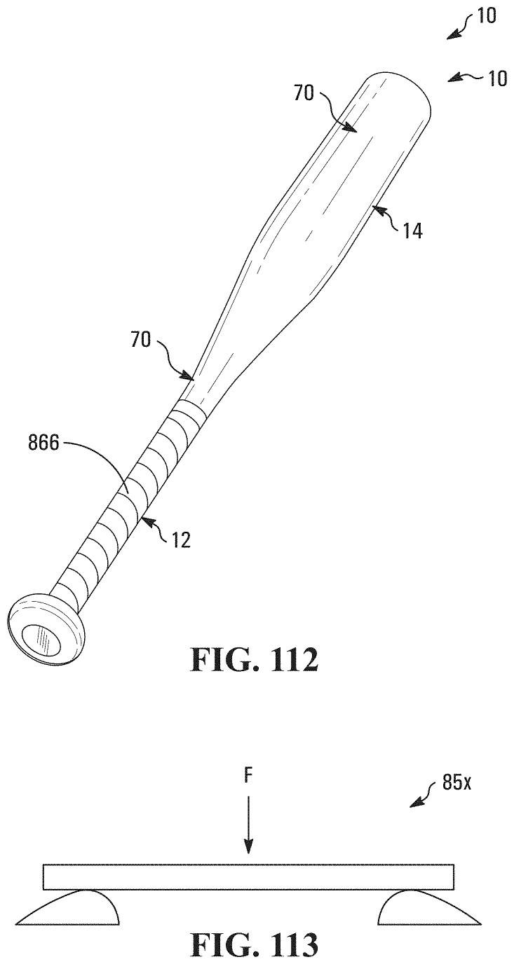

In other embodiments, as shown in FIG. 112, the sporting implement 10 may be a ball bat (e.g., a baseball or softball bat) for a ball player, in which the object-contacting member 14 of the ball bat 10 comprises a barrel for hitting a ball.

The ball bat 10 may be constructed according to principles discussed herein. For example, in some embodiments, the ball bat 10 may comprise the lattice 70 (e.g., which may be additively-manufactured or otherwise made) and/or one or more other additively-manufactured components, as discussed above. For instance, in some embodiments, the lattice 70 (e.g., which may be additively-manufactured or otherwise made) and/or one or more other additively-manufactured components may constitute at least part of a handle 866 of the elongate holdable member 12 and/or at least part of the barrel 14, according to principles discussed herein.

In still other embodiments, the article of manufacture that includes AM components may be some other form of wearable gear, such as footwear. For example, in some embodiments the article comprising additively-manufactured components may be a footwear for use by a user engaging in a sport.

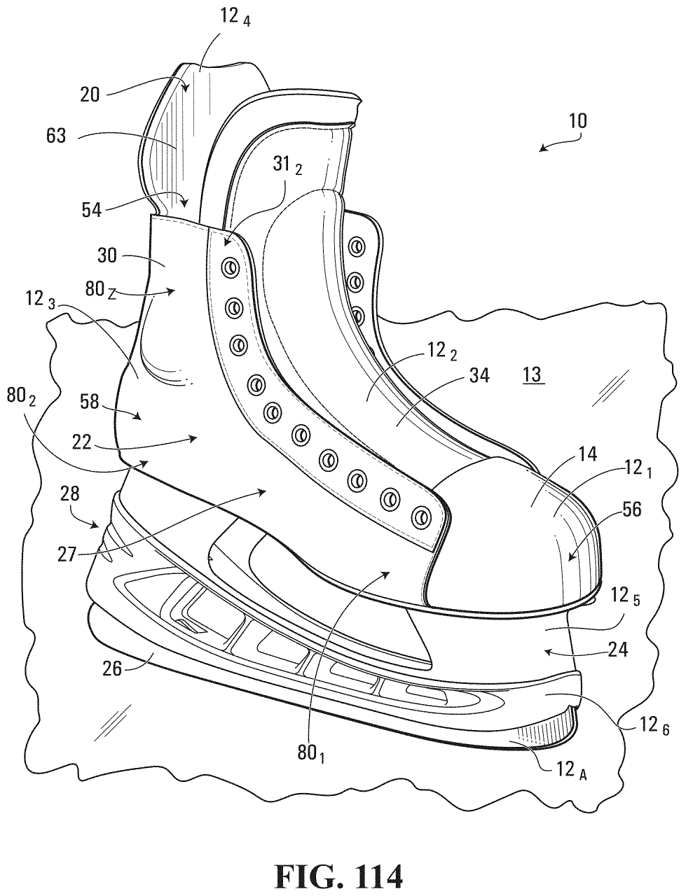

FIG. 114 shows an example of an embodiment of footwear 10 for a user and comprising additively-manufactured components 12₁-12_{A}. In this embodiment, the footwear 10 is a skate for the user to skate on a skating surface 13. More particularly, in this embodiment, the skate 10 is a hockey skate for the user who is a hockey player playing hockey. In this example, the skate 10 is an ice skate, a type of hockey played is ice hockey, and the skating surface 13 is ice.

The skate 10 comprises a skate boot 22 for receiving a foot 11 of the player and a skating device 28 disposed beneath the skate boot 22 to engage the skating surface 13. In this embodiment, the skating device 28 comprises a blade 26 for contacting the ice 13 and a blade holder 24 between the skate boot 22 and the blade 26. The skate 10 has a longitudinal direction, a widthwise direction, and a heightwise direction.

In this embodiment, the additively-manufactured components 12₁-12_{A} constitute one or more parts of the skate boot 22 and/or one or more parts of the skating device 28.

Each of the additively-manufactured components 12₁-12_{A} of the skate 10 is a part of the skate 10 that is additively manufactured, i.e., made by additive manufacturing, (e.g. 3D printing), in which material 50 thereof initially provided as feedstock (e.g., powder, liquid, filaments, fibers, and/or other suitable feedstock), which can be referred to as 3D-printed material, is added by a machine (i.e., a 3D printer) that is computer-controlled (e.g., using a digital 3D model such as a computer-aided design (CAD) file) to create it in its three-dimensional form (e.g., layer by layer, from a pool of liquid, applying continuous fibers, or in any other way, normally moldlessly, i.e., without any mold). This is in contrast to subtractive manufacturing (e.g., machining) where material is removed and molding where material is introduced into a mold's cavity.

Any 3D-printing technology may be used to make the additively-manufactured components 12₁-12_{A} of the skate 10, such as the example AM techniques that were discussed earlier with reference to the various helmet and stick embodiments.

As further discussed later, in this embodiment, the additively-manufactured components 12₁-12_{A} of the skate 10, which may be referred to as “AM” components, are designed to enhance performance and use of the skate 10, such as fit and comfort, power transfer to the skating surface 13 during skating strides, and/or other aspects of the skate 10.

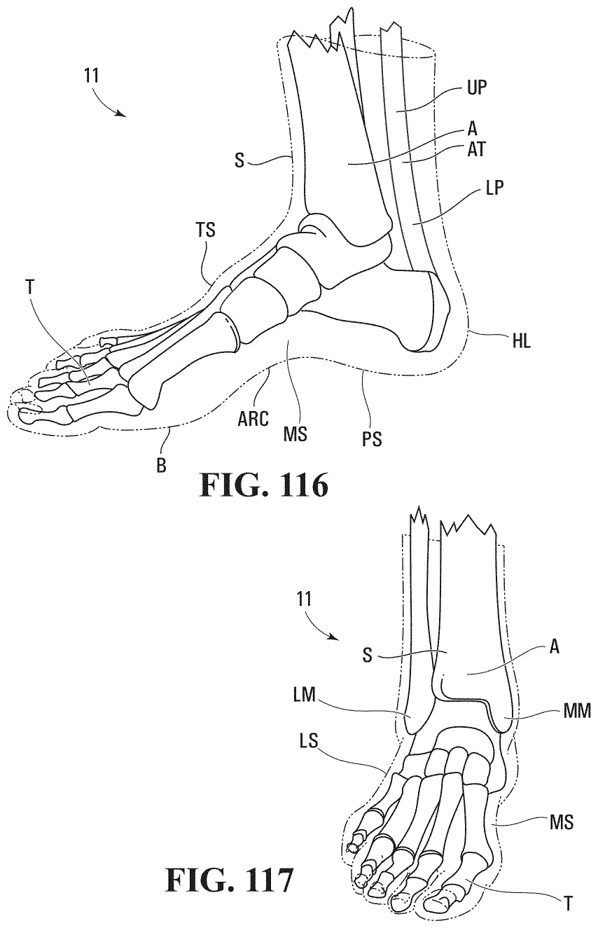

The skate boot 22 defines a cavity 54 for receiving the player's foot 11. With additional reference to FIGS. 116 and 117, the player's foot 11 comprises toes T, a ball B, an arch ARC, a plantar surface PS, a top surface TS including an instep IN, a medial side MS, a lateral side LS, and a heel HL. The top surface TS of the player's foot 11 is continuous with a lower portion of a shin S of the player. In addition, the player has an Achilles tendon AT and an ankle A having a medial malleolus MM and a lateral malleolus LM that is at a lower position than the medial malleolus MM. The Achilles tendon AT has an upper part UP and a lower part LP projecting outwardly with relation to the upper part UP and merging with the heel HL. A forefoot of the player includes the toes T and the ball B, a hindfoot of the player includes the heel HL, and a midfoot of the player is between the forefoot and the hindfoot.

More particularly, the skate boot 22 comprises a heel portion 21 configured to face the heel HL of the player's foot, an ankle portion 23 configured to face the ankle A of the player, a medial side portion 25 configured to face the medial side MS of the player's foot, a lateral side portion 27 configured to face the lateral side LS of the player's foot, an instep portion 41 configured to face the instep IN of the player's foot, a sole portion 29 configured to face the plantar surface PS of the player's foot, a toe portion 19 configured to receive the toes T of the user's foot, and a tendon guard portion 20 configured to face the upper part UP of the Achilles tendon AT of the player. The skate boot 22 has a longitudinal direction, a widthwise direction, and a heightwise direction.

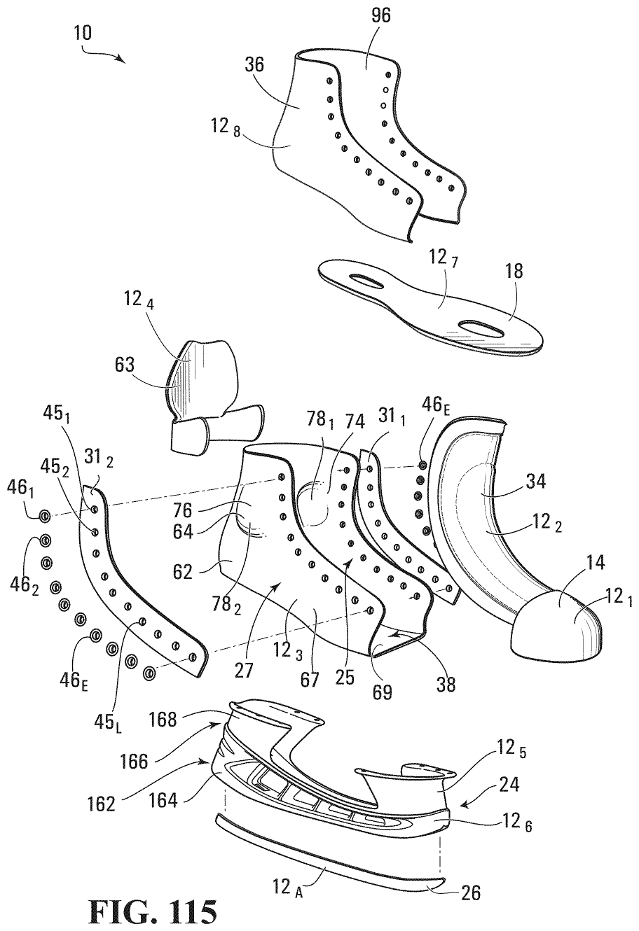

In this embodiment, with additional reference to FIGS. 114 and 115, the skate boot 22 comprises a body 30 and a plurality of parts connected to the body 30, which, in this example, includes facings 31₁, 31₂, a toe cap 14, a tongue 34, a liner 36, an insole 18, a footbed 38, a tendon guard 63 and an outsole 39. Lacing holes 45₁-45_{L} extend through each of the facings 31₁, 31₂, the body 30, and the liner 36 to receive a lace 47 for securing the skate 10 to the player's foot. In this example, the eyelets 46₁-46_{E} are provided in respective ones of the lacing holes 45₁-45_{L} to engage the lace 47.

The body 30 of the skate boot 22, which may sometimes be referred to as a “shell”, imparts strength and structural integrity to the skate 10 to support the player's foot. In this embodiment, the body 30 comprises medial and lateral side portions 66, 68 respectively configured to face the medial and lateral sides MS, LS of the player's foot, an ankle portion 64 configured to face the ankle A of the player, and a heel portion 62 configured to face the heel HL of the player. The medial and lateral side portions 66, 68, the ankle portion 64, and the heel portion 62 of the body 30 respectively constitute at least part (i.e., part or an entirety) of the medial and lateral side portions 25, 27, the ankle portion 23, and the heel portion 21 of the skate boot 22. The heel portion 62 may be formed such that it is substantially cup-shaped for following a contour of the heel HL of the player. The ankle portion 64 comprises medial and lateral ankle sides 74, 76. The medial ankle side 74 has a medial depression 78₁ for receiving the medial malleolus MM of the player and the lateral ankle side 76 has a lateral depression 80 for receiving the lateral malleolus LM of the player. The lateral depression 78₂ is located slightly lower than the medial depression 78 for conforming to the morphology of the player's foot. In this example, the body 30 also comprises a sole portion 69 configured to face the plantar surface PS of the player's foot. The sole portion 69 of the body 30 respectively constitute at least part of the sole portion 29.

In this embodiment, the body 30 of the skate boot 22 is manufactured to form its medial and lateral side portions 66, 68, its ankle portion 64, its heel portion 62, and its sole portion 69. For example, in this embodiment, at least part of the body 30 may be manufactured such that two or more of its medial and lateral side portions 66, 68, its ankle portion 64, its heel portion 62, and its sole portion 69 are integral with one another (i.e., are manufactured together as a single piece). For instance, in some embodiments, the body 30 may be a monolithic body, i.e., a one-piece body, made by AM. As another example, in some embodiments, the body 30 may be additively manufacture (e.g., 3D printed) to form its medial and lateral side portions 66, 68, its ankle portion 64, its heel portion 62, and its sole portion 69, which are distinct from (i.e. not integral with) one another.

The body 30 of the skate boot 22 may include one or more materials making it up. For example, in some embodiments, the body 30 may include one or more polymeric materials. More specifically, in this embodiment, the shell 30 comprises a plurality of materials M₁-M_{N} which may be different from one another, such as by having different chemistries and/or exhibiting substantially different values of one or more material properties (e.g., density, modulus of elasticity, hardness, etc.) and which are arranged such that the shell 30 comprises a plurality of layers 85₁-85_{L} which are made of respective ones of the materials M₁-M_{N}. In that sense, in this case, the shell 30 may be referred to as a “multilayer” shell and the layers 85₁-85_{L} of the shell 30 may be referred to as “subshells”. This may allow the skate 10 to have useful performance characteristics (e.g., reduced weight, proper fit and comfort, etc.) while being more cost-effectively manufactured.

The materials M₁-M_{N} may be implemented in any suitable way. In this embodiment, each of the materials M₁-M_{N} may be a polymeric material, such as polyethylene, polypropylene, polyurethane (PU), ethylene-vinyl acetate (EVA), nylon, polyester, vinyl, polyvinyl chloride, polycarbonate, an ionomer resin (e.g., Surlyn®), styrene-butadiene copolymer (e.g., K-Resin®) etc.), and/or any other thermoplastic or thermosetting polymer. Alternatively or additionally, in some embodiments, the materials M₁-M_{N} may include one or more composite materials, such as a fiber-matrix composite material comprising fibers disposed in a matrix. For instance, in some embodiments, the materials M₁-M_{N} may include a fiber-reinforced plastic (FRP—a.k.a., fiber-reinforced polymer), comprising a polymeric matrix may include any suitable polymeric resin, such as a thermoplastic or thermosetting resin, like epoxy, polyethylene, polypropylene, acrylic, thermoplastic polyurethane (TPU), polyether ether ketone (PEEK) or other polyaryletherketone (PAEK), polyethylene terephthalate (PET), polyvinyl chloride (PVC), poly(methyl methacrylate) (PMMA), polycarbonate, acrylonitrile butadiene styrene (ABS), nylon, polyimide, polysulfone, polyamide-imide, self-reinforcing polyphenylene, polyester, vinyl ester, vinyl ether, polyurethane, cyanate ester, phenolic resin, etc., a hybrid thermosetting-thermoplastic resin, or any other suitable resin, and fibers such as carbon fibers, glass fibers, polymeric fibers such as aramid fibers (e.g., Kevlar fibers), boron fibers, silicon carbide fibers, metallic fibers, ceramic fibers, etc., which may be provided as layers of continuous fibers (e.g. pre-preg (i.e., pre-impregnated) layers of fibers held together by an amount of matrix). Another example of a composite material may be a self-reinforced polymeric (e.g., polypropylene) composite (e.g., a Curv® composite).

In this embodiment, the materials M₁-M_{N} of the subshells 85₁-85_{L} of the shell 30 constitute at least part of the heel portion 62, the ankle portion 64, the medial and lateral side portions 66, 68, and the sole portion 69 of the shell 30. More particularly, in this embodiment, the materials M₁-M_{N} constitute at least a majority (i.e., a majority or an entirety) of the heel portion 62, the ankle portion 64, the medial and lateral side portions 66, 68, and the sole portion 69 of the shell 30. In this example, the materials M₁-M_{N} constitute the entirety of the heel portion 62, the ankle portion 64, the medial and lateral side portions 66, 68, and the sole portion 69 of the shell 30.

The subshells 85₁-85_{L} constituted by the polymeric materials M₁-M_{N} may have different properties for different purposes.

For instance, in some cases, a polymeric material Mₓ may be stiffer than a polymeric material M_{y} such that a subshell comprising the polymeric material Mₓ is stiffer than a subshell comprising the polymeric material M_{y}. For example, a ratio of a stiffness of the subshell comprising the polymeric material Mₓ over a stiffness of the subshell comprising the polymeric material M_{y} may be at least 1.5, in some cases at least 2, in some cases at least 2.5, in some cases 3, in some cases 4 and in some cases even more.

In some cases, a given one of the subshells 85₁-85_{L} may be configured to be harder than another one of the subshells 85₁-85_{L}. For instance, to provide a given subshell with more hardness than another subshell, the hardness of the polymeric materials M₁-M_{N} may vary. For example, a hardness of the polymeric material Mₓ may be greater than a hardness of the polymeric material M_{y}. For example, in some cases, a ratio of the hardness of the polymeric material Mₓ over the hardness of the polymeric material My may be at least 1.5, in some cases at least 2, in some cases at least 2.5, in some cases at least 3, in some cases at least 4, in some cases at least 5 and in some cases even more.

To observe the stiffness of a subshell 85ₓ, as shown in FIG. 113, a part of the subshell 85ₓ can be isolated from the remainder of the subshell 85ₓ (e.g., by cutting, or otherwise removing the part from the subshell 85ₓ, or by producing the part without the remainder of the subshell 85ₓ) and a three-point bending test can be performed on the part to subject it to loading tending to bend the part in specified ways (along a defined direction of the part if the part is anisotropic) to observe the rigidity and/or flexibility of the part and measure parameters indicative of the rigidity and/or flexibility of the part. For instance, in some embodiments, the three-point bending test may be based on conditions defined in a standard test (e.g., ISO 178(2010)).

For example, to observe the rigidity of the subshell 85ₓ, the three-point bending test may be performed to subject the subshell 85ₓ to loading tending to bend the subshell 85ₓ until a predetermined deflection of the subshell 85ₓ is reached and measure a bending load at that predetermined deflection of the subshell 85ₓ. The predetermined deflection of the subshell 85ₓ may be selected such as to correspond to a predetermined strain of the subshell 85ₓ at a specified point of the subshell 85ₓ (e.g., a point of an inner surface of the subshell 85ₓ). For instance, in some embodiments, the predetermined strain of the subshell 85ₓ may be between 3% and 5%. The bending load at the predetermined deflection of the subshell 85ₓ may be used to calculate a bending stress at the specified point of the subshell 85ₓ. The bending stress at the specified point of the subshell 85ₓ may be calculated as σ=My/l, where M is the moment about a neutral axis of the subshell 85ₓ caused by the bending load, y is the perpendicular distance from the specified point of the subshell 85ₓ to the neutral axis of the subshell 85ₓ, and I is the second moment of area about the neutral axis of the subshell 85ₓ. The rigidity of the subshell 85ₓ can be taken as the bending stress at the predetermined strain (i.e., at the predetermined deflection) of the subshell 85ₓ. Alternatively, the rigidity of the subshell 85ₓ may be taken as the bending load at the predetermined deflection of the subshell 85ₓ. The three-point bending test may be similarly used to determined the flexibility of the subshell 85ₓ.

A stiffness of the subshells 85₁-85_{L} may be related to a modulus of elasticity (i.e., Young's modulus) of the polymeric materials M₁-M_{N} associated therewith. For example, to provide a given subshell with more stiffness than another subshell, the modulus of elasticity of the polymeric materials M₁-M_{N} may vary. For instance, in some embodiments, the modulus of elasticity of the polymeric material Mₓ may be greater than the modulus of elasticity of the polymeric material M_{y}. For example, in some cases, a ratio of the modulus of elasticity of the polymeric material Mₓ over the modulus of elasticity of the polymeric material M_{y} may be at least 1.5, in some cases at least 2, in some cases at least 2.5, in some cases at least 3, in some cases at least 4, in some cases at least 5 and in some cases even more. This ratio may have any other suitable value in other embodiments.

In some cases, a given one of the subshells 85₁-85_{L} may be configured to be denser than another one of the subshells 85₁-85_{L}. For instance, to provide a given subshell with more density than another subshell, the density of the polymeric materials M₁-M_{N} may vary. For instance, in some embodiments, the polymeric material Mₓ may have a density that is greater than a density of the polymeric material M_{y}. For example, in some cases, a ratio of the density of the material Mₓ over the density of the material M_{y} may be at least 1.1, in some cases at least 1.5, in some cases at least 2, in some cases at least 2.5, in some cases at least 3 and in some cases even more.

In this embodiment, the subshells 85₁-85_{L} comprise an internal subshell 85₁, an intermediate subshell 85₂ and an external subshell 85₃. The internal subshell 85₁ is “internal” in that it is an innermost one of the subshells 85₁-85_{L}. That is, the internal subshell 85₁ is closest to the player's foot 11 when the player dons the skate 10. In a similar manner, the external subshell 85₃ is “external” in that is an outermost one of the subshells 85₁-85_{L}. That is, the external subshell 85₃ is furthest from the player's foot 11 when the player dons the skate 10. The intermediate subshell 85₂ is disposed between the internal and external subshells 85₁, 85₃.

The internal, intermediate and external subshells 85₁, 85₂, 85₃ comprise respective polymeric materials M₁, M₂, M₃. In this embodiment, the polymeric materials M₁, M₂, M₃ have different material properties that impart different characteristics to the internal, intermediate and external subshells 85₁, 85₂, 85₃. As a result, in certain cases, a given one of the subshells 85₁, 85₂, 85₃ may be more resistant to impact than another one of the subshells 85₁, 85₂, 85₃, a given one of the subshells 85₁, 85₂, 85₃ may be more resistant to wear than another one of the subshells 85₁, 85₂, 85₃, and/or a given one of the subshells 85₁, 85₂, 85₃ may be denser than another one of the subshells 85₁, 85₂, 85₃.

For instance, a density of each of the internal, intermediate and external subshells 85₁, 85₂, 85₃ may vary. For example, in this embodiment, the densities of the internal, intermediate and external subshells 85₁, 85₂, 85₃ increase inwardly such that the density of the internal subshell 85₁ is greater than the density of the intermediate subshell 85₂ which in turn is greater than the density of the external subshell 85₃. For example, the density of the internal subshell 85₁ may be approximately 30 kg/m³, while the density of the intermediate subshell 85₂ may be approximately 20 kg/m³, and the density of the external subshell 85₃ may be approximately 10 kg/m³. The densities of the internal, intermediate and external subshells 85₁, 85₂, 85₃ may have any other suitable values in other embodiments. In other embodiments, the densities of the internal, intermediate and external subshells 85₁, 85₂, 85₃ may increase outwardly such that the external subshell 85₃ is the densest of the subshells 85₁-85_{L}. In yet other embodiments, the densities of the internal, intermediate and external subshells 85₁, 85₂, 85₃ may not be arranged in order of ascending or descending density.

Moreover, in this embodiment, a stiffness of the internal, intermediate and external subshells 85₁, 85₂, 85₃ may vary. For example, in this embodiment, the stiffness of the internal subshell 85₁ is greater than the respective stiffness of each of the intermediate subshell 85₂ and the external subshell 85₃.

In addition, in this embodiment, a thickness of the internal, intermediate and external subshells 85₁, 85₂, 85₃ may vary. For example, in this embodiment, the intermediate subshell 85₂ has a thickness that is greater than a respective thickness of each of the internal and external subshells 85₁, 85₃. For example, in some cases, the thickness of each of the internal, intermediate and external subshells 85₁, 85₂, 85₃ may be between 0.1 mm to 25 mm, and in some cases between 0.5 mm to 10 mm. For instance, the thickness of each of the internal, intermediate and external subshells 85₁, 85₂, 85₃ may be no more than 30 mm, in some cases no more than 25 mm, in some cases no more than 15 mm, in some cases no more than 10 mm, in some cases no more than 5 mm, in some cases no more than 1 mm, in some cases no more than 0.5 mm, in some cases no more than 0.1 mm and in some cases even less.

In order to provide the internal, intermediate and external subshells 85₁, 85₂, 85₃ with their different characteristics, the polymeric materials M₁, M₂, M₃ of the internal, intermediate and external subshells 85₁, 85₂, 85₃ may comprise different types of polymeric materials. For instance, in this example, the polymeric material Mi comprises a generally soft and dense foam, the polymeric material M₂ comprises a structural foam that is more rigid than the foam of the polymeric material M₁ and less dense than the polymeric material M₁, and the polymeric material M₃ is a material other than foam. For example, the polymeric material M₃ of the external subshell 85₃ may consist of a clear polymeric coating.

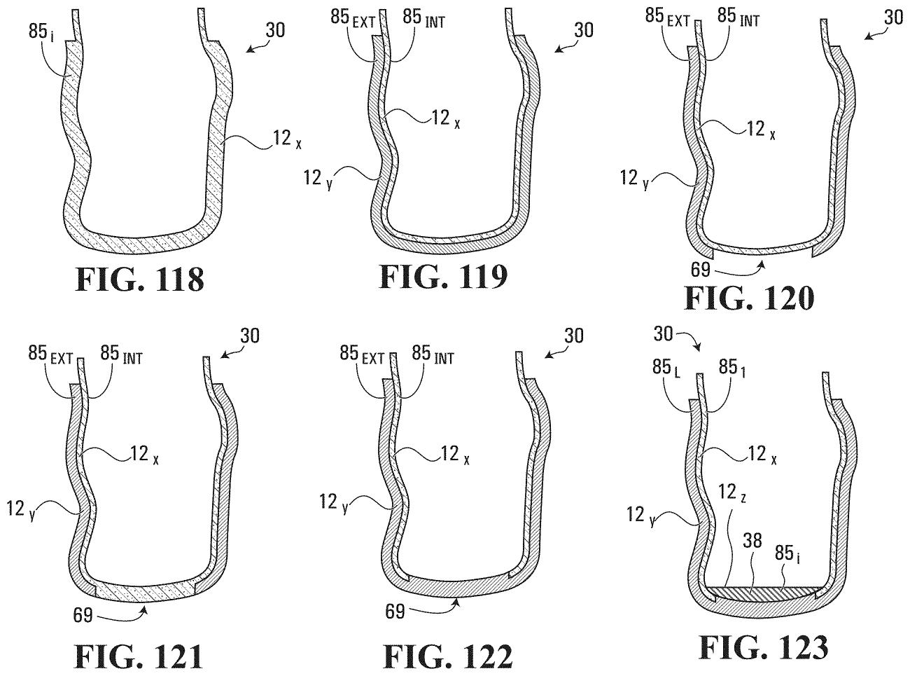

The subshells 85₁-85_{L} may be configured in various other ways in other embodiments. For instance, in other embodiments, the shell 30 may comprise a different number of subshells or no subshells. For example, in some embodiments, as shown in FIG. 118, the shell 30 may be a single shell and therefore does not comprise any subshells. In other embodiments, as shown in FIG. 119, the shell 30 may comprise two subshells 85₁-85_{L}.

Moreover, as shown in FIGS. 120 to 122, when the shell 30 comprises two subshells, notably interior and exterior subshells 85_{INT}, 85_{EXT}, if the exterior subshell 85_{EXT} has a density that is greater than a density of the interior subshell 85_{INT}, a given one of the subshells 85_{INT}, 85_{EXT} may have an opening, which can be referred to as a gap, along at least part of the sole portion 69 of the shell 30 (e.g., along a majority of the sole portion 69 of the shell 30). For example, as shown in FIG. 120, in some embodiments, the exterior subshell 85_{EXT} may comprise a gap G at the sole portion 69 of the shell 30 such that the interior and exterior subshells 85_{INT}, 85_{EXT} do not overlie one another at the sole portion 69 of the shell 30 (i.e., the interior subshell 85_{INT} may be the only subshell present at the sole portion 69 of the shell 30). As shown in FIG. 121, in an embodiment in which the exterior subshell 85_{EXT} has a gap at the sole portion 69 of the shell 30, the interior subshell 85_{INT} may project outwardly toward the exterior subshell 85_{EXT} at the sole portion 69 of the shell 30 and fill in the gap of the exterior subshell 85_{EXT} such that a thickness of the interior subshell 85_{INT} is greater at the sole portion 69 of the shell 30. As another example, as shown in FIG. 122, in an embodiment in which the interior subshell 85_{INT} has a gap at the sole portion 69 of the shell 30, the exterior subshell 85_{EXT} may project inwardly toward the interior subshell 85_{INT} at the sole portion 69 of the shell 30 and fill in the gap of the interior subshell 85_{INT} such that a thickness of the exterior subshell 85_{EXT} is greater at the sole portion 69 of the shell 30. As shown in FIG. 123, the footbed 38 may be formed integrally with the shell 30 such as to cover at least partially an inner surface of the innermost subshell (in this case, the interior subshell 85_{INT}) and overlie the sole portion 69 of the shell 30. In other cases, the footbed 38 may be inserted separately after the manufacture of the shell 30 has been completed.

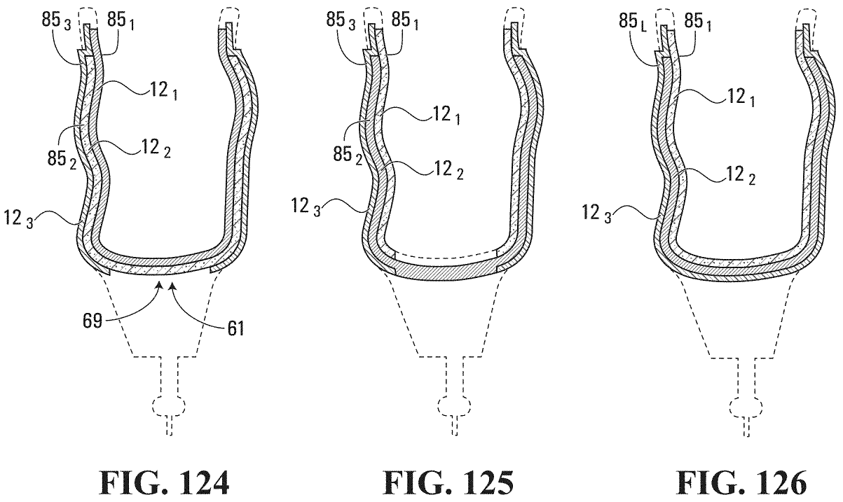

In some embodiments, as shown in FIGS. 124 to 126, when the shell 30 comprises three subshells, notably the internal, intermediate and external subshells 85₁, 85₂, 85₃, and the external subshell 85₃ has a density that is greater than a density of the intermediate subshell 85₂, the external subshell 85₃ may comprise a gap 61 at the sole portion 69 of the shell 30 and the intermediate subshell 85₂ may project into the external subshell 85₃ at the sole portion 69 of the shell 30 such as to fill in the gap 61 of the external subshell 85₃. In such embodiments, the intermediate subshell 85₂ may have a greater thickness at the sole portion 69 of the shell 30.

The toe cap 14 is configured to receive the toes T of the player's foot. It comprises a medial part 61 configured to receive a big toe of the player's toes T, a lateral part 63 configured to receive a little toe of the player's toes T, and an intermediate part 65 that is between its medial part 61 and its lateral part 63 and configured to receive index, middle and ring toes of the player's toes T. The toe cap 14 comprises a distal part 52 adjacent to distal ends of the toes T of the player's foot and a proximal part 44 adjacent to proximal ends of the toes T of the player's foot.

The toe cap 14 includes rigid material. For example, in some embodiments, the toe cap 14 may be made of nylon, polycarbonate, polyurethane, polyethylene (e.g., high density polyethylene), or any other suitable thermoplastic or thermosetting polymer. Alternatively or additionally, in some embodiments, the toe cap 14 may include composite material, such as a fiber-matrix composite material comprising fibers disposed in a matrix. For instance, in some embodiments, the toe cap 14 may include a fiber-reinforced plastic (FRP—a.k.a., fiber-reinforced polymer), comprising a polymeric matrix may include any suitable polymeric resin, such as a thermoplastic or thermosetting resin, like epoxy, polyethylene, polypropylene, acrylic, thermoplastic polyurethane (TPU), polyether ether ketone (PEEK) or other polyaryletherketone (PAEK), polyethylene terephthalate (PET), polyvinyl chloride (PVC), poly(methyl methacrylate) (PMMA), polycarbonate, acrylonitrile butadiene styrene (ABS), nylon, polyimide, polysulfone, polyamide-imide, self-reinforcing polyphenylene, polyester, vinyl ester, vinyl ether, polyurethane, cyanate ester, phenolic resin, etc., a hybrid thermosetting-thermoplastic resin, or any other suitable resin, and fibers such as carbon fibers, glass fibers, polymeric fibers such as aramid fibers (e.g., Kevlar fibers), boron fibers, silicon carbide fibers, metallic fibers, ceramic fibers, etc., which may be provided as layers of continuous fibers (e.g. pre-preg (i.e., pre-impregnated) layers of fibers held together by an amount of matrix).

In this embodiment, the toe cap 14 is manufactured to impart a shape to the toe cap 14.

The facings 31₁, 31₂ are provided on the medial and lateral side portions 66, 68 of the body 30 of the skate boot 22, including on an external surface 67 of the body 30. In this embodiment, the facings 31₁, 31₂ extend respectively along medial and lateral edges 32₁, 32₂ of the body 30 from the ankle portion 64 to the medial and lateral side portions 66, 68 towards the toe cap 14.

Each of the facings 31₁, 31₂ may comprise lacing openings 48₁-48_{L} that are part of respective ones of the lacing holes 45₁-45_{L} to receive the lace 47. In that sense, the facings 31₁, 31₂ may be viewed as lacing members. In this example, each of the facings 31₁, 31₂ includes a void 49 to receive a given one of the medial and lateral edges 32₁, 32₂ of the body 30 that it straddles and that includes lacing openings 50₁-50_{L} which are part of respective ones of the lacing holes 45₁-45_{L} to receive the lace 47.

In this embodiment, each of the facings 31₁, 31₂ is manufactured to impart a shape to the facing. For example, each of the facings 31₁, 31₂ may be made from nylon or any other suitable polymeric material, such as thermoplastic polyurethane (TPU), polyvinyl chloride (PVC), or any other thermoplastic or thermosetting polymer.

In other embodiments, the facings 31₁, 31₂ may include any other suitable material (e.g., leather, any synthetic material that resembles leather, and/or any other suitable material).

The facings 31₁, 31₂ may be connected to the body 30 of the skate boot 22 in any suitable way. For instance, in some embodiments, each of the facings 31₁, 31₂ may be fastened to the body 30 (e.g., via stitching, staples, etc.), glued or otherwise adhesively bonded to the body 30 via an adhesive, or ultrasonically bonded to the body 30.

In this embodiment, each of the facings 31₁, 31₂ overlaps and is secured to the toe cap 14 (e.g., by one or more fasteners such as a mechanical fastener, like a rivet, a tack, a screw, a nail, stitching, or any other mechanical fastening device, or an adhesive). This may enhance solidity, integrity and durability of the skate boot 22 proximate to the toe cap 14 and/or may facilitate manufacturing of the skate boot 22. More particularly, in this embodiment, the facing 311 overlaps and is secured to the medial side portion 61 of the toe cap 14 while the facing 31₂ overlaps and is secured to the lateral side portion 63 of the toe cap 14.

The liner 36 of the skate boot 22 is affixed to an inner surface 37 of the body 30 and comprises an inner surface 96 for facing the heel HL and medial and lateral sides MS, LS of the player's foot 11 and ankle A. The liner 36 may be affixed to the body 30 by stitching or stapling the liner 36 to the body 30, gluing with an adhesive and/or any other suitable technique. The liner 36 may be made of a soft material (e.g., a fabric made of NYLON® fibers, polyester fibers or any other suitable fabric). The skate boot 22 may also comprise pads disposed between the shell 30 and the liner 36, including and ankle pad for facing the ankle A. The footbed 38 may include a foam layer, which may be made of a polymeric material. For example, the footbed 38, in some embodiments, may include a foam-backed fabric. The footbed 38 is mounted inside the body 30 and comprises an upper surface 106 for receiving the plantar surface PS of the player's foot 11. In this embodiment, the footbed 38 affixed to the sole portion 69 of the body 30 by an adhesive and/or any other suitable technique. In other embodiments, the footbed 38 may be removable. In some embodiments, the footbed 38 may also comprise a wall projecting upwardly from the upper surface 106 to partially cup the heel HL and extend up to a medial line of the player's foot 11.

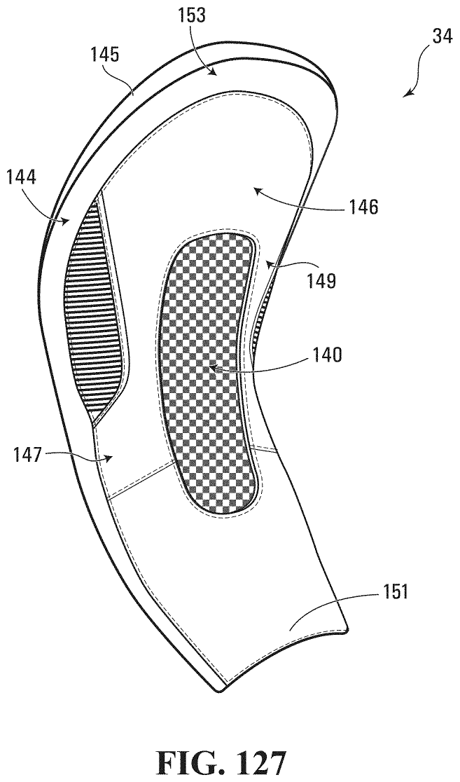

The tongue 34 extends upwardly and rearwardly from the toe portion 19 of the skate boot 22 for overlapping the top surface TS of the player's foot 11. In this embodiment, the tongue 34 is affixed to the body 30. In particular, in this embodiment, the tongue 34 is fastened to the toe cap 14. With additional reference to FIG. 127, in some embodiments, the tongue 34 comprises a core 140 defining a section of the tongue 34 with increased rigidity, a padding member (not shown) for absorbing impacts to the tongue 34, a peripheral member 94 for at least partially defining a periphery 95 of the tongue 34, and a cover member 143 configured to at least partially define a front surface of the tongue 34, The tongue 34 defines a lateral portion 147 overlying a lateral portion of the player's foot 11 and a medial portion 149 overlying a medial portion of the player's foot 11. The tongue 34 also defines a distal end portion 151 for affixing to the toe cap 14 (e.g., via stitching, riveting, welding (e.g. high-frequency welding), bonding or detachable affixing means) and a proximal end portion 153 that is nearest to the player's shin S.

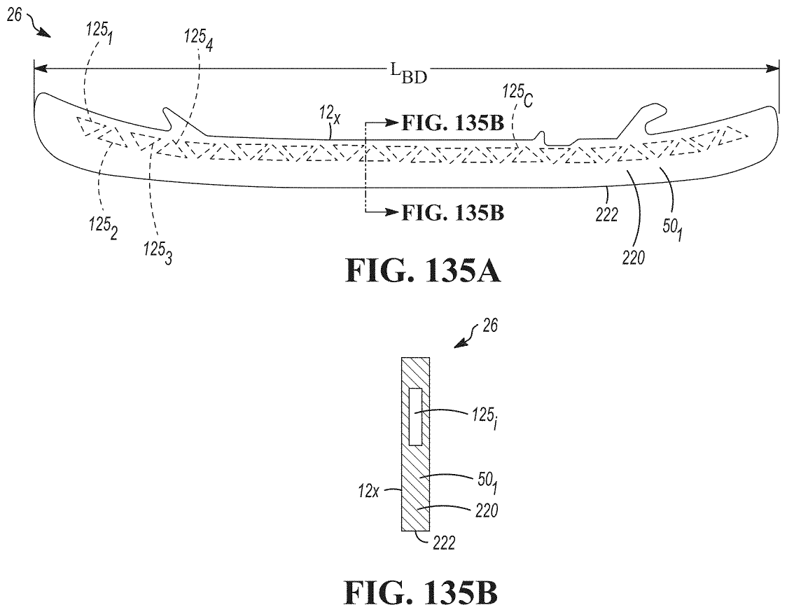

With additional reference to FIG. 135A and 135B, the blade 26 comprises an ice-contacting material 220 including an ice-contacting surface 222 for sliding on the skating surface 13 while the player skates. In this embodiment, the ice-contacting material 220 is a metallic material (e.g., stainless steel). The ice-contacting material 220 may be any other suitable material in other embodiments.

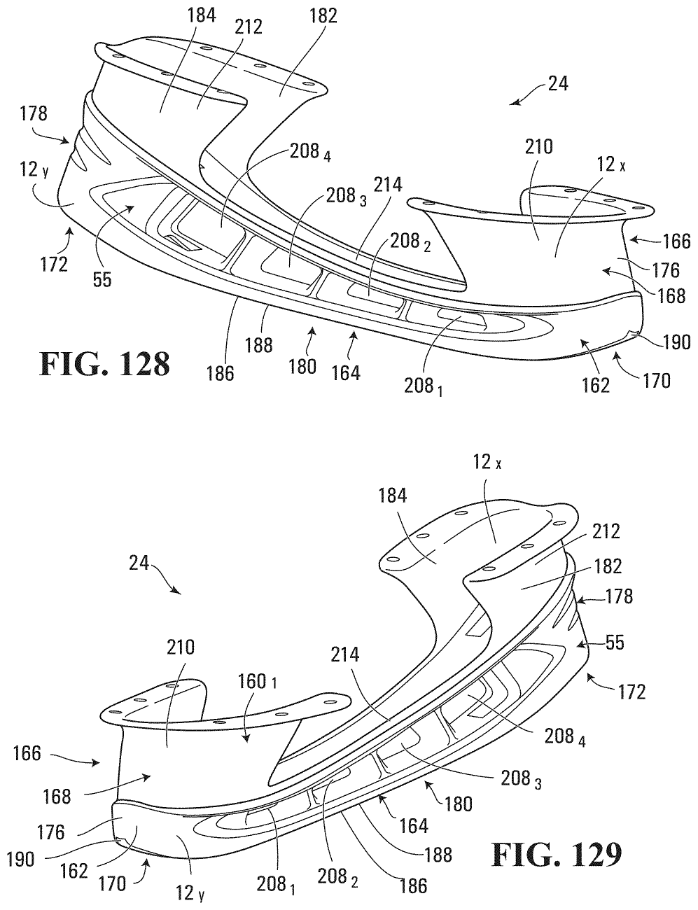

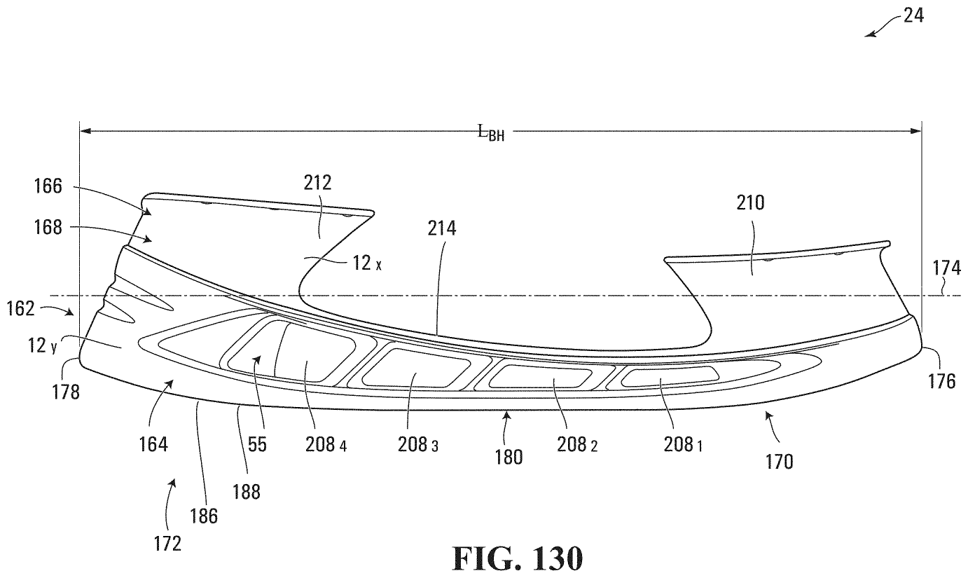

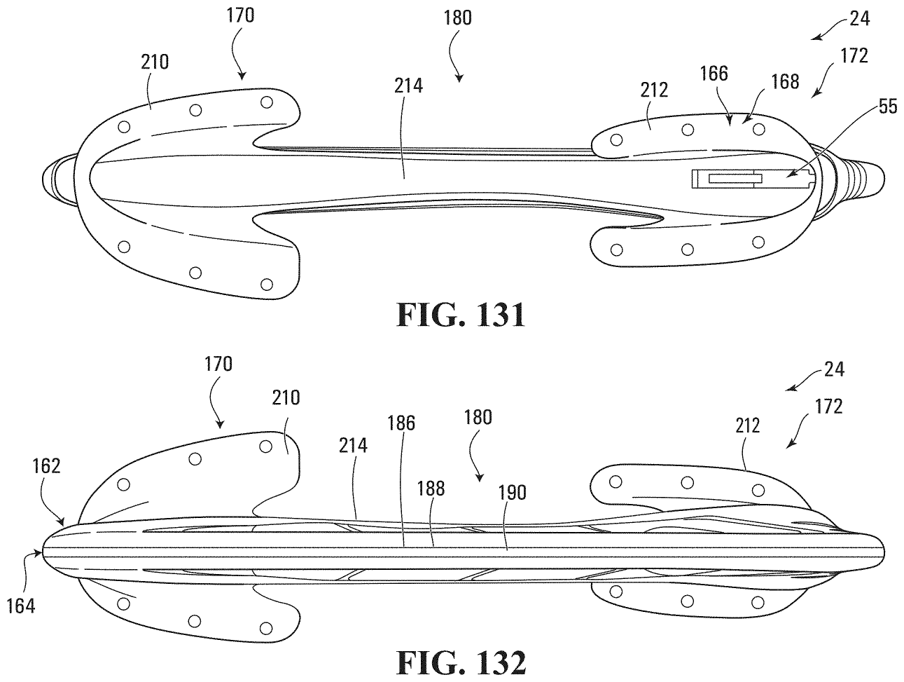

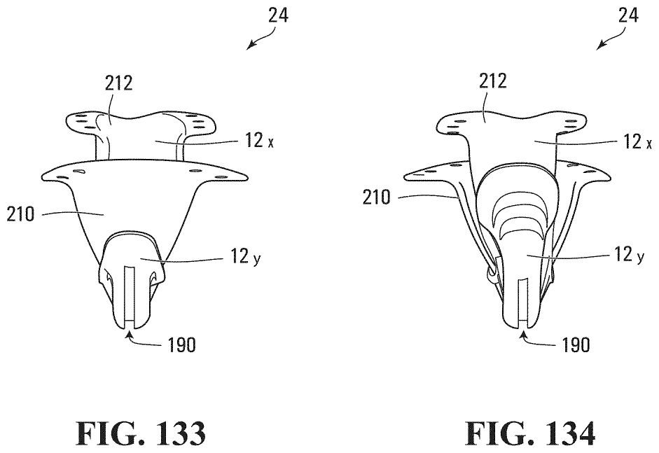

The blade holder 24 may comprise a lower portion 162 comprising a blade-retaining base 164 that retains the blade 26 and an upper portion 166 comprising a support 168 that extends upwardly from the blade-retaining base 164 towards the skate boot 22 to interconnect the blade holder 24 and the skate boot 22, as shown in FIGS. 128 to 134.

A front portion 170 of the blade holder 24 and a rear portion 172 of the blade holder 24 define a longitudinal axis 174 of the blade holder 24. The front portion 170 of the blade holder 24 includes a frontmost point 176 of the blade holder 24 and extends beneath and along the player's forefoot in use, while the rear portion 172 of the blade holder 24 includes a rearmost point 178 of the blade holder 24 and extends beneath and along the player's hindfoot in use. An intermediate portion 180 of the blade holder 24 is between the front and rear portions 170, 172 of the blade holder 24 and extends beneath and along the player's midfoot in use. The blade holder 24 comprises a medial side 182 and a lateral side 184 that are opposite one another.

The blade-retaining base 164 is elongated in the longitudinal direction of the blade holder 24 and is configured to retain the blade 26 such that the blade 26 extends along a bottom portion 186 of the blade-retaining base 164 to contact the skating surface 13. To that end, the blade-retaining base 164 comprises a blade-retention portion 188 to face and retain the blade 26. In this embodiment, the blade-retention portion 188 comprises a recess 190 in which an upper portion of the blade 26 is disposed.

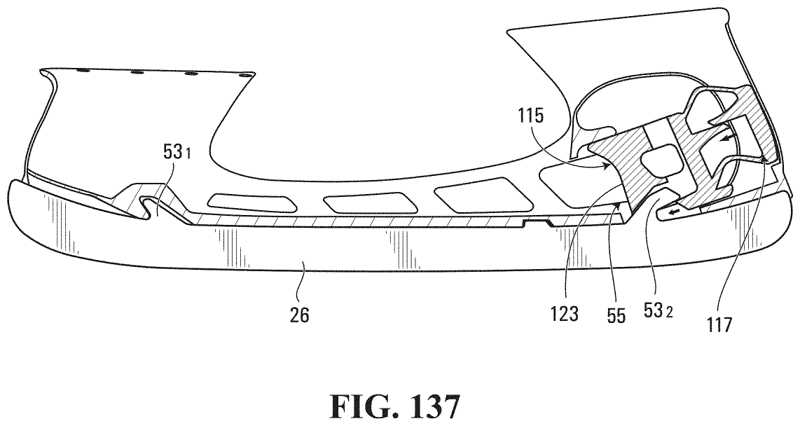

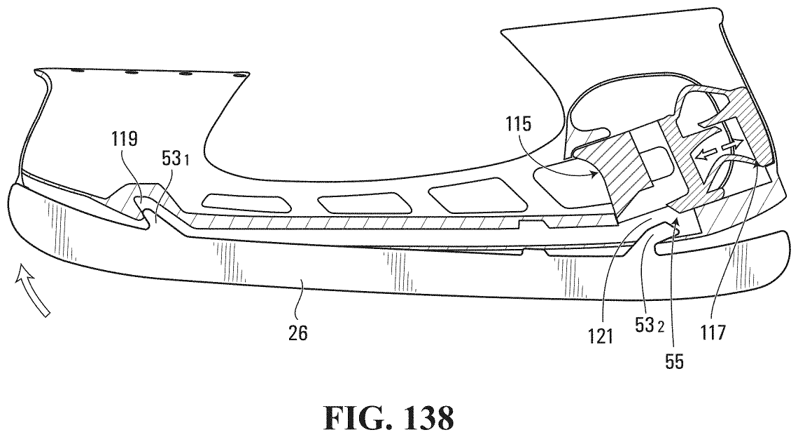

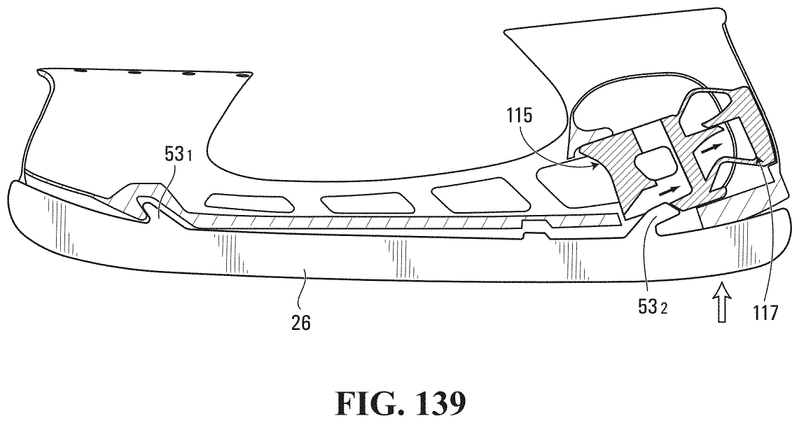

The blade holder 24 can retain the blade 26 in any suitable way. In this embodiment, with additional reference to FIGS. 137 to 139, the blade holder 24 comprises a blade-detachment mechanism 55 such that the blade 26 is selectively detachable and removable from, and attachable to, the blade holder 24 (e.g., when the blade 26 is worn out or otherwise needs to be replaced or removed from the blade holder 24) as implemented in U.S. Pat. No. 8,454,030, U.S. Pat. No. 8,534,680 and U.S. patent application Ser. No. 15/388,679, which are hereby incorporated by reference herein.

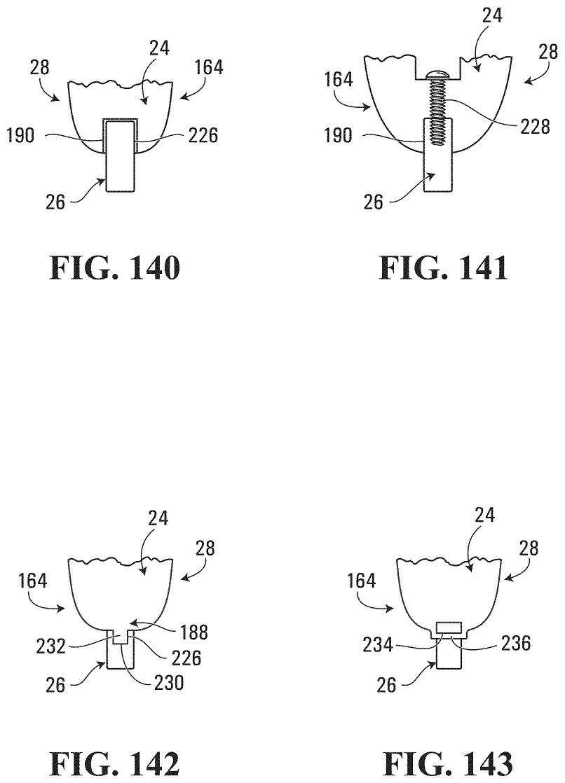

In other embodiments, the blade 26 may be permanently affixed to the blade holder 24 (i.e., not intended to be detached and removed from the blade holder 24). For example, as shown in FIG. 143, the blade 26 and the blade-retaining base 164 of the blade holder 24 may be mechanically interlocked via an interlocking portion 234 of one of the blade-retaining base 164 and the blade 26 that extends into an interlocking void 236 of the other one of the blade-retaining base 164 and the blade 26. In some embodiments, as shown in FIGS. 140 to 143, the blade holder 24 may retain the blade 26 using an adhesive 226 and/or one or more fasteners 228. For instance, in some embodiments, as shown in FIG. 140, the recess 190 of the blade holder 24 may receive the upper portion of the blade 26 that is retained by the adhesive 226. The adhesive 226 may be an epoxy-based adhesive, a polyurethane-based adhesive, or any suitable adhesive. In some embodiments, instead of or in addition to using an adhesive, as shown in FIG. 141, the recess 190 of the blade holder 24 may receive the upper part of the blade 26 that is retained by the one or more fasteners 228. Each fastener 228 may be a rivet, a screw, a bolt, or any other suitable mechanical fastener. Alternatively or additionally, in some embodiments, as shown in FIG. 142, the blade-retention portion 188 of the blade holder 24 may extend into a recess 230 of the upper part of the blade 26 to retain the blade 26 using the adhesive 226 and/or the one or more fasteners 228. For instance, in some cases, the blade-retention portion 188 of the blade-retaining base 164 of the blade holder 24 may comprise a projection 232 extending into the recess 230 of the blade 26.

In this embodiment, the blade-retaining base 164 comprises a plurality of apertures 208₁-208₄ distributed in the longitudinal direction of the blade holder 24 and extending from a medial side 182 to a lateral side 184 of the blade holder 24. In this example, respective ones of the apertures 208₁-208₄ differ in size. The apertures 208₁-208₄ may have any other suitable configuration, or may be omitted, in other embodiments.

The blade-retaining base 164 may be configured in any other suitable way in other embodiments.

The support 168 is configured for supporting the skate boot 22 above the blade-retaining base 164 and transmit forces to and from the blade-retaining base 164 during skating. In this embodiment, the support 168 comprises a front pillar 210 and a rear pillar 212 which extend upwardly from the blade-retaining base 164 towards the skate boot 22. The front pillar 210 extends towards a front portion 56 of the skate boot 22 and the rear pillar 212 extends towards a rear portion 58 of the skate boot 22. The blade-retaining base 164 extends from the front pillar 210 to the rear pillar 212. More particularly, in this embodiment, the blade-retaining base 164 comprises a bridge 214 interconnecting the front and rear pillars 210, 212.

In this embodiment, the additively-manufactured components 12₁-12_{A} of the skate 10 constitute one or more parts of the skate boot 22 and/or one or more parts of the skating device 28. More specifically, the additively-manufactured components 12₁-12_{A} of the skate 10 constitute one or more parts of each one of the subshells 85₁-85_{L} of the shell 30, the toe cap 14, the facings 31₁, 31₂, the liner 36, the tongue 34, the blade 26, the lower portion 162 of the blade holder 24 and the support 168 of the blade holder 24. Inversely, each one of the skate boot 22 and the skating device 28 may comprise at least part of (i.e. part of or an entirety of) each one of the additively-manufactured components 12₁-12_{A} of the skate 10. More specifically, in this embodiment, each one of the subshells 85₁-85_{L} of the shell 30, the tendon guard 20, the toe cap 14, the facings 311, 312, the liner 36, the tongue 34, the insole 18, the footbed 38, the blade 26, the lower portion 162 of the blade holder 24 and the support 168 of the blade holder 24 is made of a distinct one of the additively-manufactured components 12₁-12_{A}.

Each AM component 12ₓ of the skate 10 may be configured to enhance performance and use of the skate 10, such as fit and comfort, power transfer to the skating surface 13, durability, customability, foot protection, cost efficiency and/or other aspects of the skate 10.

The AM component 12ₓ of the skate 10 may be implemented in any suitable way in various embodiments.

For example, in this embodiment, the AM component 12ₓ may include a lattice 40 which is additively-manufactured such that AM component 12ₓ has an open structure. The lattice 40 can be designed and 3D-printed to impart properties and functions of the AM component 12ₓ, such as those discussed above, while helping to minimize its weight.

The lattice 40 comprises a framework of structural members 41₁-41_{E} that intersect one another. In some embodiments, the structural members 41₁-41_{E} may be arranged in a regular arrangement repeating over the lattice 40. In some cases, the lattice 40 may be viewed as made up of unit cells 32₁-32_{C} each including a subset of the structural members 41₁-41_{E} that forms the regular arrangement repeating over the lattice 40. Each of these unit cells 32₁-32_{C} can be viewed as having a voxel, which refers to a notional three-dimensional space that it occupies. In other embodiments, the structural members 41₁-41_{E} may be arranged in different arrangements over the lattice 40 (e.g., which do not necessarily repeat over the lattice 40, do not necessarily define unit cells, etc.).

Examples of framework for the lattice 40 could include frameworks similar to those shown in FIGS. 61 to 65 that were discussed previously. In some embodiments, the framework of the lattice 40 may define a hollow lattice having a lattice pattern that is observable in exploded view, as shown in the examples of FIGS. 123 to 127. In other embodiments, the framework of the lattice 40 may not be hollow or observable in exploded view, as shown in other exemplary lattices at FIGS. 36, 38 and 95. It is further noted that some lattices are not hollow or observable in exploded view while they have a lattice pattern that is similar to a lattice pattern of hollow lattices—in other words, in some embodiments, the lattice pattern of hollow lattices may be used to form a non-hollow lattice.

The lattice 40, including its structural members 41₁-41_{E}, may be configured in any suitable manner.

In this embodiment, the structural members 41₁-41_{E} are elongate members that intersect one another at nodes 42₁-42_{N}. The elongate members 41₁-41_{E} may sometimes be referred to as “beams” or “struts”. Each of the elongate members 41₁-41_{E} may be straight, curved, or partly straight and partly curved. While in some embodiments at least some of the nodes 42₁-42_{N} (i.e. some of the nodes 42₁-42_{N} or every one of the nodes 42₁-42_{N}) may be formed by having the structural members 41₁-41_{E} forming the nodes affixed to one another (e.g., chemically fastened, via an adhesive, etc.), as shown in FIGS. 66 and 67, in some embodiments at least some of the nodes 42₁-42_{N} (i.e. some of the nodes 42₁-42_{N} or every one of the nodes 42₁-42_{N}) may be formed by having the structural members 41₁-41_{E} being unitary (e.g., integrally made with one another, fused to one another, etc.), as shown in FIGS. 68 and 69. Also, in this embodiment, the nodes 42₁-42_{N} may be thicker than respective ones of the elongate members 41₁-41_{E} that intersect one another thereat, as shown in FIGS. 67 and 69, while in other embodiments the nodes 42₁-42_{N} may have a same thickness as respective ones of the elongate members 41₁-41_{E} that intersect one another thereat.

In this embodiment, the structural members 41₁-41_{E} may have any suitable shape, as shown in FIGS. 70 to 75. That is, a cross-section of a structural member 41i across a longitudinal axis of the structural member 41i may have any suitable shape, for instance: a circular shape, an oblong shape, an elliptical shape, a square shape, a rectangular shape, a polygonal shape (e.g. triangle, hexagon, and so on), etc.

Moreover, in this embodiment, the structural member 41ᵢ may comprise any suitable structure and any suitable composition, as shown in FIGS. 76 to 81. As an example, the structural member 41ᵢ may be solid (i.e. without any void) and composed of a material 50, as shown in FIG. 76. In another embodiment, the structural member 41ᵢ may comprise the material 50 and another material 51₁ inner to the material 50, as shown in FIG. 77. In another embodiment, the structural member 41ᵢ may comprise the material 50, the other material 51₁ inner to the material 50 and another material 51₂ outer to the material 50, as shown in FIG. 78. In another embodiment, the structural member 41ᵢ may be composed of the material 50 and may comprise a void 44 that is not filled by any specific solid material, as shown in FIG. 79. In another embodiment, the structural member 41ᵢ may comprise the material 50, another material outer to the material 50 and the void 44 that is not filled by any specific solid material, as shown in FIG. 80. In another embodiment, the structural member 41ᵢ may comprise the material 50 and a plurality of reinforcements 53 (e.g. continuous or chopped fibers), as shown in FIG. 81.

In other embodiments, the structural members 41₁-41_{E} of the lattice 40 may be implemented in various other ways. For example, in some embodiments, as shown in FIG. 97, the structural members 41₁-41_{E} may be planar members that intersect one another at vertices 142₁-142_{V}. The planar members 41₁-41_{E} may sometimes be referred to as “faces”. Each of the planar members 41₁-41_{E} may be straight, curved, or partly straight and partly curved. Although in the example shown in FIG. 97 the planar structural members 41₁-41_{E} are all parallel to a common axis, in some embodiments, the planar structural members 41₁-41_{E} may not be parallel to a common axis.

The 3D-printed material 50 constitutes the lattice 40. Specifically, the elongate members 41₁-41_{E} and the nodes 42₁-42_{N} of the lattice 40 include respective parts of the 3D-printed material 50 that are created by the 3D-printer.

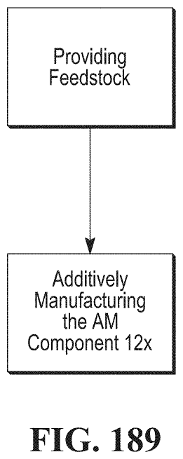

Practically, a method for making the AM component 12_{X} may include the steps of providing feedstock (corresponding to the material 50) and additively manufacturing the AM component 12, as shown in FIG. 189.

In some example of implementations, the 3D-printed material 50 includes polymeric material. For instance, in this embodiment, the 3D-printed material 50 may include polyethylene, polypropylene, polyurethane (PU), ethylene-vinyl acetate (EVA), nylon, polyester, vinyl, polyvinyl chloride, polycarbonate, an ionomer resin (e.g., Surlyn®), styrene-butadiene copolymer (e.g., K-Resin®) etc.), and/or any other thermoplastic or thermosetting polymer.

In some cases, the 3D-printed material 50 may be a composite material. More particularly, in some embodiments, the 3D-printed material 50 is fiber-reinforced composite material comprising fibers disposed in a matrix. For instance, in some embodiments, the 3D-printed material 50 may be fiber-reinforced plastic (FRP—a.k.a., fiber-reinforced polymer), comprising a polymeric matrix may include any suitable polymeric resin, such as a thermoplastic or thermosetting resin, like epoxy, polyethylene, polypropylene, acrylic, thermoplastic polyurethane (TPU), polyether ether ketone (PEEK) or other polyaryletherketone (PAEK), polyethylene terephthalate (PET), polyvinyl chloride (PVC), poly(methyl methacrylate) (PMMA), polycarbonate, acrylonitrile butadiene styrene (ABS), nylon, polyimide, polysulfone, polyamide-imide, self-reinforcing polyphenylene, polyester, vinyl ester, vinyl ether, polyurethane, cyanate ester, phenolic resin, etc., a hybrid thermosetting-thermoplastic resin, or any other suitable resin, and fibers such as carbon fibers, glass fibers, polymeric fibers such as aramid fibers (e.g., Kevlar fibers), boron fibers, silicon carbide fibers, metallic fibers, ceramic fibers, etc. In some embodiments, the fibers of the fiber-reinforced composite material 50 may be provided as layers of continuous fibers deposited along with rapidly-curing resin forming the polymeric matrix. In other embodiments, the fibers of the fiber-reinforced composite material 50 may be provided as fragmented (e.g., chopped) fibers dispersed in the polymeric matrix.

In such cases, as it includes the fiber-reinforced composite material 50, the lattice 40 may be 3D-printed using continuous-fiber 3D printing technology. For instance, in some embodiments, this may allow each of one or more of the fibers of the fiber-reinforced composite material 50 to extend along at least a significant part, such as at least a majority (i.e., a majority or an entirety), of a length of the lattice 40 (e.g., monofilament winding). This may enhance the strength, the impact resistance, and/or other properties of the AM component 12ₓ.

In other examples of implementation, the 3D-printed material 50 may include metallic material (e.g., steel such as stainless steel, aluminum, titanium).

In yet other examples of implementation, the 3D-printed material 50 may include ceramic material.

In some embodiments, the material 50 of the lattice 40 may be identical throughout the lattice 40. In other embodiments, the material 50 of the lattice 40 may be different in different parts of the lattice 40. For example, in some embodiments, the material 50 of the lattice 40 at the heel portion 62 of the shell 30 may be different from the material 50 of the portion 803 of the lattice 40 at the medial side portion 66 of the shell 30. In this embodiments, the different materials 50 of the different portions of the lattice 40 are both polymeric materials. In other embodiments, the different materials 50 of the different portions of the lattice 40 may comprise a polymeric material and a metallic material, or a ceramic material and a metallic material, or a polymeric material, a ceramic material and a metallic material.

The AM component 12ₓ of the skate 10 may be designed to have properties of interest in various embodiments, depending on the function of the AM component 12ₓ.

For example, in some embodiments, a stiffness of the AM component 12ₓ may be no more than 800 N/mm, in some cases no more than 600 N/mm , in some cases no more than 400 N/mm, in some cases no more than 200 N/mm, in some cases even less (e.g., no more than 150 N/mm) and/or at least 150 N/mm, in some cases at least 350 N/mm, in some cases at least 550 N/mm, in some cases at least 750 N/mm, and in some cases even more (e.g., at least 800 N/mm), when the AM component 12ₓ is either the blade 26, a given one of the subshells 85₁-85_{L} of the shell 30, or the toe cap 14. The stiffness of the AM component 12ₓ may be measured by a method which depends on the nature of the AM component 12ₓ. For example, when the AM component 12ₓ is the blade 26, the stiffness may be determined by a three-point bending test where a bending load is applied to the AM component 12ₓ, a deflection of the AM component 12ₓ is measured where the bending load is applied, and the bending load is divided by the deflection. In another example, when the AM component 12ₓ is a given one of the subshells 85₁-85_{L} of the shell 30, the stiffness may be determined by a Sharmin test. In another example, when the AM component 12ₓ is the toe cap 14, the stiffness may be determined by a toe compression test. The stiffness of the AM component 12ₓ may be no more than 150 KPa/mm, in some cases no more than 70 KPa/mm , in some cases no more than 7 KPa/mm, in some cases even less (e.g., no more than 4 KPa/mm) and/or at least 4 KPa/mm, in some cases at least 35 KPa/mm, in some cases at least 70 KPa/mm, and in some cases even more (e.g., at least 150 KPa/mm) when the AM component 12ₓ is either the liner 36, the tongue 34, the insole 18 or the footbed 38. In this example, the stiffness of the AM component 12ₓ may be measured by compression test.

As another example, in some embodiments, a resilience of the AM component 12ₓ at least 100 J, in some cases at least 140 J, in some cases at least 150 J, in some cases at least 175 J, in some cases at least 200 J, and in some cases even more (e.g., at least 225), when the AM component 12ₓ is either the blade 26, a given one of the subshells 85₁-85_{L} of the shell 30, or the toe cap 14, in order to resist to impacts with the hockey rink and/or the hockey puck.

As another example, in some embodiments, the AM component 12ₓ may have anisotropic properties even if the material of the AM component 12ₓ is isotropic. That is, mechanical properties of the AM component 12ₓ may vary depending on the direction of the stress. For example, in some embodiments, a stiffness of the AM component 12ₓ may be greater in a longitudinal direction of the skate 10 than in a thicknesswise direction of the skate 10, and in some embodiments, a flexibility of the AM component 12ₓ may be lower in the longitudinal direction of the skate 10 than in the thicknesswise direction of the skate 10. This may be achieved by having a greater number of elongated members 41₁-41_{E} extending in the longitudinal direction of the skate 10 than elongated members 41₁-41_{E} extending in the thicknesswise direction of the skate 10. For example, in some embodiments, a ratio of the number of elongated members 41₁-41_{E} of the AM component 12ₓ extending within 30° of the longitudinal direction of the skate 10 over the number of elongated members 41₁-41_{E} AM component 12ₓ extending within 30° of the thicknesswise direction of the skate 10 may be at least 1.1, in some embodiments 1.5, in some embodiments 2, in some embodiments 4, in some embodiments even more.

In particular, in this embodiment, the AM component 12ₓ may have a maximal stiffness in a first pre-determined direction of the AM component 12ₓ and a minimal stiffness in a second pre-determined direction of the AM component 12ₓ. The first and second pre-determined directions of the AM component 12ₓ may have any suitable relative position. For instance, in some embodiments, the first and second pre-determined directions of the AM component 12ₓ may form an angle between 15° and 30°, in some embodiments between 30° and 45°, in some embodiments between 45° and 60°, in some embodiments in some embodiments between 60° and 75°, in some embodiments between 75° and 90°, in some embodiments about 90°. In some embodiments, a ratio of the maximal stiffness in the first pre-determined direction of the AM component 12ₓ over the minimal stiffness in the second pre-determined direction of the AM component 12ₓ may be at least 2, in some embodiments at least 4, in some embodiments at least 6, in some embodiments at least 10, and in some embodiments even more.

In this embodiment, the AM component 12ₓ may have a maximal flexibility in a third pre-determined direction of the AM component 12ₓ and a minimal flexibility in a fourth pre-determined direction of the AM component 12ₓ. The third and fourth pre-determined directions of the AM component 12ₓ may have any suitable relative position. For instance, in some embodiments, the third and fourth pre-determined directions of the AM component 12ₓ may form an angle between 15° and 30°, in some embodiments between 30° and 45°, in some embodiments between 45° and 60°, in some embodiments in some embodiments between 60° and 75°, in some embodiments between 75° and 90°, in some embodiments about 90°. More particularly, in this embodiment, the third pre-determined direction of the AM component 12ₓ may correspond to the second pre-determined direction of the AM component 12ₓ and the fourth pre-determined direction of the AM component 12ₓ may correspond to the first pre-determined direction of the AM component 12ₓ. In some embodiments, a ratio of the maximal flexibility in the third pre-determined direction of the AM component 12ₓ over the minimal flexibility in the fourth pre-determined direction of the AM component 12ₓ may be at least 2, in some embodiments at least 4, in some embodiments at least 6, in some embodiments at least 10, and in some embodiments even more.

In some embodiments, the lattice 40 may include distinct zones 80₁-80_{Z} that are structurally different from one another. For instance, this may be useful to modulate properties, such as the strength, flex, stiffness, etc., of the zones 80₁-80_{Z} of the lattice 40.

In this embodiment. the distinct zones 80₁-80_{Z} of the lattice 40 of the additively-manufactured component 12ₓ include at least three distinct zones 80₁, 80₂, 80₃. For example, the zones 80₁-80_{Z} of the lattice 40 of the subshell 85ₓ may include a zone 80₁ at the heel portion 62 of the shell 30, a zone 80₂ at the ankle portion 64 of the shell 30, and zones 80₃,80₄ at the medial and lateral side portions 66, 68 of the shell 30.

In this embodiment, delimitations of the zones 80₁-80_{Z} of the lattice 40 are configured to match different parts of the skate 10 which may be subject to different stresses and may require different mechanical properties. Accordingly, the zones 80₁-80_{Z} of the lattice 40 may have different mechanical properties to facilitate skating, to increase power transmission and/or energy transmission from the wearer's foot 11 to the skating surface 13 to the puck during skating, to lighten the skate 10, to increase impact resistance and/or impact protection of the skate 10, to reduce manufacturing costs, and so on.

Mechanical properties of the zones 80₁-80_{Z} of the lattice 40 may be achieved by any suitable means.

For example, in some embodiments, a shape of the unit cells 32₁-32_{c} of each zone 80ᵢ may be pre-determined to increase or diminished the aforementioned mechanical properties.

As another example, in some embodiments, the voxel (or size) of the unit cells 32₁-32_{c} of each zone 80ᵢ may be pre-determined to increase or diminished the aforementioned mechanical properties.

As another example, in some embodiments, a thickness of elongate members 41₁-41_{E} of each zone 80ᵢ may be pre-determined to increase or diminished the aforementioned mechanical properties.

As another example, in some embodiments, the material 50 of each zone 80ᵢ may be pre-determined to increase or diminished the aforementioned mechanical properties.

As such, in some embodiments, the shape of the unit cells 32₁-32_{c} (and thus the shape of the elongate members 41₁-41_{E} and/or nodes 42₁-42_{N}), the voxel (or size) of the unit cells 32₁-32_{c}, a thickness of elongate members 41₁-41_{E} of each zone 80ᵢ, a density of the lattice 40 and/or the material 50 of each zone 80ᵢ may vary between the zones 80₁-80_{z}.

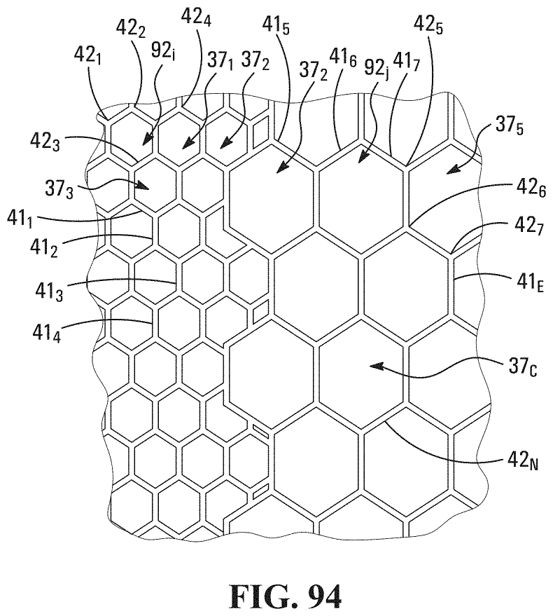

For instance, in some embodiments, adjacent ones of the nodes 42₁-42_{N} in one zone 80ᵢ of the lattice 40 may be closer to one another than adjacent ones of the nodes 42₁-42_{N} in another zone of the lattice 40, as shown in FIGS. 36 and 94, and/or the thickness of the elongate members 41₁-41_{E} and nodes 42₁-42_{N} in one zone 80ᵢ of the lattice 40 may be greater than the thickness of the elongate members 41₁-41_{E} and nodes 42₁-42_{N} in another zone 80ⱼ of the lattice 40, as shown in FIGS. 38 and 95. In other words, in some embodiments, the density of the lattice 40 in a first one of the distinct zones 80₁-80_{Z} is greater than the density of the lattice 40 in a second one of the distinct zones 80₁-80_{Z}. This may be achieved by having a spacing of elongate members 41₁-41_{E} of the lattice 40 in the first one of the distinct zones 80₁-80_{Z} that is less than the spacing of elongate members 41₁-41_{E} of the lattice 40 in the second one of the distinct zones 80₁-80_{Z} of the lattice 40 and/or by having cross-sectionally larger elongate members 41₁-41_{E} in the first one of the distinct zones 80₁-80_{Z} than in the second one of the distinct zones 80₁-80_{Z}. For example, in some embodiments, a ratio of the density of a given one of the zones 80₁-80_{Z} of the lattice 40 over the density of another one of the zones 80₁-80_{Z} of the lattice 40 may be at least 5%, in some embodiments at least 15%, in some embodiments even more.

In some embodiments, also, an orientation of elongate members 41₁-41_{E} of the lattice 40 in the first one of the distinct zones 80₁-80_{Z} may be different from the orientation of elongate members 41₁-41_{E} of the lattice 40 in the second one of the distinct zones 80₁-80_{Z}.

In this embodiment, the distinct zones 80₁-80_{Z} of the lattice 40 differ in stiffness. For example, in some embodiments, a ratio of the stiffness of a given one of the zones 80₁-80_{Z} of the lattice 40 over the stiffness of another one of the zones 80₁-80_{Z} of the lattice 40 may be at least 5%, in some embodiments at least 15%, in some embodiments even more.

The first stiffer one of the distinct zones 80₁-80_{Z} of the lattice 40 may be configured to be located where more force is applied during a skating stride and/or where more power transfer is desired, and the second less stiff one of the distinct zones 80₁-80_{Z} of the lattice 40 may be configured to be located where less force is applied during the skating stride and/or where more comfort is desired.

In this embodiment, the distinct zones 80₁-80_{Z} of the lattice 40 differ in resilience. For example, in some embodiments, a ratio of the resilience of a given one of the zones 80₁-80_{Z} of the lattice 40 over the resilience of another one of the zones 80₁-80_{Z} of the lattice 40 may be at least 5%, in some embodiments at least 15%, in some embodiments even more.

In this embodiment, a material composition of the lattice 40 in the first one of the distinct zones 80₁-80_{Z} is different from the material composition of the lattice 40 in the second one of the distinct zones 80₁-80_{Z}.

Examples of the additively-manufactured components 12₁-12_{A} constituting one or more parts of the skate boot 22 and/or one or more parts of the skating device 28 in various embodiments are discussed below.

In this embodiment, the shell 30 of the skate boot 22 comprises at least part of a given one of the AM components 12₁-12_{A}. The AM components 12₁-12_{A} may allow the shell 30 to be customizable and to have desired comfort and stiffness properties over different zones of the wearer's foot 11.

In this embodiment, the liner 36 of the skate boot 22 comprises at least part of the additively-manufactured components 12₁-12_{A}. The pads, including the ankle pad, of the skate boot 22, disposed between the shell 30 and the liner 36, may also comprise at least part of the AM components 12₁-12A. The AM components 12₁-12_{A} may allow the liner 36 and the pads to fit to the wearer's foot 11 and to provide desired comfort and stiffness over different zones of the wearer's foot 11.

In this embodiment, the tongue 34 of the skate boot 22 comprises at least part of the additively-manufactured components 12₁-12_{A}. The AM components 12₁-12_{A} may allow the tongue 34 to be relatively lightweight, yet to provide high protection against flying puck. For example, the tongue 34 may have an increased protection by having an increased thickness while having a diminished weight relative to a traditional tongue (i.e. without AM components). For example, in some embodiments, a ratio of the thickness of the tongue 34 over a thickness of a traditional tongue may be at least 1.05, in some embodiments at least 1.1, in some embodiments at least 1.2, in some embodiments at least 1.5, in some embodiments at least 2, in some embodiments even more.

In this embodiment, the facings 31₁, 31₂ of the skate boot 22 comprises at least part of the additively-manufactured components 12₁-12_{A}. The AM components 12₁-12_{A} may allow the facings 31₁, 31₂ to be lightweight, durable, at relatively stiff. Additionally, the AM components 12₁-12_{A} may allow the facings 31₁, 31₂ to be customizable and to have desired comfort and stiffness properties over different portions of the wearer's foot 11. The positioning, number and shape of the eyelets 461-46E, and shape of the facings 31₁, 31₂, may also be customizable for the wearer specific needs.

In this embodiment, the tendon guard 63 of the skate boot 22 comprises at least part of the additively-manufactured components 12₁-12_{A}. The AM components 12₁-12_{A} may allow the tendon guard 63 to be lightweight, to have an enhanced comfort while effectively protecting the Achilles' tendon of the wearer's foot. For example, the tendon guard 63 may have an inner surface for facing the wearer's Achilles' tendon that is less stiff and less hard than an outer surface of the tendon guard 63 facing away from the inner surface. As another example, the tendon guard 63 of the skate boot 22 may be integrally made with the shell 30 and the tendon guard 63 may thus be free of an attachment portion with the shell 30, resulting in enhanced comfort. As another example, the tendon guard 63 may have any desired stiffness and may provide suitable protection to the wearer's foot 11 while being substantially less stiff than the shell 30. For example, in some embodiments, a ratio of the stiffness of the tendon guard 63 over the stiffness of the shell 30 may be no more than 0.95, in some embodiments no more than 0.9, in some embodiments no more than 0.8, in some embodiments no more than 0.7, in some embodiments no more than 0.6, in some embodiments no more than 0.5, and in some embodiments even less.

In this embodiment, the toe cap 14 of the skate boot 22 comprises at least part of the additively-manufactured components 12₁-12_{A}. The AM components 12₁-12_{A} may allow the toe cap 14 to be lightweight while still offering a suitable protection. For example, the toe cap 14 may comprise a lattice 40 having elongated members 41₁-41_{E} arranged to increase stiffness and hardness of the toe cap 14 in a direction normal to its surface while diminishing the weight of the toe cap 14. This may be achieved by having a greater number of elongated members 41₁-41_{E} extending in the direction normal to the outer surface of the toe cap 14 than elongated members 41₁-41_{E} extending in other directions. For example, a ratio of the weight of the toe cap 14 over a weight of a traditional toe cap (i.e. without AM components) may be no more than 0.95, in some embodiments no more than 0.9, in some embodiments no more than 0.8, in some embodiments no more than 0.7, in some embodiments no more than 0.6, in some embodiments no more than 0.5, and in some embodiments even less. Additionally, the AM components 12₁-12_{A} may allow the toe cap 14 to be customizable and to have desired comfort and stiffness properties over different zones of the wearer's foot 11. For example, inner dimensions of the toe cap 11 may be customizable to improve fit, performance and comfort of the toe cap 11.

In this embodiment, each one of the insole 18 and the footbed 38 of the skate 10 comprises at least part of the additively-manufactured components 12₁-12_{A}. The AM components 12₁-12_{A} may allow the insole 18 and the footbed 38 to fit to the wearer's foot 11 and to provide desired comfort and stiffness over different zones of the wearer's foot 11.

In some embodiments, the skate 10 comprises an outsole 39 disposed between the shell 30 and the blade holder 24 to enhance stiffness, power transmission between the wearer's foot 11 and the blade holder 24, and to increase durability. The outsole 39 may comprise at least part of the additively-manufactured components 12₁-12_{A}. The AM components 12₁-12_{A} may allow the outsole 39 to be lighter and stiffer, or lighter and softer, to further enhance power transmission between the wearer's foot 11 and the blade holder 24 and/or to enhance comfort and customability.

In this embodiment, the blade holder 24 comprises at least part of the additively-manufactured components 12₁-12_{A}. More specifically, the base 164 and the support 168 of the blade holder 24 each comprises at least part of distinct ones of the additively-manufactured components 12₁-12A. The AM components 12₁-12_{A} may allow the base 164 and the support 168 of the blade holder 24 to have an increased stiffness and a diminished weight. Notably, the blade holder 24 may enhance power transmission between the wearer's foot 11 and the blade 26. Additionally, the AM components 12₁-12_{A} may allow designs (e.g. shapes, dimensions) of the base 164 and the support 168 which either: require complex manufacturing tools and/or manufacturing operations to manufacture traditionally; or are impossible to manufacture traditionally. For example, the AM components 12₁-12_{A} may comprise internal voids, undercuts restrictions, etc., which would be complex or impossible to manufacture traditionally. In this embodiment, also, the AM components 12₁-12_{A} may allow the base 164 and the support 168 to integrate mechanisms (e.g. the blade-detachment mechanism 55) without making separate components.

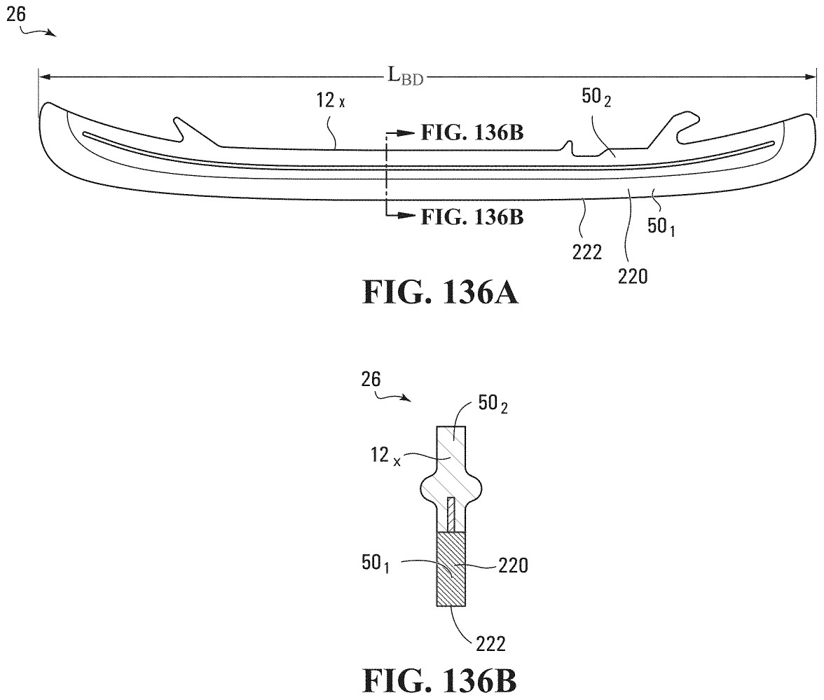

In this embodiment, the blade 26 comprises at least part of the additively-manufactured components 12₁-12_{A}. In this example, the blade 26 is removable (i.e. detachable) from the blade holder 24 and, as such, the additively-manufactured components 12₁-12_{A} of the skate 10 may be movable relative to one another. More specifically, AM components 12₁-12_{A} may comprise 3D-printed metallic material 501 constituting at least an ice-contacting surface of the blade 26. The 3D-printed metallic material 501 may constitute at least a majority of the blade 26. In this embodiment, the -printed metallic material 501 constitutes an entirety of the blade, as shown in FIGS. 135A and 135B. In other embodiments, the AM components 12₁-12_{A} may further comprise a 3D-printed polymeric material 502 (e.g. comprising 3D-printed fiber-reinforced composite material) constituting at least part of the blade 26 and connected to the 3D-printed metallic material 501, as shown in FIGS. 136A and 136B. With additional reference to FIGS. 135A and 135B, the AM components 12₁-12_{A} may allow the blade 26 to be lightweight while preserving its hardness, stiffness and durability. For instance, the blade 26 may comprise internal cells 125₁-125_{C} that do not comprise any 3D-printed material and that may be filled with air in areas where local stresses are typically lower in order to diminish weight of the blade 26. In this example, the internal cells 125₁-125_{C} may be viewed as internal “voids” which would be complex or impossible to manufacture traditionally.

The skate 10 may be implemented in any other suitable manner in other embodiments.

For example, in some embodiments, each one of the heel portion 62, the ankle portion 64, the medial and lateral side portions 66, 68, and the sole portion 69 of the shell 30 may comprise a distinct one of the additively-manufactured components 12₁-12_{A} such that the heel portion 62, the ankle portion 64, the medial and lateral side portions 66, 68, and the sole portion 69 are connected to one another to form the shell 30. In this embodiment, the subshells 85₁-85ₛ are the heel portion 62, the ankle portion 64, the medial and lateral side portions 66, 68, and the sole portion 69 of the shell 30 rather than layers forming the shell 30. Each one of the subshells 85₁-85ₛ may comprise distinct zones 80₁-80_{Z} that are structurally different from one another to modulate properties, such as the strength, flex, stiffness, etc., of the zones 80₁-80_{Z} of the lattice 40. For example, in this embodiment, the distinct zones 80₁-80_{Z} of the additively-manufactured components 12₁-12_{A} are layers of the additively-manufactured component that layered on one another. In this embodiment, a distal (i.e. outer) zone 85a of the additively-manufactured component 12ₓ may be stiffer than a proximal (i.e. inner) zone 85ₚ of the additively-manufactured component 12ₓ.

As another example, in some embodiments, the AM component 12ₓ may be at least part (i.e. may be part but not constitute an entirety or may constitute an entirety) of two or more of: the subshells 85₁-85_{L} of the shell 30, the tendon guard 63, the toe cap 14, the facings 31₁, 31₂, the liner 36, the tongue 34, the insole 18, the footbed 38, the blade 26, the lower portion 162 of the blade holder 24 and the support 168 of the blade holder 24.

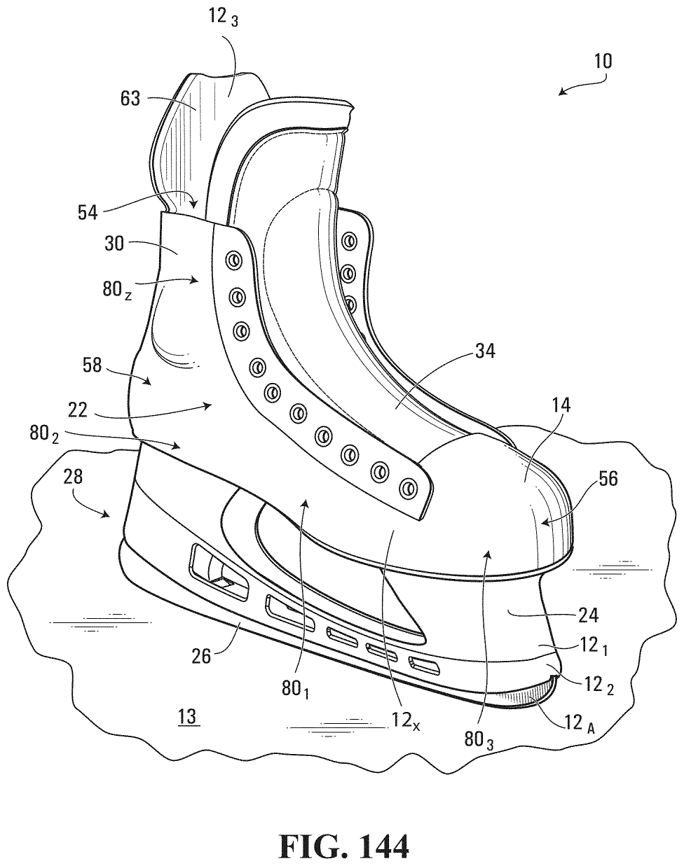

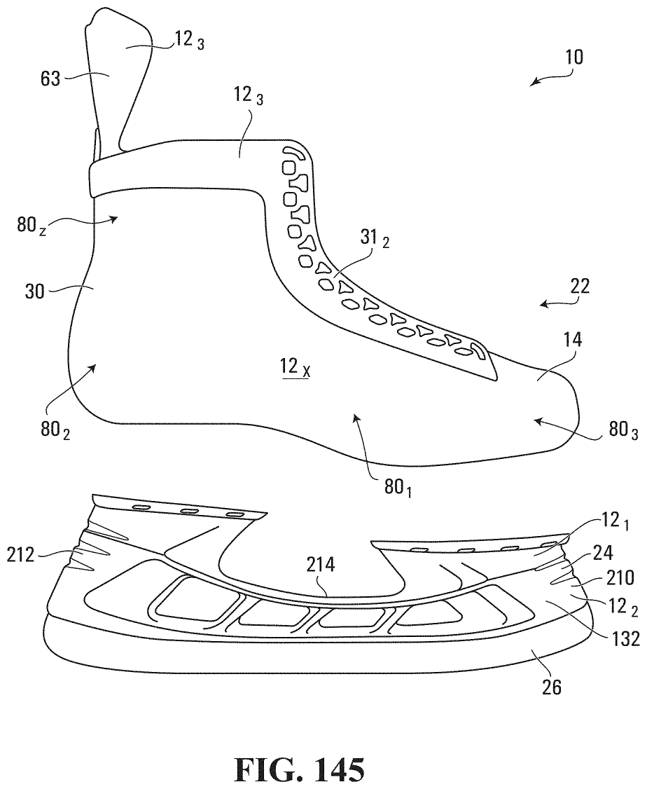

For instance, in some cases, as shown in FIGS. 144 and 145, the subshells 85₁-85_{L} of the shell 30 and the toe cap 14 may be formed of the same AM component 12ₓ. That is, the shell 30 and the toe cap may be a one-piece AM component 12ₓ. In this example, the shell 30 still comprises the distinct zones 80₁-80_{Z} that are structurally different from one another to modulate properties.

In some cases, the lower portion 162 of the blade holder 24 and the support 168 of the blade holder 24 may be formed of the same AM component 12ₓ. That is, the blade holder 24 may be a one-piece AM component 12ₓ connected to the skate boot comprising or being connected to a blade attachment mechanism of the blade holder 24. In this example, the blade holder 24 still comprises the distinct zones 80₁-80_{Z} that are structurally different from one another to modulate properties.

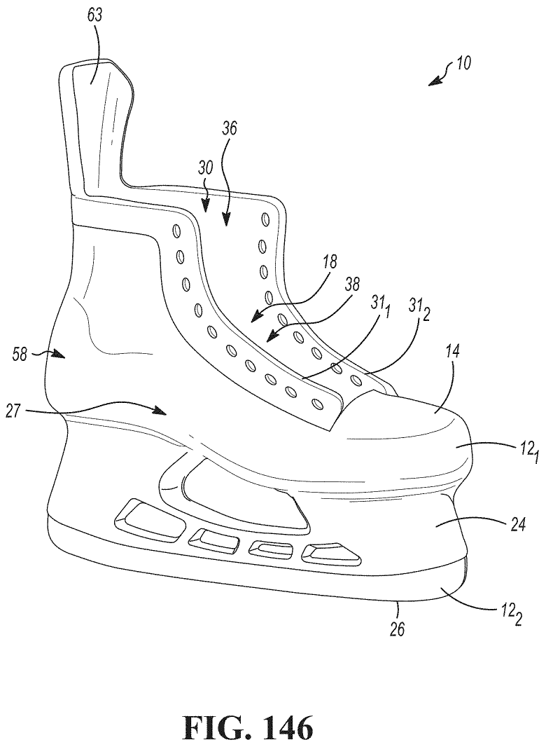

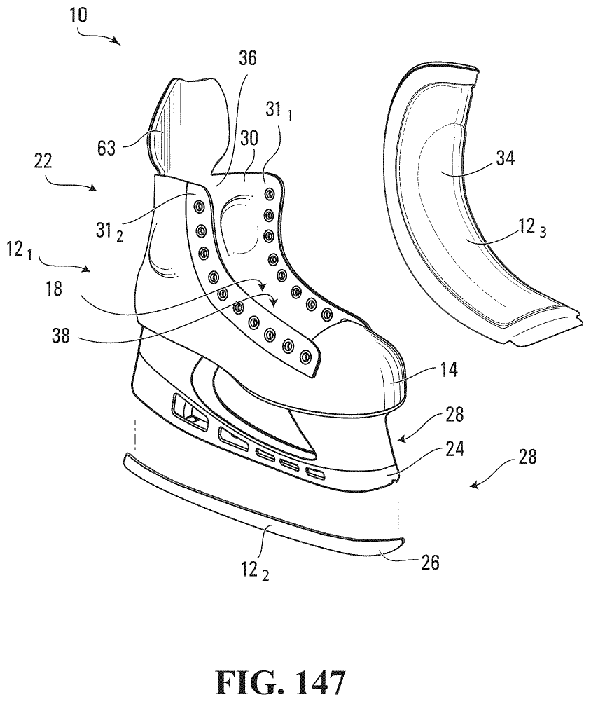

In some cases, as shown in FIGS. 146 to 148, the subshells 85₁-85_{L} of the shell 30, the tendon guard 63, the toe cap 14, the facings 31₁, 312, the liner 36, the insole 18, the footbed 38, the lower portion 162 of the blade holder 24 and the support 168 of the blade holder 24 are made of a single AM component 12ₓ. That is, the shell 30, the tendon guard 63, the toe cap 14, the facings 31₁, 31₂, the liner 36, the insole 18, the footbed 38, the lower portion 162 of the blade holder 24 and the support 168 of the blade holder 24 may be a one-piece AM component 12ₓ. In this example, the one-piece AM component 12ₓ still comprises the distinct zones 80₁-80_{z} that are structurally different from one another to modulate properties.

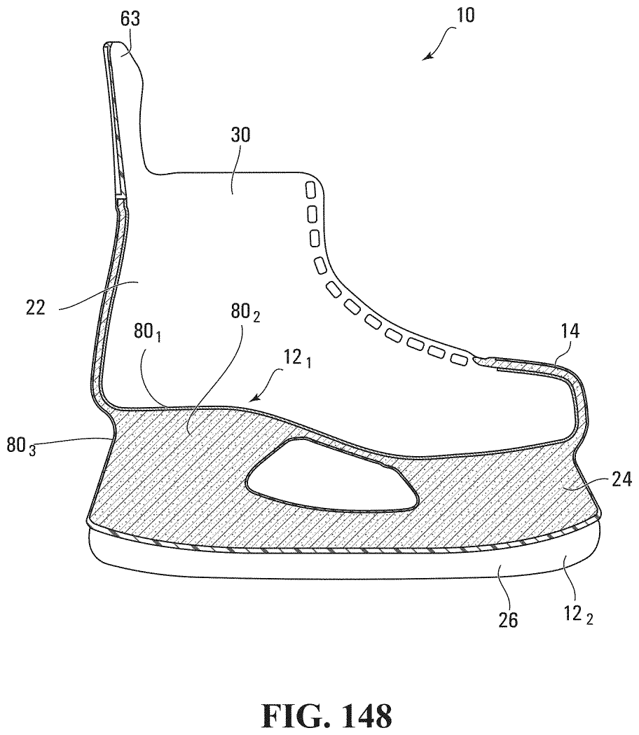

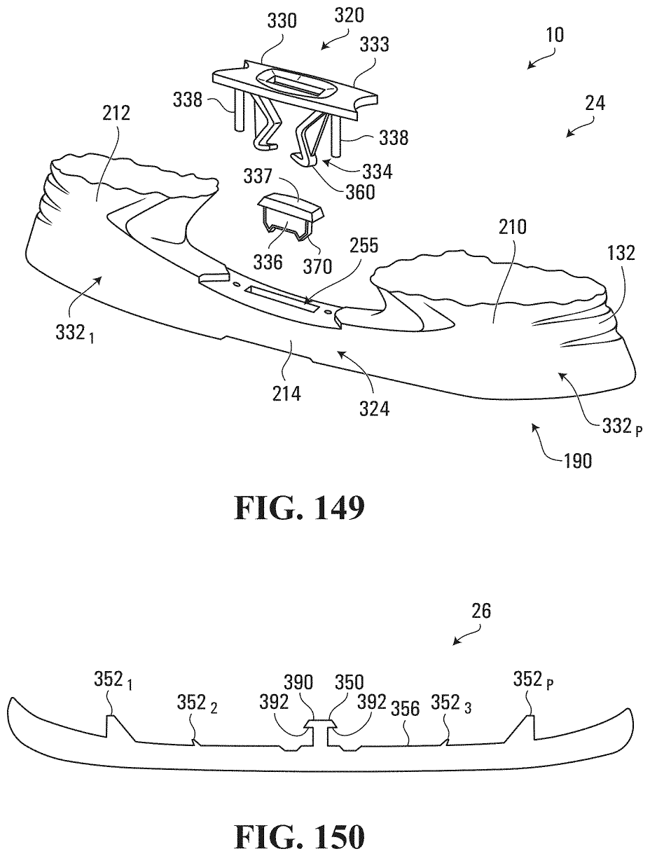

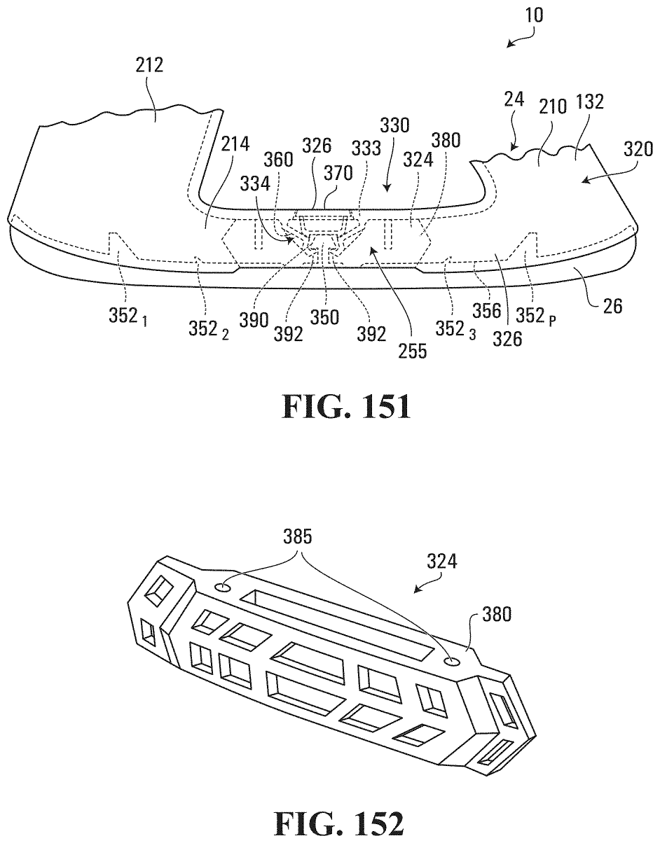

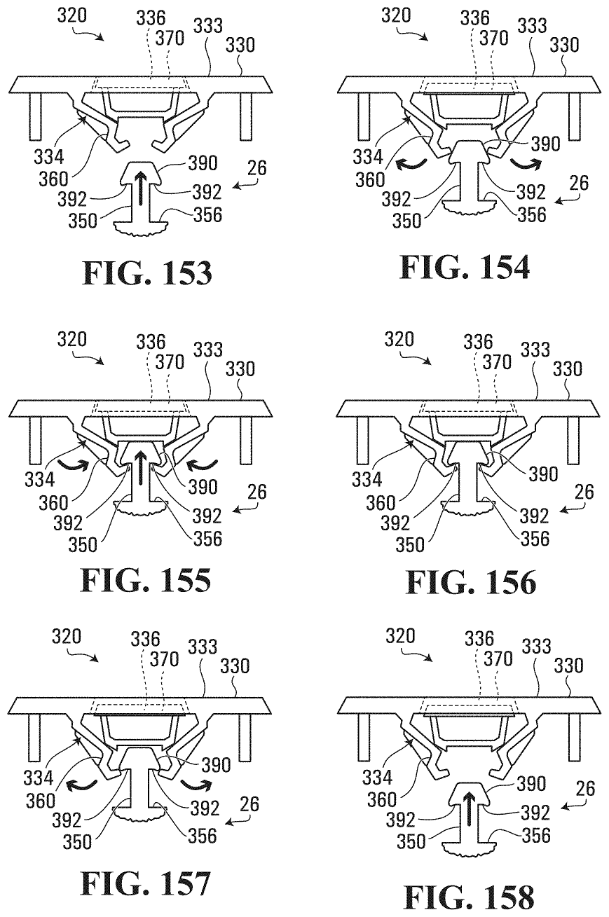

As another example, in some embodiments, with additional reference to FIGS. 148 to 159, the blade holder 24 comprises a connection system 320 configured to attach the blade 26 to and detach the blade 26 from the blade holder 24. The connection system 320 facilitates installation and removal of the blade 26, such as for replacement of the blade 26, assemblage of the skate 10, and/or other purposes.

More particularly, in this embodiment, the connection system 320 of the blade holder 24 is a quick-connect system configured to attach the blade 26 to and detach the blade 26 from the blade holder 24 quickly and easily.

Notably, in this embodiment, the quick-connect system 320 of the blade holder 24 is configured to attach the blade 26 to and detach the blade 26 from the blade holder 24 without using a screwdriver when the blade 26 is positioned in the blade holder 24. In this example, the quick-connect system 320 is configured to attach the blade 26 to and detach the blade 26 from the blade holder 24 screwlessly (i.e., without using any screws) when the blade 26 is positioned in the blade holder 24. It is noted that although the quick-connect system 320 is configured to attach the blade 26 to and detach the blade 26 from the blade holder 24 screwlessly, the quick-connect system 320 may comprise screws that are not used (i.e. manipulated) for attachment or detachment of the blade 26. Thus, in this embodiment, the quick-connect system 320 is configured to attach the blade 26 to and detach the blade 26 from the blade holder 24 without using a screwdriver and screwlessly when the blade 26 is positioned in the longitudinal recess 190 of the blade holder 24.

In this example, the quick-connect system 320 of the blade holder 24 is configured to attach the blade 26 to and detach the blade 26 from the blade holder 24 toollessly (i.e., manually without using any tool) when the blade 26 is positioned in the blade holder 24. That is, the blade 24 is attachable to and detachable from the blade holder 24 manually without using any tool (i.e., a screwdriver or any other tool). Thus, in this example, the quick-connect system 320 is configured to attach the blade 26 to and detach the blade 26 from the blade holder 24 toollessly when the blade 26 is positioned in the longitudinal recess 190 of the blade holder 24.

In this embodiment, the quick-connect system 320 of the blade holder 24 comprises a plurality of connectors 330, 332₁-332_{P} to attach the blade 26 to and detach the blade 26 from the blade holder 24. The blade 26 comprises a plurality of connectors 350, 352₁-352_{P} configured to engage respective ones of the connectors 330, 332₁-332_{P} of the quick-connect system 320 of the blade holder 24 to be attached to and detached from the blade holder 24. The connectors 330, 332₁-332_{P} of the quick-connect system 320 of the blade holder 24 are spaced apart in the longitudinal direction of the skate 10, and so are the connectors 350, 352₁-352_{P} of the blade 26.

In this embodiment, the connectors 330, 350 of the quick-connect system 320 of the blade holder 24 and the blade 26 are configured to preclude the blade 26 from moving in a distal direction, i.e., away from the blade holder 24, when the blade 26 is attached to the blade holder 24, and the connector 330 of the quick-connect system 320 of the blade holder 24 is disposed between the pillars 210, 212 of the blade holder 24. In order to be connectable with the connector 330 of the quick-connect system 320 of the blade holder 24, in some embodiments, the connector 350 of the blade 26 may be disposed within 30% of a length L_{BL} of the blade 26 from a longitudinal center C_{BL} of the blade 26, in some embodiments within 20% of the length L_{BL} of the longitudinal center C_{BL}, in some embodiments within 10% of the length L_{BL} of the longitudinal center C_{BL}, in some embodiments within 5% of the length L_{BL} of the longitudinal center C_{BL}, in some embodiments at the longitudinal center C_{BL}.

In this example, the connector 330 of the quick-connect system 320 of the blade holder 24 is movable relative to the body 132 of the blade holder 24 to attach the blade 26 to and detach the blade 26 from the blade holder 24. That is, at least part of the connector 330 is configured to move relative to the body 132 of the blade holder 24 (e.g., be displaced in relation to or disconnected from the body 132 of the blade holder 24) while attaching the blade 26 to and detaching the blade 26 from the blade holder 24 to allow attachment and detachment of the blade 26.

In particular, in this embodiment, the connector 330 of the quick-connect system 320 remains connected to the body 132 of the blade holder 24 while at least partly moving relative to the body 132 of the blade holder 24 to attach the blade 26 to and detach the blade 26 from the blade holder 24. In this embodiment, the connector 330 of the quick-connect system 320 is threadless (i.e., without any thread required to attach the blade to the blade holder).

The connector 330 of the quick-connect system 320 may comprise a base 333 for affixing the connector 330 to the body 132 of the blade holder 24 and for connecting parts of the connector 330.

The connector 330 of the quick-connect system 320 may comprise a resilient portion 334 configured to resiliently deform (i.e., resiliently change in configuration from a first configuration to a second configuration in response to a load and to revert to the first configuration in response to the load ceasing to be applied) to allow the connector 330 to move relative to the body 132 of the blade holder 24 to attach the blade 26 to and detach the blade 26 from the blade holder 24. More specifically, in this example, the resilient portion 334 of the connector 330 of the quick-connect system 320 is configured to bias the connector 330 in a position to attach the blade 26 to the blade holder 24. The resilient portion 334 of the connector 330 of the quick-connect system 320 is also configured to exert a spring force during attachment of the blade 26 to and detachment of the blade 26 from the blade holder 24 and to resiliently deform when the blade 26 is placed in the blade holder 24 to attach the blade 26 to the blade holder 24 and when the blade 26 is removed from the blade holder 24 to detach the blade 26 from the blade holder 24. As such, at least part of the resilient portion 334 may be considered to form a clip configured to attach the blade 26 to the blade holder 24 by gripping, clasping, hooking or otherwise clipping a portion of the blade 26.

In this embodiment, the connector 330 of the quick-connect system 320 comprises a hand-engaging actuator 336 configured to be manually operated to move part of the connector 330 of the quick-connect system 320 relative to the body 132 of the blade holder 24. The hand-engaging actuator 336 of the connector 330 may be configured to be manually operated by manually pushing thereon. More specifically, the hand-engaging actuator 336 of the connector 330 may comprise a button 370. The base 333 may thus be viewed as a “button cage” as it receives and keeps the button 370 captive.

In this embodiment, the button 370 may have a width W_{B} and a length L_{B} allowing the quick-connect system 320 to be ensure that an impact between the blade holder 24 and a flying hockey puck would not eject any component (e.g., the button 370) from the blade holder 24. For instance, in some embodiments, the width W_{B} of the button 370 may be between 0.25 inch and 1 inch, in some embodiments about 0.5 inch, while in some embodiments the length L_{B} of the button 370 may be between 0.25 inch and 2 inches, in some embodiments between 0.75 inch and 1.5 inch, and in some embodiments about 1 inch. Thus, the hand-engaging actuator 336 may have a hand-engaging actuating surface 337 that is greater, therefore allowing the user to actuate the hand-engaging actuator 336 using a smaller pressure, thereby facilitating the use of the hand-engaging actuator. For example, in this embodiment, the hand-engaging surface 33 occupies at least a majority of a width of a cross-section of the blade holder 24 normal to the longitudinal direction of the blade holder 24 where the hand-engaging surface 337 is located. For instance, the hand-engaging surface 337 may occupy at least 60%, in some cases at least 70%, and in some cases at least 80% of the width of the cross-section of the blade holder 24 normal to the longitudinal direction of the blade holder 24 where the hand-engaging surface 337 is located. For example, in some embodiments, the hand-engaging actuating surface 337 may be of at least 0.0625 in², in some embodiments of at least 0.125 in², in some embodiments of at least 0.5 in², in some embodiments of at least 1 in², in some embodiments of at least 2 in², in some embodiments even more.

In this embodiment, the quick-connect system 320 comprises a frame 324 affixed to or integrally made with the body 132 of the blade holder 24 and supporting the connector 330 of the quick-connect system 320. For instance, in some cases, at least part of the frame 324 is fastened to the body 132 of the blade holder 24 by at least one fastener, such as a screw, a bolt, or any other threaded fastener, an adhesive, or any other fastener. In some cases, at least part of the body 132 of the blade holder 24 is manufactured over the frame 324. In some base, the frame 324 and the body 132 of the blade holder 24 are additively manufactured and form a one-piece additively manufactured component. The frame 324 may be concealed by material of the body 132 of the blade holder 24. In some cases, the frame 324 may comprise two apertures 385 and the base 333 may comprise two posts 338 extending through the apertures 385 of the frame 324 and secured to the frame 324 by any suitable means, for instance using screws or bolts, thereby affixing the base 333 to the frame 324.

In this embodiment, the connector 350 of the blade 26 comprises a connecting projection 390 projecting from an upper surface 356 of the blade 26. The connecting projection 390 of the blade 26 comprises two hooks 392. Each hook 392 is configured to engage the connector 330 of the blade holder 24 to hold the blade 26 and comprises an upper end 394 configured to enlarge the resilient portion 330 of the connector 330 while the blade 26 is being attached to the blade holder 24. For instance, in this embodiment, the upper end 394 of the projection 390 defines a width of the projection 390 progressively diminishing as the projection 390 projects from the upper surface 356 of the blade 26.

In this embodiment, the connectors 332₁-332_{P} of the blade holder 24 are voids of pre-determined shapes and the connectors 352₁-352_{P} of the blade 26 are projections projecting from the upper surface 356 of the blade 26 to engage the voids 332₁-332_{P} and stabilize the blade 26 in longitudinal and widthwise directions of the skate 10.

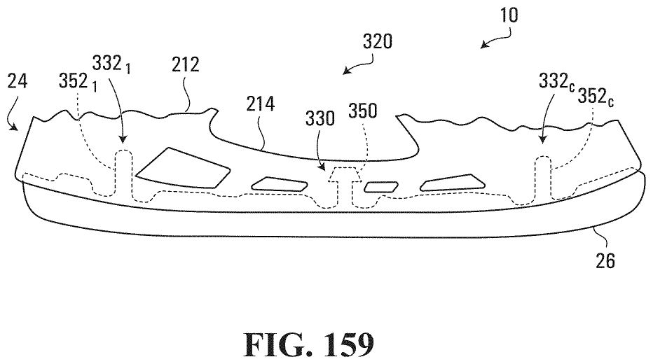

In this embodiment, the quick-connect system 320 is configured such that the blade 26 is attachable to and detachable from the blade holder 24 by a single translation of the blade 26 relative to the blade holder 24 in a heightwise direction of the skate. In other words, the quick-connect system 320 may be configured such that the blade 26 is attachable to and detachable from the blade holder 24 without rotating the blade 26 relative to the blade holder 24. Although this may be achieved by having connectors 352₁-352_{c} of the blade 26 having edges that may be oblique relative to a longitudinal direction of the blade 26, as shown in FIG. 150, in some embodiments, the connectors 352₁-352_{c} of the blade 26 may project from the blade 26 in a straight manner and perpendicularly relative to the longitudinal direction of the blade 26, as shown in FIG. 159.

In other embodiments, the connectors 332₁-332_{P} of the blade holder 24 are structurally substantially similar to the connector 330 of the blade holder 24 and the connectors 352₁-352_{P} of the blade 26 are structurally substantially similar to the connector 350 of the blade 26.

In particular, in this embodiment, the connector 330, the hand-engaging actuator 336 and the frame 324 of the quick-connect system 320 and the body 132 of the blade holder 24 comprise AM components 12₁-12_{A}. More specifically, at least one of the connector 330, the hand-engaging actuator 336 and the frame 324 of the quick-connect system 320, and the body 132 of the blade holder 24 may be made by additive manufacturing. For example, in some cases, the frame 324 of the quick-connect system 320 may be integrally made, i.e. made of the same AM component 12ₓ, with the body 132 of the blade holder 24. In this embodiment, each one of the connector 330, the hand-engaging actuator 336 and the frame 324 of the quick-connect system 320 and the body 132 of the blade holder 24 comprises at least part of AM components 12₁-12_{A}.

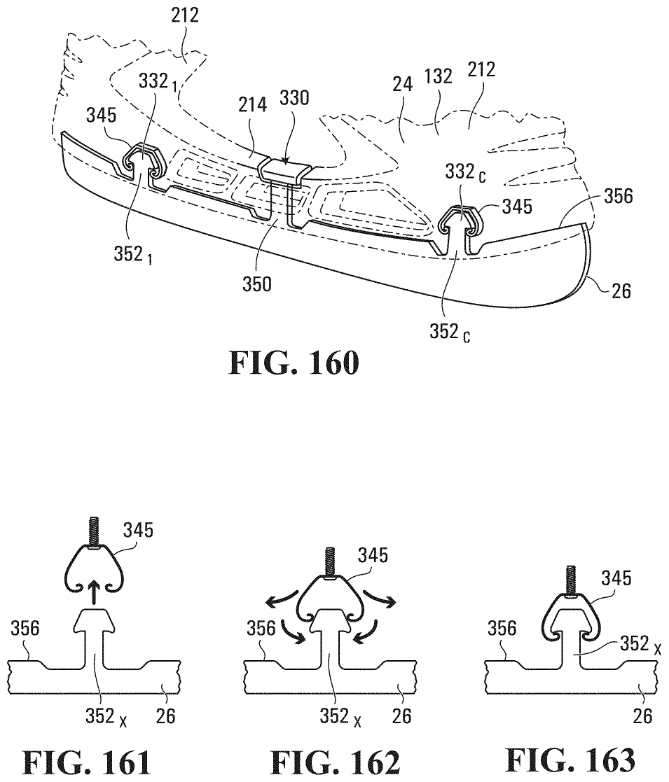

In other embodiments, as shown in FIGS. 160 to 163, the connectors 352₁-352_{P} of the blade 26 comprises two hooks to engage the connectors 332₁-332_{P} of the blade holder 24, each comprising a clip 345. Each clip 345 may be made of the same AM component 12ₓ than that of the body 132 of the blade holder 24 such that the clip 345 is configured to retain a given one of the connectors 352₁-352_{c} of the blade 26 from being attached to or detached from the clip 345, but when an attaching or detaching force exceeds a pre-determined threshold, the clip 345 resiliently deforms to allow the given one of the connectors 352₁-352_{c} of the blade 26 to be attached to or detached from the clip 345 and returns to its original shape after the attachment or detachment.

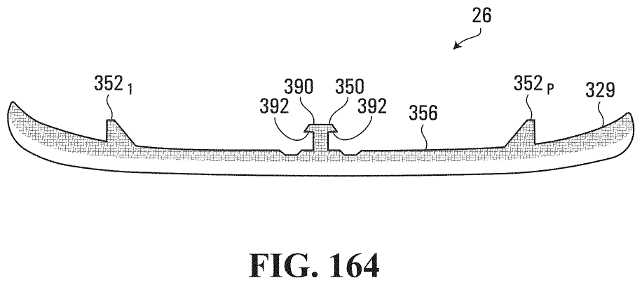

With additional reference to FIG. 164, in some embodiments, the upper portion of the blade 26 may comprise a silkscreen 329 that may serve as a visual indicator of the adjustment and alignment of the blade 26 relative to the blade holder 24 to ease attachment of the blade 26 to the blade holder 24.

In some embodiments, a lower portion of the blade 26 may also comprise the silkscreen 329, for example as a visual indicator of the use and condition of the blade 26. For instance, when the blade 26 is used for play, it needs to be sharpened and sharpening of the blade 26 reduces height of the blade 26 and the ice-contacting surface 222 of the blade 26 gets closer to the upper portion of the blade 26. In this example, the silkscreen 329 may comprise a mark indicating that the blade 26 needs to be changed for a new blade when the ice-contacting surface 222 meets the mark.

In some embodiments, the silkscreen 329 may be three-dimensional. As such, the silkscreen 329 may help reducing lateral movements of the blade 26 relative to the blade holder 24 and reduce loss of energy caused by these movements. For instance, the silkscreen 329 may comprise a material of the blade 26. In other cases, the silkscreen 329 may comprise a material that is softer and/or less rigid than the material of the blade 26, for instance aluminum or polymeric material. In some cases, the polymeric material may comprise an adhesive material.

More specifically, in this embodiment, the silkscreen 329 is additively manufactured and may be part of the AM component 12ₓ.

As another example, in some embodiments, the skate 10 may be an “intelligent” skate 10. That is, the skate 10 may comprise sensors 280₁-280ₛ to sense a force acting on the skate, a position, a speed, an acceleration and/or a deformation of the skate 10 during play or during a testing (e.g. of hockey sticks, of players, etc.). More particularly, in this embodiment, the lattice 40 comprises the sensors 280₁-280ₛ. More specifically, in this embodiment, the sensors 280₁-280ₛ are associated with an additively-manufactured component of the lattice 40.

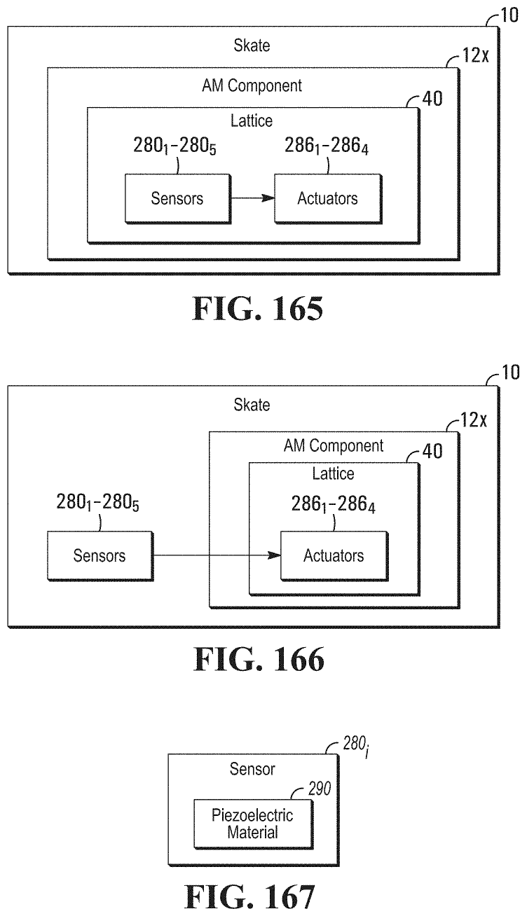

Further, in some embodiments, as shown in FIGS. 165 and 166, the skate 10 may comprise actuators 286₁-286_{A}. Specifically, the actuators 286₁-286_{A} may be associated with at least some of sensors 280₁-280ₛ and may be configured to respond to a signal of the sensors 280₁-280ₛ. In particular, the sensors 280₁-280ₛ (which may be disposed in the lattice 40, as shown in FIG. 165, or out of the AM component 12ₓ, as shown in FIG. 166) may be responsive to an event (e.g. an increase in acceleration of the skate 10, an increase of a force acting on the skate 10, an increase of the deformation of the skate 10, etc.) to cause the actuators 286₁-286_{A} to alter the additively-manufactured component to alter the lattice 40 (e.g. to increase resilience, to increase stiffness, etc.).

Practically, in this embodiment, this may be achieved using piezoelectric material 290 implementing the sensors 280₁-280s, the piezoelectric material 290 being comprised in the additively-manufactured component of the lattice 40, as shown in FIG. 167.

As another example, in some embodiments, more or less of the skate 10 may be latticed as discussed above.

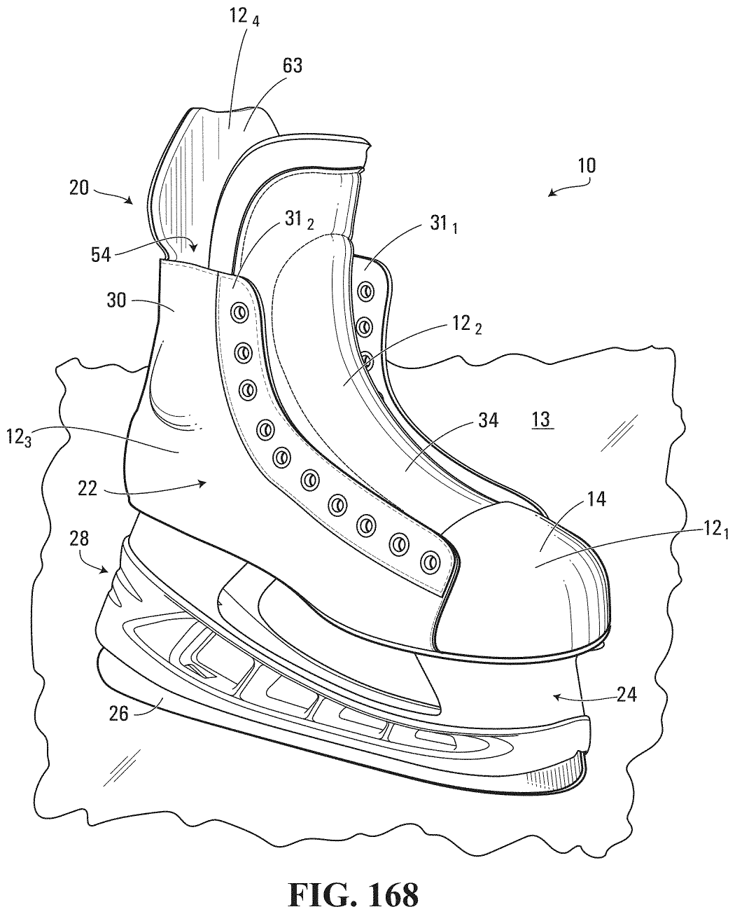

In some embodiments, as shown in FIG. 168, the lattice 40 may constitute at least part (e.g., occupy at least a majority, i.e., a majority or an entirety) of the skate boot 22, but not constitute any part of the blade holder 24 and/or the blade 26. That is, the skate boot 22 may include AM components 12₁-12_{A}, while the blade holder 24 and/or the blade 26 may not include any AM components 12₁-12_{A}.

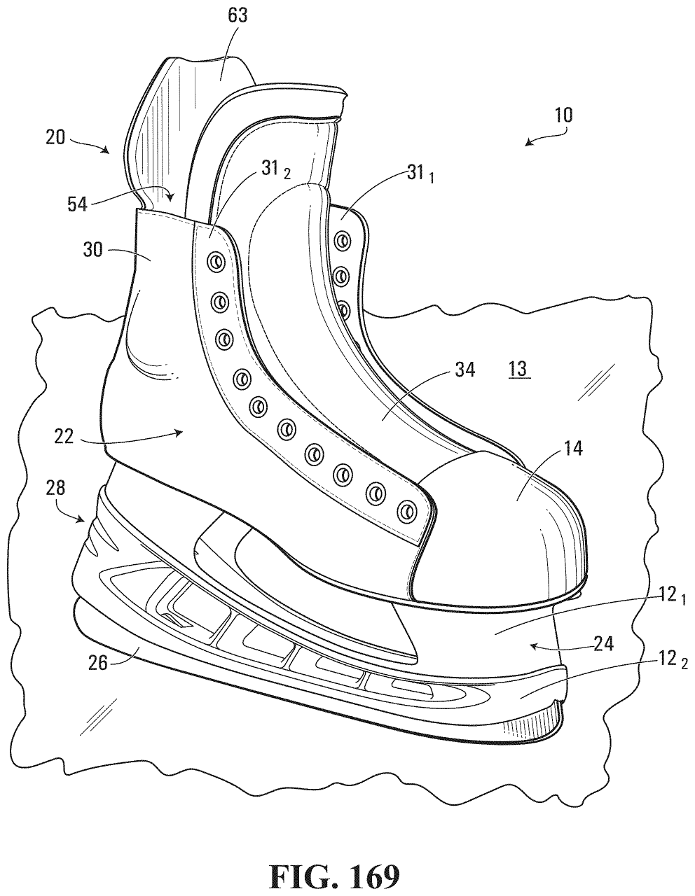

In another example, in some embodiments, as shown in FIG. 169, the lattice 40 may constitute at least part (e.g., occupy at least a majority, i.e., a majority or an entirety) of the blade holder 24, but not constitute any part of the skate boot 22 and/or the blade 26.

That is, the blade holder 24 may include AM components 12₁-12_{A}, while the skate boot 22 and/or the blade 26 may not include any AM components 12₁-12_{A}.

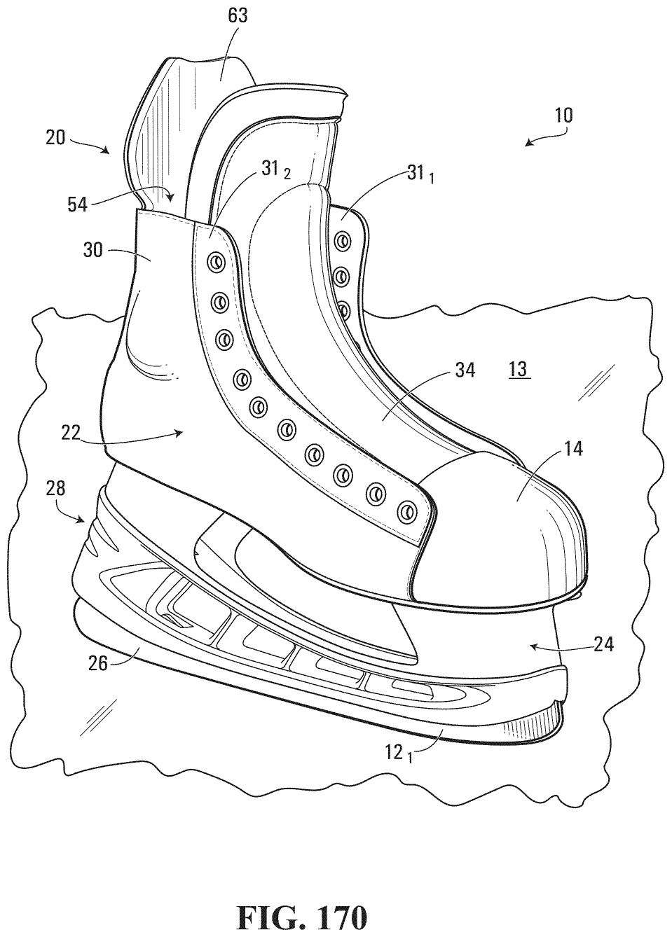

In another example, in some embodiments, as shown in FIG. 170, the lattice 40 may constitute at least part (e.g., occupy at least a majority, i.e., a majority or an entirety) of the blade 26, but not constitute any part of the skate boot 22 and/or blade holder 24. That is, the blade 26 may include AM components 12₁-12_{A}, while the skate boot 22 and/or blade holder 24 may not include any AM components 12₁-12_{A}.

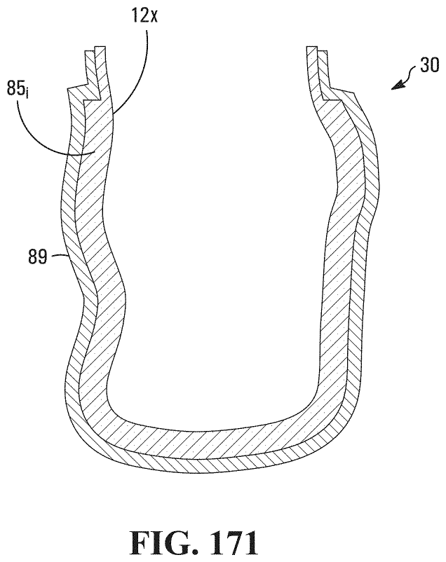

In some embodiments, the skate 10 may comprise one or more AM components 12₁-12_{A}, instead of or in addition to the latticed AM components. That is, the lattice 40 is one example of an additively-manufactured component in embodiments where it is 3D-printed. Such one or more additively-manufactured components of the skate 10 may be 3D-printed as discussed above, using any suitable 3D-printing technology, similar to what was discussed above in relation to the lattice 40 in embodiments where the lattice 40 is 3D-printed. The skate 10 may comprise the lattice 40, which may or may not be additively-manufactured, or may not have any lattice in embodiments where the skate 10 comprises such one or more additively-manufactured components. For example, in some embodiments, as shown in FIG. 171, the AM components 12₁-12_{A} may comprise a non-lattice member 89 connected to the lattice 40. The non-lattice member 89 may configured to be positioned between the lattice and the user when the skate is worn. In this case, the non-lattice member is a thin member thinner than the lattice. In other case, the non-lattice member may be bulkier than the lattice. More specifically, in this embodiment, the non-lattice member 89 is a covering that covers at least part of the lattice and constitutes at least part of a surface of the additively-manufactured component. The covering 89 may be clear (i.e. translucent), while in other embodiments the covering 89 may be opaque.

In other embodiments, the covering 89 may be apart from the AM components 12₁-12_{A}, i.e., may not be part of any AM components 12ₓ. For instance, the covering 89 may cover part of the skate boot 22 and/or the blade holder 24 by being applied over the skate boot 22 and/or the blade holder 24 in any suitable way. In some cases, the covering 89 may be provided as a polymeric sheet that is folded or wrapped over the skate boot 22 and/or the blade holder 24, while in other cases the covering 89 may be sprayed or injection molded around the skate boot 22 and/or the blade holder 24 to protect skate boot 22 and/or the blade holder 24 from premature wear and/or to protect graphical elements displayed by the skate boot 22 and/or the blade holder 24.

In some embodiments, also, the method of manufacture, the materials and the structure of each additively-manufactured component of the skate 10 may differ.

Although in embodiments considered above the skate 10 is designed for playing ice hockey on the skating surface 13 which is ice, in other embodiments, the skate 10 may be constructed using principles described herein for playing roller hockey or another type of hockey (e.g., field or street hockey) on the skating surface 13 which is a dry surface (e.g., a polymeric, concrete, wooden, or turf playing surface or any other dry surface on which roller hockey or field or street hockey is played). Thus, in other embodiments, instead of comprising the blade 26, the skating device 28 may comprise a set of wheels to roll on the dry skating surface 13 (i.e., the skate 10 may be an inline skate or other roller skate).

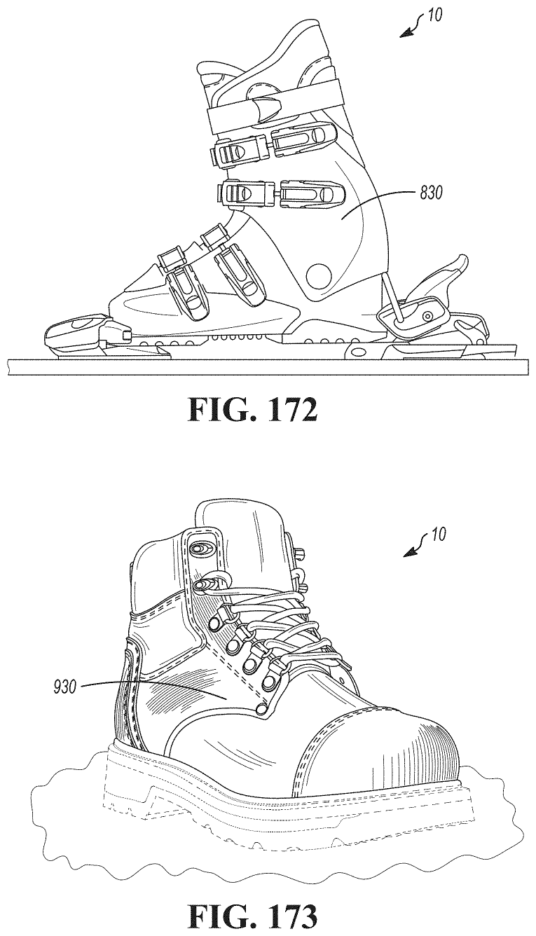

Furthermore, although in embodiments considered above the footwear 10 is a skate for skating on the skating surface 13, in other embodiments, the footwear 10 may be any other suitable type of footwear. For example, as shown in FIG. 172, the footwear 10 may be a ski boot comprising a shell 830 which may be constructed in the manner described above with respect to the shell of the skate. In particular, the ski boot 10 is configured to be attachable and detachable from a ski 802 which is configured to travel on a ground surface 8 (e.g., snow). To that end, the ski boot 10 is configured to interact with an attachment mechanism of a ski. In some embodiments, an AM component may constitute at least part of a liner disposed between the shell 830 and the user's foot for comfort and/or shock absorption. In some embodiments, the AM component of the ski boot 10 may be a post-AM expandable component constructed using principles described herein in respect of the post-AM expandable component 512_{X}.

In another example, as shown in FIG. 173, the footwear 10 may be a boot (e.g., a work boot or any other type of boot) comprising a shell 930 which can be constructed in the manner described above with respect to the shell of the skate. In some embodiments, an AM component may constitute at least part of a liner disposed between the shell 930 and the user's foot for comfort and/or shock absorption. In some embodiments, the AM component of the boot 10 may be a post-AM expandable component constructed using principles described herein in respect of the post-AM expandable component 512_{X}.

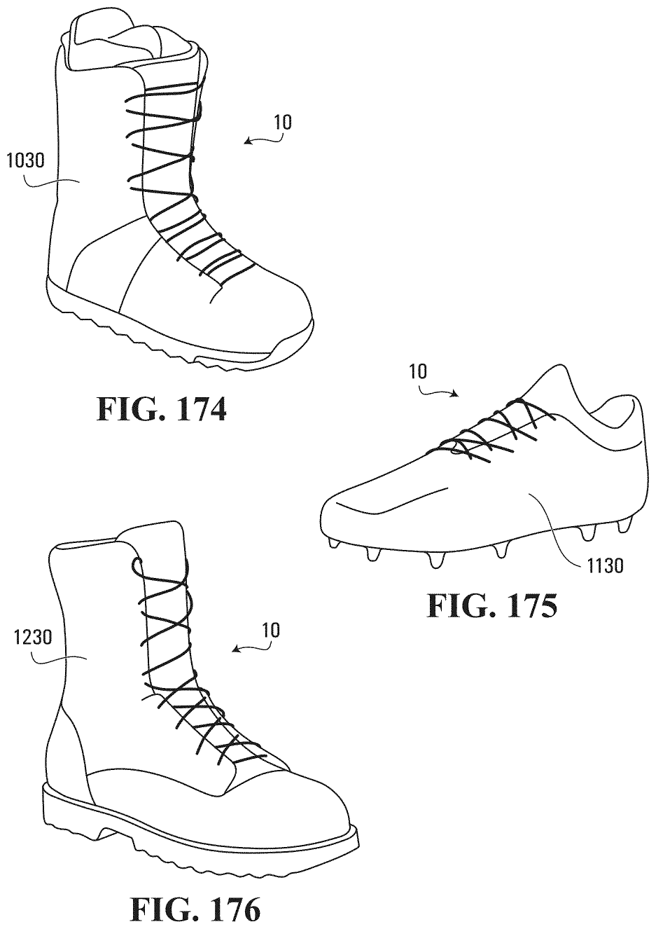

In another example, as shown in FIG. 174, the footwear 10 may be a snowboard boot comprising a shell 1030 which can be constructed in the manner described above with respect to the shell of the skate. In some embodiments, an AM component may constitute at least part of a liner disposed between the shell 1030 and the user's foot for comfort and/or shock absorption. In some embodiments, the AM component of the snowboard boot 10 may be a post-AM expandable component constructed using principles described herein in respect of the post-AM expandable component 512_{X}.

In another example, as shown in FIG. 175, the footwear 10 may be a sport cleat comprising a shell 1130 which can be constructed in the manner described above with respect to the shell of the skate. In some embodiments, an AM component may constitute at least part of a liner disposed between the shell 1130 and the user's foot for comfort and/or shock absorption. In some embodiments, the AM component of the sport cleat 10 may be a post-AM expandable component constructed using principles described herein in respect of the post-AM expandable component 512_{X}.

In another example, as shown in FIG. 176, the footwear 10 may be a hunting boot comprising a shell 1230 which can be constructed in the manner described above with respect to the shell of the skate. In some embodiments, an AM component may constitute at least part of a liner disposed between the shell 1230 and the user's foot for comfort and/or shock absorption. In some embodiments, the AM component of the hunting boot 10 may be a post-AM expandable component constructed using principles described herein in respect of the post-AM expandable component 512_{X}.

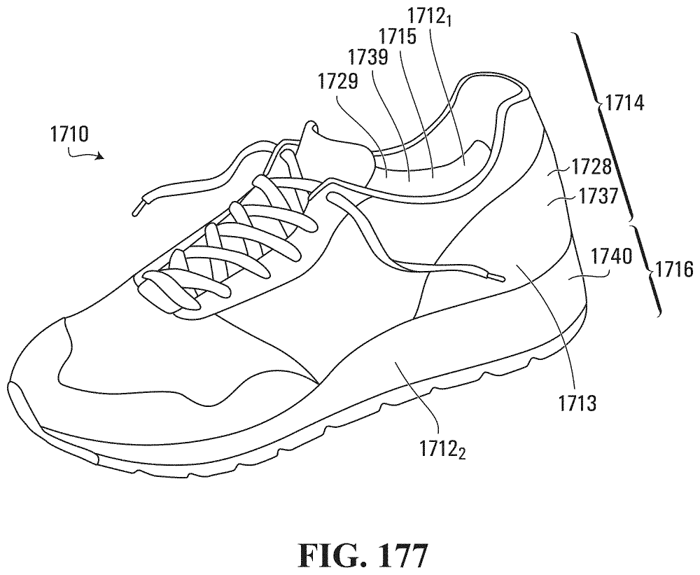

In another example, as shown in FIG. 177, the footwear may be a shoe 1710 comprising an upper portion 1714 and a lower potion 1716. The upper portion 1714 of the shoe 1710 comprises an outer portion 1737 comprising an outer surface 1728 of the shoe 1710 and an inner portion 1739 comprising an inner surface 1729 of the shoe 1710. The outer portion 1737 comprises an outer cover 1713 and the inner portion 1739 comprises an AM component 1712₁ constituting at least part of a liner 1715. The liner 1715 may be disposed between the outer cover 1713 and the user's foot for comfort and/or shock absorption. The lower portion 1716 of the shoe 1710 comprises an outer sole 1740. In some embodiments, in addition to or instead of the AM component 17121 constituting at least part of the liner 1715, the shoe 1710 may also or instead comprise an AM component 1712₂ constituting at least part of the outsole 1740 of the shoe 1710. In some embodiments, either or both of the AM components 1712₁ and 1712₂ of the shoe 1710 may be a post-AM expandable component constructed using principles described herein in respect of the post-AM expandable component 512_{X}.

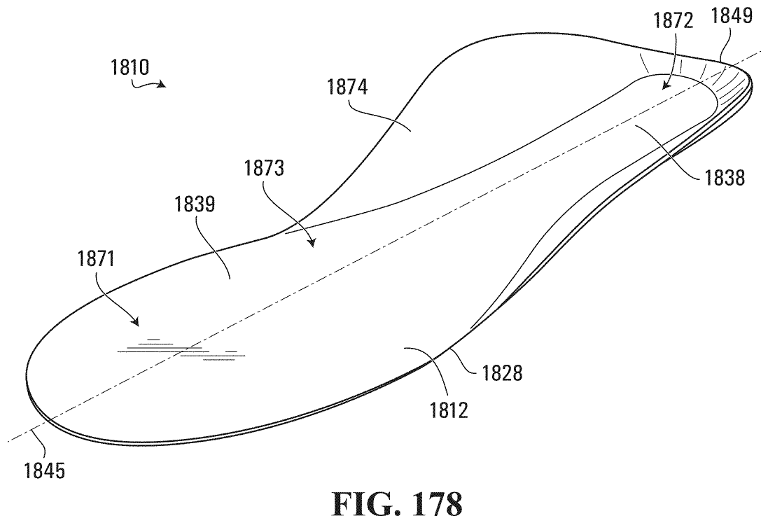

As another example, in some embodiments, as shown in FIG. 178, a footbed 1810 wearable on a user's foot while the user's foot is in a cavity of footwear (e.g., a skate, a ski boot, a shoe, etc.) may comprise an AM component 1812 that may be constructed according to principles discussed herein in respect of the post-AM expandable component 512_{X}. The footbed 1810 comprises an inner surface 1839 for facing the user's foot and an outer surface 1828 opposite to the inner surface 1839. In this embodiment, the footbed 1810 is elongated such that it has a longitudinal axis 1845 defining a longitudinal direction of the footbed 1810 and comprises a forefoot portion 1871, a hindfoot portion 1872, and a midfoot portion 1873 to respectively engage the user's forefoot, hindfoot and midfoot. The inner surface 1839 of the footbed 1810 comprises a plantar surface 1838 for engaging the plantar surface of the user's foot when the user's foot is received on the footbed 1810. In this embodiment, the footbed 1810 comprises a wall 1849 projecting upwardly from the plantar surface 1838. In this example, the wall 1849 is configured to turn about the user's heel and face part of the medial side and part of the lateral side of the user's foot. The wall 1849 includes an arched portion 1874 that projects upwardly from the plantar surface 1838 for engaging the arch of the user's foot.

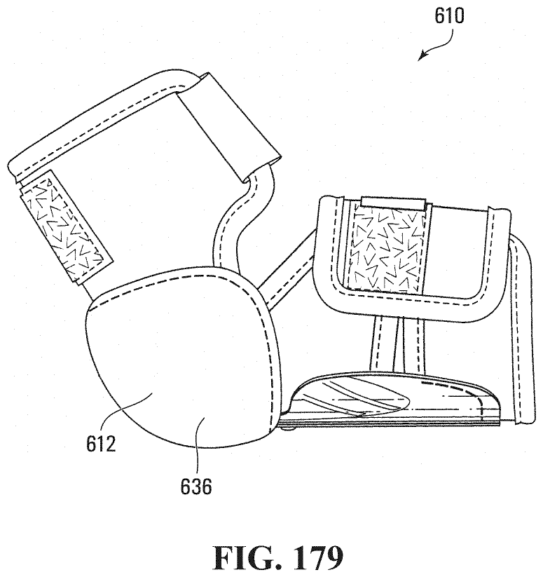

As another example, in some embodiments, as shown in FIG. 179, the article comprising an AM component may be an article of protective athletic gear other than a helmet, such as an arm guard (e.g., an elbow pad) for protecting an arm (e.g., an elbow) of a user. More particularly, in this embodiment the arm guard 610 comprises a post-AM expandable component 612 that may be constructed using principles described herein in respect of the post-AM expandable component 512_{X} and constituting a pad 636 of the arm guard 610.

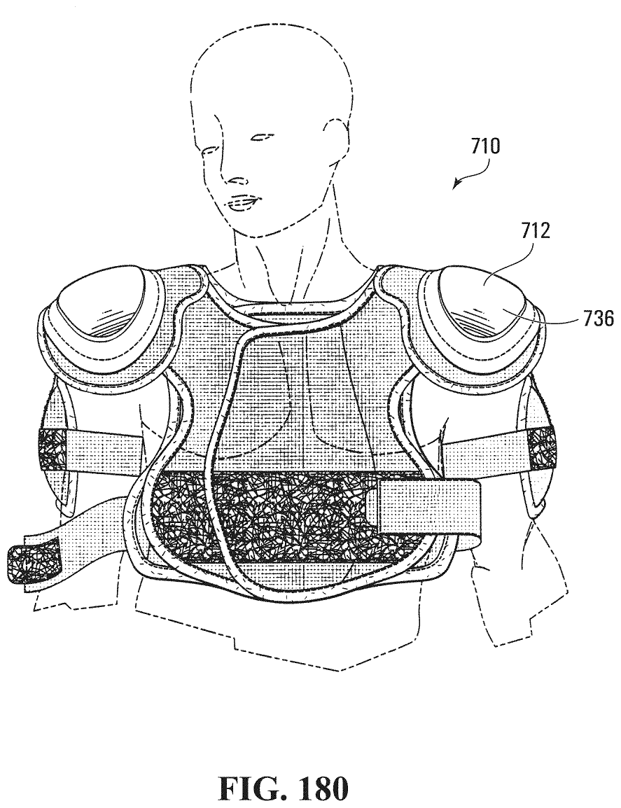

As another example, in some embodiments, as shown in FIG. 180, the article of protective athletic gear may be shoulder pads 710 for protecting an upper torso (e.g., shoulders and a chest) of a user, in which the shoulder pads 710 comprise a post-AM expandable component 712 that may be constructed using principles described herein in respect of the post-AM expandable component 512_{X} and constituting a pad 736 of the shoulder pads 710.

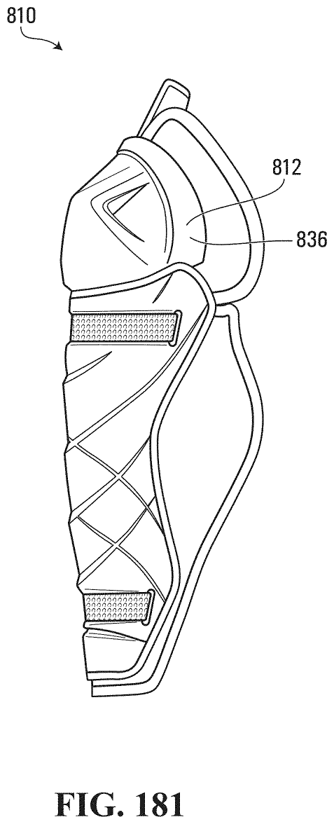

As another example, in some embodiments, as shown in FIG. 181, the article of protective athletic gear may be a leg guard 810 for protecting a leg of a user, in which the leg guard 810 comprises a post-AM expandable component 812 that may be constructed using principles described herein in respect of the post-AM expandable component 512_{X} and constituting a pad 836 of the leg guard 810.

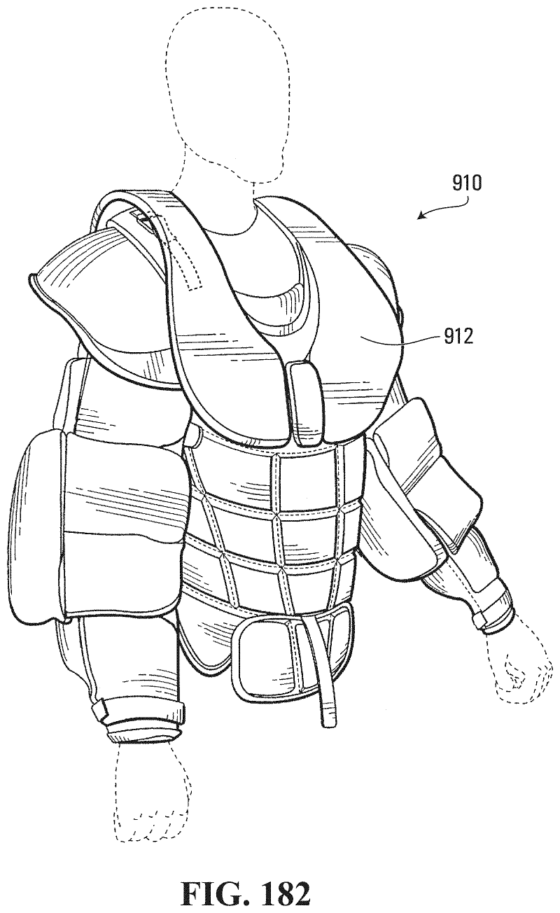

In some cases, with additional reference to FIGS. 182 to 184, the article of protective athletic gear may be for a hockey goalie. For example, as shown in FIG. 182, the article of protective athletic gear may be a chest protector 910 for a goalie for protecting the goalie's torso and arms. For example, the chest protector 910 may comprise a post-AM expandable component 912 that may be constructed using principles described herein in respect of the post-AM expandable component 512_{X}. The post-AM expandable component 912 may constitute any portion of the chest protector 910 (e.g., a chest portion, an upper arm portion, a lower arm portion, an abdominal portion, etc.).

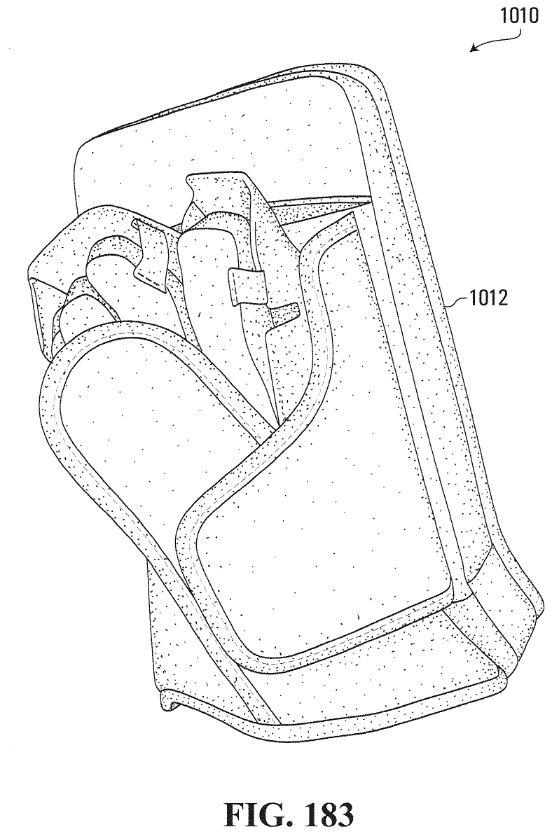

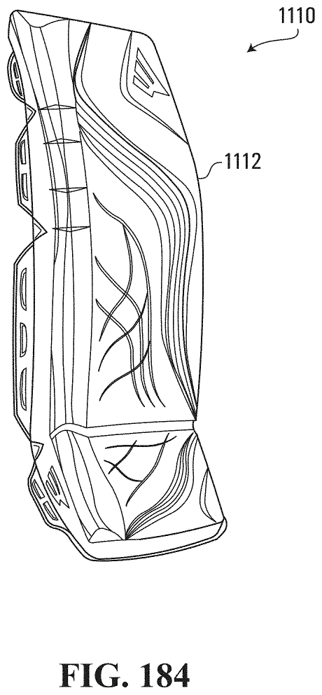

As another example, as shown in FIG. 183, the article of protective athletic gear may be a blocker glove 1010 for a goalie for protecting the goalie's hand and deflecting a puck or ball. In this example, the blocker glove 1010 comprises a post-AM expandable component 1012 that may be constructed using principles described herein in respect of the post-AM expandable component 512_{X}. For example, the post-AM expandable component 1012 may constitute a board portion of the blocker glove 1010 which the goalie uses to deflect pucks or balls.

As yet another example, as shown in FIG. 184, the article of protective athletic gear may be a leg pad 1110 for a goalie for protecting a leg and knee of the goalie. In this example, the leg pad 1110 comprises a post-AM expandable component 1112 that may be constructed using principles described herein in respect of the post-AM expandable component 512_{X}. For example, the post-AM expandable component 1112 may constitute a padding portion of the leg pad 1110 that is disposed underneath an outer cover of the leg pad 1110. In other examples, the post-AM expandable component 1112 may be an outermost layer of the leg pad 1110 such that an object (e.g., a puck or ball) impacting the leg pad 1110 impacts the post-AM expandable component 1112 directly.

Although in embodiments considered above the article of athletic gear is hockey lacrosse, or baseball/softball gear, in other embodiments, the article of athletic gear may be any other article of athletic gear usable by a player playing another type of contact sport (e.g., a “full-contact” sport) in which there are significant impact forces on the player due to player-to-player and/or player-to-object contact or any other type of sports, including athletic activities other than contact sports. For example, in other embodiments, the article of athletic gear may be an article of football gear for a football player, an article of soccer gear for a soccer player, etc.

In other embodiments, a device comprising one or more post-AM expandable components constructed using principles described herein in respect of the post-AM expandable component 512_{X} may be anything other than an article of athletic gear and may thus be designed for any suitable purpose. For example, this may include blunt trauma personal protective equipment (PPE), social distancing PPE such as face masks or shields, insulating components, surf boards, swimming boards, automotive bumpers, motocross gear, cushioning devices, etc.

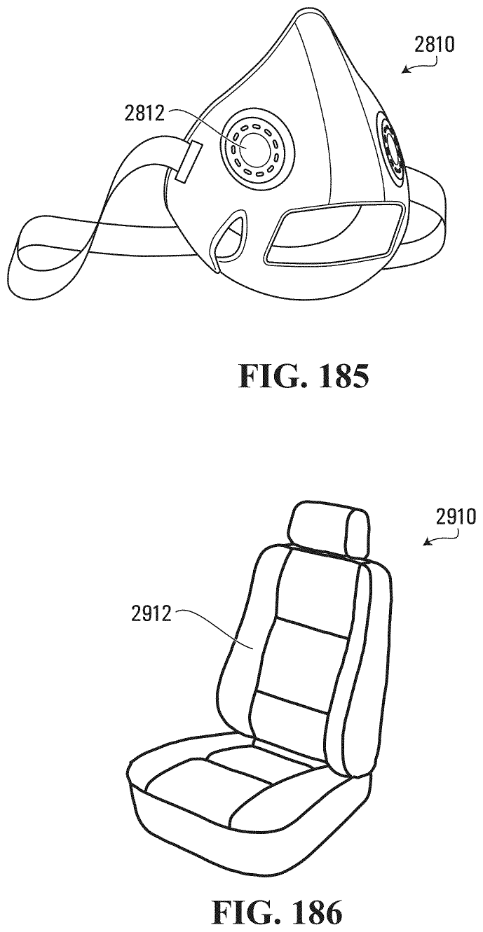

For example, in some embodiments, as shown in FIG. 185, the article comprising an AM component may be an article of personal protective equipment, such as a face mask 2810 for protecting a user. More particularly, in this embodiment the face mask 2810 comprises a post-AM expandable component 2812 that may be constructed using principles described herein in respect of the post-AM expandable component 512_{X}. For example, an article of PPE may include an AM component that constitutes a padding element, a filter element, an adjustability element, etc. The customizability provided by additive manufacturing techniques may provide for better fit solutions that provide better protection. For example, a customized mask could be additively manufactured based on a facial scan of a user's face to provide a customized fit that is more comfortable and provides a better seal to the user's face than a generic face mask.

As another example, in some embodiments, as shown in FIG. 186, the article comprising an AM component is not necessarily a wearable item, and may instead be another functional item, such as a seat assembly 2910 for a vehicle. More particularly, in this embodiment the seat assembly 2910 is for an automotive vehicle, in which the seat assembly comprises a post-AM expandable component 2912 that may be constructed using principles described herein in respect of the post-AM expandable component 512_{X}. For example, the post-AM expandable component 2912 may constitute a pad of the seat assembly 2910.

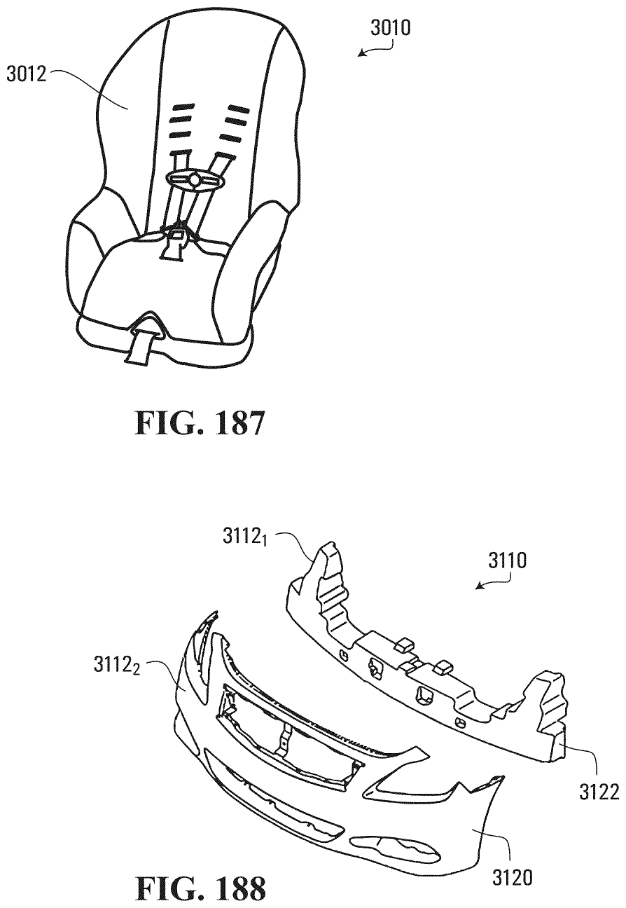

As another example, in some embodiments, as shown in FIG. 187, the article comprising an AM component may be a child's car seat assembly 3010, in which the seat assembly 3010 comprises a post-AM expandable component 3012 that may be constructed using principles described herein in respect of the post-AM expandable component 512_{X}. For example, the post-AM expandable component 3012 may constitute a pad of the seat assembly 3010.

As another example, in some embodiments, as shown in FIG. 188, the article comprising an AM component may be a bumper assembly 3110 for a vehicle. More particularly, in this embodiment the bumper assembly 3110 comprises an outer shell 3120 and an inner energy absorbing component 3122. In the illustrated embodiment, the inner energy absorbing component 3122 comprises an AM component 31121. In some embodiments, in addition to or instead of the AM component 3112₁ constituting at least part of the inner energy absorbing component 3122, the bumper assembly 3110 may also or instead comprise an AM component 3112₂ constituting at least part of the outer shell 3120. In some embodiments, either or both of the AM components 3112₁ and 3112₂ of the bumper assembly 3110 may be a post-AM expandable component constructed using principles described herein in respect of the post-AM expandable component 512_{X}.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

In case of any discrepancy, inconsistency, or other difference between terms used herein and terms used in any document incorporated by reference herein, meanings of the terms used herein are to prevail and be used.

Although various embodiments and examples have been presented, this was for purposes of describing, but should not be limiting. Various modifications and enhancements will become apparent to those of ordinary skill and are within a scope of this disclosure.

1. A component for an article, the component comprising 3D-printed expandable material expanded after being 3D printed via binder jetting, wherein:
the 3D-printed expandable material is 3D-printed into an initial shape via binder jetting and expanded to an expanded shape that is a scaled-up version of the initial shape and that defines the component;
the 3D-printed expandable material comprises an expansion agent that is expandable in response to heat; and
a temperature of the 3D-printed expandable material during 3D printing into the initial shape via binder jetting is lower than an expansion temperature of the expansion agent.

2. The component of claim 1, comprising a 3D-printed lattice including at least part of the 3D-printed expandable material.

3. The component of claim 2, comprising a 3D-printed non-lattice member including at least part of the 3D-printed expandable material and connected to the 3D-printed lattice.

4. The component of claim 2, wherein the 3D-printed lattice includes distinct zones that are structurally different.

5. The component of claim 1, wherein the 3D-printed expandable material comprises a polymeric substance and the expansion agent.

6. The component of claim 5, wherein the polymeric substance is a binding agent used to 3D print the expandable material into the initial shape via binder jetting.

7. The component of claim 6, wherein the component is more shock-absorbent than if the component had been made entirely of the expansion agent and lighter than if the component had been made entirely of the polymeric substance.

8. The component of claim 6, wherein the expansion agent comprises expandable microspheres.

9. The component of claim 1, wherein the 3D-printed expandable material is expanded to the expanded shape a plurality of hours after being 3D printed into the initial shape.

10. A method of making a component of an article, the method comprising:
providing expandable material, the expandable material comprising an expansion agent that is expandable in response to heat;
3D printing the expandable material to create 3D-printed expandable material, wherein 3D printing the expandable material comprises 3D printing the expandable material into an initial shape via binder jetting; and
expanding the 3D-printed expandable material to define the component, wherein expanding the 3D-printed expandable material comprises expanding the 3D-printed expandable material from the initial shape to an expanded shape that is a scaled-up version of the initial shape and that defines the component, and wherein a temperature of the expandable material during 3D printing into the initial shape via binder jetting is lower than an expansion temperature of the expansion agent.

11. The method of claim 10, wherein the component comprises a 3D-printed lattice including at least part of the 3D-printed expandable material.

12. The method of claim 11, wherein the component comprises a 3D-printed non-lattice member including at least part of the 3D-printed expandable material and connected to the 3D-printed lattice.

13. The method of claim 11, wherein the 3D-printed lattice includes distinct zones that are structurally different.

14. The method of claim 10, wherein the expandable material comprises a polymeric substance and the expansion agent.

15. The component of claim 14, wherein the polymeric substance is a binding agent used to 3D print the expandable material into the initial shape via binder jetting.

16. The method of claim 15, wherein the component is more shock-absorbent than if the component had been made entirely of the expansion agent and lighter than if the component had been made entirely of the polymeric substance.

17. The method of claim 15, wherein the expansion agent comprises expandable microspheres.

18. The method of claim 10, wherein the 3D-printed expandable material is expanded to the expanded shape a plurality of hours after being 3D printed into the initial shape.

19. The method of claim 10, further comprising:
after the expandable material has been 3D printed into the initial shape via binder jetting, curing a binding agent in the 3D-printed expandable material prior to expanding the 3D-printed expandable material to define the component.

20. The method of claim 19, wherein curing the binding agent in the 3D-printed expandable material comprises heat curing the initial shape of the 3D-printed expandable material at a temperature that is below the expansion temperature of the expansion agent.
